(19) United States
(12) Patent Application Publication
(10) Pub. No.: US 2026/0354430 A1
(43) Pub. Date: Nov. 12, 2026

(54) FORMULATED TASTANT COMPOSITIONS

(71) Applicant: VitaKey Inc., Washington, DC (US)

(72) Inventors: Aaron C. Anselmo, Chapel Hill, NC (US); Anant S. Balijepalli, Durham, NC (US); Emily E. Bonacquisti, Chapel Hill, NC (US); Andrew D. Christenson, Raleigh, NC (US); Joshua K. DeGennaro, Cary, NC (US); Seo Yeon Kim, Apex, NC (US); Kevin M. Luo, Raleigh, NC (US); James D. Sievert, Pittsboro, NC (US); Andrea Stamp, Brookline, MA (US); Ana Jaklenec, Lexington, MA (US); Catherine B. Reynolds, Mountain Brook, AL (US); Robert S. Langer, Newton, MA (US); Christina Lynn Makris, Durham, NC (US); Sarah Grace Adzema, Durham, NC (US)

(21) Appl. No.: 19/122,360

(22) PCT Filed: Oct. 19, 2023
(86) PCT No.: PCT/US2023/035553

§ 371 Date: Apr. 18, 2025

Related U.S. Application Data
(60) Provisional application No. 63/417,677, filed on Oct. 19, 2022.
(60) Provisional application No. 63/459,574, filed on Apr. 14, 2023.
(60) Provisional application No. 63/517,318, filed on Aug. 2, 2023.
(60) Provisional application No. 63/579,921, filed on Aug. 31, 2023.

(51) Int. Cl. A23L 27/00; A23L 2/56; A23P 20/10

(52) U.S. Cl. CPC A23L 27/88; A23L 2/56; A23L 27/72; A23P 20/105

(57) ABSTRACT

A formulated tastant composition includes a carrier component and a payload component, the payload component being encapsulated in the carrier component, the carrier and/or payload component including at least one taste modulator designed to confer at least one nutritional and/or health benefit.

### CROSS-REFERENCE TO RELATED APPLICATIONS

The present application claims priority to U.S. Provisional Patent Application No. 63/417,677, filed on Oct. 19, 2022; U.S. Provisional Patent Application No. 63/459,574, filed on Apr. 14, 2023; U.S. Provisional Patent Application No. 63/517,318, filed on Aug. 2, 2023; U.S. Provisional Patent Application No. 63/579,921, filed on Aug. 31, 2023. Each of the above-referenced applications are herein incorporated by reference.

### TECHNICAL FIELD

The present disclosure is generally related to tastant compositions (e.g., formulated tastants) and technologies (e.g., methods of preparation, use, etc.) relating thereto.

### BACKGROUND

The taste, and/or flavor of formulated foods, formulated beverages, formulated supplements, and their nutritional constituents as experienced by mammals such as humans have been studied for several decades. However, in many cases, the challenges associated with controlling the taste and/or flavor of formulated meals and/or formulated foods and/or formulated beverages and/or formulated supplements and/or their nutritional constituents remain unsolved. As such, tastants in meals and/or foods and/or beverages and/or supplements and/or their nutritional constituents have yet to realize their full potential.

### SUMMARY

A tastant compositions (e.g., formulated tastants) can be included in a supplement, a food, a supplemented (i.e., fortified) food product, a beverage, a supplemented (i.e., fortified) beverage product, a powder, or a supplemented (i.e., fortified) powder product intended to confer health benefits and/or induce pleasurable tastes and/or flavors.

Popular tastant compositions (e.g., formulated tastants) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, candy, chewing gum, fermented foods and beverages (e.g., yogurt, beer, etc.); for example, MREs, Gatorade, Truly, Ensure, PKU Sphere Liquid, etc.

In some embodiments, the present disclosure provides technologies (e.g., tastant compositions, such as formulated tastants) that provide one or more advantages for tastants (e.g., sugars, salts, carbohydrates, fats, proteins, vitamins, minerals, etc.) such as extending retention time in the oral cavity, controlling release rate, controlling adsorption and/or absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

In some embodiments, the present disclosure provides technologies and/or tastant compositions (e.g., formulated tastants) that involve utilizing energy sources (e.g., macronutrients, ketones) such as proteins, carbohydrates, fats, and ketones to confer taste benefits.

In some embodiments, the present disclosure provides technologies (e.g., and/or tastant compositions, such as (e.g., formulated tastants) in which one or more tastants, which in some embodiments may be or comprise one or more amino acids, polypeptides (e.g., peptides or proteins), elements, lipids (e.g., fats, fatty acids, short-chain fatty acids, etc), saccharides (e.g., a mono- or poly-saccharide, such as sugars, a carbohydrates, etc, which may in some embodiments be or comprise dietary fiber such as prebiotic fiber), minerals (e.g., electrolytes, salts, etc), carotenoids, ketone bodies, polyphenols (e.g., flavonoids), vitamins, probiotics (bacteria, yeast, etc.), postbiotics (e.g., short-chain fatty acids, lactic acid, etc.), etc., are provided as a preparation that is compatible, for example, with an ingestible source such as a supplement, and/or a food or nutrient, and/or a beverage, consumed by a human or an animal (e.g., a chicken, a cow, a dog, etc.).

Disclosed herein, among other things, are compositions and methods for manufacture, maintenance (e.g., storage, stability, etc.), incorporation (e.g., addition to food, addition to beverages, addition to supplements, addition to products, etc.) and/or use (e.g., administration or delivery) of tastant compositions (e.g., formulated tastants).

In some cases, the tastant compositions (e.g., formulated tastants) is or comprises, for example, one or more antioxidants, macronutrients, micronutrients, polyphenols, fatty acids, ketones, minerals, electrolytes, prebiotics, probiotics, vitamins, or combinations thereof.

In some embodiments, provided tastant compositions (e.g., formulated tastants) are characterized by one or more of the following advantages: (i) improved absorption and/or adsorption of payloads, (ii) improved shelf-life and resistance to degradation at decreased temperatures (e.g., −80 °C, −20 °C, and/or 4 °C), elevated temperatures (e.g., 22 °C, 25 °C, 30 °C, 35 °C, and/or 40 °C), in food and/or food products, in beverages and/or beverage products, in supplements, in dry powders, in the presence of high relative humidity (e.g., up to 100%) or moisture, or a combination thereof; (iii) prolonged residence time or transit time in the mouth and proximal areas (nasal cavity, esophagus, etc.) and their sub-components (mucosa, epithelium, taste buds, cells, etc.), (iv) controlled release or sustained release of payload components in the mouth and proximal areas (nasal cavity, esophagus, etc.) and their sub-components (mucosa, epithelium, taste buds, cells, etc.), (v) controlled spatial distribution of payloads in the mouth and proximal areas (nasal cavity, esophagus, etc.) and their sub-components (mucosa, epithelium, taste buds, cells, etc.), (vi) controlled concentration of payloads in the mouth and proximal areas (nasal cavity, esophagus, etc.) and their sub-components (mucosa, epithelium, taste buds, cells, etc.), (vii) improved shelf-life in food or beverage matrices (e.g., protein bars, dry powders, milk powders, whey powders, yogurt, drinkable yogurt, candy, chewing gum, water, etc.); (viii) improved compatibility with other components of nutraceutical products and/or compositions that include them (e.g., supplements, foods, drinks, or other edible materials), (ix) stability of particles and payload in an aqueous liquid against heat, acid, protons, salt, light, water, oxidation, and/or elevated temperatures; (x) improved payload resistance to losses during manufacturing processes such as pasteurization, shear mixing, elevated pressurized processes, elevated temperature processes, etc.; (xi) stability of payloads in, or as, a dry powder against heat, acid, protons, salt, light, water, moisture, humidity, oxidation, antimicrobial peptides, and/or elevated temperatures; (xii) tunable properties including size, coating thickness, morphology, geometry, loading, dose, interactions with the surrounding environment, and release conditions, etc.; (xiii) improved anti-caking, anti-clumping, anti-agglomerating, and/or anti-aggregating functionality at elevated temperatures; (xiv) maintenance and preservation of composition morphology (e.g., particle geometry) when exposed to typically degrading conditions, such as: decreased temperatures (e.g., −80 °C, −20 °C, and/or 4 °C), elevated temperatures (e.g., 22 °C, 25 °C, 30 °C, 35 °C, and/or 40 °C), in foods and/or food products, in beverages and/or beverage products, in supplements, in dry powders, in the presence of high relative humidity (e.g., up to 100%) or moisture, or a combination thereof; (xii) mitigation of changes to taste, texture, or scents upon addition, storage, or ingestion of the tastant compositions (e.g., formulated tastants); (xiii) reduction of salt content in a tastant composition without altering and/or changing the taste and/or texture of a tastant composition; (xiv) reduction of sugar content in a tastant composition and/or food without altering and/or changing the taste and/or texture of a tastant composition; (xiv) reduction of fat content in a tastant composition and/or food without altering and/or changing the taste and/or flavor of a tastant composition.

As disclosed herein, tastant compositions (e.g., formulated tastants) may be used to confer taste and health benefits in a human or animal. For example, tastant compositions (e.g., formulated tastants) may be administered to a human or animal to control intensity of taste, control duration of taste, control onset of taste, control physiological reflexes, etc.

As disclosed herein, tastant compositions (e.g., formulated tastants) may be used to confer taste and health benefits in a human or animal. For example, tastant compositions (e.g., formulated tastants) may be administered to a human or animal to reduce salt and/or sugar and/or fat content in tastant compositions without changing the taste and/or flavor of a tastant composition.

Without being bound by any theory, tastant compositions (e.g., formulated tastants) confer taste benefits, may do so by extending retention time in the oral cavity, controlling release rate, controlling adsorption/absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

Alternatively or additionally, in some embodiments, provided tastant compositions (e.g., formulated tastants) may be used to accelerate, extend, and/or control the onset of absorption/adsorption of tastants. Controlling tastant composition (e.g., formulated tastants) absorption/adsorption time in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological reflexes, etc.).

Still further alternatively or additionally, in some embodiments, tastant compositions (e.g., formulated tastants) may be used to accelerate, extend, and/or control the residence time of tastants. Controlling tastant composition (e.g., formulated tastants) residence time in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control the surface area or volume that tastants have access to. Controlling tastant composition (e.g., formulated tastants) spatial interactions with host-tissues in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g. formulated tastants) may be used to control the rate of release of tastants and/or payloads. Controlling tastant and/or payload release rate from tastant composition (e.g., formulated tastants) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control the concentration of tastants and/or payloads in localized areas (mucosa, epithelium, taste buds, cells, etc.). Controlling the concentration of tastants and/or payloads in localized areas (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to facilitate payload passage through selective barriers and components (e.g. enzymatic components (ATPases, etc.), physical components (zonula occludens, etc.), molecular components (chondroitin, heparan sulfates, glycosaminoglycans, proteoglycans, etc.). Facilitating payload passage through selective barriers and components may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control binding of tastants to taste receptors. Controlling binding of tastants and/or payloads to taste receptors may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

The present disclosure provides an insight that one challenge in using tastant compositions (e.g., formulated tastants) may be achieving tastant and/or payload stability after host ingestion due to tastant and/or payload sensitivity (e.g., chemical degradation) in various physiological conditions (e.g., saliva, low pH etc.), which may (i) reduce tastant and/or payload amount, (ii) reduce benefits outlined above (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.), or both (i) and (ii).

The present disclosure further provides an insight that one challenge in using tastant compositions (e.g., formulated tastants) may be achieving sufficient control over taste and/or payload release, absorption, adsorption, residence time, spatial interactions, etc. within the mouth and proximal areas, which may (i) reduce tastant and/or payload amount, (ii) reduce control over taste and/or payload absorption/adsorption, (iii) reduce benefits outlined above (e.g., controlled/enhanced taste, reduction of salt in a tastant composition and/or food and/or beverage, reduction of in a tastant composition and/or food and/or beverage, controlled duration of taste, controlled onset of taste), or (i), (ii), and/or (iii) and combinations thereof.

The present disclosure further provides an insight that one challenge in using tastant compositions (e.g., formulated tastants) may be achieving sufficient taste and/or payload dose in various supplement, food and/or beverage formats (e.g., a sufficient number of tastes to confer taste benefits in a host) in conditions that these products are often stored in (e.g., high water activity, high humidity, high moisture, high temperatures, high oxygen, etc.), tastant compositions (e.g., formulated tastants), which may (i) reduce tastant and/or payload amount, (ii) reduce control over taste and/or payload absorption, (iii) reduce benefits outlined above (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste), or (i), (ii), and/or (iii) and combinations thereof.

The present disclosure further observes that some or all of these challenges are often presented together in a tastant composition (e.g., formulated tastants) that has been stored in an unfavorable condition, and is then subsequently ingested by the consumer/host. A tastant composition (e.g., formulated tastants) will face multiple challenges in series and/or in parallel that reduce tastant and/or payload stability and reduce control over tastant and/or payload release, spatial interactions with host-tissues, absorption, adsorption, residence time, etc.

The present disclosure provides technologies that address these challenges, e.g., that can preserve and maintain these features (individually and/or in combination) throughout the lifetime of a tastant composition (e.g., formulated tastant).

The present disclosure appreciates that preserving tastant and/or payload stability in tastant compositions (e.g., formulated tastants) can be important at least because many of the beneficial functions provided by tastants require their stability.

When considering ideal conditions for tastant compositions (e.g., formulated tastants) that can withstand challenges encountered throughout the lifetime (e.g., as ingredients, during processing, during manufacturing, incorporation into consumer products, shelf-storage, ingestion, digestion, etc.), the present disclosure appreciates that effective technologies desirably confer prevention, limitation, mitigation, and/or control interactions with the surrounding environment (which may change throughout the lifetime of the tastant composition).

When considering surrounding environments with which a tastant composition (or components thereof) may interact, possibilities include the food and/or beverage itself (e.g., a particular unit or portion of a composition is exposed to and/or in contact with other units or portions of the composition), the tastant and/or tastants itself, one or more particular constituents of the tastant composition, shelf-storage conditions, manufacturing conditions, the environmental conditions after the food and/or beverage is unsealed/opened, physiological environment within a host that ingests the composition, etc.

The present disclosure further appreciates that tastant and/or payload stability can impact certain tastant compositions (e.g., formulated tastants) functions (e.g., extending retention time of payload in the oral cavity, controlling payload release rate, controlling payload adsorption/absorption rates, controlling payload spatial interactions and concentrations within the oral cavity and specific areas (e.g. tongue, throat, nasal cavities, mucosa, epithelium, taste buds, microvilli, taste bud cell, etc.), facilitating payload passage through selective barriers and components, controlling binding of payload to taste receptors, etc.) that confer tastant composition taste and health benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) in some cases, tastant compositions may comprise promoters that increase payload stability, modulate the environment to favor payload stability, or combinations thereof.

The present disclosure provides an insight that including sufficient amounts of provided tastant composition(s) (e.g., formulated tastants) in consumer products, or otherwise delivering them to a host, can have beneficial impacts (e.g., extending payload absorption time, extending payload retention time, controlling payload spatial interactions within the host, controlling payload release rate, increasing or decreasing payload absorption, increasing or decreasing payload concentrations within the host, etc.), some or all of which may confer taste benefits.

In some embodiments, attributes of certain provided technologies tastant compositions (e.g., formulated tastants), including specifically performance (e.g. controlled retention time, controlling release rate, controlling adsorption/absorption, controlling concentration, facilitating passage through selective barriers and components, controlling binding of payload to taste receptors, etc.) following ingestion provide important benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) not otherwise achieved.

In some embodiments, the present disclosure provides tastant compositions (e.g., formulated tastants) that are or comprise a particle preparation, wherein the particles of the particle preparation comprise (i) an encapsulant component; and (ii) a payload component, wherein the encapsulant component comprises a protein, carbohydrate, fat, or other tastant that is compatible with supplement, food, beverage, and/or physiological fluid/environments (e.g., mouth, saliva, etc.); and the payload component comprises a tastant and wherein the preparation enables: (i) protection (maintenance/preservation of tastant stability) of the payload in supplements, foods, beverages, and/or physiological fluids/environment (e.g., mouth, saliva, etc.), and/or processing/manufacturing environments (e.g., high pressure pasteurization, high temperature pasteurization, etc.); (ii) delivery functions (e.g., extending payload absorption time, extending payload retention time, controlling payload spatial interactions within the host, controlling payload release rate, increasing or decreasing payload absorption, increasing or decreasing payload concentrations within the host, etc.) that confer tastant composition taste benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.). In some such embodiments, the composition and/or the preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material. Alternatively or additionally, in some such embodiments, the compositions and/or the particle preparation is characterized in that it enables controlled release of the payload component in the.). Alternatively or additionally, in some such embodiments, the compositions and/or the particle preparation is characterized in that it enables sustained release of the payload component in the host's.). Alternatively or additionally, in some such embodiments, the compositions and/or the particle preparation is characterized in that it retention time of the payload component in the host's gastrointestinal tract is controlled (e.g., esophagus, stomach, small intestine, large intestine, etc.). Alternatively or additionally, in some such embodiments, the compositions and/or the particle preparation is characterized in that payload absorption in the host's Alternatively or additionally, in some such embodiments, the compositions and/or the particle preparation is characterized in that payload spatiotemporal association within the host's gastrointestinal tract is controlled (e.g., esophagus, stomach, small intestine, large intestine, etc.). Alternatively or additionally, in some such embodiments, the compositions and/or the particle preparation is characterized in that it controls the payload concentration in the host's gastrointestinal tract (e.g., esophagus, stomach, small intestine, large intestine, etc.). Alternatively or additionally, in some such embodiments, the compositions and/or the particle preparation is characterized in that it facilitates payload passage through selective barriers and components (e.g. enzymatic components (ATPases, etc.), physical components (zonula occludens, etc.), molecular components (chondroitin, heparan sulfates, glycosaminoglycans, proteoglycans, etc.). Alternatively or additionally, in some such embodiments, the compositions and/or the particle preparation is characterized in that it controls binding of tastants and/or payloads to taste receptors.

In certain embodiments, the present disclosure provides human and/or animal consumable compositions (e.g., supplement products, food products, powder products, beverage products, liquid products, etc.) comprising disclosed tastant compositions (e.g., formulated tastants), at least one tastant, or a combination thereof. In some instances, tastant compositions (e.g., formulated tastants) further comprise at least one nutraceutical.

In some cases, humans may be a prenatal human, infant, toddler, child, teenager, adolescent, young adult, adult, geriatric, medical patient, athlete, student, etc.

In some cases, animals may be an agricultural animal (e.g., a horse, a cow, a camel, a goat, a sheep, a fish, a crab, etc.), a pet (e.g., a dog, a cat, a fish, a duck, etc.), and/or a wild animal (e.g., a raccoon, a deer, a moose, a bear, a whale, an ant, a bee, a wasp, etc.).

In many embodiments, provided compositions are edible (i.e., consumable by eating). In some aspects, an edible composition may be a powder or slurry that is mixed with food (e.g., a freshly prepared meal, a pre-prepared meal, etc.) prior to consumption.

In many embodiments, provided compositions are drinkable (i.e., amenable to consumption by drinking). In some aspects, a drinkable composition may be a powder or slurry that is mixed with a beverage (e.g., water, a protein shake, etc.) prior to consumption.

In some aspects, consumable compositions comprising tastant compositions (e.g., formulated tastants) may be drinkable. In some aspects, an edible composition may be a powder or slurry that is mixed with a beverage (e.g., water, a protein shake, etc.) prior to consumption.

In some aspects, the present disclosure provides methods for preparing a tastant and/or tastant payload component. In some such embodiments, a provided method may comprise steps of: (i) formulation (e.g., encapsulation, association, and/or complexation with materials); (ii) post-formulation processing (e.g., drying, characterization, additions of excipients, etc.); (iii) storage (e.g., bagging in aluminum sachets, addition of nitrogen or vacuum environments, etc.); (iv) combination with or as supplements and/or foods and/or beverages; (v) methods to ingestions (e.g., swallowing as a capsule, addition to other existing food and/or beverages); or (vi) a combination of (i), (ii), (iii), (iv), and (v).

In some aspects, the disclosure provides tastant compositions (e.g., formulated tastants) and/or tastant payloads, which may in some embodiments have been prepared by a method described herein.

In some aspects, the present embodiments are directed to tastant compositions (e.g., formulated tastants) comprising a carrier component and a payload component, wherein the payload component is associated with (e.g., encapsulated in, adhered to, dispersed in) the carrier component; and wherein the payload component comprises: (i) a taste component; (ii) a component that the payload utilizes for functional performance (e.g., extending retention time of payload in the oral cavity, controlling payload release rate, controlling payload adsorption/absorption rates, controlling payload spatial interactions and concentrations within the oral cavity and specific areas (e.g. tongue, throat, nasal cavities, mucosa, epithelium, taste buds, microvilli, taste bud cell, etc.), facilitating payload passage through selective barriers and components, controlling binding of payload to taste receptors, etc.) within the host; (iii) a component that modulates the environment (e.g., food matrix, liquid environment, physiological fluid, tissue/organ such as mouth, esophagus, epithelium, etc.) to preserve or maintain taste stability and/or delivery functions; (iv) one or more other payload component(s), or (v) a combination of (i), (ii), (iii), or (iv).

In some embodiments, provided tastant compositions (e.g., formulated tastants) are or comprise particles (e.g., microparticles) that include a matrix component (e.g., a polymer component) and a payload component (e.g., tastants, nutrients, macronutrients, micronutrients, proteins, carbohydrates, fats, vitamins, minerals, ketones, polyphenols, etc.). In some instances, one or more layers of matrix components are present.

In some embodiments, a matrix component is or comprises a hydrophobic component. In some instances, a hydrophobic component is or comprises a sugar, a polysaccharide, a carbohydrate, an oil, a fat, a wax, a protein, or a combination thereof. In some instances, a matrix component comprises a salt (e.g., calcium carbonate). In some instances, a matrix component comprises a surfactant (e.g., sodium dodecyl sulfate). In some instances, a matrix component comprises a polymer (e.g., polyvinyl alcohol). In some instances, one or more layers of payload components are present.

In some embodiments, a matrix component is or comprises a hydrophilic component. In some instances, a hydrophilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some embodiments, a matrix component is or comprises an amphiphilic component. In some instances, an amphiphilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some instances, a matrix component comprises a biocompatible material. In some instances a biocompatible material is or comprises a sugar, a polysaccharide, a carbohydrate, an oil, a fat, a wax, a lipid, a protein, an amino acid, a peptide, or a combination thereof. In some instances, a matrix component comprises a salt (e.g., calcium carbonate). In some instances, a matrix component comprises a surfactant (e.g., sodium dodecyl sulfate).

In some cases, a matrix component further comprises one or more nutrient (e.g., antioxidants, flavonoids, polyphenols, vitamins, minerals, micronutrients, prebiotics, electrolytes, etc.) payloads.

The present disclosure provides technologies for making and/or characterizing matrix components comprising encapsulants described herein, and/or compositions that include them. In some embodiments, the disclosed processes and methodologies to generate matrices include extrusion, granulation, extrusion-based methods, melt processing, shear-based granulation methods, lyophilization, atomization, prilling, spray chilling, and/or spray congealing methods.

In some embodiments, the carrier component comprises at least one carbohydrate, at least one polymer, and/or at least one lipid.

In some embodiments, the disclosed food component comprises a tastant selected from the group consisting of: a naturally-occurring tastant, and a tastant prepared by any method described herein; a commercially-available tastant, and a tastant prepared by any method described herein; a commercially-available tastant preparation (e.g., freeze-dried, or already-formulated tastants), and a tastant prepared by any method described herein. As such, in some embodiments according to the present disclosure, the disclosed food component comprises a commercially-available tastant powder that includes a carrier or matrix component that is then further encapsulated in a carrier, as described herein. In such embodiments, an inner carrier containing the tastant is itself encapsulated in one or more outer encapsulant layers or carriers.

In some embodiments, a provided composition may be or comprise one or more particles; typically, a population of particles. In some embodiments, a particle or population thereof is characterized by its diameter (e.g., average diameter). A particle “diameter” (i.e., a particle size) is the longest distance from one end of the particle to another end of the particle. In some embodiments, tastant compositions (e.g., formulated tastants) are or comprise particles with a distribution of particle diameters (e.g., D[3,2], D[4,3], etc.). In some embodiments, tastant compositions (e.g., formulated tastants) are or comprise particles with a distribution of particle diameters (e.g., D[3,2], D[4,3], etc.) of up to about 1 nm, up to about 100 nm, up to about 500 nm, up to about 1 μm, up to about 10 μm, up to about 100 μm, up to about 500 μm, up to about 1 mm, up to about 1 mm, up to about 10 mm, or up to about 50 mm.

In some embodiments, tastant compositions (e.g., formulated tastants) may include particle preparations that include any shape or form, for example, having a cross-section shape of a circle, an oval, a triangle, a square, a hexagon, or an irregular shape. In some embodiments, tastant compositions (e.g., formulated tastants) comprise particles (e.g., nanoparticles, microparticles), wherein a majority of particles have a common shape. In some embodiments, tastant compositions (e.g., formulated tastants) are or comprise particles of various such shapes in combination.

In some embodiments, tastant compositions (e.g., formulated tastants) may include individual constituents that self-assemble into particle preparations upon exposure to a specific environment (e.g., food matrix, beverage matrix, physiological fluid, stomach acids, bile salts, temperature, etc.). tastant compositions (e.g., formulated tastants) that self-assemble into particle preparations upon introduction into specific environments include any shape or form, for example, having a cross-section shape of a circle, an oval, a triangle, a square, a hexagon, or an irregular shape. In some embodiments, tastant compositions (e.g., formulated tastants) comprise particles (e.g., nanoparticles, microparticles), wherein a majority of particles have a common shape. In some embodiments, tastant compositions (e.g., formulated tastants) are or comprise particles of various such shapes in combination.

In some embodiments, provided tastant compositions (e.g., formulated tastants) are characterized by having a layered structure, e.g., wherein adjacent layers have different chemical structures.

In some embodiments, provided tastant compositions (e.g., formulated tastants) are characterized by having multiple polymer components, wherein the tastant compositions (e.g., formulated tastants) may be additionally encapsulated with a separate polymer component.

In some embodiments, the compositions (e.g., formulated tastants) provided by the present disclosure include, a first layer that is or comprises a tastant and/or a second tastant and a second layer that is or comprises a different tastant and/or the same tastant. For example, in some particular embodiments, a tastant material may be or comprise proteins and/or carbohydrates; in some embodiments, the protein may be encapsulated within the carbohydrate; in some embodiments, the carbohydrate may be encapsulated within the protein; in some embodiments, the carbohydrate may be encapsulated within the same or a distinct carbohydrate. In some embodiments, the carbohydrate may be encapsulated within a mixture of protein and carbohydrates. In some embodiments, the layers are reversed.

In some such embodiments, the composition and/or the preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material.

Tastant compositions (e.g., formulated tastants) comprising enhanced stability provides benefits over existing comparable products, among other things because enhanced stability will extend shelf-life.

In some embodiments, the present disclosure provides technologies for manufacturing provided tastant compositions (e.g., formulated tastants) that increase payload stability during and/or following manufacturing (thereby minimizing payload losses in food and/or beverage products). Thus, the present disclosure provides technologies with a variety of advantages.

In some embodiments, the present disclosure provides technologies for manufacturing provided tastant compositions (e.g., formulated tastants) that increase shelf-life following manufacturing (thereby minimizing payload losses in food and/or beverage products). Thus, the present disclosure provides technologies with a variety of advantages.

Tastant compositions (e.g., formulated tastants) comprising enhanced shelf-life provides benefits over existing products, among other things because extended shelf-life will provide longer-duration of product lifetime.

In some embodiments, the present disclosure provides technologies for manufacturing provided tastant compositions (e.g., formulated tastants) that increase shelf-life time following manufacturing (thereby minimizing payload losses in food and beverage products). Thus, the present disclosure provides technologies with a variety of advantages.

In some such embodiments, the compositions and/or the particle preparation is characterized in that it enables controlled release of the payload component in the host's oral cavity and specific areas (e.g. tongue, throat, nasal cavities, mucosa, epithelium, taste buds, microvilli, taste bud cell, etc.

Tastant compositions (e.g., formulated tastants) comprising controlled release of payloads have benefits over existing products, among other things because controlled payload release will provide methods to improve or control taste.

In some embodiments, the present disclosure provides technologies for manufacturing provided tastant compositions (e.g., formulated tastants) that provide controlled release of payloads following manufacturing (thereby ensuring that products containing compositions can provide controlled delivery of tastants). Thus, the present disclosure provides technologies with a variety of advantages.

In some such embodiments, the compositions and/or the particle preparation is characterized in that it enables sustained release of the payload component in the host's oral cavity and specific areas (e.g. tongue, throat, nasal cavities, mucosa, epithelium, taste buds, microvilli, taste bud cell, etc.

In some embodiments, tastant compositions (e.g., formulated tastants) comprising sustained release of payloads have benefits over existing products, among other things because sustained payload release will provide methods to improve or control taste.

In some embodiments, tastant compositions (e.g., formulated tastants) that provide methods to improve or control taste have benefits over existing products, among other things because controlled taste can enable reduction of salt and/or sugar and/or fat in tastant compositions.

In some embodiments, the present disclosure provides technologies for manufacturing provided tastant compositions (e.g., formulated tastants) that provide sustained release of payloads following manufacturing (thereby ensuring that products containing compositions can provide sustained taste). Thus, the present disclosure provides technologies with a variety of advantages.

In some such embodiments, the compositions and/or the particle preparation is characterized in that it enables extended retention time of the payload component in the host's oral cavity and specific areas (e.g. tongue, throat, nasal cavities, mucosa, epithelium, taste buds, microvilli, taste bud cell, etc.).

Tastant compositions (e.g., formulated tastants) comprising extended retention time of payloads have benefits over existing products, among other things because extended retention of payloads will provide methods to improve or control taste.

In some embodiments, the present disclosure provides technologies for manufacturing provided tastant compositions (e.g., formulated tastants) that provide extended retention time of payloads following manufacturing (thereby ensuring that products containing compositions can provide sustained taste). Thus, the present disclosure provides technologies with a variety of advantages.

In some such embodiments, the compositions and/or the particle preparation is characterized in that payload absorption in the host's oral cavity and specific areas (e.g. tongue, throat, nasal cavities, mucosa, epithelium, taste buds, microvilli, taste bud cell, etc.) is controlled.

Tastant compositions (e.g., formulated tastants) comprising controlled payload absorption have benefits over existing products, among other things because controlled absorption of payloads will provide methods to improve or control taste.

In some embodiments, the present disclosure provides technologies for manufacturing provided tastant compositions (e.g., formulated tastants) that provide controlled absorption of payloads following manufacturing (thereby ensuring that products containing compositions can improve or control taste). Thus, the present disclosure provides technologies with a variety of advantages.

In some such embodiments, the compositions and/or the particle preparation is characterized in that payload spatiotemporal association within the host's oral cavity and specific areas (e.g. tongue, throat, nasal cavities, mucosa, epithelium, taste buds, microvilli, taste bud cell, etc.) is controlled.

Tastant compositions (e.g., formulated tastants) comprising controlled payload spatial association within the host's oral cavity and specific areas have benefits over existing products, among other things because controlled payload spatial association within the host's oral cavity and specific areas will provide methods to improve or control taste.

In some embodiments, the present disclosure provides technologies for manufacturing provided tastant compositions (e.g., formulated tastants) that provide controlled payload spatial association within the host's oral cavity and specific areas following manufacturing (thereby ensuring that products containing compositions can improve or control taste). Thus, the present disclosure provides technologies with a variety of advantages.

In some such embodiments, the compositions and/or the particle preparation is characterized in that it controls the payload concentration within the host's oral cavity and specific areas (e.g. tongue, throat, nasal cavities, mucosa, epithelium, taste buds, microvilli, taste bud cell, etc.).

Tastant compositions (e.g., formulated tastants) comprising controlled payload concentrations within and around the host's oral cavity have benefits over existing products, among other things because controlled payload concentrations within the host's gastrointestinal tract will provide methods to improve or control taste.

In some embodiments, the present disclosure provides technologies for manufacturing provided tastant compositions (e.g., formulated tastants) that provide controlled payload concentration within and around the host's oral cavity following manufacturing (thereby ensuring that products containing compositions can improve or control taste from foods and/or beverages). Thus, the present disclosure provides technologies with a variety of advantages.

In some such embodiments, the compositions and/or the particle preparation are characterized in that it facilitates payload passage through selective barriers and components (e.g. enzymatic components (ATPases, etc.), physical components (zonula occludens, etc.), molecular components (chondroitin, heparan sulfates, glycosaminoglycans, proteoglycans, etc.)).

Tastant compositions (e.g., formulated tastants) facilitating payload passage through selective barriers and components have benefits over existing products, among other things because facilitated passage will provide methods to improve or control taste.

In some embodiments, the present disclosure provides technologies for manufacturing provided tastant compositions (e.g., formulated tastants) that facilitate passage through selective barriers and components of payloads following manufacturing (thereby ensuring that products containing compositions can improve or control taste). Thus, the present disclosure provides technologies with a variety of advantages.

In some such embodiments, the compositions and/or the particle preparation are characterized in that it controls binding of payload to taste receptors.

Tastant compositions (e.g., formulated tastants) comprising control of binding of payload to taste receptors have benefits over existing products, among other things because controlled binding to taste receptors will provide methods to improve or control taste.

In some embodiments, the present disclosure provides technologies for manufacturing provided tastant compositions (e.g., formulated tastants) that provide controlled binding of payload to taste receptors following manufacturing (thereby ensuring that products containing compositions can improve or control taste). Thus, the present disclosure provides technologies with a variety of advantages.

In some embodiments, the present disclosure provides tastant compositions (e.g., formulated tastants) for stability in supplements, foods and/or beverages at elevated temperatures, water activities, humidity and/or moisture. This provides benefits over existing products, among other things because these conditions lead to rapid tastant degradation after incorporation with products and during shelf-storage. Thus, the present disclosure provides technologies with a variety of advantages.

In some embodiments, the present disclosure provides particular insight that identifies the source of a limitation associated with certain current tastant compositions (e.g., formulated tastants) in that tastant compositions do not provide control over: 1) retention time in the oral cavity; 2) payload release rate; 3) payload adsorption/absorption rate; 4) payload spatial interactions within and around the oral cavity; 5) payload passages through selective barriers and components; 6) binding of payload to taste receptors, which lead to limitations in being able to create and implement food and beverage products capable of controlling: 1) intensity of taste; 2) duration of taste; 3) onset of taste; 4) physiological reflexes.

Without wishing to be bound by theory, many presently available food and/or beverage products and/or tastants cannot achieve control over taste and/or flavor and therefore lack various benefits provided by the present disclosure. Technologies provided herein enable delivery and delivery functions when individually ingested, and/or when combined with or into a multitude of food and/or beverage and/or powder and/or tastant products in the areas of supplements, foods, tastants, and/or beverages.

In some cases, a temperature-responsive encapsulant is more readily processed at lower temperatures (e.g., glass transition temperature) through addition of payloads or plasticizers. In some embodiments, payloads alone can lower the glass transition temperature of temperature-responsive polymers. Collectively, this facilitates manufacturing and processing approaches at lower temperatures, since encapsulant component and payload component can more easily transition from flowable homogenous liquid states to solid states (e.g., particles).

In some instances, a provided tastant composition (e.g., formulated tastant) provides increased shelf-life in beverages at 4 °C, 18 °C, 25 °C, 30 °C, 35 °C.

In some instances, a provided tastant composition (e.g., formulated tastant) provides increased shelf-life in dry powders at −20 °C, 4 °C, 18 °C, 25 °C, 30 °C, 35 °C.

In some instances, a provided tastant composition (e.g., formulated tastant) provides increased shelf-life in food matrices at −20 °C, 4 °C, 18 °C, 25 °C, 30 °C, 35 °C.

In some instances, a provided tastant composition (e.g., formulated tastant) provides increased shelf-life prior to incorporation into any matrix at −20 °C, 4 °C, 18 °C, 25 °C, 30 °C, 35 °C.

In some instances, a provided tastant composition (e.g., formulated tastant) provides increased shelf-life in capsules and/or tablets and/or pills at −20 °C, 4 °C, 18 °C, 25 °C, 30 °C, 35 °C.

In some embodiments, a provided tastant compositions (e.g., formulated tastants) may be or is effective at protecting payload components (e.g., tastant payload component) and/or encapsulant components (e.g., a tastant encapsulant) against a physical change, a chemical change, or both (e.g., degradation, oxidation, hydrolysis, isomerization, fragmentation, or a combination thereof).

In some embodiments, a provided tastant compositions (e.g., formulated tastants) may be or remain stable, e.g., to store for a particular period of time under particular conditions.

For example, in some embodiments, 99% of a payload and/or encapsulant component present in a provided composition at a particular point in time remains present, and/or one or more size characteristics (e.g., average diameter and/or one or more features of size distribution of a particle composition) remains stable throughout a period of time during which the composition is maintained under particular conditions. For example, a payload component present in a provided composition may remain stable in a dry powder form for a period of time. In some embodiments, a payload component present in a provided composition may remain stable for a period of time when dispersed within solid food (at chilled, room temperature, and/or elevated temperatures). In some embodiments, a payload component present in a provided composition may remain stable for a period of time when dispersed within a beverage (at chilled, room temperature, and/or elevated temperatures). In some embodiments, a payload component present in a provided composition may remain stable for a period of time when dispersed within an acidic solution (for example, at a pH<3).

In some embodiments, the period of time is at least 2, 3, 4, 5, 6, 7, 8, 9, 10, 11, 12, 13, 14, 15, 16, 17, 18, 19, 20, 21, 22, 23, 24 weeks or more, and/or at least about 1, 2, 3, 4, 5, 6, 7, 8, 9, 10, 11, 12 months or more, and/or at least about 1, 2, 3, 4, 5 years or more.

In some such embodiments, the particular conditions comprise ambient temperature. In some such embodiments, the particular conditions comprise elevated (above ambient) temperature. Alternatively or additionally, in some embodiments, the particular conditions comprise aqueous conditions (e.g., aqueous liquid conditions). In some embodiments, the period of time is at least two months and the particular conditions comprise ambient temperature.

In some embodiments, stability comprises mitigation, limitation, or prevention of chemical degradation of tastant payloads and/or tastant encapsulants.

In some embodiments, stability comprises maintenance of delivery functions (e.g., extending retention time of payload in the oral cavity, controlling payload release rate, controlling payload adsorption/absorption rates, controlling payload spatial interactions and concentrations within and around the oral cavity and specific areas (e.g. tongue, throat, nasal cavities, mucosa, epithelium, taste buds, microvilli, taste bud cell, etc.), facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.)), controlling binding of payload to taste receptors, etc.) of provided tastant compositions (e.g., formulated tastants) and/or tastant payloads and/or tastant encapsulants.

In some embodiments, stability comprises maintenance of conferred taste benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) for tastant compositions (e.g., formulated tastants) and/or tastant payloads and/or tastant encapsulants.

In some embodiments, tastant compositions (e.g., formulated tastants) exhibit improved anti-caking, anti-clumping, anti-agglomerating, and/or anti-aggregating performance to enable incorporation into food and beverage products (e.g., food, liquid beverages, dry powders, etc.).

In some embodiments, a tastant composition (e.g., formulated tastants) may further comprise an excipient component (e.g., an anti-caking component, an anti-clumping component, a plasticizer, an anti-agglomerating component, and/or an anti-aggregating component [e.g., any of an excipient comprising microcrystalline cellulose, starches, calcium carbonate, etc.], wherein an excipient component is at least about 99 wt %, at least about 90 wt %, at least about 85 wt %, at least about 80 wt %, at least about 75 wt %, at least about 70 wt %, at least about 65 wt %, at least about 60 wt %, at least about 55 wt %, at least about 50 wt %, at least about 45 wt %, at least about 40 wt %, at least about 35 wt %, at least about 30 wt %, at least about 25 wt %, at least about 20 wt %, at least about 15 wt %, at least about 10 wt %, at least about 5 wt %, at least about 1 wt %, at least about 0.8 wt %, at least about 0.5 wt %, at least about 0.1 wt % of a particle preparation (i.e., a tastant composition).

The disclosed tastant composition (e.g., formulated tastants) may be particularly useful for stabilizing tastant payloads and/or encapsulant payloads and/or taste payloads, and maintaining delivery functions (e.g., extending retention time of payload in the oral cavity, controlling payload release rate, controlling payload adsorption/absorption rates, controlling payload spatial interactions and concentrations within and around the oral cavity and specific areas (e.g. tongue, throat, nasal cavities, mucosa, epithelium, taste buds, microvilli, taste bud cell, etc.), facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.)), controlling binding of payload to taste receptors), and enabling the associated taste and health benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, etc.) in consumable compositions (e.g., a food product, a beverage product, an animal-consumable product, dry powders, supplements, etc.), where food components typically lose stability, delivery functions, and the associated taste benefits.

In certain embodiments, the present disclosure provides consumable compositions (e.g., a food product, a beverage product, an animal-consumable product, dry powders, a supplement, etc.)

In some aspects, consumable compositions comprising tastant composition (e.g., formulated tastants) may be edible. In some aspects, an edible composition may be a protein bar, a cereal, a protein powder, a milk powder, a salad dressing, a nutritional supplement, a baby formula, a smoothie, a yogurt, an ice cream, a sachet, a spice, a food additive, a candy, a sprinkle packet, and/or a pet food

In some aspects, consumable compositions comprising tastant composition (e.g., formulated tastants) are drinkable. In some aspects, a drinkable composition may be a sports drink, beer, wine, tea, coffee, milk, juice, water, yogurt, soda, carbonated water, or a liquid pharmaceutical formulation.

In some embodiments, enhanced stability, maintenance of delivery functions, and/or conferring taste and health benefits are maintained after storage (e.g., with or within a consumable composition) in a freezer (−85 °C to 0 °C), a refrigerator (1-10 °C), or atmospheric temperature (−10 °C-40 °C) for time periods between 0-1 week, 0-1 month, 0-1 year or 1-5 years.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWING

FIG. 1 shows, in a non-limiting example, a schematic of exemplary core-shell preparations which may comprise carrier components, payload components, excipient components, and combinations thereof.

FIG. 2 shows, in a non-limiting example, a schematic of exemplary core-shell particle preparations with multiple layers which may comprise food components, excipient components, or combinations thereof.

FIG. 3 shows, in a non-limiting example, a schematic of exemplary matrix preparations which may comprise food components, excipient components, or combinations thereof.

FIG. 4 shows, in a non-limiting example, photographs and brightfield micrographs of exemplary encapsulated sugar compositions comprising a core component (e.g., sucrose) and a shell component (e.g., zein).

FIG. 5 shows, in a non-limiting example, a schematic of a method used to apply a coating to a food and/or beverage composition, referred to herein as “coating”.

FIG. 6 shows, in a non-limiting example, a schematic of a method used to create a matrix food and/or beverage composition, referred to herein as “matrix”.

FIG. 7 shows, in a non-limiting example, a schematic of a method used to characterize dissolution and/or release of food and/or beverage composition, referred to herein as “dissolution” and/or “release”.

FIG. 8 presents, in a non-limiting example, 4 target (e.g., theoretical) release profiles (concentration of food component vs incubation period) of one or more food component(s) from one or more tastant composition(s).

FIG. 9 presents, in a non-limiting example, a plot of glucose release (mg/dL or mg/dL/min) over time, indicating release of sucrose payload from tastant compositions (e.g., with exemplary tastant compositions comprising encapsulated sucrose coated with 10% zein).

FIG. 10 presents, in a non-limiting example, a plot of glucose release (mg/dL or mg/dL/min) over time, indicating release of glucose payload from food and/or beverage compositions (e.g., with exemplary food and/or beverage compositions (10% zein, 2.5% glyceryl monostearate, 1% propylene glycol)) at 37 °C for 60 minutes.

FIG. 11 illustrates, in a non-limiting example, photographs of food and/or beverage compositions (e.g., alginate/sucrose beads, gelatin/sucrose beads, and/or sucrose/amylose beads) blended homogeneously with commercially available food product (e.g., MRE, Ensure), imparting minimal change to visible appearance (e.g., color and texture).

FIG. 12 illustrates, in a non-limiting example, brightfield micrographs of the stability of tastant compositions (e.g., alginate/sucrose beads, gelatin/sucrose beads, and/or sucrose/amylose beads) when blended homogeneously with water. Morphological changes are observed following a 1-hour incubation period.

FIG. 13 shows, in a non-limiting example, a comparison of unformulated carbohydrate powder and taste composition(s) comprising carbohydrate(s) as component(s) of matrix composition(s) and/or core-shell preparation(s). (A) Unformulated glucose; (B) sucrose-amylose matrix preparation(s) encapsulated in Zein; (C) 60% (w/v) glucose encapsulated in 2% (w/v) pectin; (D) 1% (w/v) inulin encapsulated in 2% (w/v) agarose; (E) 10% (w/v) calcium caseinate and 1% (w/v) inulin encapsulated in 2% (w/v) sodium alginate.

FIG. 14 shows, in a non-limiting example, a comparison of unformulated protein and taste composition(s) comprising protein(s) as component(s) of matrix composition(s) and/or core-shell preparation(s). (A) Unformulated whey protein isolate (WPI) powder; (B) 20% (w/v) whey protein isolate encapsulated in 80% (w/v) beeswax, (C) whey protein (5% w/v) encapsulated in 80% (w/v) fully hydrogenated soy oil and Tween 80 (15% w/v); (D) whey protein (10% w/v) encapsulated in 3% (w/v) agarose and 1% (w/v) chitosan.

FIG. 15 shows, in a non-limiting example, a comparison of unformulated lipid and taste composition(s) comprising lipid(s) as component(s) of matrix composition(s) and/or core-shell preparation(s). (A) Unformulated oleic acid (OLEA); (B) 80% (w/v) oleic acid in ethyl cellulose (20% w/v); (C) 80% (w/v) oleic acid in carnauba wax (20% w/v); (D) 80% (w/v) oleic acid in ethyl cellulose (20% w/v); (E) 80% (w/v) oleic acid in ethyl cellulose (20% w/v) with a polymeric coating.

FIG. 16 illustrates, in a non-limiting example, several exemplary release profiles of carbohydrate(s) encapsulated within one or more taste composition(s) in phosphate buffered saline, pH 7.4, 37 °C. Taste composition(s) characterized as matrix preparation(s) are colored light grey, while those characterized as core-shell preparations wherein the core component(s) are further characterized as matrix preparation(s) are colored dark grey. (A) Release of glucose from taste composition(s) over time; each line represents an average of 3 dissolution experiments for a distinct taste composition (e.g., distinct component(s) and concentration(s)) comprising glucose. (B) First order release rates modeled from glucose release of distinct taste composition(s) sorted from fastest release (top) to slowest release (bottom).

FIG. 17 illustrates, in a non-limiting example, several exemplary release profiles of protein(s) encapsulated within one or more taste composition(s) in phosphate buffered saline, pH 7.4, 37 °C. Taste composition(s) characterized as matrix preparation(s) are colored light grey, while those characterized as core-shell preparations wherein the core component(s) are further characterized as matrix preparation(s) are colored dark grey. (A) Release of whey from taste composition(s) over time; each line represents an average of 3 dissolution experiments for a distinct taste composition (e.g., distinct component(s) and concentration(s)) comprising whey. (B) First order release rates modeled from whey release of distinct taste composition(s) sorted from fastest release (top) to slowest release (bottom).

FIG. 18 illustrates, in a non-limiting example, several exemplary release profiles of lipid(s) encapsulated within one or more taste composition(s) in phosphate buffered saline, pH 7.4, 37 °C. Taste composition(s) characterized as matrix preparation(s) are colored light grey. (A) Release of oleic acid from taste composition(s) over time; each line represents an average of 3 dissolution experiments for a distinct taste composition (e.g., distinct component(s) and concentration(s)) comprising oleic acid. (B) First order release rates modeled from oleic acid release of distinct taste composition(s) sorted from fastest release (top) to slowest release (bottom).

FIG. 19 illustrates, in a non-limiting example, a comparison of unformulated flavonoid (e.g., polyphenol) and formulated flavonoid (e.g., polyphenol) in taste composition(s) as components of matrix preparation(s) and/or core-shell preparation(s), as well as release profile(s) of encapsulated flavonoid(s). (A) Unformulated cyanidin chloride powder. (B) Matrix preparation comprising glucose. (C) core-shell preparation wherein core component(s) comprise glucose and shell component(s) comprise cyanidin chloride. (D) Release of cyanidin chloride from core-shell preparation in phosphate buffered saline, pH 7.4, 37 °C.

FIG. 20 illustrates, in a non-limiting example, a comparison of unformulated carbohydrate and formulated carbohydrate in taste composition(s) as components of matrix preparation(s) and/or core-shell preparation(s), as well as release profile(s) of encapsulated carbohydrate(s). (A) Unformulated inulin powder. (B) Matrix preparation comprising inulin. (C) Release of inulin from matrix preparation in phosphate buffered saline, pH 7.4, 37 °C.

FIG. 21 shows, in a non-limiting example, exemplary multi-layer core-shell particle preparation(s) controlling the release of protein payload(s). FIG. 21A illustrates a photograph of multi-layer core-shell particle preparation(s) comprising 50% (w/w) casein, 27% (w/w) starch, 9% (w/w) lactose, 4% (w/w) inulin, 5% (w/w) hypromellose, and 5% (w/w) ethyl cellulose produced through a wet granulation, extrusion, and spheronization process, followed by fluid bed coating to a total coating weight gain of 10% (w/w). Particles exhibit a 14-mesh size.

FIG. 21B illustrates exemplary release of casein from exemplary multi-layer core-shell particle preparation(s) over 4 hours in 10 mM phosphate buffered saline, pH 7.4 with no shell (black circles), inner shell of Hypromellose and outer shell of ethyl cellulose (dark grey diamonds), or inner shell of ethyl cellulose and outer shell of hypromellose (light grey squares). Data are an average percent release with respect to loaded protein concentration (e.g., initial loading within exemplary multi-layer core-shell particles) of 3 replicates +/−standard deviation.

FIG. 22 shows, in a non-limiting example, exemplary pH-responsive matrix particle preparation(s) controlling the release of protein payload(s). FIG. 22A illustrates a micrograph of pH-responsive matrix particle preparation(s) comprising 61% (w/w) sodium alginate and 29% (w/w) calcium caseinate produced through a spray drying process utilizing an ultrasonic nozzle. Particles size analysis yields an average particle diameter (e.g., Dv₅₀) of 19.2 μm. FIG. 22B illustrates exemplary release of casein from exemplary pH-responsive matrix particle preparation(s) over 4 hours in either simulated intestinal fluid, pH 6.8 (black circles) or simulated gastric fluid, pH 1 (grey squares). Data are an average percent release with respect to loaded protein concentration (e.g., initial loading within exemplary matrix particles) of 3 replicates +/−standard deviation.

FIG. 23 shows, in a non-limiting example, exemplary bile salt-resistive matrix particle preparation(s) controlling the release of fatty acid payload(s). FIG. 23A illustrates a micrograph of bile salt-resistive matrix particle preparation(s) comprising 30% (w/w) 27-Stearine, 30% (w/w) CITREM, and 40% (w/w) linoleic acid produced through a hot melt homogenization process. Particles size analysis yields an average particle diameter (e.g., Dv₅₀) of 149 μm. FIG. 23B illustrates exemplary release of unformulated linoleic acid (black circles) or formulated linoleic acid (e.g., 30% (w/w) 27-Stearine, 30% (w/w) CITREM, 40% (w/w) linoleic acid) (grey squares) from exemplary bile salt-resistive matrix particle preparation(s) over 4 hours in simulated intestinal fluid, pH 6.8 with 0.2% (w/v) sodium taurocholate. Data are an average percent release with respect to loaded protein concentration (e.g., initial loading within exemplary matrix particles) of 3 replicates +/−standard deviation.

FIG. 24 shows, in a non-limiting example, exemplary pH-responsive core-shell particle preparation(s) controlling the release of carbohydrate payload(s). FIG. 24A illustrates a micrograph of pH-responsive core-shell particle preparation(s) comprising 50% (w/w) casein, 27% (w/w) starch, 9% (w/w) lactose, 4% (w/w) glucose, 5% (w/w) hypromellose acetate succinate, and 5% (w/w) sodium alginate produced through a wet granulation, extrusion, and spheronization process, followed by fluid bed coating to a total coating weight gain of 10% (w/w). Particles exhibit a 14-mesh size. FIG. 24B illustrates exemplary release of glucose from exemplary pH-responsive core-shell particle preparation(s) over 3 hours in either simulated intestinal fluid, pH 6.8 (black circles) or simulated gastric fluid, pH 1 (grey squares). Data are an average percent release with respect to loaded protein concentration (e.g., initial loading within exemplary multi-layer core-shell particles) of 3 replicates +/−standard deviation.

FIG. 25 shows, in a non-limiting example, exemplary pH-responsive core-shell particle preparation(s) controlling the release of protein payload(s). Exemplary release of protein from exemplary pH-responsive core-shell particle preparation(s) over 4 hours in either simulated intestinal fluid, pH 6.8 (green dashed line) or simulated gastric fluid, pH 1 (grey solid line). Data are an average percent release with respect to loaded protein concentration (e.g., initial loading within exemplary multi-layer core-shell particles) of 3 replicates +/−standard deviation.

FIG. 26 shows, in a non-limiting example, controlling one or more properties of particle preparation(s) by selecting method(s) of manufacture and incorporation thereof into commercial food and/or beverage products. FIG. 26A Macroscopic matrix preparation comprising a protein payload dispersed within a lipid matrix. FIG. 26B Macroscopic granulated and spheronized particle preparation(s) comprising protein payload dispersed within a carbohydrate matrix. FIG. 26C Microscopy of coarsely milled protein-containing particle preparation(s) with associated particle size histogram (FIG. 26F) and median particle diameter Dv₅₀. FIG. 26D Microscopy of finely milled protein-containing particle preparation(s) with associated particle size histogram (FIG. 26G) and median particle diameter Dv₅₀. FIG. 26E Microscopy of spray dried protein-containing particle preparation(s) with associated particle size histogram (FIG. 26H) and median particle diameter Dv₅₀. FIG. 26I commercial food and/or beverage powder with incorporation of spheronized protein-containing particle preparation; FIG. 26J uniform integration of finely milled protein-containing particle preparation into commercial food and/or beverage powder. FIG. 26G poor incorporation of particle preparation into aqueous suspension; FIG. 26L additional matrix component(s) leading to better incorporation; FIG. 26H uniform incorporation of improved particle preparation(s) into enteral nutrition (Nutren®, Nestlé).

FIGS. 27A-27D show, in a non-limiting example, micrographs of particles (e.g., microparticles) of formulations, according to illustrative embodiments of the present disclosure.

FIGS. 28A and 28B show theoretical data plots of apparent viscosity (FIG. 28A) and apparent tack for formulations, according to illustrative embodiments of the present disclosure.

FIGS. 28C-28F show, in a non-limiting example, micrographs of particles (e.g., microparticles) of formulations, according to illustrative embodiments of the present disclosure.

FIGS. 29A-29C show, in a non-limiting example, photographs of food products including disclosed formulations, according to illustrative embodiments of the present disclosure.

FIGS. 30A and 30B show, in a non-limiting example, photographs of food products including disclosed formulations, according to illustrative embodiments of the present disclosure.

FIGS. 31A and 31B show, in a non-limiting example, photographs of food products including disclosed formulations, according to illustrative embodiments of the present disclosure.

FIGS. 32A-32F show, in a non-limiting example, a plot of particle size distribution (FIG. 32A), a micrograph of particles (e.g., microparticles) of a formulation (FIG. 32B), a photograph of a bulk amount of a formulation (FIG. 32C), and a photographs of food products (FIGS. 32D and 32E) and water (FIG. 32F) including formulations, according to illustrative embodiments of the present disclosure.

FIGS. 33A-33F show, in a non-limiting example, a plot of particle size distribution (FIG. 33A), a micrograph of particles (e.g., microparticles) of a formulation (FIG. 33B), a photograph of a bulk amount of a formulation (FIG. 33C), and a photographs of food products (FIGS. 33D and 33E) and water (FIG. 33F) including formulations, according to illustrative embodiments of the present disclosure.

FIGS. 34A-34F show, in a non-limiting example, a plot of particle size distribution (FIG. 34A), a micrograph of particles (e.g., microparticles) of a formulation (FIG. 34B), a photograph of a bulk amount of a formulation (FIG. 34C), and a photographs of food products (FIGS. 34D and 34E) and water (FIG. 34F) including formulations, according to illustrative embodiments of the present disclosure.

FIGS. 35A-35F show, in a non-limiting example, a plot of particle size distribution (FIG. 35A), a micrograph of particles (e.g., microparticles) of a formulation (FIG. 35B), a photograph of a bulk amount of a formulation (FIG. 35C), and a photographs of food products (FIGS. 35D and 35E) and water (FIG. 35F) including formulations, according to illustrative embodiments of the present disclosure.

FIGS. 36A-36F show, in a non-limiting example, a plot of particle size distribution (FIG. 36A), a micrograph of particles (e.g., microparticles) of a formulation (FIG. 36B), a photograph of a bulk amount of a formulation (FIG. 36C), and a photographs of food products (FIGS. 36D and 36E) and water (FIG. 36F) including formulations, according to illustrative embodiments of the present disclosure.

FIGS. 37A-37E show, in a non-limiting example, a plot of particle size distribution (FIG. 37A), a micrograph of particles (e.g., microparticles) of a formulation (FIG. 37B), and a photographs of food products (FIGS. 37C and 37D) and water (FIG. 37F) including formulations, according to illustrative embodiments of the present disclosure.

FIGS. 38A-38F show, in a non-limiting example, a plot of particle size distribution (FIG. 38A), a micrograph of particles (e.g., microparticles) of a formulation (FIG. 38B), a photograph of a bulk amount of a formulation (FIG. 38C), and a photographs of food products (FIGS. 38D and 38E) and water (FIG. 38F) including formulations, according to illustrative embodiments of the present disclosure.

FIGS. 39A-39F show, in a non-limiting example, a plot of particle size distribution (FIG. 39A), a micrograph of particles (e.g., microparticles) of a formulation (FIG. 39B), a photograph of a bulk amount of a formulation (FIG. 39C), and a photographs of food products (FIGS. 39D and 39E) and water (FIG. 39F) including formulations, according to illustrative embodiments of the present disclosure.

FIGS. 40A-40F show, in a non-limiting example, a plot of particle size distribution (FIG. 40A), a micrograph of particles (e.g., microparticles) of a formulation (FIG. 40B), a photograph of a bulk amount of a formulation (FIG. 40C), and a photographs of food products (FIGS. 40D and 40E) and water (FIG. 40F) including formulations, according to illustrative embodiments of the present disclosure.

FIGS. 41A-41F show, in a non-limiting example, a plot of particle size distribution (FIG. 41A), a micrograph of particles (e.g., microparticles) of a formulation (FIG. 41B), a photograph of a bulk amount of a formulation (FIG. 41C), and a photographs of food products (FIGS. 41D and 41E) and water (FIG. 41F) including formulations, according to illustrative embodiments of the present disclosure.

FIGS. 42A-42F show, in a non-limiting example, a plot of particle size distribution (FIG. 42A), a micrograph of particles (e.g., microparticles) of a formulation (FIG. 42B), a photograph of a bulk amount of a formulation (FIG. 42C), and a photographs of food products (FIGS. 42D and 42E) and water (FIG. 42F) including formulations, according to illustrative embodiments of the present disclosure.

FIGS. 43A-43F show, in a non-limiting example, a plot of particle size distribution (FIG. 43A), a micrograph of particles (e.g., microparticles) of a formulation (FIG. 43B), a photograph of a bulk amount of a formulation (FIG. 43C), and a photographs of food products (FIGS. 43D and 43E) and water (FIG. 43F) including formulations, according to illustrative embodiments of the present disclosure.

FIGS. 44A-44F show, in a non-limiting example, a plot of particle size distribution (FIG. 44A), a micrograph of particles (e.g., microparticles) of a formulation (FIG. 44B), a photograph of a bulk amount of a formulation (FIG. 44C), and a photographs of food products (FIGS. 44D and 44E) and water (FIG. 44F) including formulations, according to illustrative embodiments of the present disclosure.

FIGS. 45A-45F show, in a non-limiting example, a plot of particle size distribution (FIG. 45A), a micrograph of particles (e.g., microparticles) of a formulation (FIG. 45B), a photograph of a bulk amount of a formulation (FIG. 45C), and a photographs of food products (FIGS. 45D and 45E) and water (FIG. 45F) including formulations, according to illustrative embodiments of the present disclosure.

FIGS. 46A-46E show, in a non-limiting example, a plot of particle size distribution (FIG. 46A), photograph of a bulk amount of a formulation (FIG. 46B), photographs of food products (FIGS. 46C and 46D) and water (FIG. 46E) including formulations, according to illustrative embodiments of the present disclosure.

FIGS. 47A-47E show, in a non-limiting example, a plot of particle size distribution (FIG. 47A), a micrograph of particles (e.g., microparticles) of a formulation (FIG. 47B), and a photographs of food products (FIGS. 47C and 47D) and water (FIG. 47E) including formulations, according to illustrative embodiments of the present disclosure.

FIGS. 48A-48C show, in a non-limiting example, a plot of particle size distribution (FIG. 48A), a micrograph of particles (e.g., microparticles) of a formulation (FIG. 48B) and a photograph of a bulk amount of a formulation (FIG. 48C), according to illustrative embodiments of the present disclosure.

FIGS. 49A-49F show, in a non-limiting example, a plot of particle size distribution (FIG. 49A), a micrograph of particles (e.g., microparticles) of a formulation (FIG. 49B), a photograph of a bulk amount of a formulation (FIG. 49C), and a photographs of food products (FIGS. 49D and 49E) and water (FIG. 49F) including formulations, according to illustrative embodiments of the present disclosure.

FIGS. 50A-50B show, in a non-limiting example, a plot of particle size distribution (FIG. 50A), and a micrograph of a particles (e.g., a microparticle) of a formulation (FIG. 50B), according to illustrative embodiments of the present disclosure.

FIGS. 51A-51C show, in a non-limiting example, a plot of particle size distribution (FIG. 51A), a micrograph of particles (e.g., microparticles) of a formulation (FIG. 51B) and a photograph of a bulk amount of a formulation (FIG. 51C), according to illustrative embodiments of the present disclosure.

FIGS. 52A-52F show, in a non-limiting example, a plot of particle size distribution (FIG. 52A), a micrograph of particles (e.g., microparticles) of a formulation (FIG. 52B), a photograph of a bulk amount of a formulation (FIG. 52C), and a photographs of food products (FIGS. 52D and 52E) and water (FIG. 52F) including formulations, according to illustrative embodiments of the present disclosure.

FIGS. 53A-53F show, in a non-limiting example, a plot of particle size distribution (FIG. 53A), a micrograph of particles (e.g., microparticles) of a formulation (FIG. 53B), a photograph of a bulk amount of a formulation (FIG. 53C), and a photographs of food products (FIGS. 53D and 53E) and water (FIG. 53F) including formulations, according to illustrative embodiments of the present disclosure.

FIGS. 54A-54F show, in a non-limiting example, a plot of particle size distribution (FIG. 54A), a micrograph of particles (e.g., microparticles) of a formulation (FIG. 54B), a photograph of a bulk amount of a formulation (FIG. 54C), and a photographs of food products (FIGS. 54D and 54E) and water (FIG. 54F) including formulations, according to illustrative embodiments of the present disclosure.

FIGS. 55A-55F show, in a non-limiting example, a plot of particle size distribution (FIG. 55A), a micrograph of particles (e.g., microparticles) of a formulation (FIG. 55B), a photograph of a bulk amount of a formulation (FIG. 55C), and a photographs of food products (FIGS. 55D and 55E) and water (FIG. 55F) including formulations, according to illustrative embodiments of the present disclosure.

FIGS. 56A-56F show, in a non-limiting example, a plot of particle size distribution (FIG. 56A), a micrograph of particles (e.g., microparticles) of a formulation (FIG. 56B), a photograph of a bulk amount of a formulation (FIG. 56C), and a photographs of food products (FIGS. 56D and 56E) and water (FIG. 56F) including formulations, according to illustrative embodiments of the present disclosure.

FIGS. 57A-57F show, in a non-limiting example, a plot of particle size distribution (FIG. 57A), a micrograph of particles (e.g., microparticles) of a formulation (FIG. 57B), a photograph of a bulk amount of a formulation (FIG. 57C), and a photographs of food products (FIGS. 57D and 57E) and water (FIG. 57F) including formulations, according to illustrative embodiments of the present disclosure.

FIG. 58A shows, in a non-limiting example, data plots of bicinchoninic assays to determine protein concentration, according to illustrative embodiments of the present disclosure.

FIG. 58B shows, in a non-limiting example, a data plot of a Pierce™ 360 assay to determine protein concentration, according to illustrative embodiments of the present disclosure.

FIG. 59 shows, in a non-limiting example, a data plot of a glucose oxidase amplex red assay quantifying glucose, according to illustrative embodiments of the present disclosure.

FIGS. 60A and 60B show, in a non-limiting example, data plots of dinitrosalicylic assays quantifying glucose, according to illustrative embodiments of the present disclosure.

FIGS. 61A-61C show, in a non-limiting example, data plots of a non-esterified fatty acid Wako (HR-2) assay to determine fatty acid concentration, according to illustrative embodiments of the present disclosure.

FIGS. 62A-62C show, in a non-limiting example, data plots of a fluorometric FITC inulin assay (FIG. 62A) and dinitrosalicylic (DNS) assays (FIGS. 62B and 62C) to quantify inulin, according to illustrative embodiments of the present disclosure.

FIGS. 63A-63D show, in a non-limiting example, data plots of standard colorimetric assays to quantify concentrations of flavonoids, according to illustrative embodiments of the present disclosure.

FIGS. 63E-63H show, in a non-limiting example, data plots of ferric antioxidant status detection kits to quantify concentration of flavonoids, according to illustrative embodiments of the present disclosure.

FIGS. 64A-65D show, in a non-limiting example, data plots of release curve measurements of formulations, according to illustrative embodiments of the present disclosure.

FIGS. 66A-66K show, in a non-limiting example, plots of particle size distribution of formulations (FIGS. 66A-66F), release curve measurements of formulations, photographs of a bulk amount of formulations (FIGS. 66H-66J), and a micrograph of particles of formulations (FIG. 66K), according to illustrative embodiments of the present disclosure.

FIGS. 67A-67D show, in a non-limiting example, gelation of formulations (FIG. 67A) and plots of melting temperature v. component mass fraction of formulations (FIGS. 67B-67D), according to illustrative embodiments of the present disclosure.

FIGS. 68A-68F show, in a non-limiting example, release curve measurements of formulations (FIGS. 68A-68C) and micrographs of particles of formulations (FIGS. 68D-68F), according to illustrative embodiments of the present disclosure.

FIGS. 69A-70B show, in a non-limiting example, release curve measurements of formulations, according to illustrative embodiments of the present disclosure.

FIGS. 71A-71E show, in a non-limiting example, photographs of a bulk amount of formulations (FIGS. 71A-71D) and release curve measurements of formulations (FIG. 71E), according to illustrative embodiments of the present disclosure.

FIGS. 72A-72D show, in a non-limiting example, photographs of formulations incorporated into food compositions, according to illustrative embodiments of the present disclosure.

FIGS. 73A-73F show, in a non-limiting example, photographs of a bulk amount of formulations, according to illustrative embodiments of the present disclosure.

FIGS. 74A-74H show, in a non-limiting example, a method of manufacturing formulations (FIG. 74A and FIG. 74E), micrographs of formulations (FIG. 74B and FIG. 74F), photographs of a bulk amount of formulations (FIG. 74C and FIG. 74G), and plots of particle size distributions of formulation (FIG. 74D and FIG. 74H), according to illustrative embodiments of the present disclosure.

FIGS. 75A-75D show, in a non-limiting example, release curve measurements (FIGS. 75A and 75B), a schematic of a particle of formulations (FIG. 75C), and a photograph of a bulk amount of a formulation (FIG. 75D), according to illustrative embodiments of the present disclosure.

FIGS. 75E-75K show, in a non-limiting example, release curve measurements (FIGS. 75E and 75F), schematics of a particle of formulations (FIG. 75G and FIG. 75I), and photographs of a bulk amount of formulations (FIG. 75J and FIG. 75K), according to illustrative embodiments of the present disclosure.

FIGS. 76A-75I show, in a non-limiting example, release curve measurements (FIGS. 76A and 76B), plots of particle size distribution of formulations (FIGS. 76C and 76D) a schematic of a particle of formulations (FIG. 76E), photographs of a bulk amount of formulations (FIG. 76F and FIG. 76H), and micrographs of particles of formulations (FIGS. 76G and 76I), according to illustrative embodiments of the present disclosure.

FIGS. 77A-77H show, in a non-limiting example, a plot of particle size distribution of particles of a formulation (FIG. 77A), micrographs of particles of formulations (FIG. 77B-77F), plots of release curve measurements of formulations (FIGS. 77C-77G, and 77H), according to illustrative embodiments of the present disclosure.

FIGS. 77A-78G show, in a non-limiting example, plots of TEER measurements (FIGS. 78A, 78D, and 78G), permeability (FIGS. 78B and 78E), and P_{eff} (FIGS. 78C and 78F), according to illustrative embodiments of the present disclosure.

FIGS. 79A-79D show, in a non-limiting example, release curve measurement plots of formulations, according to illustrative embodiments of the present disclosure.

### DETAILED DESCRIPTION OF CERTAIN EMBODIMENTS

Section headings used herein are for organizational purposes only and are not to be construed as limiting the subject matter described.

### A. Certain Terminology

Unless defined otherwise, technical and scientific terms used herein have the same meaning as is commonly understood to which the claimed subject matter belongs. In the event that there are a plurality of definitions for terms herein, those in this section prevail.

It is to be understood that the general description and the detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Definition of standard chemistry terms may be found in reference works, including but not limited to, Carey and Sundberg “Advanced Organic Chemistry 4th Ed.” Vols. A (2000) and B (2001), Plenum Press, New York.

As used herein, the symbol “<” means less than or fewer than. As used herein, the symbol “>” means more than.

As used herein, the term “about” or “approximately” means within 10%, preferably within 10%, and more preferably within 5% of a given value or range.

Ambient: The term “ambient”, as used herein, refers to a typical indoor (e.g., climate-controlled) temperature, usually within a range of about 18 °C to about 32 °C, and/or typical indoor (e.g., climate-controlled) humidity, usually within a range of about 30% to 50%. In some embodiments, ambient temperature is within a range of about 20 °C to about 30 °C. In some embodiments, ambient temperature is 25±5 °C. In some embodiments, ambient temperature is approximately 21 °C. In some embodiments, ambient temperature is 18 °C. In some embodiments, ambient temperature is 19 °C. In some embodiments, ambient temperature is 20 °C. In some embodiments, ambient temperature is 21 °C. In some embodiments, ambient temperature is 22 °C. In some embodiments, ambient temperature is 23 °C. In some embodiments, ambient temperature is 24 °C. In some embodiments, ambient temperature is 25 °C. In some embodiments, ambient temperature is 26 °C. In some embodiments, ambient temperature is 27 °C. In some embodiments, ambient temperature is 28 °C. In some embodiments, ambient temperature is 29 °C. In some embodiments, ambient temperature is 30 °C. In some embodiments, ambient may be used to describe outdoor conditions, and may include temperatures ranging from about 15 °C to about 40 °C, or from about 25 °C to about 40 °C. In some embodiments, ambient humidity is within a range of about 35% to about 45%. In some embodiments, ambient temperature is 35%. In some embodiments, ambient temperature is 36%. In some embodiments, ambient temperature is 37%. In some embodiments, ambient temperature is 38%. In some embodiments, ambient temperature is 39%. In some embodiments, ambient temperature is 40%. In some embodiments, ambient temperature is 41%. In some embodiments, ambient temperature is 42%. In some embodiments, ambient temperature is 43%. In some embodiments, ambient temperature is 44%. In some embodiments, ambient temperature is 45%.

Beverage: As used herein, the term “beverage” is used to refer to a potable liquid (e.g., that can be ingested, swallowed, drunk, or consumed by a person or animal without material risk to the person or animal). For example, beverage can be or comprise beer, juice, milk, a sports drink, tea, water, soda, yogurt, etc. In some embodiments, a “beverage” may be or comprise a pharmaceutical formulation in liquid form.

Biocompatible: As used herein, the term “biocompatible” is used to describe a characteristic of not causing significant detectable harm to living tissue when placed in contact therewith e.g., in vivo. In certain embodiments, materials are “biocompatible” if they are not significantly toxic to cells, e.g., when contacted therewith in a relevant amount and/or under relevant conditions such as over a relevant period of time. In certain embodiments, materials are “biocompatible” if their addition to cells in vitro results in less than or equal to 20% cell death, and/or their administration in vivo does not induce significant inflammation or other adverse effects.

Comparable: As used herein, the term “comparable” refers to two or more agents, entities, situations, sets of conditions, etc., that may not be identical to one another but that are sufficiently similar to permit comparison therebetween so that one skilled in the art will appreciate that conclusions may reasonably be drawn based on differences or similarities observed. In some embodiments, comparable sets of conditions, circumstances, individuals, or populations are characterized by a plurality of substantially identical features and one or a small number of varied features. Those of ordinary skill in the art will understand, in context, what degree of identity is required in any given circumstance for two or more such agents, entities, situations, sets of conditions, etc. to be considered comparable. For example, those of ordinary skill in the art will appreciate that sets of circumstances, individuals, or populations are comparable to one another when characterized by a sufficient number and type of substantially identical features to warrant a reasonable conclusion that differences in results obtained or phenomena observed under or with different sets of circumstances, individuals, or populations are caused by or indicative of the variation in those features that are varied.

Degradation: As used herein, the term “degradation” refers to a change in chemical structure and often involves breakage of at least one chemical bond. To say that a chemical compound is degraded typically means that the chemical structure of the chemical compound has changed (e.g., a chemical bond is broken). Common mechanisms of degradation include, for example, oxidation, hydrolysis, isomerization, fragmentation, or a combination thereof.

Delivery: As used herein, the term “delivery” is used to refer to the carrying and/or deposition and/or moving of payloads and/or encapsulants to particular location (e.g., into and/or throughout the body). In some instances, for example, delivery may refer to payload delivery to the epithelial cells in the gastrointestinal tract. In some instances, for example, delivery may refer to payload delivery to into the blood stream (e.g., systemic absorption). In some instances, for example, delivery may refer to ingestion at the point of consumption for a shelf-stable tastant composition containing a tastant payload.

Diameter: As used herein, the term “diameter” is used to refer to the longest distance from one end of a particle to another end of the particle. Those skilled in the art will appreciate that a variety of techniques are available for use in characterizing particle diameters (i.e., particle sizes). In some instances, for example, size of particles (e.g., diameter of particles) can be measured by a Coulter Counter. In some instances, for example, size of particles (e.g., diameter of particles) can be measured by a Malvern Mastersizer. In some embodiments, a population of particles is characterized by an average size (e.g., D[3,2], D[4,3], etc.) and/or by particular characteristics of size distribution (e.g., absence of particles above or below particular sizes [e.g., Dv10, Dv20, Dv30, Dv40, Dv50, Dv60, Dv70, Dv80, Dv90, Dv99, etc.], a unimodal, bimodal, or multimodal distribution, etc.).

Dispersity: As used herein, the term “dispersity” is used to refer to the breadth of particle size distribution relative to the average particle size. In some instances, for example, size of particles (e.g., diameter of particles) can be measured by a Coulter Counter. In some instances, for example, size of particles (e.g., diameter of particles) can be measured by a Malvern Mastersizer. In some embodiments, the population of particles is characterized by, for example, an average size (e.g., Dv50) and, for example, a corresponding standard deviation. In some instances, the dispersity of a population of particles refers to double (e.g., 2-fold) the ratio of standard deviation (e.g., σ) to average particle diameter (e.g., Dv50).

Encapsulant: As used herein, the term “encapsulant” is used to refer to anything that is used to encapsulate a payload. For example, in many embodiments of the present disclosure, a payload component (e.g., a tastant) is described as being encapsulated by an encapsulant (e.g., polymer component, food component, material component, etc.).

Encapsulated: As used herein, the term “encapsulated” is used to refer to a characteristic of being physically associated with, and in some embodiments partly or wholly covered or coated. For example, in many embodiments of the present disclosure, a payload component (e.g., a tastant) is described as being encapsulated by a polymer component.

Flavor: As used herein, the term “flavor” is used to refer to a mix of sensations, including the scent, taste and texture of a food and/or beverage that are perceived after ingestion.

Food: As used herein, the term “food” is used to refer to an edible solid (e.g., that can be ingested, swallowed, chewed, or consumed by a person or animal without material risk to the person or animal). For example, food can be or comprise agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, yogurt, etc. In some embodiments, a “food” may be or comprise a pharmaceutical formulation in solid form. In some embodiments, a “food” may generally refer to a tastant and/or food and/or beverage product. In some embodiments, a “food” may generally refer to an edible object that is intended to confer a benefit (e.g., taste, health, energy, nutrition, performance, well-being) on one or more animal(s).

Food Components: As used herein, the term “food components” is used to refer to components that makes up a composition (e.g. tastant composition), and comprises of at least one of a tastant, a tastant facilitator, a tastant modulator, a nutrient, a nutraceutical, a macronutrient, a carbohydrate, a sugar, a monosaccharide, a polysaccharide, a dietary fiber, a fat, a fatty acid, a lipid, a protein, an amino acid, a peptide, a micronutrient, a vitamin, a mineral, a polypeptide, a carotenoid, an element, a ketone body, a prebiotic (e.g., a prebiotic fiber), a polyphenol, a flavonoid, an antioxidant, an electrolyte, a salt, a circadian rhythm modulator, a supplement, a nootropic, and/or a source of energy, one or more excipient component(s), means for the controlled release of food component(s) from one or more tastant composition(s), and methods of manufacture, maintenance (e.g., storage), and/or use (e.g., administration or delivery) of one or more tastant composition(s).

Formulated Beverages: As used herein, the term “formulated beverages” is used to refer to an ingestible liquid (e.g., that can be ingested, swallowed, drank, or consumed by a person or animal without material risk to the person or animal) that provides health benefits resulting from controlled release, absorption, spatial access, concentration, and/or residence time of nutrients. Examples include protein shakes, coffee, Meal Ready-to-Drink (RTD), electrolyte beverages, sports beverages, hard seltzers (alcoholic seltzers), water, medical foods (e.g., Ready-to-drink low phenylalanine medical food), supplements, beer, wine, soda, fermented foods and beverages (e.g., yogurt, beer, etc.).

Formulated Foods: As used herein, the term “formulated foods” is used to refer to an edible solid (e.g., that can be ingested, swallowed, chewed, or consumed by a person or animal without material risk to the person or animal) that provides health benefits resulting from controlled release, absorption, spatial access, concentration, and/or residence time of nutrients. Examples include dry powders (e.g., baby formula, protein powder, drink mixes), Meal Ready-to-Eat (MRE), yogurt, cheese, freshly prepared meals, frozen meals, etc.

Formulated tastants: As used herein, the term “formulated tastants” is used to refer to an edible dosage form (e.g., that can be ingested, drank, swallowed, chewed, or consumed by a person or animal without material risk to the person or animal) such as a pill, capsule, tablet, etc. that provides taste benefits resulting from controlled release, absorption, spatial access, concentration, and/or residence time of tastants.

Formulated Meals: As used herein, the term “formulated meals” is used to refer to a solid meals (e.g., that can be ingested, swallowed, chewed, or consumed by a person or animal without material risk to the person or animal) such as microwavable meals, freshly prepared meals, frozen meals, MREs, etc., that provides health benefits resulting from controlled release, absorption, spatial access, concentration, and/or residence time of nutrients.

Formulated Supplements: As used herein, the term “formulated supplements” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Hard Seltzers: As used herein, the term “hard seltzer” is used to refer to an ingestible liquid that contains alcohol and carbonated water.

HLB: As used herein, the term “HLB” is used to refer to the hydrophilic lipophilic balance that is an inherent property of, for example, a nonionic surfactant. In some instances, the HLB value of a given non-ionic surfactant is obtained from a commonly accessible tabular source. In some embodiments, non-ionic surfactants characterized as having a low HLB value (e.g., <8) are compatible emulsifiers for lipid systems. In some embodiments, nonionic surfactants characterized as having a high HLB value (e.g., >15) are compatible emulsifiers for aqueous systems. In some embodiments, non-ionic surfactants characterized as having an intermediate HLB value (e.g., >8 and <15) are compatible emulsifiers with both lipid and aqueous systems.

Homogenous: As used herein, the term “homogenous” means of substantially uniform structure and/or composition throughout.

Hydrophobic: As used herein, the term “hydrophobic” is used to refer to the propensity of a material to reject association, chemically and/or physically, with water. In some instances, a material characterized as being hydrophobic is biologically derived and/or synthetically derived. In some instances, a material characterized as being hydrophobic is a lipid, protein, and/or carbohydrate. In some instances, a material characterized as being hydrophobic is a polymer and/or small molecule. Alternatively, or additionally, in some embodiments, composites, mixtures, blends, or super-structures of several materials are collectively referred to as hydrophobic based on their observed propensity to reject association, chemically and/or physically, with water.

Incorporation: As used herein, the term “incorporation” is used to refer to a characteristic of being physically associated with, and in some embodiments, dispersed within, embedded within, or mixed in a bulk material (e.g., a lipid matrix component).

Layer: As used herein, the term “layer” typically refers to a material disposed above or below a distinguishable material. In some embodiments, a particular entity or preparation (e.g., particle preparation) is described as “layered” if it is prepared via a process in which a first material is laid down and then a second material is applied atop or underneath the first material (e.g., as by dipping or spraying, etc); in some such embodiments, physical or chemical distinctness of layers may be maintained over time, whereas in some such embodiments, physical or chemical distinctness of layers may decay over time, at least at layer interface(s). Alternatively or additionally, in some embodiments, a particular sample or preparation may be described as layered, independent of its mode of preparation, so long as at a particular point in time and/or using a particular mode of assessment, distinct materials can be identified in a layered structure. In some embodiments, a “layered” particle may include one or more layers that wholly encapsulate a material below. In some embodiments, a “layered” particle may include one or more layers that does not wholly encapsulate a material below. In some embodiments, at least one layer of a layered preparation is or comprises a polymer, e.g., a hydrophobic polymer or hydrophilic polymer. In some embodiments, each layer of a layered preparation is or comprises a polymer, e.g., a pH responsive polymer or a temperature-responsive polymer.

Lipid: As used herein, the term “lipid” is used to refer to a class of chemical structures characterized as hydrophobic materials. In some instances, a lipid material is derived from a biological source. In other instances, a lipid material is derived from a synthetic source. In some instances, a lipid is comprised of one or more aliphatic alcohols and/or acids linked by glycerol and/or glycol moieties. In other instances, a lipid is comprised of aliphatic chains, linear conjugated, aromatic, and/or cyclic aliphatic moieties. In some embodiments, a lipid refers to a pure chemical entity. In other embodiments, a lipid refers to a mixture of several pure chemical entities. For example, lipids include, but are not limited to: paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

Lyophilized: As used herein, the term “lyophilized” is used to refer to the end product of a process by which water is removed from a material via sublimation. In some instances, prior to sublimation of water, the material is cooled to <−10 °C, <−20 °C, <−30 °C, <−40 °C, <−50 °C, <−60 °C, and/or <−70 °C. In some instances, prior to the sublimation of water, the pressure is lowered to <200 torr, <150 torr, <100 torr, <50 torr, <10 torr, <5 torr, and/or <1 torr. Those skilled in the art recognize that the cooling temperature and pressure influence the physicochemical properties of the end product; it is understood that “lyophilized” encompasses all suitable manners of cooling and vacuum protocol.

Medical Foods: As used herein, the term “medical foods” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Nasal Cavity: As used herein, the term “nasal cavity” is used to refer to the inside of the nose.

Nutraceutical: As used herein, the terms “nutraceutical” or “nutraceutical composition” refer to a substance or material that is or comprises a nutraceutical agent (e.g., a nutraceutical). Those skilled in the art will be aware of a variety of agents understood in the art to be nutraceutical agents such as, for example, agents that are or comprise one or more antioxidants, macronutrients, micronutrients, minerals, prebiotics, probiotics, probiotic powders, probiotic ingredients, probiotic food ingredients, probiotic supplement ingredients, prebiotics, vitamins, or combinations thereof. In some embodiments, a nutraceutical is or comprises a carotenoid compound such as alpha-lipoic acid, astaxanthin, adonixanthin, adonirubin, beta-carotene, coenzyme Q10, lutein, lycopene, or zeaxanthin. In some embodiments, a nutraceutical is or comprises a vitamin such as vitamin D. In many embodiments, a nutraceutical agent is a natural product, and in certain such embodiments it is a product produced by plants. Many nutraceutical agents are compounds that have been reported or demonstrated to confer a benefit or provide protection against a disease in an animal or a plant. In some cases, nutraceuticals may be used to improve health, delay the aging process, protect against chronic diseases, increase life expectancy, or support the structure or function of the body of an animal, such as a human, a pet animal, an agricultural animal, or another domesticated animal. As used in the present disclosure, which focuses on probiotics, the term “nutraceutical composition” will generally be understood to mean a composition comprising at least one probiotic component, among other potential components (including one or more of the nutraceutical agents disclosed above). As such, as used in the present disclosure, the terms “nutraceutical composition,” “probiotic preparation,” “probiotic composition,” “particle preparation,” “microbe composition,” etc. may all be generally understood to describe compositions, preparations, and/or particles that include one or more probiotics (for example, encapsulated probiotics).

Nutrient: As used herein, the term “nutrient” is used to refer to a nutraceutical, a macronutrient, a carbohydrate, a sugar, a polysaccharide, a dietary fiber, a fat, a fatty acid, a lipid, a short-chain fatty acid, a protein, an amino acid, a peptide, a micronutrient, a vitamin, a mineral, a carotenoid, an element, a ketone body, a prebiotic, a probiotic, a postbiotic, a bacteria, a yeast, a polyphenol, a flavonoid, an antioxidant, an electrolyte, a salt, a circadian rhythm modulator, a supplement, a nootropic, a scent, a tastant, and/or a source of energy.

Oral Cavity: As used herein, the term “oral cavity” is used to comprise the lips, the inside lining of the lips and cheeks (buccal mucosa), the teeth, the gums, the front two-thirds of the tongue, the floor of the mouth below the tongue, the hard palate, the retromolar trigone, and/or the nasal cavity.

Overfortification: As used herein, the term “overfortification” is used to refer to the addition of a nutrient in excess of a label claim, due to expected nutrient degradation or loss of stability during manufacturing, processing, and/or shelf-life. This additional amount of nutrient is used to account for losses during manufacturing, processing, and/or shelf-life to still meet the nutrient label claim.

Particle: As used herein, the term “particle” is used to refer to a discrete physical entity, typically having a size (e.g., a longest cross-section, such as a diameter) within a range. For example, a particle can have a size of about 5-3000 μm, about 5-2000 μm, about 5-1000 μm, about 5-500 μm, about 5-50 μm, about 5-300 μm, about 5-200 μm, about 5-100 μm, about 5-50 μm, about 5-25 μm, or about 5-10 μm. In some embodiments, a particle may describe or include animal pellets ranging in size up to 1 mm, 5 mm, 10 mm, 25 mm, and even about 50 mm (about 2 inches) in diameter. A “particle” is not limited to a particular shape or form, for example, having a cross-section shape of a sphere, an oval, a triangle, a square, a hexagon, or an irregular shape. In some cases, particles can be solid particles. In some cases, particles can be liquid particles. In some cases, particles can be gel or gel-like particles. In some cases, particles may have a particle-in-particle structure wherein a layer of one material (e.g., one type of polymer component) encapsulates another material (e.g., another type of polymer component, which may itself encapsulate yet another, or rather may be or comprise a “core”—e.g., a polymer matrix core—of the particle).

Parts per million (ppm): As used herein, 1 ppm (“parts per million”) is equivalent to 1 milligram per liter (mg/L) or 1 milligram per kilogram (mg/kg).

Payload: In general, the term “payload”, as used herein, refers to an agent that may be delivered or transported by association with another entity. In some embodiments, such association may be or include a covalent linkage; in some embodiments such association may be or include non-covalent interaction(s). In some embodiments, association may be direct; in some embodiments, association may be indirect. The term “payload” is not limited to a particular chemical identity or type; for example, in some embodiments, a payload may be or comprise, for example, an entity of any chemical class including, for example, a scent, a tastant, a nutrient, a lipid, a metal, a nucleic acid, a polypeptide, a saccharide (e.g., a polysaccharide), small molecule, or a combination or complex thereof. In some embodiments, a payload may be or comprise a biological modifier, a detectable agent (e.g., a dye, a fluorophore, a radiolabel, etc.), a detecting agent, a nutrient, a therapeutic agent, etc., or a combination thereof. In some embodiments, a payload may be or comprise a cell or organism, or a fraction, extract, or component thereof. In some embodiments, a payload may be or comprise a natural product in that it is found in and/or is obtained from nature; alternatively or additionally, in some embodiments, the term may be used to refer to one or more entities that is man-made in that it is designed, engineered, and/or produced through action of the hand of man and/or is not found in nature. In some embodiments, a payload may be or comprise an agent in isolated or pure form; in some embodiments, such agent may be in crude form.

pH Responsive: The term “pH-responsive” is used to refer to certain polymer component(s) as described herein, and in particular means that the relevant polymer component is characterized in that one or more aspects of its structure or arrangement is altered when exposed to a change in pH condition (e.g., to a particular pH and/or to a pH change of particular magnitude). In some embodiments, a polymer component is considered to be “pH-responsive” if, when the relevant polymer component is associated with a payload component in a particle preparation as described herein, the particle preparation releases the payload component under specific pH condition(s). In some embodiments, >90% of payload component is released from a particle preparation that includes a pH-responsive polymer component within 15 minutes when the particle preparation is exposed to a particular defined pH condition (e.g., within a range of defined pH values and/or at a specific pH value); in some embodiments, such release results when such contacting occurs at temperatures between 33-40 °C, and in aqueous-based buffers of ionic strength ranging from 0.001-0.151 M (e.g., water, simulated gastric fluid, gastric fluid, simulated intestinal fluid, intestinal fluid) with osmolality between 1-615 mOsm/kg. In some embodiments, a pH-responsive polymer component is one that degrades when exposed to a particular pH or pH change. Alternatively or additionally, in some embodiments, a pH-responsive polymer component is one that becomes soluble, or significantly (e.g., (e.g., by at least about 5%) increases its solubility when exposed to a particular pH level, or pH change. In some embodiments, a pH-responsive polymer component includes one or more moieties whose protonation state changes at the relevant pH or in response to the relevant pH change. For example, in some embodiments, a pH responsive polymer component includes one or more amine moieties that become protonated upon exposure to a relevant pH or pH chance.

Polyphenols: As used herein, the term “polyphenol” is used to refer to naturally occurring organic compounds, comprising one or multiple aromatic groups with one or more hydroxyl groups or hydroxyl derivatives (e.g., methoxyl, ethoxyl, acetyl, etc.) and/or deriving from the shikimate, phenylpropanoid, and/or polyketide pathways. For example, a polyphenol may be a phenolic acids, flavonoids, stilbenes, and lignans, antioxidants, tannins, and/or combinations thereof.

Prebiotic: As used herein, the term “prebiotic” is used to refer to a nondigestible food ingredient that promotes the growth of beneficial microorganisms in the intestines.

Reference: As used herein describes a standard or control relative to which a comparison is made. For example, in some embodiments, an agent, animal, individual, population, sample, sequence or value of interest is compared with a reference or control agent, animal, individual, population, sample, sequence or value. In some embodiments, a reference or control is tested and/or determined substantially simultaneously with the testing or determination of interest. In some embodiments, a reference or control is a historical reference or control, optionally embodied in a tangible medium. Typically, as would be understood by those skilled in the art, a reference or control is determined or characterized under comparable conditions or circumstances to those under assessment. Those skilled in the art will appreciate when sufficient similarities are present to justify reliance on and/or comparison to a particular possible reference or control.

Residual solvent: As used herein, the term “residual solvent” refers to a solvent that remains in a material after manufacture or processing of the material. In some embodiments, level of residual solvent is assessed by HPLC, mass spec, NMR, FTIR, and/or gas chromatography.

Satiety: As used herein, the term “satiety” refers to being full and/or sated; for example, feeling satisfied due to ingestion of a tastant composition or having a desire removed following ingestion of a tastant composition.

Stable: The term “stable,” when applied to compositions herein, means that the compositions maintain (e.g., as determined by one or more analytical assessments) one or more aspects of their physical structure and/or performance characteristic(s) (e.g., activity) over a period of time and/or under a designated set of conditions. When an assessed composition is a particle composition, in some embodiments, as will be clear from context to those skilled in the art, the term “stable” refers to maintenance of a characteristic such as average particle size, maximum and/or minimum particle size, range of particle sizes, and/or distribution of particle sizes (i.e., the percentage of particles above a designated size and/or outside a designated range of sizes) over a period of time and/or under a designated set of conditions. For tastants, stable often refers to maintenance or preservation of delivery functions (e.g., controlled release, sustained release, controlled residence time, sustained residence time, etc.), and/or scents, and/or taste.

Tastant: As used herein, the term “tastant” is used to refer to any compound and/or entity and/or chemical that provides taste and/or flavor and/or affects the taste and/or flavor of a food and/or beverage. In some embodiments, a tastant is considered to be a chemical that produces a taste sensation by activating taste receptors. In some embodiments a tastant is considered to be any compound and/or chemical and/or entity that produces activity in taste-related pathways in the nervous system. In some embodiments, a tastant can be a taste modulator. In some embodiments, a tastant can be a taste facilitator.

Taste: As used herein, the term “taste” is used to refer to a perceived sensation resulting from contact/binding of tastants with taste receptors and subsequent activation of taste-related pathways in the nervous system.

Tastant compositions: As used herein, the term “tastant compositions” is used to refer to an edible solid (e.g., that can be ingested, swallowed, chewed, or consumed by a person or animal without material risk to the person or animal) or an ingestible liquid (e.g., that can be ingested, swallowed, drank, or consumed by a person or animal without material risk to the person or animal) that provides taste benefits resulting from controlled retention time, controlled release rate, controlled adsorption/absorption rates, controlled spatial interactions and concentrations, controlled passage through selective barriers, and/or controlled taste receptor binding of one or more food component(s), tastant(s), tastant facilitator(s), or tastant modulator(s). For example, tastant compositions can be or comprise dry powders, supplements, solid foods, beverages and/or drinks, etc. In some embodiments, a “tastant composition” may be or comprise a pharmaceutical formulation in solid form. In some embodiments, a “tastant composition” may be or comprise a pharmaceutical formulation in liquid form. In some embodiments, a “tastant composition” may generally refer to a food and/or beverage product. In some embodiments, a “tastant composition” may generally refer to an edible object that is intended to improve upon the taste and/or flavor of its payload. Example tastant compositions (e.g., formulated tastants) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, candy, chewing gum, fermented foods and beverages (e.g., yogurt, beer, etc.); for example, MREs, Gatorade, Truly, Ensure, PKU Sphere Liquid, etc.

Taste facilitator: As used herein, the term “taste facilitator” is used to refer to any compound and/or entity and/or chemical that is characterized by an ability to facilitate passage of a payload through selective barriers and components. In certain embodiments, one or more taste facilitator(s) is characterized by an ability to penetrate into the taste bud from the mucosal, serosal or vascular environments. In certain embodiments, one or more taste facilitator(s) is characterized by reducing the activity and/or effectiveness of enzymatic components of a selective barrier. In certain embodiments, one or more taste facilitator(s) is characterized by reducing the activity and/or effectiveness of physical components of a selective barrier. In certain embodiments, one or more taste facilitator(s) is characterized by reducing the activity and/or effectiveness of molecular components of a selective barrier.

Taste modulator: As used herein, the term “taste modulator” (s) is used to refer to any compound and/or entity and/or chemical that is characterized by an ability to control the binding and/or response of a tastant to a taste receptor. In certain embodiments, one or more taste modulators(s) is characterized by potentiating the perceived taste of tastant(s). In certain embodiments, one or more taste modulator(s) is characterized by binding to G protein coupled receptors of taste cells. In certain embodiments, one or more taste modulator(s) is characterized by allosteric or orthosteric modulation of taste receptors.

Temperature-responsive: As used herein, the term “temperature-responsive” is used to refer to certain polymer component(s) as described herein, and in particular means that the relevant polymer component is characterized in that one or more aspects of its structure or arrangement is altered when exposed to a change in temperature condition (e.g., to a particular temperature and/or to a temperature change of particular magnitude). In some embodiments, a polymer component is considered to be “temperature-responsive” if, when the relevant polymer component is associated with a payload component in a particle preparation as described herein, amorphous regions of the polymer component experience a transition from a rigid state (e.g., glassy state) to a more fluid-like flexible state (e.g., more conducive to flow), at a temperature close to the point of transition from the solid state to rubbery state (e.g., glass transition).

Water activity: As used herein, “water activity” of a material is an indication (e.g., a measurement) of how much free (i.e., available to bind or react) water is present in the material, and is typically determined as the ratio of the vapor pressure of water in a material (p) to the vapor pressure of pure water (p0) at the same temperature. For example, a water activity of 0.80 means the vapor pressure is 80 percent of that of pure water. Water activity typically increases with temperature. Those skilled in the art will be familiar with three basic water activity measurement systems: Preventive Electrolytic Hygrometers (REH), Capacitance Hygrometers, and Dew Point Hygrometers (sometimes called chilled mirror).

### B. Overview

Disclosed herein, among other things, are compositions (e.g., tastant compositions (e.g., formulated tastants)) comprised of food component(s), comprising at least one of a tastant, a tastant facilitator, a tastant modulator, a nutrient, a nutraceutical, a macronutrient, a carbohydrate, a sugar, a monosaccharide, a polysaccharide, a dietary fiber, a fat, a fatty acid, a lipid, a protein, an amino acid, a peptide, a micronutrient, a vitamin, a mineral, a polypeptide, a carotenoid, an element, a ketone body, a prebiotic (e.g., a prebiotic fiber), a polyphenol, a flavonoid, an antioxidant, an electrolyte, a salt, a circadian rhythm modulator, a supplement, a nootropic, and/or a source of energy, one or more excipient component(s), means for the controlled release of food component(s) from one or more tastant composition(s), and methods of manufacture, maintenance (e.g., storage), and/or use (e.g., administration or delivery) of one or more tastant composition(s).

In some embodiments, provided tastant compositions (e.g., formulated tastants) are comprised of food component(s) and/or excipient component(s) physically or chemically arranged in a predetermined configuration. In some embodiments, provided tastant compositions (e.g., formulated tastants) are comprised of food component(s) and/or excipient component(s) physically or chemically arranged in an indeterminate configuration. In some embodiments, a predetermined physical configuration is a core-shell preparation and/or a matrix preparation and/or a layered preparation. In some embodiments, a predetermined chemical configuration is a salt, a linear oligomer, a linear polymer, a star-shaped oligomer, and/or a star-shaped polymer. In some embodiments, the configuration of one or more food component(s) establishes the means of controlled release of food component(s) from tastant composition(s).

In some embodiments, provided tastant compositions (e.g., formulated tastants) are comprised, on a dry weight basis, of a majority of food component(s), comprising at least one of a carbohydrate, a fat, a protein, a vitamin, a ketone body, and/or a polyphenol. In some embodiments, provided tastant compositions (e.g., formulated tastants) are comprised, on a dry weight basis, of at least 90% of food component(s), comprising at least one of a carbohydrate, a fat, a protein, a vitamin, a ketone body, and/or an antioxidant. In some embodiments, provided tastant compositions (e.g., formulated tastants) are comprised, on a dry weight basis, of at least 99% of food component(s), comprising at least one of a carbohydrate, a fat, a protein, a vitamin, a ketone body, and/or an antioxidant. In some embodiments, one or more food component(s) establishes the means of controlled release of food component(s) from tastant composition(s).

In some embodiments according to the present disclosure, a combination of one or more food component(s) and their configuration establishes the means of controlled release of food component(s) from tastant composition(s).

The present disclosure provides one or more tastant composition(s) characterized as providing a means of controlled release of one or more food component(s) comprising one or more food component(s) and their arrangement. In some embodiments, the present disclosure leverages (e.g., understanding and repurposing) the physical and/or chemical traits of one or more food component(s) to control the interaction of one or more tastant composition(s) in one or more animal(s).

In some embodiments, one or more tastants, nutrients, nutraceuticals, macronutrients, carbohydrates (e.g., one or more carbohydrate components), proteins (e.g., one or more protein components), fats (e.g., one or more fat components), micronutrients, vitamins, minerals, polyphenols, electrolytes, salts, ketone bodies, prebiotics, polymers, or combinations thereof are used to encapsulate a food component and/or core-shell and/or matrix preparations comprising one or more tastant composition(s).

In some embodiments, one or more hydrophobic materials, hydrophilic materials, and/or amphiphilic materials are used to encapsulate a food component and/or core-shell and/or matrix preparations comprising one or more tastant composition(s).

In some embodiments, one or more responsive properties of one or more food component(s) enables the means of controlled release of food component(s) from tastant composition(s). In some embodiments, properties of one or more food component(s) advantageous to establishing means of controlled release include, but are not limited to, response to pH, response to temperature, response to water, response to mechanical forces, response to endogenous chemical or enzymatic triggers, response to exogenous chemical or enzymatic triggers, response to osmotic pressure, and/or response to time.

In some embodiments, one or more interfacial properties of one or more food component(s) enables the means of controlled release of food component(s) from tastant composition(s). In some embodiments, properties of one or more food component(s) advantageous to establishing means of controlled release include, but are not limited to, mucoadhesion, bioadhesion, size, and/or shape.

In some embodiments, a combination of one or more responsive properties and one or more interfacial properties of one or more food component(s) establishes the means of controlled release of food component(s) from tastant composition(s).

### C. Tastant Compositions and Means of Controlled Release of One or More Food Component(s) from One or More Tastant Composition(s)

### 1. Tastant Composition(s)

In some aspects, the provided tastant composition(s) are comprised of one or more food component(s) (e.g. tastants, etc.), as described herein, in a predetermined physical and/or chemical configuration, as described herein. In some aspects, the provided tastant composition(s) are comprised of one or more food component(s) (e.g. tastants, etc.), as described herein, in an indeterminate physical and/or chemical configuration. In some aspects, the configuration of the food component(s) (e.g. tastants, etc.) comprising a tastant composition establishes a means of controlled release of food component(s) (e.g. tastants, etc.). In some aspects, the selection of food component(s) comprising one or more tastant compositions (e.g., formulated tastants) establish a means of controlled release of food component(s) (e.g. tastants, etc.).

In some embodiments, the provided tastant composition(s) are comprised of one food component (e.g. tastant, etc.). In some embodiments, the provided tastant composition(s) are comprised of several food components (e.g. tastants, etc.). In some embodiments, the arrangement of a single food component is used as a means of controlling the release of one or more food component(s) (e.g. tastants, etc.). In some embodiments, the arrangement of several food components is used as a means of controlling the release of one or more food component(s) (e.g. tastants, etc.).

In some embodiments, the provided tastant composition(s) are comprised of one or more food component(s) (e.g. tastants, etc.), as described herein, characterized by their taste benefits. In certain embodiments, one or more food component(s) characterized as material(s) providing a taste, flavor, and/or taste benefit upon consumption (e.g., an advantage conferred upon consumption) are additionally characterized as providing a means for the controlled release of one or more food component(s) (e.g. tastants, etc.).

(i) Food Component(s) Providing a Taste, Flavor, and/or Taste/Health Benefit

In certain embodiments, one or more tastant composition(s) are comprised of one or more food component(s). In certain embodiments, one or more food component(s) are characterized as material(s) providing a taste, flavor, and/or taste/health benefit upon consumption (e.g., an advantage conferred upon consumption) by one or more animals. In certain embodiments, a taste benefit is controlling the intensity of taste. In certain embodiments, a taste benefit is controlling the duration of taste. In certain embodiments, a taste benefit is controlling the onset of taste. In certain embodiments, a health benefit is the control of physiological reflexes (e.g., pancreatic secretions). In certain embodiments, a health benefit is the reduction of salt and/or sugar and/or fat in a tastant composition. In certain embodiments, one or more tastant composition(s) comprised of one or more food component(s) provide one, two, several, or all, of the following subset of taste and health benefits: controlled intensity of taste, controlled duration of taste, controlled onset of taste, control of physiological reflexes, and/or reduction of salt and/or sugar and/or fat.

In certain embodiments, taste, flavor, and/or taste/health benefits conferred upon consumption (e.g., an advantage conferred upon consumption) by one or more food component(s) are enabled by one or more delivery function(s). In certain embodiments, one or more food component(s) are characterized as material(s) providing a delivery function upon consumption (e.g., a utility conferred upon consumption) by one or more animals. In certain embodiments, a delivery function is extending retention time of payload in the oral cavity. In certain embodiments, a nutritional benefit is controlling payload release rate. In certain embodiments, a nutritional benefit is controlling payload adsorption/absorption rates. In certain embodiments, a nutritional benefit is controlling payload spatial interactions and concentrations within and around the oral cavity and specific areas (e.g. tongue, throat, nasal cavities, mucosa, epithelium, taste buds, microvilli, taste bud cell, etc.). In certain embodiments, a nutritional benefit is facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.). In certain embodiments, a nutritional benefit is controlling binding of payload to taste receptors. In certain embodiments, one or more tastant composition(s) comprised of one or more food component(s) provide one, two, several, or all, of the following subset of delivery functions: extending retention time, controlling release rate, controlling adsorption/absorption rates, controlling spatial interaction and concentrations, and facilitating passage through selective barriers and components).

In certain embodiments, as described herein, one or more food component(s) providing a taste, flavor, and/or taste benefit upon consumption may be characterized as being at least one of: a carbohydrate, a protein, a fat, and/or a ketone body.

As provided herein, one or more food component(s) characterized as being a carbohydrate may be or comprises at least one carbohydrate. In some instances, food component(s) characterized as being a carbohydrate can be a combination of carbohydrates, each of which may or may not individually provide a taste, flavor, and/or taste/health benefit.

For example, in some instances, one or more food component(s) characterized as being a carbohydrate may comprise glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being a protein may be or comprises at least one protein. In some instances, food component(s) characterized as being a protein can be a combination of proteins, each of which may or may not individually provide a taste, flavor, and/or taste/health benefit.

For example, in some instances, one or more food component(s) characterized as being a protein may comprise pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or legumin.

As provided herein, one or more food component(s) characterized as being a fat may be or comprises at least one fat. In some instances, food component(s) characterized as being a fat can be a combination of fats, each of which may or may not individually provide a taste, flavor, and/or taste/health benefit.

For example, in some instances, one or more food component(s) characterized as being a fat may comprise paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

As provided herein, one or more food component(s) characterized as being a polyunsaturated fatty acid may be or comprises at least one polyunsaturated fatty acid. In some instances, food component(s) characterized as being a polyunsaturated fatty acid can be a combination of polyunsaturated fatty acids, each of which may or may not individually provide a taste, flavor, and/or taste/health benefit.

For example, in some instances, one or more food component(s) characterized as being a polyunsaturated fatty acid may comprise at least one of medium-chain triglyceride, docosahexaenoic acid, eicosapentaenoic acid, arachidonic acid, linoleic acid, linolenic acid, oleic acid, parinaric acid, rumenic acid, or combinations thereof.

As provided herein, one or more food component(s) characterized as being a ketone body may be or comprises at least one ketone body. In some instances, food component(s) characterized as being a ketone body can be a combination of ketone bodies, each of which may or may not individually provide a taste, flavor, and/or taste/health benefit.

For example, in some instances, one or more food component(s) characterized as being a ketone body may comprise acetoacetate, R-β-hydroxybutyl R-β-hydroxybutyrate, β-hydroxybutyrate, R-3-hydroxybutyl R-3-hydroxybutyrate monoester, and/or 1,3-butanediol.

In certain embodiments, the provided tastant composition(s) are comprised of one or more food component(s) that each individually provide one or more taste, flavor, and/or taste benefit upon consumption. In certain embodiments, the provided tastant composition(s) are comprised of one or more food component(s) that each individually exhibit one or more delivery functions upon consumption.

### (ii) Food Component(s) Providing for Controlled Taste

In certain embodiments, one or more food component(s) comprising the provided tastant composition(s) provide for controlled taste. Controlled taste may be characterized as one or more of any taste/health benefits (e.g. controlled intensity of taste, controlled duration of taste, controlled onset of taste, and/or control of physiological reflexes, and/or reduction of salt and/or sugar and/or fat) and is enabled by a delivery function of a food component(s) (e.g. extending retention time, controlling release rate, controlling adsorption/absorption rates, controlling spatial interaction and concentrations, and facilitating passage through selective barriers and components). Typically, as described herein, one or more food component(s) providing for controlled taste is or are characterized as being at least one of: a tastant, a tastant facilitator, a tastant modulator, a nutrient, a nutraceutical, a macronutrient, a micronutrient, a polyphenol, a metal, a cofactor, a vitamin, an antioxidant, a mineral, an amino acid, a peptide, a ketone, an electrolyte, a salt, a protein, a carbohydrate, a sugar, a polysaccharide, a fat, a lipid, a fatty acid, a prebiotic, a dietary fiber, a carotenoid, a circadian rhythm modulator, a supplement, a nootropic, and/or a source of energy.

In some embodiments, one or more food component(s) comprising the provided tastant composition(s) may comprise a formulated food component (e.g., food ingredient, ingredient, formulated tastant, encapsulated tastant).

As provided herein, one or more food component(s) characterized as being a metal may be or comprises at least one metal. In some instances, food component(s) characterized as being a metal can be a combination of metals, each of which may or may not individually provide for the health of one or more animal(s).

For example, in some instances, one or more food component(s) characterized as being a metal may comprise calcium, chromium, cobalt, copper, iodine, iron, magnesium, manganese, molybdenum, potassium, selenium, sodium, and/or zinc.

As provided herein, one or more food component(s) characterized as being a cofactor may be or comprises at least one cofactor. In some instances, food component(s) characterized as being a cofactor can be a combination of cofactors, each of which may or may not individually provide for the health of one or more animal(s).

For example, in some instances, one or more food component(s) characterized as being a cofactor may comprise nicotinamide adenine dinucleotide, flavin adenine dinucleotide, adenosine triphosphate, S-adenosylmethionine, Coenzyme Q, glutathione, heme, lipoamide, molybdopterin, and/or tetrahydrobiopterin.

As provided herein, one or more food component(s) characterized as being a vitamin may be or comprises at least one vitamin. In some instances, food component(s) characterized as being a vitamin can be a combination of vitamins, each of which may or may not individually provide for the health of one or more animal(s).

For example, in some instances, one or more food component(s) characterized as being a vitamin may comprise trans-retinol, trans-β-carotene, thiamine, riboflavin, niacin, niacinamide, nicotinamide riboside, pantothenic acid, pyridoxine, pyridoxamine, pyridoxal, biotin, folic acid, cyanocobalamin, hydroxocobalamin, methylcobalamin, adenosylcobalamin, ascorbic acid, cholecalciferol, ergocalciferol, tocopherol, tocotrienol, phylloquinone, and/or menaquinone.

As provided herein, one or more food component(s) characterized as being an antioxidant may be or comprises at least one antioxidant. In some instances, food component(s) characterized as being an antioxidant can be a combination of antioxidants, each of which may or may not individually provide for the health of one or more animal(s).

For example, in some instances, one or more food component(s) characterized as being a polyphenol and/or an antioxidant may comprise tannic acid, ellagitannin, apigenin, luteolin, tangeritin, isorhamnetin, kaempferol, myricetin, quercetin, rutin, eriodictyol, genipin, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, and/or betanin.

As provided herein, one or more food component(s) characterized as being a mineral may be or comprises at least one mineral. In some instances, food component(s) characterized as being a mineral can be a combination of minerals, each of which may or may not individually provide for the health of one or more animal(s).

For example, in some instances, one or more food component(s) characterized as being a mineral may comprise iron oxide, calcium chloride, calcium carbonate, and/or calcium hydroxyapatite.

As provided herein, one or more food component(s) characterized as being an amino acid may be or comprises at least one amino acid. In some instances, food component(s) characterized as being an amino acid can be a combination of amino acids, each of which may or may not individually provide for the health of one or more animal(s).

For example, in some instances, one or more food component(s) characterized as being an amino acid may comprise alanine, arginine, asparagine, aspartic acid, cysteine, selenocysteine, glutamine, glutamic acid, glycine, histidine, isoleucine, leucine, lysine, methionine, phenylalanine, proline, serine, threonine, tryptophan, tyrosine, valine, norvaline, norleucine, pipecolic acid, ornithine, homocysteine, homoserine, isovaline, and/or sarcosine.

As provided herein, one or more food component(s) characterized as being a branched chain amino acid may be or comprises at least one branched chain amino acid. In some instances, food component(s) characterized as being a branched chain amino acid can be a combination of branched chain amino acids, each of which may or may not individually provide for the health of one or more animal(s).

For example, in some instances, one or more food component(s) characterized as being a branched chain amino acid may comprise isoleucine, leucine, and/or valine.

As provided herein, one or more food component(s) characterized as being a peptide may be or comprises at least one peptide. In some instances, food component(s) characterized as being a peptide can be a combination of peptides, each of which may or may not individually provide for the health of one or more animal(s).

For example, in some instances, one or more food component(s) characterized as being a peptide may comprise aspartame, GLP-1, GLP-2, collagen, sermorelin, tesamorelin, lenomorelin, anamorelin, ipamorelin, macimorelin, ghrelin, tabimorelin, alexamorelin, GHRP-1, GHRP-2, GHRP-3, GHRP-4, GHRP-5, GHRP-6, and/or hexarelin.

As provided herein, one or more food component(s) characterized as being a dietary fiber may be or comprises at least one dietary fiber. In some instances, food component(s) characterized as being a dietary fiber can be a combination of dietary fibers, each of which may or may not individually provide for the health of one or more animal(s).

For example, in some instances, one or more food component(s) characterized as being a dietary fiber may comprise cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being at least one macronutrient. In some instances, a macronutrient is or comprises at least one carbohydrate, at least one fat, at least one protein, or a combination thereof.

As provided herein, one or more food component(s) characterized as being at least one fatty acid. In some instances, a fatty acid is or comprises at least one of medium-chain triglyceride, docosahexaenoic acid, eicosapentaenoic acid, or combinations thereof.

As provided herein, one or more food component(s) characterized as being at least one short chain fatty acid. In some instances, a short chain fatty acid is or comprises acetate, propionate, and butyrate, or a combination thereof.

As provided herein, one or more food component(s) characterized as being a carotenoid may be or comprises at least one carotenoid. In some instances, food component(s) characterized as being a carotenoid can be a combination of carotenoids, each of which may or may not individually provide for the health of one or more animal(s).

For example, in some instances, one or more food component(s) characterized as being a carotenoid may comprise alpha-lipoic acid, lycopene, β-carotene, lutein, zeaxanthin, adonixxanthin, adonirubin, meso-zeaxanthin, astaxanthin, capsanthin, citroxanthin, echinenone, astacein, bixin, crocetin, and/or peridin.

As provided herein, one or more food component(s) characterized as being a circadian rhythm modulator may be or comprises at least one circadian rhythm modulator. In some instances, food component(s) characterized as being a circadian rhythm modulator can be a combination of circadian rhythm modulators, each of which may or may not individually provide for the health of one or more animal(s).

For example, in some instances, one or more food component(s) characterized as being a circadian rhythm modulator may comprise melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine.

(iii) Excipient Components

In certain embodiments, one or more component(s) comprising one or more tastant composition(s) may be further characterized as an excipient component.

In some embodiments, an excipient component utilized in accordance with the present disclosure is or comprises components that are not one or more food component(s) as described herein.

In some embodiments, an excipient component is or comprises at least one anti-caking (e.g., anti-agglomerating, anti-clumping, anti-aggregating) component, surfactant component, plasticizing component, acid scavenger (e.g., buffering agent), moisture scavenger, water scavenger, oxygen scavenger, a desiccant, a polymer, a preservative, a colorant, a flavoring, an antioxidant, a humectant, a solvent, or a combination thereof. In some embodiments, an excipient component imparts a benefit (e.g., reduced caking, increased stability, increased solubility, improved physical properties, improved taste, improved longevity, increased biocompatibility) on one or more tastant composition(s). In some embodiments, an excipient component imparts a change to the environment within the tastant composition (e.g., pH change, color change, oxygen concentration change, water concentration change). In some embodiments, an excipient component imparts a change (e.g., pH change, oxygen concentration change, flavor change, water concentration change) to the local environment (e.g., stomach, food matrix, beverage) where the tastant composition resides at a point in time. In some embodiments, an excipient component increases and/or decreases the solubility of one or more food component(s) in one or more tastant composition(s) upon mixing in one or more dissolution solvent(s).

Excipient components exhibiting one or more of anti-caking (e.g., anti-agglomerating, anti-clumping, anti-aggregating), surfactant, plasticizing, acid scavenger (e.g., buffering agent), moisture scavenger, water scavenger, desiccant, polymer, preservative, colorant, flavoring, antioxidant, humectant, and/or solvent properties may be comprised of substance(s) identified by one or more governing bodies as safe (e.g., generally regarded as safe and/or food additives). In some instances, those skilled in the art will appreciate that excipient component(s) are or may be selected from those excipient(s) recognized as Generally Regarded as Safe (i.e., GRAS) by the U.S. Food and Drug Administration. In some instances, those skilled in the art will appreciate that excipient component(s) are or may be selected from those excipient(s) recognized in 21 C.F.R. 184. In some instances, those skilled in the art will appreciate that excipient component(s) are or may be selected from those excipient(s) recognized in GB2760-2014 by the National Health and Family Planning Commission of the People's Republic of China.

In some cases, an excipient component is or comprises a single excipient species. In some instances, an excipient component can comprise multiple excipients and combinations thereof.

In some embodiments, excipients are added to one or more tastant composition(s) during a manufacturing process. In some embodiments, one or more shell component(s), core component(s), matrix component(s), and/or solute component(s) further comprise an excipient component. In certain embodiments, excipients are added to one or more tastant composition(s) prior to consumption.

In some cases, an excipient component is at least about 10 wt %, at least about 5 wt %, at least about 1 wt %, at least about 0.8 wt %, at least about 0.5 wt %, and/or at least about 0.1 wt % of one or more tastant composition(s).

In some cases, an excipient component can lower water activity of tastant compositions (e.g., formulated tastants).

In some cases, an excipient component can lower moisture content of tastant compositions (e.g., formulated tastants).

In some cases, an excipient component can lower residual solvent content of tastant compositions (e.g., formulated tastants).

In some cases, an excipient component can reduce the friability of tastant compositions (e.g., formulated tastants).

In some cases, an excipient component can improve the flowability of tastant compositions (e.g., formulated tastants).

In some cases, an excipient component can reduce clumping upon storage of tastant compositions (e.g., formulated tastants).

In some cases, an excipient component can improve the solubility of one or more food component(s) comprising one or more tastant composition(s).

In some cases, an excipient component can improve the mixing of one or more food component(s) with one or more dissolution solvent(s).

In some cases, an excipient component can improve the mixing of one or more food component(s) with one or more food products(s).

In some cases, an excipient component can improve the mixing of one or more food component(s) with one or more beverage products(s).

In some cases, an excipient component can improve the mixing of one or more food component(s) with one or more supplement products(s).

In some cases, an excipient component can improve the mixing of one or more food component(s) with other food component(s).

In some cases, an excipient component can either raise or lower the elastic modulus of tastant compositions (e.g., formulated tastants). In some cases, this may enable or facilitate methods of formulating or manufacturing tastant compositions (e.g., formulated tastants).

In some cases, an excipient component can either raise or lower the crystallinity of tastant compositions (e.g., formulated tastants).

In some cases, an excipient component can either alter and/or maintain the pH of a tastant composition. In some embodiments, excipient components used as a means of maintaining pH are additionally used as a means of gas generation. Without wishing to be bound by any particular theory, generation of gas within one or more tastant composition(s) may reduce the density of a tastant composition and introduce buoyancy leading to increased residence time in one or more gastrointestinal compartments.

In some cases, an excipient component can either react with environmental molecular oxygen or introduce molecular oxygen towards one or more tastant composition(s).

In some cases, an excipient component is essential to triggered release, as described herein, for one or more food component(s) from one or more tastant compositions (e.g., formulated tastants).

In some cases, an excipient component can alter pH within the microenvironment (e.g., stomach, food matrix, beverage, etc.) where the tastant composition resides.

In some cases, an excipient component affects response of the tastant composition to heat.

In some cases, an excipient component affects response of the tastant composition to shear.

In some cases, an excipient component affects response of the tastant composition to elevated pressure.

In some cases, an excipient component prevents fouling (e.g., microbial growth) of one or more tastant compositions (e.g., formulated tastants) over a period of at least 4 weeks, at least 12 weeks, at least 6 months, at least 1 year, at least 2 years, at least 5 years, and/or at least 10 years.

In some cases, an excipient component improves the taste and/or fragrance of one or more tastant composition(s).

In some cases, an excipient component improves the texture and/or mouthfeel of one or more tastant composition(s).

In some cases, an excipient component maintains the water activity of one or more tastant composition(s).

In some cases, an excipient component provides a visually pleasing appearance to one or more tastant composition(s).

In some cases, an excipient component can affect the stability of one or more tastant composition(s) towards light, heat, pressure, shear, enzymes, bacteria, and/or one or more dissolution solvent(s) as described herein.

### 2. Food Component(s) Providing a Means for Controlled Release of Food Component(s)

In certain embodiments, one or more tastant composition(s) are comprised of one or more food component(s). In certain embodiments, one or more food component(s) are characterized as material(s) providing a means of controlled release. In certain embodiments, release of one or more food component(s) from one or more tastant composition(s) is characterized by physical and/or chemical dissociation. In some cases, release of one or more food component(s) from one or more tastant composition(s) is characterized by the amount of one or more food component(s) released from one or more tastant composition(s) in the presence of one or more dissolution solvent(s) (e.g., dissolution). In some cases, release of one or more food component(s) from one or more tastant composition(s) is characterized by the rate of one or more food component(s) released from one or more tastant composition(s) in the presence of one or more dissolution solvent(s) (e.g., release rate). In some cases, the release of one or more food component(s) from one or more tastant composition(s) is characterized by a combination of amount of dissolution and/or release rate (e.g., release profile).

Those skilled in the art will appreciate that one or more food component(s) may be essentially characterized by solubility. Those skilled in the art will further appreciate that one or more food component(s) may be characterized as slightly soluble, partially soluble, and/or completely soluble in one or more dissolution solvent(s). Those skilled in the art will further appreciate that solubility of one or more food component(s) may be achieved by physical and/or chemical dispersal of one more food component(s) within one or more dissolution solvent(s). Those skilled in the art will further appreciate that the dispersal (e.g., dissolution) of one or more food component(s) in one or more dissolution solvent(s) relevant to a useful (e.g., to provide a taste and/or health benefit) application of one or more technologies may be further characterized as release.

Without wishing to be bound by any particular theory, it is contemplated that the solubility characteristic(s) of one more food component(s) is an important factor(s) determining their perceivable taste. Without wishing to be bound by any particular theory, it is contemplated that the solubility characteristic(s) of one more food component(s) is an important factor(s) determining their absorption in the mucosa. Without wishing to be bound by any particular theory, it is contemplated that the solubility characteristic(s) of one more food component(s) is an important factor(s) determining their absorption in the epithelium. Without wishing to be bound by any particular theory, it is contemplated that the solubility characteristic(s) of one more food component(s) is an important factor(s) determining their passage into and within a taste bud. Without wishing to be bound by any particular theory, it is contemplated that the solubility characteristic(s) of one more food component(s) is an important factor(s) determining their kinetics of binding to a protein receptor. Without wishing to be bound by any particular theory, a means of controlling the release of one or more food component(s) may be characterized as a means of controlling the solubilization of one or more food component(s) (e.g., release modifier).

In certain embodiments of the present disclosure, means of controlling the release of one or more food component(s) from one or more tastant composition(s) are provided. In certain embodiments, one or more food component(s) provides a means of controlling the release of one or more food component(s) from one or more tastant composition(s).

In some embodiments, a means of controlling the release of one or more food component(s) from one or more tastant composition(s) may be characterized by at least one of: (i) controlling access of one or more dissolution solvent(s) to one or more food component(s) (e.g., core-shell preparation) and/or (ii) diffusivity of one or more food component(s) (e.g., matrix preparation).

In certain embodiments, a means of controlling the release of one or more food component(s) from one or more tastant composition(s) characterized as core-shell and/or matrix preparations is further characterized as controlling the chemical properties and/or chemical structure of one or more food component(s), modulators of gastrointestinal residence time, and/or trigger-responsive materials.

### (i) Core-Shell Preparations

Among other things, the present disclosure provides core-shell preparations (e.g., tastant compositions (e.g., formulated tastants)) as a means of controlling the release of one or more food component(s) from one or more tastant composition(s). For example, in some embodiments, one or more tastant composition(s) are or comprise core-shell preparations. For example, core-shell preparations may comprise a core component (e.g., interior component) and/or a shell component (e.g., coating, exterior component), each of which are essentially comprised of one or more food component(s), as described herein. In some embodiments, a core component is comprised of one or more food component(s) and/or one or more excipient component(s). In some embodiments, a shell component is comprised of one or more food component(s) and/or one or more excipient component(s).

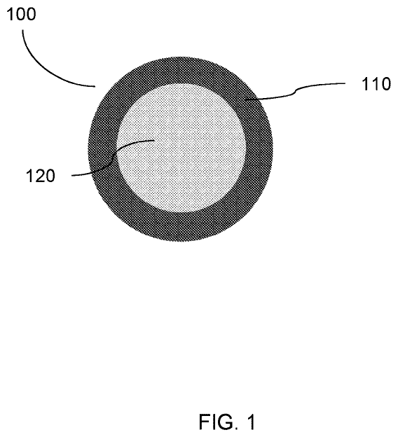

As depicted in a non-limiting schematic in FIG. 1, in some embodiments, an exemplary core-shell preparation may comprise a formulation comprising at least one food component and/or one excipient component arranged as a core component and at least one food component and/or one excipient component arranged as a shell component. In some embodiments, the at least one food component and/or one excipient component comprising a core component are additionally the at least one food component and/or one excipient component comprising a shell component. In some embodiments, the at least one food component and/or one excipient component comprising a core component are different from the at least one food component and/or one excipient comprising a shell component.

As depicted in a non-limiting schematic in FIG. 1, in some embodiments, an exemplary core-shell preparation 100 may comprise a core component 120 comprising at least one food component and/or at least one excipient component. In some embodiments, an exemplary core-shell preparation 100 may comprise a shell component 110 comprising at least one food component and/or at least one excipient component.

In some embodiments, the at least one food component and/or at least one excipient component comprising exemplary core component 120 is different from the at least one food component and/or at least one excipient component comprising exemplary shell component 110. In some embodiments, the at least one food component and/or at least one excipient component comprising exemplary core component 120 is the same as the at least one food component and/or at least one excipient component comprising exemplary shell component 110.

In some embodiments, the exemplary core component 120 is comprised of a single food component and/or excipient component. In some embodiments, the exemplary core component 120 is comprised of several food components and/or excipient components. In some embodiments, the exemplary shell component 110 is comprised of a single food component and/or excipient component. In some embodiments, the exemplary shell component 110 is comprised of several food components and/or excipient components.

In some embodiments, at least one food component and/or excipient component 120 may be described as being dispersed within (e.g., embedded within) at least one shell component 110.

In some embodiments, at least one shell component 110 may be described as encapsulating at least one core component 120, comprising at least one food component and/or excipient component.

In some embodiments, one or more core component(s) and/or a shell component(s) may be further characterized as a matrix preparation. In some embodiments one or more core component(s) and/or shell component(s) comprise a matrix preparation.

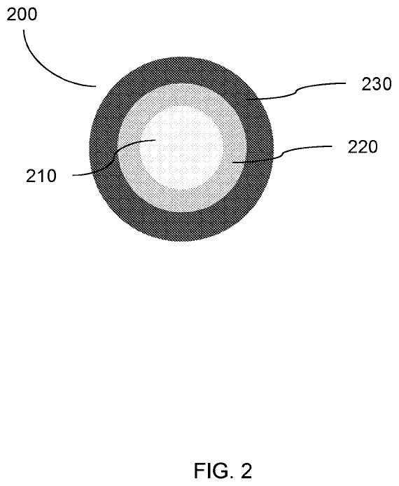

As depicted in a non-limiting schematic in FIG. 2, in some embodiments, an exemplary core-shell preparation may comprise a formulation comprising multiple layers of at least one food component and/or one excipient component arranged as a core component and at least one food component and/or one excipient component arranged as at least one shell component.

As depicted in a non-limiting schematic in FIG. 2, in some embodiments, an exemplary core-shell preparation 200 may comprise a core component 210 comprising at least one food component and/or excipient component, at least one shell component 220 comprising at least one food component and/or excipient component, and/or a second shell component 230 comprising at least one food component and/or excipient component.

In some embodiments, at least one core-shell composition 220 and 210 may be described as being dispersed within (e.g., embedded within) at least one shell component 230.

In some embodiments, at least one shell component 230 may be described as encapsulating at least one core-shell preparation and/or matrix preparation 210 and 220.

In some embodiments, at least one payload component 120, at least one excipient component 130, at least one matrix component 140, or a combination thereof may be described as being dispersed within (e.g., encapsulated in) at least one carrier component 110.

In some embodiments, one or more core-shell preparation(s) are encapsulated in a range of 1-15, 1-10, 1-8, 1-6, 1-4, and/or 1-2 distinct shell component(s). In some embodiments, one or more core component(s) may be characterized as a core-shell preparation. In some embodiments, a core-shell preparation is further encapsulated in 1 shell component. In other embodiments, a core-shell preparation is encapsulated in 2 layered shell components.

In certain embodiments, a core-shell preparation is encapsulated in a range of 1-15, 1-10, 1-8, 1-6, 1-4, and/or 1-2 shell component(s) that are homogeneously blended. In certain embodiments, the core-shell preparations are encapsulated in a range of 1-15, 1-10, 1-8, 1-6, 1-4, and/or 1-2 shell components that are subsequently encapsulated in a range of 1-15, 1-10, 1-8, 1-6, 1-4, and/or 1-2 shell components.

In some embodiments, one or more food component(s) comprising a shell component and/or a core component is characterized as being a liquid. In some embodiments, one or more food component(s) comprising a shell component and/or a core component is characterized as being a solid.

In some embodiments, provided core-shell preparations may be characterized as a particle (e.g., particle preparation), an emulsion, a suspension, a powder, a bar, a gel, a capsule, a tablet, a fiber, an extrudate, a hard candy, a chip, and/or a mesh.

In certain aspects, one or more core-shell preparation(s) comprising one or more tastant composition(s) may be further characterized as an emulsion. In certain embodiments, one or more emulsion(s) present in one or more tastant composition(s) comprise one or more shell component(s), one or more core component(s), or both shell component(s) and core component(s) characterized by low solubility (e.g., miscibility) in water. Additionally, or alternatively, one or more emulsion(s) present in one or more tastant composition(s) comprise one or more shell component(s), one or more core component(s), or both shell component(s) and core component(s) of amphiphilic nature. In certain embodiments, one or more core-shell preparation(s) further characterized as an emulsion may be described as having one or more core component(s) of low solubility (e.g., miscibility) in water and one or more shell component(s) of amphiphilic nature. In certain embodiments, one or more core-shell preparation(s) further characterized as an emulsion may be described as having one or more core component(s) of high solubility (e.g., miscibility) in water and one or more shell component(s) of amphiphilic nature. In certain embodiments, one or more emulsion(s) are prepared prior to consumption by one or more animal(s). In certain embodiments, one or more emulsion(s) form spontaneously upon addition to one or more dissolution solvent(s). In certain embodiments, one or more emulsion(s) form spontaneously upon exposure to one or more triggers. For example, in certain embodiments, one or more emulsion(s) form spontaneously in response to cross-linkers, pH, bile salts, surfactants, reducing and/or oxidizing agents, osmotic pressure, proteases, amylases, lipases, bacteria, yeast, transglutaminases, thrombin, temperature, time, and/or mechanical forces.

In certain embodiments, core-shell preparations (e.g., tastant compositions) are characterized as a means of controlling the release of one or more food component(s). In certain embodiments, one or more shell component(s) controls the release profile of one or more core component(s). In certain embodiments, one or more core component(s) controls the release profile of one or more shell component(s). In certain embodiments, control of the release of one more core component(s) is achieved by one or more shell component(s) providing a physical barrier to a dissolution solvent, controlling the diffusivity of one or more core component(s), controlling the chemical properties of one or more core component(s), controlling residence time of one or more core component(s) in the dissolution medium, and/or responsiveness to one or more triggers, as described herein. In certain embodiments, control of the release of one more shell component(s) is achieved by one or more core component(s) controlling the diffusivity of one or more shell component(s), controlling the chemical properties of one or more shell component(s), controlling residence time of one or more shell component(s) in the dissolution medium, and/or responsiveness to one or more triggers, as described herein.

In certain embodiments, one or more shell component(s) provides a physical barrier between a dissolution solvent and one or more core component(s). For example, in some embodiments, one or more shell component(s) may be characterized as insoluble in aqueous media (e.g., water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer). For example, in some embodiments, one or more shell component(s) may be characterized by slow and/or zero-order solubilization in aqueous media. Without wishing to be bound by any particular theory, it is contemplated that one or more shell component(s) characterized by insolubility, slow, and/or zero-order solubilization in aqueous media prevent access of such aqueous media to one or more core component(s), thus preventing dissolution (e.g., release) of one or more core component(s).

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be ionically and/or covalently bonded (i.e., associated, complexed) to itself (e.g., a polymer and/or a crystal) and/or one or more core component(s). Additionally, or alternatively, one or more core component(s) may be ionically and/or covalently bonded (i.e., associated, complexed) to itself (e.g., a polymer and/or a crystal) and/or one or more shell component(s). Without wishing to be bound by any particular theory, it is contemplated that ionic and/or covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that ionic and/or covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be non-covalently bonded (e.g., hydrogen bonding, Van der Waals forces, electrostatic interactions, hydrophobic interactions, etc.) to itself (e.g., a polymer and/or a crystal) and/or one or more core component(s).

Additionally, or alternatively, one or more core component(s) may be non-covalently bonded (i.e., associated, complexed) to itself (e.g., a polymer and/or a crystal) and/or one or more shell component(s). Without wishing to be bound by any particular theory, it is contemplated that non-covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that non-covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the residence time of one or more core component(s) in and around the oral cavity and specific areas (e.g. tongue, throat, nasal cavities, mucosa, epithelium, taste buds, microvilli, taste bud cell, etc.). In certain embodiments, one or more core-shell preparation(s) (e.g., tastant compositions), as provided herein, are characterized by retention in and around the oral cavity and specific areas (e.g. tongue, throat, nasal cavities, mucosa, epithelium, taste buds, microvilli, taste bud cell, etc.). In certain embodiments, one or more core-shell preparation(s) (e.g., tastant compositions), as provided herein, are characterized by lack of retention in and around the oral cavity and specific areas (e.g. tongue, throat, nasal cavities, mucosa, epithelium, taste buds, microvilli, taste bud cell, etc.). In certain embodiments, one or more shell component(s) is or are characterized as being mucoadhesive (e.g., affinity and/or adhesion to one or more mucosal interfaces through interaction with the mucus, glycocalyx, extracellular matrix, cell membrane proteins, and/or cell membranes). In certain embodiments, one or more shell component(s) is or are characterized as being mucopenetrative (e.g., lack of interaction with the mucus, glycocalyx, extracellular matrix, cell membrane proteins, and/or cell membranes).

In some embodiments, mucoadhesive component(s) are further characterized as pH-responsive carbohydrates, as described herein. In certain embodiments, pH-responsive carbohydrates are carbohydrate materials that are characterized by their water solubility at a predetermined pH. In some embodiments, pH-responsive carbohydrates are characterized by their water solubility at low pH (e.g., pH<about 5, pH<about 4, pH<about 3, pH<about 2, pH<about 1). In some embodiments, pH-responsive carbohydrates exhibit low water solubility at low pH and higher water solubility at moderate (e.g., pH of about 5.5, about 6, about 6.5, about 7, about 7.5, about 8) to high (e.g., pH>8, pH>9, pH>10, pH>11, pH>12) pH. In other embodiments, pH-responsive carbohydrates exhibit higher water solubility at low pH and lower water solubility at moderate to high pH.

For example, in some embodiments, pH-responsive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, cellulose acetate succinate, cellulose acetate butyrate, cellulose acetate phthalate, hydroxypropyl methylcellulose acetate succinate, heparin sodium, sodium carboxymethylcellulose, chitosan, and/or combinations thereof.

In some embodiments, mucoadhesive component(s) are considered mucoadhesive carbohydrates. In certain embodiments, mucoadhesive carbohydrates are carbohydrate materials that are characterized by their ability to interact with the mucosal interface (e.g., mucus, mucins, glycocalyx, proteoglycans, cell membrane, phospholipids). Without wishing to be bound by any particular theory, mucoadhesive carbohydrates may utilize a combination of hydrogen bonding, charge-charge interaction, and hydrophobic effect to prolong residence time of formulations (e.g., particle preparations) on a mucosal surface.

For example, in some embodiments, mucoadhesive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, sodium carboxymethylcellulose, chitosan, and/or combinations thereof.

In some embodiments, mucoadhesive component(s) are considered mucoadhesive proteins. In certain embodiments, mucoadhesive proteins are protein materials that are characterized by their ability to interact with the mucosal interface (e.g., mucus, mucins, glycocalyx, proteoglycans, cell membrane, phospholipids). Without wishing to be bound by any particular theory, mucoadhesive proteins may utilize a combination of hydrogen bonding, charge-charge interaction, and hydrophobic effect to prolong residence time of formulations (e.g., particle preparations) on a mucosal surface.

For example, in some embodiments, mucoadhesive protein component(s) may comprise Lycopersicon esculentum agglutinin, wheat germ agglutinin, Urtica dioica agglutinin, and/or combinations thereof.

In some embodiments, mucoadhesive component(s) are considered catechols. In certain embodiments, mucoadhesive catechols are polyphenol (e.g., as described herein) that are characterized by their ability to interact with the mucosal interface (e.g., mucus, mucins, glycocalyx, proteoglycans, cell membrane, phospholipids). Without wishing to be bound by any particular theory, mucoadhesive catechols may utilize a combination of hydrogen bonding, π-stacking, chemical cross-linking, and hydrophobic effect to prolong residence time of formulations (e.g., particle preparations) on a mucosal surface.

For example, in some embodiments, mucoadhesive catechols may comprise L-dopamine, poly(L-dopamine), hydroxytyrosol, catechol, caffeic acid, vanillin, veratraldehyde, eugenol, tannic acid, syringaldehyde, and/or protocatechuic aldehyde.

In some embodiments, mucoadhesive component(s) are further characterized as charged polymers (e.g., polymers exhibiting charge depending on pH of one or more dissolution solvent(s)). In some embodiments, a charged polymer may be an anionic mucoadhesive polymer component (e.g., polymers exhibiting a negative charge depending on pH of one or more dissolution solvent(s)). In some embodiments, a charged polymer may be cationic mucoadhesive polymer component (e.g., polymers exhibiting a positive charge depending on pH of one or more dissolution solvent(s)). Without wishing to be bound by any particular theory, it is contemplated that charged polymers facilitate interaction with the mucosal interface (e.g., mucus, mucins, glycocalyx, proteoglycans, cell membrane, phospholipids) thereby enabling greater retention time of one or more core-shell preparation(s).

For example, in some embodiments anionic mucoadhesive polymer component(s) may comprise poly(acrylic acid), poly(methacrylic acid), and/or poly(glycerol citrate)

For example, in some embodiments cationic mucoadhesive polymer component(s) may comprise poly(ethyleneimine), trimethylchitosan, and/or poly(L-arginine).

In some embodiments, mucopenetrative component(s) are characterized by lack of interaction with the mucus, glycocalyx, extracellular matrix, cell membrane proteins, and/or cell membranes. Without wishing to be bound by any particular theory, one or more shell component(s) comprising a mucopenetrative component is contemplated to increase the diffusion of one or more core-shell preparation(s) at a mucosal interface. For example, in some embodiments, mucopenetrative component(s) may comprise poly(ethylene glycol), poly(propylene glycol), poly(vinyl alcohol), and/or poly(ethylene oxide-co-propylene oxide).

In certain embodiments, one or more shell component(s) controls the release of one or more core component(s) by responding to a trigger. In certain embodiments, one or more core component(s) controls the release of one or more shell component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more core component(s) and/or one or more shell component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

### (ii) Matrix Preparations

Among other things, the present disclosure provides matrix preparations (e.g., tastant compositions (e.g., formulated tastants)) as a means of controlling the release of one or more food component(s) from one or more tastant composition(s). For example, in some embodiments, one or more tastant composition(s) are or comprise matrix preparations. For example, matrix preparations may comprise a solute component and/or a matrix component, each of which are essentially comprised of one or more food component(s), as described herein. In some embodiments, a solute component is comprised of one or more food component(s) and/or one or more excipient component(s). In some embodiments, a matrix component is comprised of one or more food component(s) and/or one or more excipient component(s).

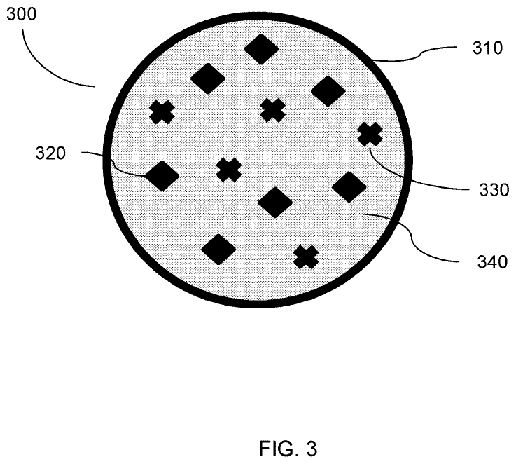

As depicted in a non-limiting schematic in FIG. 3 in some embodiments, an exemplary matrix preparation may comprise a formulation comprising at least one food component and/or one excipient component arranged as a solute component and at least one food component and/or one excipient component arranged as a matrix component. In some embodiments, the at least one food component and/or one excipient component comprising a solute component are additionally the at least one food component and/or one excipient component comprising a matrix component. In some embodiments, the at least one food component and/or one excipient component comprising a solute component are different from the at least one food component and/or one excipient comprising a matrix component. In some embodiments, one or more solute component(s) are distributed homogeneously within a matrix preparation (e.g., food composition). In some embodiments, one or more solute component(s) are distributed heterogeneously within a matrix preparation (e.g., food composition).

As depicted in a non-limiting schematic in FIG. 3 in some embodiments, an exemplary matrix preparation 300 may comprise one or more solute components 320 and/or 330 further comprising one or more food component(s) and/or excipient component(s). In some embodiments, an exemplary matrix preparation 300 may comprise one or more matrix components 340 further comprising one or more food component(s) and/or excipient component(s) comprising at least one carrier component 110, at least one payload component 120, at least one excipient component 130, or a combination thereof.

In some embodiments, at least one food component 320 and/or an at least one excipient component 330 may be described as being dispersed within (e.g., embedded within) at least one matrix component 340.

In some embodiments, at least one matrix component 340 may be described as encapsulating (i) at least one food component 320, and/or at least one excipient component 330.

In some embodiments, at least one food component 320, at least one excipient component 330, at least one matrix component 340, or a combination thereof may be described as being dispersed within (e.g., encapsulated in) at least one matrix preparation 300.

In some embodiments, at least one food component 320, at least one excipient component 330, at least one matrix component 340, or a combination thereof comprising one or more matrix preparations 300 may be described as being dispersed within (e.g., encapsulated or embedded within) a shell component 310, as a core-shell preparation.

In some embodiments, one or more solute component(s) and/or matrix component(s) may be further characterized as a core-shell preparation. In some embodiments, one or more solute component(s) and/or matrix component(s) comprise a core-shell preparation.

In some embodiments, one or more food component(s) comprising a matrix component and/or a solute component is characterized as being a liquid. In some embodiments, one or more food component(s) comprising a matrix component and/or a solute component is characterized as being a solid.

In some embodiments, provided matrix preparations may be characterized as a particle (e.g., particle preparation), a bar, a gel, a capsule, a tablet, a fiber, an extrudate, a hard candy, a chip, and/or a mesh.

In certain embodiments, matrix preparations (e.g., tastant compositions (e.g., formulated tastants)) are characterized as a means of controlling the release of one or more food component(s). In certain embodiments, one or more matrix component(s) controls the release profile of one or more solute component(s). In certain embodiments, one or more solute component(s) controls the release profile of one or more matrix component(s). In certain embodiments, control of the release of one more solute component(s) is achieved by one or more matrix component(s) providing a physical barrier to a dissolution solvent, controlling the diffusivity of one or more solute component(s), controlling the chemical properties of one or more solute component(s), controlling residence time of one or more solute component(s) in the dissolution medium, and/or responsiveness to one or more triggers, as described herein. In certain embodiments, control of the release of one more matrix component(s) is achieved by one or more solute component(s) controlling the chemical properties of one or more matrix component(s), and/or responsiveness to one or more triggers, as described herein.

In certain embodiments, one or more matrix component(s) controls the residence time of one or more core component(s) in and around the oral cavity and specific areas (e.g. tongue, throat, nasal cavities, mucosa, epithelium, taste buds, microvilli, taste bud cell, etc.). In certain embodiments, one or more matrix preparation(s) (e.g., tastant compositions), as provided herein, are characterized by retention in and around the oral cavity and specific areas (e.g. tongue, throat, nasal cavities, mucosa, epithelium, taste buds, microvilli, taste bud cell, etc.). In certain embodiments, one or more matrix preparation(s) (e.g., tastant compositions), as provided herein, are characterized by lack of retention in and around the oral cavity and specific areas (e.g. tongue, throat, nasal cavities, mucosa, epithelium, taste buds, microvilli, taste bud cell, etc.). In certain embodiments, one or more matrix component(s) is or are characterized as being mucoadhesive (e.g., affinity and/or adhesion to one or more mucosal interfaces through interaction with the mucus, glycocalyx, extracellular matrix, cell membrane proteins, and/or cell membranes). In certain embodiments, one or more matrix component(s) is or are characterized as being mucopenetrative (e.g., lack of interaction with the mucus, glycocalyx, extracellular matrix, cell membrane proteins, and/or cell membranes).

In certain embodiments, one or more matrix component(s) controls the diffusivity of one or more solute component(s). In certain embodiments, one or more solute component(s) controls the diffusivity of one or more matrix component(s). For example, in some embodiments, one or more matrix component(s) and/or one or more solute component(s) may be characterized by at least one of porosity, chain length, and/or electric charge. Without wishing to be bound by any particular theory, it is contemplated that one or more matrix component(s) characterized by reduced porosity and/or increased chain length and/or complementary charge to one or more solute component(s) reduce free movement (e.g., diffusivity) of one or more solute component(s) by presenting a physical obstruction and/or an electric field, thus preventing dissolution (e.g., release) of one or more solute component(s). Without wishing to be bound by any particular theory, it is contemplated that one or more solute component(s) characterized by increased chain length and/or complementary charge to one or more matrix component(s) reduce free movement (e.g., diffusivity) of one or more matrix component(s) by presenting a physical obstruction and/or an electric field, thus preventing dissolution (e.g., release) of one or more matrix component(s).

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be ionically and/or covalently bonded (i.e., associated, complexed) to itself (e.g., a polymer) and/or one or more solute component(s). Additionally, or alternatively, one or more solute component(s) may be ionically and/or covalently bonded (i.e., associated, complexed) to itself (e.g., a polymer) and/or one or more matrix component(s). Without wishing to be bound by any particular theory, it is contemplated that ionic and/or covalent bonding of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that ionic and/or covalent bonding of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be non-covalently bonded (e.g., hydrogen bonding, Van der Waals forces, electrostatic interactions, hydrophobic interactions, etc.) to itself (e.g., a polymer) and/or one or more solute component(s).

Additionally, or alternatively, one or more solute component(s) may be non-covalently bonded (e.g., hydrogen bonding, Van der Waals forces, electrostatic interactions, hydrophobic interactions, etc.) to itself (e.g., a polymer) and/or one or more matrix component(s). Without wishing to be bound by any particular theory, it is contemplated that non-covalent bonds (e.g., hydrogen bonding, Van der Waals forces, electrostatic interactions, hydrophobic interactions, etc.) of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that non-covalent bonds (e.g., hydrogen bonding, Van der Waals forces, electrostatic interactions, hydrophobic interactions, etc.) of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the release of one or more solute component(s) by responding to a trigger. In certain embodiments, one or more solute component(s) controls the release of one or more matrix component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more solute component(s) and/or one or more matrix component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

(iii) Release Profiles

In certain embodiments, the release of one or more food component(s) is characterized by the amount (e.g., concentration) of one or more food component(s) solubilized in one or more dissolution solvent(s) over a predetermined period of time (e.g., incubation period). In certain embodiments, the present disclosure provides for a means of controlled release of one or more food component(s) (e.g., core-shell preparations and/or matrix preparations). In certain embodiments, controlled release of one or more food component(s) is control of the amount (e.g., concentration) of one or more food component(s) released over an incubation period (e.g., release rate). In many embodiments, the concentration and release rate comprise the release profile of one or more food component(s).

In certain embodiments, control of the release profile of one or more food component(s) provides a taste benefit (e.g., controlled duration of taste, controlled onset of taste). For example, in certain embodiments, the release of one or more food component(s) may be held at a constant release rate for at least about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur in intervals (e.g., bolus dose) every about 0.5 seconds, about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur with a release rate that increases after at least about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur with a release rate that decreases after at least about 1, about 3, about 5, about 10, about 15, about 30, about 45, about 60, about 120, about 180, about 300, about 600, about 1200, and/or about 2400 seconds.

In certain embodiments, control of the release profile of one or more food component(s) provides a taste benefit (e.g., controlled duration of taste, controlled onset of taste). For example, in certain embodiments, the release of one or more food component(s) may be held at a constant release rate for at least about 1, about 2, about 4, about 6, about 12, about 24, and/or about 48 hours. For example, in certain embodiments, the release of one or more food component(s) may occur in intervals (e.g., bolus dose) every about 30 minutes, about 1 hour, about 2 hours, about 4 hours, about 6 hours, about 8 hours, about 12 hours, and/or about 24 hours. For example, in certain embodiments, the release of one or more food component(s) may occur with a release rate that increases after at least about 1, about 2, about 4, about 6, about 12, about 24, and/or about 48 hours. For example, in certain embodiments, the release of one or more food component(s) may occur with a release rate that decreases after at least about 1, about 2, about 4, about 6, about 12, about 24, and/or about 48 hours.

### (iv) Dissolution Solvents

In certain embodiments, the release of one or more food component(s) from one or more tastant composition(s) is characterized by quantification of solubilization in one or more dissolution solvent(s), as provided herein.

In certain embodiments, one or more dissolution solvent(s) may be characterized by their miscibility with water. In certain embodiments, one or more dissolution solvent(s) may be characterized by their salinity. In certain embodiments, one or more dissolution solvent(s) may be characterized by their pH. In certain embodiments, one or more dissolution solvent(s) may be characterized as being a native biological fluid (i.e., a fluid characterized as essential to a living organism). In certain embodiments, one or more dissolution solvent(s) may be characterized as being a surrogate of a native biological fluid (i.e., a surrogate of a fluid characterized as essential to a living organism). In certain embodiments, one or more dissolution solvent(s) may be characterized by a combination of at least one of their miscibility with water, pH, and/or salinity, as being a native biological fluid, and/or resembling a native biological fluid.

In certain embodiments, one or more tastant composition(s) is added to an excess quantity, by weight, of one or more dissolution solvent(s) to characterize solubility. In certain embodiments, one or more tastant composition(s) is added to at least about 5 fold, at least about 10 fold, at least about 20 fold, at least about 50 fold, at least about 100 fold, at least about 200 fold, at least about 1000 fold, at least about 5000 fold, and/or at least about 10000 fold, by weight, excess of one or more dissolution solvent(s) to characterize solubility.

In certain embodiments, one or more tastant composition(s) is added to one or more dissolution solvent(s) at a controlled temperature to characterize solubility. In certain embodiments, one or more tastant composition(s) is added to one or more dissolution solvent(s) held at least at about −20 °C, at least at about 0 °C, at least at about 4 °C, at least at about 20 °C, at least at about 37 °C, and/or at least at about 50 °C to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 30 seconds, at least about 1 minute, at least about 5 minutes, and/or at least about 10 minutes to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 10 minutes, at least about 30 minutes, at least about 60 minutes, and/or at least about 120 minutes to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 120 minutes, at least about 6 hours, at least about 12 hours, and/or at least about 24 hours to characterize solubility.

In certain embodiments, one or more tastant composition(s) is added to one or more dissolution solvent(s) at a particular combination of weight ratio, temperature, and/or period of time, as described herein, to characterize solubility.

In certain embodiments, one or more dissolution solvent(s) is characterized as being miscible with water. In certain embodiments, one or more dissolution solvent(s) is characterized as being immiscible with water.

For example, one or more dissolution solvent(s) characterized as being miscible with water may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, Cyrene, Glycofurol, furfural, Kreb's buffer, acetone, tetrahydrofuran, ethanol, methanol, dimethylformamide, and/or dimethyl sulfoxide.

For example, one or more dissolution solvent(s) characterized as being immiscible with water may be n-octanol, n-nonanol, n-decanol, n-dodecanol, n-tetradecanol, n-hexadecanol, n-octadecanol, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, dichloromethane, hexanes, toluene, 2-methyltetrahydrofuran, and/or ethyl acetate.

In certain embodiments, one or more dissolution solvent(s) is characterized by salinity. For example, one or more dissolution solvent(s) characterized by salinity may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized by pH. For example, one or more dissolution solvent(s) characterized by pH may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized as being a native biological fluid. For example, one or more dissolution solvent(s) characterized as being a native biological fluid may be water, biological intestinal fluid, biological gastric fluid, plasma, saliva, urine, feces, sweat, oral fluid, cecum fluid, bile, and/or tear fluid.

In certain embodiments, one or more dissolution solvent(s) is characterized as being a surrogate of native biological fluid. For example, one or more dissolution solvent(s) characterized as being a surrogate of native biological fluid may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, and/or Kreb's buffer.

### 3. Moisture Content

In some embodiments, provided tastant composition(s) is or are characterized by low moisture content. In some embodiments, the present disclosure provides technologies for preparing and/or characterizing tastant compositions (e.g., formulated tastants) comprising low moisture content.

In some embodiments, the present disclosure provides one or more tastant composition(s) with low moisture content. Disclosed technologies provide benefits over existing products because high moisture content formulations may lead to rapid degradation of food component(s).

In some embodiments, the present disclosure provides one or more tastant composition(s) with low moisture content. In some instances, provided tastant compositions (e.g., formulated tastants) may have a moisture content of <8 wt %, <6 wt %, <4 wt %, <2 wt %, <1 wt %, or <0.5 wt %.

In some embodiments, provided tastant compositions (e.g., formulated tastants) are characterized by resistance or mitigation of water absorption or moisture absorption when exposed to high humidity or moisture content. In some embodiments, the present disclosure provides technologies for preventing uptake of water or moisture.

In some embodiments, the present disclosure provides one or more tastant composition(s) that resist or mitigate moisture absorption when exposed to high humidities or moisture. In some instances, provided tastant compositions (e.g., formulated tastants) resist absorption of less than about 0.25%, less than about 0.5%, less than about 1%, and/or less than about 5% (w/w) moisture content, as compared to initial moisture content, after incubation in relative humidities of about 33%, about 53%, and/or about 75%.

### 4. Water Activity

Without wishing to be bound by any particular theory, food component(s) may exhibit poor stability in environments with high water activity. In certain aspects of the present embodiments, a tastant composition of low water activity exhibits a water activity of <about 0.4, <about 0.3, <about 0.2, and/or <about 0.1.

In certain embodiments, the disclosed invention provides one or more tastant composition(s) of water activity <about 0.4, <about 0.3, <about 0.2, and/or <about 0.1. In certain embodiments, the disclosed invention provides one or more tastant composition(s) of low water activity. In some embodiments, the present disclosure provides technologies for preparing and/or characterizing tastant composition(s) comprising low water activity.

In some embodiments, the present disclosure provides one or more tastant composition(s) with low water activity. Disclosed technologies provide benefits over existing products because high water activity formulations lead to rapid degradation of food component(s).

### 5. Particle Preparations

Among other things, the present disclosure provides particle preparations (e.g., tastant compositions, e.g. tastant particle preparations). For example, in some embodiments, tastant compositions (e.g., formulated tastants) are or comprise particles (e.g., particle preparations, e.g., tastant particle preparations). For example, particles may comprise a payload component (e.g., tastant, etc.) and/or a carrier component.

In some embodiments, one or more tastant composition(s) are or comprise particles (e.g., particle preparations). In some embodiments, the present disclosure provides particle preparations in which particles have a particular shape or form, for example, having a cross-section shape of a circle, an oval, a triangle, a square, a hexagon, or an irregular shape. In some embodiments, a preparation includes particles of different shapes or forms. In some embodiments, most or substantially all or all particles in a preparation have a common shape.

In some embodiments, particles in a provided particle preparation may have a distribution of diameters (e.g., Dv(10), Dv(20), Dv(30), Dv(40), Dv(50), Dv(60), Dv(70), Dv(80), Dv(90), Dv99, etc.). In some embodiments, particles in a provided particle preparation may have an average diameter (e.g., D[3,2], D[4,3], etc.). Regardless of the shape of the particle, the “diameter” (i.e., size) of a particle is the longest distance from one end of the particle to another end of the particle.

In some instances, particles in a particle preparation as described and/or utilized herein may have a distribution of diameters (e.g., Dv(10), Dv(20), Dv(30), Dv(40), Dv(50), Dv(60), Dv(70), Dv(80), Dv(90), Dv(99), etc.) of up to about 10000 μm, up to about 5000 μm, up to about 2500 μm, up to about 1250 μm, up to about 800 μm, up to about 400 μm, up to about 200 μm, up to about 100 μm, up to about 50 μm, up to about 40 μm, up to about 30 μm, up to about 20 μm, up to about 10 μm, or up to about 5 μm.

### 6. Release of Food Component(s)

In certain embodiments of the present disclosure, a means for controlled release of one or more food component(s) from one or more tastant composition(s) is provided. In certain embodiments, the controlled release of one or more food components is characterized by at least one of release profile (e.g., as described herein), total amount (e.g., mass and/or weight) of one or more food component(s) released, total amount of one or more food component(s) released relative to initial loading (e.g., percent release), and/or location of release in a given incubation period in one or more dissolution solvent(s).

In certain embodiments, a total amount (e.g., mass and/or weight) of one or more food component(s), percent release, total amount of tastants provided, and/or location of release is characterized by one or more release profiles (e.g., as described herein). In certain embodiments, the release of one or more food component(s) is characterized by release over a given time frame. In certain embodiments, release is characterized over a time period of at least about 1 second, at least about 3 seconds, at least about 5 seconds, at least about 10 seconds, at least about 30 seconds, at least about 1 minute, at least about 5 minutes, at least about 10 minutes, at least about 30 minutes, at least about 60 minutes, at least about 2 hours, at least about 4 hours, at least about 8 hours, at least about 16 hours, and/or at least about 24 hours. In certain embodiments, release is characterized over a time period relevant to time periods between one or more meals. For example, in certain embodiments, release is characterized over a time period of at least about 8 hours, at least about 16 hours, and/or at least about 24 hours. In certain embodiments, release profiles of one or more food component(s) may be characterized (e.g., as described herein) as held at a constant release rate, bolus dose in intervals, with increasing release rate, and/or decreasing release rate for at least about 1 second, about 3 seconds, about 5 seconds, about 10 seconds, about 30 seconds, about 1 minute, about 5 minutes, about 10 minutes, about 30 minutes, about 1 hour, about 2 hours, about 4 hours, about 6 hours, about 8 hours, about 12 hours, about 24 hours, and/or about 48 hours. In some embodiments, one or more food component(s) comprising one or more tastant composition(s) exhibit the same release (e.g., release profile). In some embodiments, one or more food component(s) comprising one or more tastant composition(s) exhibit differing release (e.g., release profile).

In certain embodiments, controlled release of one or more food component(s) is characterized by the percent release in a given incubation period in one or more dissolution solvent(s). In certain embodiments, at least about 0%, about 10%, about 25%, about 50%, about 75%, and/or about 100% of one or more food component(s) are released over an 8 hour period. In certain embodiments, at least about 0%, about 10%, about 25%, about 50%, about 75%, and/or about 100% of one or more food component(s) are released over a 16 hour period. In certain embodiments, at least about 0%, about 10%, about 25%, about 50%, about 75%, and/or about 100% of one or more food component(s) are released over a 24 hour period.

In certain embodiments, controlled release of one or more food component(s) is characterized by a targeted location of release. In certain embodiments, one or more food component(s) is characterized by release in at least one of the mouth, throat, nasal cavity, and/or mucosa. In certain embodiments, one or more food component(s) comprising one or more core component(s) and/or shell component(s) is characterized as controlling release in at least one of the mouth, throat, nasal cavity, and/or mucosa. In certain embodiments, one or more food component(s) comprising one or more solute component(s) and/or matrix component(s) is characterized as controlling release in at least one of the mouth, throat, nasal cavity, and/or mucosa. In certain aspects, the at least one food component controlling release in at least one of the mouth, throat, nasal cavity, and/or mucosa is further characterized as triggered by pH. In certain embodiments, one or more food component(s) is characterized by release at a pH of at about 1-2, about 2-3, about 3-4, about 4-5, about 5-6, about 6-7, about 7-8, about 8-9, and/or about 9-10. In certain aspects, the at least one food component controlling release in at least one of the mouth, throat, nasal cavity, and/or mucosa is further characterized as enzymatically triggered. In certain embodiments, one or more food component(s) is characterized by susceptibility to amylases, lipases, proteases, and/or bacteria. In certain aspects, the at least one food component controlling release in at least one of the mouth, throat, nasal cavity, and/or mucosa is further characterized as triggered by physical forces. In certain embodiments, one or more food component(s) is characterized by release upon application of physical pressure and/or shear forces. In certain aspects, the at least one food component controlling release in at least one of the mouth, throat, nasal cavity, and/or mucosa is further characterized as triggered by temperature. In certain embodiments, one or more food component(s) is characterized by release at a temperature of at least about 20 °C, about 25 °C, about 28 °C, about 30 °C, about 35 °C, about 37 °C, about 40 °C, about 45 °C, and/or about 50 °C. In certain aspects, the at least one food component controlling release in at least one of the mouth, throat, nasal cavity, and/or mucosa is further characterized as triggered by time. In certain embodiments, one or more food component(s) is characterized by release after an incubation period of at least about 0.5 seconds, about 1 second, about 3 seconds, about 5 seconds, about 8 seconds, about 10 seconds, about 12 minutes, about 18 minutes, about 24 minutes, and/or about 30 minutes.

In certain embodiments, the current disclosure provides for the incorporation of one or more tastant composition(s) into food and/or beverage products.

In some cases, one or more tastant composition(s) are incorporated into food and/or beverage products in the food and/or beverage manufacturing process. In some cases, one or more tastant composition(s) are incorporated into food and/or beverage products in the food and/or beverage packaging process. In some cases, one or more tastant composition(s) are incorporated prior to pasteurization of a food and/or beverage product. In some cases, one or more tastant composition(s) are incorporated prior to mixing of a food and/or beverage product. In some cases, one or more tastant composition(s) are incorporated into finished food and/or beverage products. In some cases, one or more tastant composition(s) are incorporated into food and/or beverage products immediately prior to consumption.

In certain embodiments, incorporation of tastant composition(s) (e.g., core-shell and/or matrix preparations) into food and/or beverage products utilizes size reduction techniques and/or homogenization. In some cases, size reduction techniques are applied to tastant composition(s) prior to incorporation. Alternatively or additionally, size reduction techniques are applied to food and/or beverage products during incorporation of the tastant composition(s). Alternatively or additionally, size reduction techniques are applied to food and/or beverage products after incorporation of the tastant composition(s). The present disclosure provides for size reduction using, for example, planetary milling, ball milling, burr milling, roller milling, media milling, impact milling, jet milling, high-pressure homogenization, cryo milling, hammer milling, conical milling, hand screening, or granulation/extrusion, extrusion, spray drying, lyophilization/milling, fluid bed agglomeration, spray congealing, high-shear granulation, tableting, pouring, roller compaction, crosslinking, prilling, spinning disc atomization, and/or combinations thereof.

In certain embodiments, homogenization is applied to tastant composition(s) following incorporation into food and/or beverage products. The present disclosure provides for homogenization using, for example, overhead stirrer, manual stirring, stir bar, high pressure homogenization, low pressure homogenization, sonication, ultrasonication, vortexing, or combinations thereof.

In certain embodiments, incorporation of tastant composition(s) into food and/or beverage products significantly affects the visual appearance, texture, and/or taste of the food and/or beverage products. In other embodiments, incorporation of tastant composition(s) into food and/or beverage products minimally affects the visual appearance, texture, and/or taste of the food and/or beverage products.

In some embodiments, disclosed tastant composition(s) minimally affect visual appearance, texture, and/or taste when incorporated, as provided herein, into a protein beverage (e.g., Ensure). In some instances, disclosed tastant composition(s) minimally affect visual appearance, texture, and/or taste when incorporated, as provided herein, into a MRE (i.e., meal ready-to-eat).

Some aspects of the current disclosure provide methods of providing an effective amount of tastant compositions described herein in combination with a consumable composition (e.g., a food product, a beverage product, an animal-consumable product, etc.) to an animal. In some cases, consumable compositions comprise core-shell preparations and/or matrix preparations.

In some embodiments, an animal is a human, for example, an adult, an elder, a teenager, an adolescent, or an infant. In some cases, an animal is an agricultural animal, for example, a horse, a cow, a pig, a sheep, a goat, a domesticated bird (e.g., chicken, duck, goose), a non-domesticated (e.g., wild) bird, etc. In some cases, an animal is a pet animal, for example, a dog, a cat, a rabbit, and/or a fish.

Some aspects of the current disclosure provide consumable compositions (e.g., food products, beverage products, animal-consumable compositions) comprising disclosed tastant compositions. In some cases, consumable compositions comprising tastant compositions is or comprises a food product. In some cases, a food product is characterized by high water activity. In some cases, a food product is or comprises at least one of agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, and/or yogurt. In some cases, consumable compositions comprising tastant compositions are provided to an animal in a mixture with a food or food ingredient.

Some aspects of the current disclosure provide consumable compositions (e.g., food products, beverages, animal-consumable compositions) comprising disclosed tastant compositions. In some cases, consumable compositions comprising tastant compositions is or comprises a beverage product. In some cases, a beverage product is characterized by high water activity. In some cases, a beverage product is or comprises at least one of liquid supplement formulation, beer, seltzer, kefir, coffee, juice, liquid pharmaceutical formulation, milk, soda, sports drink (e.g., Gatorade, sports drinks, Vitamin beverage), tea, water, liquor (e.g., vodka, whiskey, rum, etc.) and/or wine. In some cases, the formulation is provided to an animal in a mixture with a beverage or beverage ingredient.

Some aspects of the current disclosure provide powder-based supplement, food, and/or beverage-mix products comprising tastant compositions disclosed herein. In some cases, the powder-based supplement, food, and/or beverage-mix products are characterized by high water activity. In some cases, the powder-based supplement, food, and/or beverage-mix products is a pre-workout powder, post-workout powder or pill, pre-workout capsule/pill, baby formula, whey powder, milk powder, protein powder, drink powder mix (e.g., Kool-Aid type mix), or a powder-based supplement, food, or beverage-mix products.

7. Stability of Tastant Payload Component in Food and/or Beverage Products

Those skilled in the art will recognize that incorporation of one or more food component(s) into food and/or beverage products may be associated with significant reduction in its stability. As defined herein, the stability of one or more food component(s) may refer to a chemical stability, a physical stability, a stability of function, a stability of benefit, and/or combinations thereof. The present disclosure provides stability of one or more food component(s) via one or more tastant composition(s) upon standing, upon incorporation into one or more food and/or beverage products, and/or upon mixing with one or more dissolution solvent(s) at a predetermined temperature, a predetermined humidity, and/or a predetermined period of time (e.g., incubation period). In some instances, a tastant composition provides for stability of a food component in a liquid (e.g., water, simulated gastric fluid, simulated intestinal fluid), food and/or beverage product(s) (e.g., sachet, yogurt, milk powder, seltzer, alcoholic beverage, vitamin beverage, sprinkle packet, meals ready-to-eat, protein drink) or environment (e.g., elevated humidity, temperature).

In some embodiments, tastant composition(s) may be or are effective at protecting food component(s) against a physical change, a chemical change, a functional change, a change in benefit or combinations thereof. In some instances, a physical, chemical, functional change or change in benefit may be induced by one or more of heat, light, shear, water, acid, enzymes, bacteria, or combinations thereof.

In some embodiments, stability of one or more food component(s) in one or more tastant composition(s) refers to the percentage of change of a measured stability characteristic (e.g., stability properties) after a period of storage relative to the measured property immediately after formulation. In some embodiments, stability of one or more food component(s) is defined as <about 40%, <about 30%, <about 20%, <about 10%, <about 5%, <about 2%, and/or <about 1% change in one or more measured stability properties. In some cases, the chemical stability of one or more food component(s) may be determined by a chemical quantity (e.g., mol, g, lbs) of one or more food component(s) relative to initial formulation. In some cases, the physical stability of one or more food component(s) may be determined by a physical quantity (e.g., diameter, morphology, porosity) of one or more food component(s) relative to initial formulation. In some cases, the functional stability of one or more food component(s) may be determined by comparison of release profile, as described herein, of one or more food component(s) relative to initial formulation.

In some embodiments, stability of one or more food components(s) in a provided tastant composition (e.g., as described above), is assessed over a period of time at a particular environmental condition. In some embodiments, stability is assessed after 6 months at ambient temperature.

In some embodiments, a provided tastant composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 8 weeks and the environmental condition is or comprises ambient temperature. In some embodiments, the period of time is up to about 2 weeks and the environmental condition is or comprises presence of water (e.g., in aqueous solution). In some embodiments, the period of time is up to about 72 hours and the environmental condition is or comprises exposure to light at elevated temperatures (e.g., about 37 °C.).

In some embodiments, a provided tastant composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 36 months and the environmental condition is or comprises ambient temperature. In some embodiments, the period of time is up to about 12 months and the environmental condition is or comprises presence of food product (e.g., in a mixture with a food product). In some embodiments, the period of time is up to about 1 month and the environmental condition is or comprises exposure to a food product (e.g., in a mixture with yogurt).

In some instances, stability of one or more food component(s) (<about 20% change in one or more stability properties) is maintained after storage in a solid food (e.g., bread, rice, baked goods, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a dry powder (e.g., supplement powder, milk powder, baby formula, flour, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a liquid beverage (e.g., coffee, drinkable yogurt, protein beverage, water, soda, Gatorade, sports drinks, etc.) at ambient temperatures for time periods between 0-1 week, 0-1 month, 0-1 years, or 1-5 years of storage.

In some embodiments, disclosed tastant compositions are stable (<about 20% change in one or more stability properties) up to 2 weeks, up to 1 month, up to 6 months, up to 1 year, up to 2 years, up to 5 years, etc. in water at ambient temperature.

In some embodiments, disclosed tastant compositions are stable (<about 20% change in one or more stability properties) up to 2 weeks in yogurt at ambient temperature.

In some embodiments, disclosed tastant compositions are stable (<about 20% change in one or more stability properties) up to 2 weeks in milk powder at ambient temperature.

In some embodiments, disclosed tastant compositions are stable (<about 20% change in one or more stability properties) up to 2 weeks in baby formula at ambient temperature.

In some embodiments, disclosed tastant compositions are stable (<about 20% change in one or more stability properties) up to 2 weeks in milk powder at ambient temperature.

In some embodiments, disclosed tastant compositions are stable (<about 20% change in one or more stability properties) up to 2 weeks in high dry powders at ambient temperature.

In some embodiments, disclosed tastant compositions are stable (<about 20% change in one or more stability properties) up to 2 weeks in a sachet at ambient temperature.

In some embodiments, disclosed tastant compositions are stable (<about 20% change in one or more stability properties) up to 2 weeks when combined with animal feed (e.g., total meal ration, animal feed pellets, etc.) at ambient temperature.

In some embodiments, tastant compositions may be effective to protect food component(s) against humidity-induced degradation. In some instances, food component(s) dispersed in food product(s) is or are stable (<about 20% change in one or more stability properties) when exposed to ambient humidity (e.g., 30% relative humidity) at ambient temperatures (e.g., 25 °C) for up to 6 weeks.

In some embodiments, tastant compositions are incorporated into a food and/or beverage product in the presence of humidity (e.g., water, moisture content, water activity). In some instances, tastant compositions are effective to protect food component(s) against humidity-induced degradation. In some instances, food component(s) is or are stable (<about 20% change in one or more stability properties) when exposed to >15%, >20%, >25%, and/or >30% relative humidity, at >−20 °C and/or >4 °C and/or >25 °C and/or >30 °C and/or >35 °C and/or >37 °C and/or >50 °C, for >1, >2, >3, >4, >6, and/or >8 weeks.

In some instances, stability of the food component (<about 20% change in one or more stability properties) is maintained after storage in a freezer (−85C to 0 °C), a refrigerator (1-10 °C), or atmospheric temperature (−10 °C-40 °C) for time periods between 0-1 week, 0-1 month, 0-1 years, or 1-5 years of storage.

In some instances, protection against oxygen, heat, light, and water of a food component is maintained after storage in a freezer (−85 °C to 0 °C), a refrigerator (1-10 °C), or atmospheric temperature (−10 °C-40 °C) for time periods ranging from 0-1 week, 0-1 month, 0-1 year, and/or 1-5 years of storage.

In certain embodiments, the disclosed tastant compositions provide protection against degradation (e.g., oxidation, hydrolysis, isomerization, fragmentation, lysis, or a combination thereof) of food component(s). In some embodiments, the disclosed tastant compositions comprise core-shell and/or matrix preparations wherein food components are protected from environmental factors (e.g., water, humidity, moisture, water activity, light, heat, and/or acid).

It is contemplated that provided tastant compositions disclosed herein are suitable for use in varying consumable compositions (e.g., a food product, a beverage product, an animal-consumable product). It is further contemplated that provided tastant compositions disclosed herein are suitable for use in consumable compositions of high water activity. In some instances, disclosed tastant compositions provide for stability of food component(s) further characterized as core components, shell components, matrix components, solute components, or a combination thereof when used with consumable compositions (e.g., a food product, a beverage product, an animal-consumable product).

### D. Methods of Manufacturing Food Composition(s)

The present disclosure provides a method of manufacturing (e.g., formulating) one or more tastant composition(s) that comprises, on a dry weight basis, at least about 90%, at least about 95%, and/or at least about 99% of one or more food component(s), as described herein. Additionally, or alternatively, the disclosure provides a means of controlling the release of one or more food component(s) from one or more tastant composition(s). In certain embodiments, a means of controlling the release of one or more food component(s) is characterized as being a physical arrangement (e.g., formulation) of one or more food component(s) comprising one more tastant composition(s). In certain embodiments, the physical arrangement (e.g., formulation) of one or more food component(s) comprising one or more tastant composition(s) is further characterized as a core-shell preparation and/or a matrix preparation. In certain embodiments, one or more core-shell and/or matrix preparations are further characterized as particle preparations.

In some aspects, the disclosure provides a method of manufacture for tastant compositions (e.g., formulated tastants) for improving taste and/or health benefits. In certain embodiments, one or more matrix preparation(s) are formulated using one or more matrix component(s) and one or more solute component(s). In certain embodiments, one or more core-shell preparation(s) are formulated using one or more shell component(s) and one or more core component(s). In certain embodiments, one or more solute component(s) are characterized as a core-shell preparation. In certain embodiments, one or more core component(s) are characterized as a matrix preparation. Among other things, the present disclosure provides a method of formulating one or more matrix, solute, core, and/or shell component(s). Among other things, the present disclosure provides a method of formulating one or more core-shell preparations and/or matrix preparations.

In certain embodiments, tastant compositions (e.g., formulated tastants) are characterized by average particle diameter. In some cases, tastant compositions (e.g., formulated tastants) are characterized as having an average particle diameter of <10000 μm, <5000 μm, <1000 μm, <500 μm, <250 μm, <125 μm, <50 μm, <20 μm, and/or <5 μm. In certain preferred embodiments, one or more tastant composition(s) are characterized as having an average particle diameter between about 10 μm-200 μm.

In certain preferred embodiments, one or more tastant composition(s) are characterized as having an average particle diameter between about 50 μm-800 μm. In certain preferred embodiments, one or more tastant composition(s) are characterized as having an average particle diameter in a range from about 90 μm-400 μm.

### (i) Methods of Size Reduction

In some cases, one or more core, shell, matrix, solute, core-shell, and/or matrix preparation component(s), as described herein, are reduced to a size (e.g., size reduction) amenable to homogeneous formulation. In some cases, one or more core, shell, matrix, solute, core-shell, and/or matrix preparation component(s) is reduced to a size (e.g., size reduction) amenable to mitigate any sensory aspects (e.g., texture, grit, taste, etc.). In some cases, one or more core, shell, matrix, solute, core-shell, and/or matrix preparation component(s) undergoing one or more size reduction processes are characterized as a particle preparation, as described herein. In some cases, one or more core, shell, matrix, solute, core-shell, and/or matrix preparation component(s) characterized as particle preparation(s) are further characterized by particle diameter, morphology, and/or porosity.

For example, in some embodiments, methods of size reduction of tastant compositions (e.g., formulated tastants) include, but are not limited to, planetary milling, ball milling, burr milling, roller milling, media milling, impact milling, jet milling, high-pressure homogenization, cryo milling, hammer milling, conical milling, hand screening, or granulation/extrusion, extrusion, spray drying, fluid bed agglomeration, spray congealing, high-shear granulation, tableting, pouring, roller compaction, crosslinking, prilling, spinning disc atomization, and/or combinations thereof.

### (ii) Methods of Mixing

In some cases, one or more core, shell, matrix, solute, core-shell, and/or matrix preparation component(s), as described herein, are mixed within a homogeneous formulation. In some cases, mixing is between solid food component(s) in liquid food component(s), solid food component(s) in solid food component(s), liquid food component(s) in liquid food component(s), and/or liquid food component(s) in solid food component(s). In some cases, mixing of one or more core, shell, matrix, solute, core-shell, and/or matrix component(s) enables uniformity of sensory aspects (e.g., texture, grit, taste, etc.). In some cases, mixing of one or more core, shell, matrix, solute, core-shell, and/or matrix component(s) enables a uniform distribution in a formulation. In some cases, mixed core, shell, matrix, solute, core-shell, and/or matrix preparation component(s) are characterized by concentration as a function of sampling location.

For example, in some embodiments, methods of mixing of tastant compositions (e.g., formulated tastants) include, but are not limited to, stir-bar, overhead stirring, ultrasonic mixing, high-shear mixing, and/or combinations thereof.

(iii) Methods of Preparing Matrix Component(s) and/or Matrix Preparation(s)

In some cases, methods of preparation of one or more matrix component(s) and/or matrix preparation(s) are provided. In certain embodiments, one or more matrix component(s) and/or matrix preparation(s) is characterized as a solid, a gel, a particle, a liquid, or combinations thereof. In certain embodiments, one or more matrix component(s) and/or matrix preparation(s) is characterized as having partial, high, and/or complete solubility in water (e.g., hydrophilic). In certain embodiments, one or more matrix component(s) and/or matrix preparation(s) are characterized as having no, low, and/or moderate solubility in water (e.g., hydrophobic). In certain embodiments, one or more matrix component(s) and/or matrix preparation(s) are characterized as being amphiphilic. In certain embodiments, the preparation of one or more matrix component(s) and/or matrix preparation(s) is characterized as solidification, crystallization, self-assembly, gelation, and/or hydration.

In certain embodiments, the preparation of one or more matrix component(s) and/or matrix preparation(s), characterized as solidification, crystallization, self-assembly, gelation, and/or hydration, is achieved through heating, in a range of about 20 °C to about 200 °C, mixing of one or more tastant composition(s), and subsequent cooling in a range of about −40 °C to about 20 °C. In certain embodiments, the preparation of one or more matrix component(s) and/or matrix preparation(s), characterized as solidification, crystallization, self-assembly, gelation, and/or hydration, is achieved through the action of a trigger (e.g., exposure to water, pH, light, physical forces, chemical reaction, enzymatic reaction) as provided herein.

In certain embodiments, the preparation of one or more matrix component(s) and/or matrix preparation(s) further includes size reduction, as provided herein.

(iv) Methods of Preparing Shell Component(s) and/or Core-Shell Preparation(s)

In some cases, methods of preparation of one or more shell component(s) and/or core-shell preparation(s) are provided. In certain embodiments, one or more shell component(s) and/or core-shell preparation(s) is characterized as a solid, a gel, a particle, a liquid, or combinations thereof. In certain embodiments, one or more shell component(s) and/or core-shell preparation(s) is characterized as having partial, high, and/or complete solubility in water (e.g., hydrophilic). In certain embodiments, one or more shell component(s) and/or core-shell preparation(s) are characterized as having no, low, and/or moderate solubility in water (e.g., hydrophobic). In certain embodiments, one or more shell component(s) and/or core-shell preparation(s) are characterized as being amphiphilic. In certain embodiments, the preparation of one or more shell component(s) and/or core-shell preparation(s) is further characterized as a coating process and/or layering process.

As provided herein, methods of coating and/or layering may be or comprise a single method of coating and/or layering. In some instances, methods of coating and/or layering may be or comprise at least 1, 2, or 3 successive methods of coating and/or layering. In some instances, methods of coating and/or layering may be or comprise several successive methods of coating and/or layering.

For example, in some embodiments, methods of coating comprise, but are not limited to, spray pan coating, fluidized bed coating, dip coating, roller coating, sputter coating, self-assembly, or combinations thereof.

For example, in some embodiments, methods of layering comprise, but are not limited to, dip coating, roller coating, layered deposition, vapor deposition, physical arrangement, or combinations thereof.

In certain embodiments, one or more shell component(s) and/or core-shell preparation(s) are prepared by homogenous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by homogenous coating and/or layering of one or more core component(s), solute component(s), and/or matrix preparation(s) with an organic solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an organic solution of one or more shell component(s) and/or core-shell preparation(s).

In some embodiments, a method of coating a tastant compositions (e.g., formulated tastants) uses or may utilize materials that improve (e.g., protect, or improve the functionality of) the tastant compositions (e.g., formulated tastants). In some cases, a method of coating a tastant compositions (e.g., formulated tastants) improves resistance to moisture (e.g., humidity, water, water activity). In some cases, a method of coating a tastant compositions (e.g., formulated tastants) improves resistance to acidity (e.g., pH responsive materials). In some cases, a method of coating a tastant composition reduces porosity. In some cases, a method of coating a tastant compositions (e.g., formulated tastants) reduces agglomeration, aggregation, and/or tackiness. In some cases, a method of coating a tastant composition increases gastrointestinal residence time (e.g., mucoadhesive components). In some cases, a method of coating a tastant composition improves taste and/or fragrance.

In certain embodiments, the preparation of one or more shell component(s) and/or core-shell preparation(s) further includes size reduction, as provided herein.

### (v) Methods of Drying Tastant Composition(s)

In certain embodiments, a method of drying tastant compositions (e.g., formulated tastants) is provided. In some cases, drying of a tastant compositions (e.g., formulated tastants) comprises reduction of moisture content. In some cases, drying of a tastant compositions (e.g., formulated tastants) comprises reduction of water activity.

The disclosed method of drying certain tastant compositions (e.g., formulated tastants), as provided herein, improves upon the prior art by further eliminating exposure of food components (e.g., micronutrients, macronutrients, etc.) to moisture and/or presence of water.

In certain embodiments, drying of certain tastant compositions (e.g., formulated tastants) is achieved by the use of chemical drying agents, elevated temperature, vacuum, or combinations thereof.

For example, in some embodiments, drying of tastant compositions (e.g., formulated tastants) is achieved by use of drierite, heating, vacuum, molecular sieves, sodium sulfate, magnesium sulfate, calcium carbonate, calcium chloride, or combinations thereof.

### (vi) Method of Quantifying Amount of Food Component(s) in One or More Tastant Composition(s)

In certain aspects, the present disclosure provides methods for the quantification of food component(s) present in one or more disclosed tastant composition(s) (e.g., loading). In certain embodiments, quantifying loading is beneficial to understanding the efficiency of the manufacturing process. In certain embodiments, quantifying loading is beneficial to understanding the relative composition of tastants in one or more tastant composition(s). In certain embodiments, quantifying loading is beneficial to understanding the nutritional content of one or more tastant composition(s).

In certain embodiments, loading of one or more tastant composition(s) is quantification of amount of one food component. In certain embodiments, loading of one or more tastant composition(s) is quantification of amount of several distinct food components. In certain embodiments, quantification of one or more food component(s) within one or more tastant composition(s) is quantification of the concentration (e.g., amount) of one or more food component(s) following complete release (e.g., 100%) from one or more tastant composition(s).

In certain embodiments, loading of one or more tastant composition(s) is quantified by subjecting one or more tastant composition(s) to one or more dissolution solvent(s) and/or trigger(s) to effect complete release.

In certain embodiments, quantification of one or more food component(s) is achieved using at least one of nuclear magnetic resonance, mass spectrometry, liquid chromatography, intrinsic colorimetry, intrinsic fluorimetry, enzymatic colorimetry, enzymatic fluorimetry, enzymatic amperometry, and/or antibody-mediated recognition (e.g., ELISA, Western blot).

### E. Means of Controlling Physiological Response

In certain embodiments, one or more delivery functions of tastant composition(s) (e.g. extending retention time, controlling release rate, controlling adsorption/absorption rates, controlling spatial interaction and concentrations, and facilitating passage through selective barriers and components) is characterized as enabling controlled physiological response (e.g. physiological modulation) and providing a health benefit. In certain embodiments, a health benefit provided by one or more delivery functions of tastant composition(s) is increased and/or extended satisfaction and/or satiety. In certain embodiments, a health benefit provided by one or more delivery functions of tastant composition(s) is a reduced salt and/or sugar and/or fat in food and/or beverages. Without being bound by any theory, tastant composition(s) confer a health benefit(s) through a delivery function(s) that extends and/or enhances taste, thereby reducing the required dosage of salt and/or sugar and/or fat in a food and/or beverage to produce the same level of taste and/or reducing the need to replace a loss and/or reduction in taste with additional ingestion of food and/or beverage.

Alternatively or additionally, in certain embodiments, one or more food component(s), excipient component(s), and/or tastant composition(s) themselves are characterized as controlling physiological response (e.g., physiological modulator).

As provided herein, one or more physiological modulator(s) are characterized by the modulation of an endogenous physiological satiety response. In certain embodiments, one or more physiological modulator(s) elicits an endogenous physiological satiety response to provide satisfaction and/or satiety. In certain embodiments, an endogenous physiological satiety response may be characterized by factors including, but not limited to: reduced desire to eat, reduced serum ghrelin, increased serum leptin, and/or cephalic-phase response. In certain embodiments, physiological modulation of satiety is achieved through chemical means.

In certain embodiments, chemical means of modulating a physiological response to satiety include selection of food component(s) and/or selection of food component release profile(s). In certain embodiments, one or more tastant composition(s) characterized as a core-shell preparation and/or a matrix preparation provides a chemical means of modulating a physiological response to satiety.

For example, in certain embodiments, one or more food component(s) characterized as a chemical modulator of physiological response include micronutrients, macronutrients, or combinations thereof. For example, in certain embodiments, a micronutrient is tannic acid, ellagitannin, apigenin, luteolin, tangeritin, isorhamnetin, kaempferol, myricetin, quercetin, genipin, rutin, eriodictyol, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine. For example, in certain embodiments, a macronutrient is aspartame, GLP-1, GLP-2, collagen, sermorelin, tesamorelin, lenomorelin, anamorelin, ipamorelin, macimorelin, ghrelin, leptin, tabimorelin, alexamorelin, GHRP-1, GHRP-2, GHRP-3, GHRP-4, GHRP-5, GHRP-6, hexarelin, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or sodium carboxymethylcellulose.

In certain embodiments, a release profile of one or more micronutrient(s) and/or macronutrient(s) is a chemical means of modulating a physiological response. For example, in certain embodiments, the release profile(s) of one or more macronutrients (e.g., carbohydrates, proteins, fats) is controlled in order to maximize satiety. For example, without wishing to be bound by any particular theory, in certain embodiments, the release profile(s) of one or more carbohydrates (e.g., glucose, sucrose) are characterized as slow, constant release to provide a continuous energy source. For example, without wishing to be bound by any particular theory, in certain embodiments, the release profile(s) of one or more proteins (e.g., whey protein, soy protein) are characterized as bolus dose in 8 hour intervals to sufficiently stimulate growth hormone secretion.

In certain embodiments, one or more physical and/or chemical means of modulating a physiological response for at least about 8 hours, about 10 hours, about 12 hours, about 16 hours, about 20 hours, and/or about 24 hours.

In certain embodiments, one or more physical and/or chemical means of modulating a physiological response to satiety comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

### F. Facilitating Payload Passage

In certain embodiments, enhancing taste of a payload comprises an effective dose of one or more taste facilitator(s). As provided herein, one or more taste facilitator(s) are characterized by the facilitation of a payload through selective barriers and components. In certain embodiments, one or more taste facilitator(s) is characterized by an ability to penetrate into the taste bud from the mucosal, serosal or vascular environments. In certain embodiments, one or more taste facilitator(s) is characterized by reducing the activity and/or effectiveness of enzymatic components of a selective barrier. In certain embodiments, one or more taste facilitator(s) is characterized by reducing the activity and/or effectiveness of physical components of a selective barrier. In certain embodiments, one or more taste facilitator(s) is characterized by reducing the activity and/or effectiveness of molecular components of a selective barrier. Without wishing to be bound by any particular theory, it is contemplated that one or more taste facilitator(s) bypasses or reduces the effectiveness of selective barriers to taste cells, thereby increasing access and/or binding of tastants to taste cells, enhancing taste. In certain embodiments, means of facilitating payload passage (e.g., taste facilitators) are comprised of one or more food component(s), excipient component(s), and/or tastant composition(s), as provided herein.

In certain embodiments, an effective dose of one or more taste facilitator(s) comprising one or more food component(s), excipient component(s), and/or tastant composition(s) is characterized by an ability to inhibit, neutralize or otherwise reduce the effectiveness of one or more components of selective barriers to taste cells. For example, in certain embodiments, an effective dose of one or more taste facilitator(s) results in the degradation of at least about 10%, about 20%, about 30%, about 40%, about 50%, about 60%, about 75%, about 90%, and/or about 100% of proteoglycan. For example, in certain embodiments, an effective dose of one or more taste facilitator(s) reduces the activity of extracellular ATPase (e.g. ectonucleotidase NTPDase2) by at least about 10%, about 20%, about 30%, about 40%, about 50%, about 60%, about 75%, about 90%, and/or about 100%.

For example, a taste facilitator may be comprised of at least one of clostridium-perfringens, verapamil, EGTA, EDTA, sodium caprate, salcaprozate sodium, collagenase, dispase, elastase, heparitinase, chondroitinase, hyaluronidase, and/or lysozyme.

In certain embodiments, one or more food component(s), excipient component(s), and/or tastant composition(s) are characterized as facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.).

One skilled in the art will appreciate that one or more taste facilitator(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more taste facilitator(s) comprise, on a dry weight basis, at least about 0%, about 1%, about 5%, about 10%, about 15%, about 20%, about 25%, about 50%, about 75%, about 90%, about 95%, about 99%, and/or about 100% of one or more tastant compositions.

### G. Controlling Taste Receptor Binding

In certain embodiments, enhancing taste of a payload comprises an effective dose of one or more taste modulator(s). As provided herein, one or more taste modulator(s) are characterized by controlling the binding and/or response of a tastant to a taste receptor. In certain embodiments, one or more taste modulators(s) is characterized by potentiating the perceived taste of tastant(s). In certain embodiments, one or more taste modulator(s) is characterized by binding to G protein coupled receptors of taste cells. In certain embodiments, one or more taste modulator(s) is characterized by allosteric or orthosteric modulation of taste receptors. In certain embodiments, means of modulate the binding and/or response of a tastant to a taste receptor (e.g., taste modulators) are comprised of one or more food component(s), excipient component(s), and/or tastant composition(s), as provided herein.

In certain embodiments, an effective dose of one or more taste modulator(s) comprising one or more food component(s), excipient component(s), and/or tastant composition(s) is characterized by an ability to modulate the binding and/or response of a tastant to a taste receptor. For example, in certain embodiments, an effective dose of one or more taste modulator(s) results in an increased stabilization of a specific conformation of a taste receptor by at least about 10%, about 20%, about 30%, about 40%, about 50%, about 60%, about 75%, about 90%, and/or about 100%.

In certain embodiments, one or more food component(s), excipient component(s), and/or tastant composition(s) are characterized by controlling the binding and/or response of a tastant to a taste receptor.

For example, a taste modulator may be characterized as being a metal and may comprise calcium, chromium, cobalt, copper, iodine, iron, magnesium, manganese, molybdenum, potassium, selenium, sodium, and/or zinc, and/or may be comprised of at least one of an anthocyanin and/or poryphyrin.

Having read the present disclosure, one skilled in the art will appreciate that one or more taste facilitator(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more taste modulators comprise, on a dry weight basis, at least about 0%, about 1%, about 5%, about 10%, about 15%, about 20%, about 25%, about 50%, about 75%, about 90%, about 95%, about 99%, and/or about 100% of one or more tastant compositions.

### H. Absorption Enhancers

In certain embodiments, a means of providing a nutritional benefit comprises an effective dose of one or more absorption enhancer(s). In certain embodiments, one or more absorption enhancer(s) is characterized by increasing the oral absorption of one or more food component(s). Without wishing to be bound by any particular theory, it is contemplated that a means of increasing tastant delivery increases the intensity of taste. In certain embodiments, means of increasing the absorption of one or more food component(s) (e.g., absorption enhancers) are comprised of one or more food component(s), excipient component(s), and/or tastant composition(s), as provided herein.

In certain embodiments, an effective dose of one or more absorption enhancer(s) comprising one or more food component(s), excipient component(s), and/or tastant composition(s) is characterized by an increase in the oral bioavailability of one or more food component(s). For example, in certain embodiments, an effective dose of one or more absorption enhancer(s) increases the bioavailability of one or more food component(s) by at least about 10%, about 20%, about 30%, about 40%, about 50%, about 60%, about 75%, about 90%, and/or about 100%. For example, in certain embodiments, an effective dose of one or more absorption enhancer(s) increases the bioavailability of one or more food component(s) by at least about 1-fold, 2-fold, 3-fold, 5-fold, 10-fold, 20-fold, and/or 50-fold.

In certain embodiments, one or more absorption enhancers is comprised of at least one or more food component(s), excipient component(s), and/or tastant composition(s). In certain embodiments, one or more absorption enhancers is characterized by one or more release profile(s), as described herein. Without wishing to be bound by any particular theory, it is contemplated that the release profile of one or more absorption enhancer(s) is critical to its function. In certain embodiments, controlled release, as provided herein, is applied to one or more food component(s), excipient component(s), and/or tastant composition(s) comprising an absorption enhancer.

For example, an absorption enhancer may be comprised of at least one of sodium caprylate, sodium caprate, sodium laurate, sodium oleate, sodium linoleate, propyl gallate, propyl syringate, propyl shikimate, octyl gallate, octyl syringate, octyl shikimate, ammoniated glycyrrhizin, quillaia extract, tocopherol PEG succinate, lauroyl polyoxylglycerides, polysorbate 80, ethanol, propylene glycol, poly(ethylene glycol), diethylene glycol monoethyl ether, sodium citrate, medium chain triglycerides, lipase, sodium lauryl sulfate, and/or ascorbyl palmitate.

Having read the present disclosure, one skilled in the art will appreciate that one or more absorption enhancer(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more absorption enhancers comprise, on a dry weight basis, at least about 0%, about 1%, about 5%, about 10%, about 15%, about 20%, about 25%, about 50%, about 75%, about 90%, about 95%, about 99%, and/or about 100% of one or more means of reducing daily meal frequency.

### I. Characterizing Compositions and/or Components Thereof

In some embodiments, provided composition(s), and/or component(s) thereof, are subjected to one or more assessments, for example to characterize one or more structural features and/or functional properties thereof (e.g., for quality control and/or after storage under particular conditions and for a particular period of time). In some embodiments, batches that do not meet designated criteria may be discarded or not further utilized.

### EXEMPLIFICATION

The following examples are intended to illustrate but not limit the disclosed embodiments. The following examples are useful to confirm aspects of the disclosure described above and to exemplify certain embodiments of the disclosure.

These non-limiting examples demonstrate particular features and advantages of provided technologies—e.g., of provided tastant composition(s).

In some embodiments, the present disclosure provides technologies (e.g., tastant compositions, such as formulated tastants) that provide one or more advantages for tastants (e.g sugars, salts, carbohydrates, fats, proteins, vitamins, minerals, etc.) such as extending retention time in the oral cavity, controlling release rate, controlling adsorption and/or absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

### J. Example 1: Encapsulation of Tastant

In certain embodiments, one or more food component(s) characterized by sweet taste are encapsulated in one or more core-shell preparations and/or matrix preparations. In one exemplary embodiment, one or tastants is encapsulated in a core-shell preparation further characterized as a particle preparation.

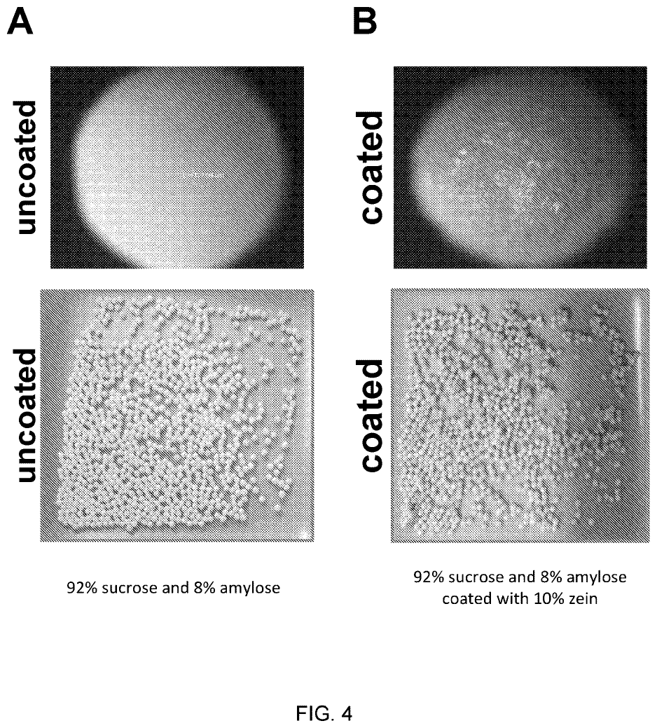

For example, in one non-limiting instance, a tastant composition comprised of a carbohydrate (e.g., a solute component) is embedded within a carbohydrate (e.g., a matrix component), further characterized as encapsulation of a carbohydrate. For example, in one non-limiting instance, a tastant composition comprised of an encapsulated carbohydrate (e.g., a matrix preparation) is encapsulated by a protein (e.g., a core-shell preparation). In one non-limiting instance, a core-shell preparation is further characterized as a particle preparation. For example, in FIG. 4A, sucrose is dispersed within a wet amylose matrix, the slurry sprayed into cool air to generate particles of controlled diameter. The encapsulation of sucrose within amylose is calculated to be 92%, on a dry weight basis. For example, in FIG. 4B, particles comprising encapsulated sucrose (92% loading, 2 mm diameter) are further coated (e.g., spray pan coating) with a 10% ethanolic solution of Zein with a colorant (e.g., excipient component). Brightfield micrographs reveal increased surface roughness and a red coloring, indicative of successful coating.

### K. Example 2: Exemplary Coating Formulation Protocols

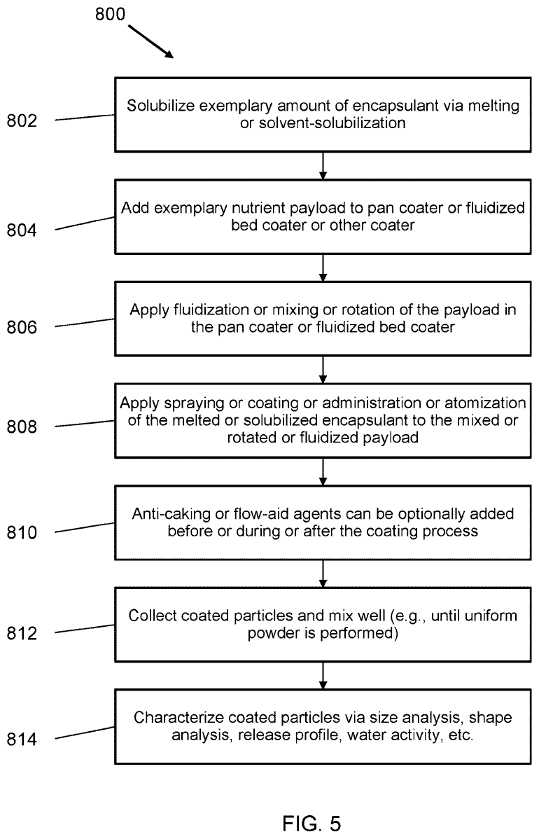

This example describes two non-limiting processes of arranging one or more food component(s) as a shell component to one or more food component(s) characterized as a core component via spray pan coating and/or fluidized bed spray coating. A schematic of an exemplary coating procedure, method, or protocol 800 is presented in FIG. 5. At step 802, the method 800 may include solubilizing an exemplary amount of encapsulant via melting or solvent-solubilization. At step 804, the method 800 may include adding an exemplary nutrient payload to pan coater or fluidized bed coater or other coater. At step 806, the method 800 may include applying fluidization or mixing or rotation of the payload in the pan coater or fluidized bed coater. At step 808, the method 800 may include applying spraying or coating or administration or atomization of the melted or solubilized encapsulant to the mixed, rotated and/or fluidized payload. At step 810, the method 800 may include adding anti-caking or flow-aid agents before, during and/or after the coating process. At step 812, the method 800 may include collecting the coated particles and thoroughly mixing (e.g., until uniform powder is achieved). At step 814, the method 800 may include characterizing the coated particles via size analysis, shape analysis, release profile, water activity, etc.

In one non-limiting example, tastant composition(s) are prepared in core-shell preparations using the procedure described below. Particle preparations comprising sucrose encapsulated in amylose (10 g) are coated using a spray pan coater with an inlet air temperature of 80 °C, pan temperature of 70 °C, rotation speed of 2 Hz, and spray rate of 0.5 mL/s. A 10% (w/v) ethanolic (90% ethanol) solution of Zein with 1% (v/v) Propylene Glycol and 0.5% (w/v) Talc powder is applied as a thin film over 5 minutes to the encapsulated sucrose. The volume-normalized weight gain due to coating is 120%]. The concentration of formulated tastant in this embodiment, on a dry weight basis, is 100% (w/w).

### L. Example 4: Exemplary Matrix Formulation Protocol

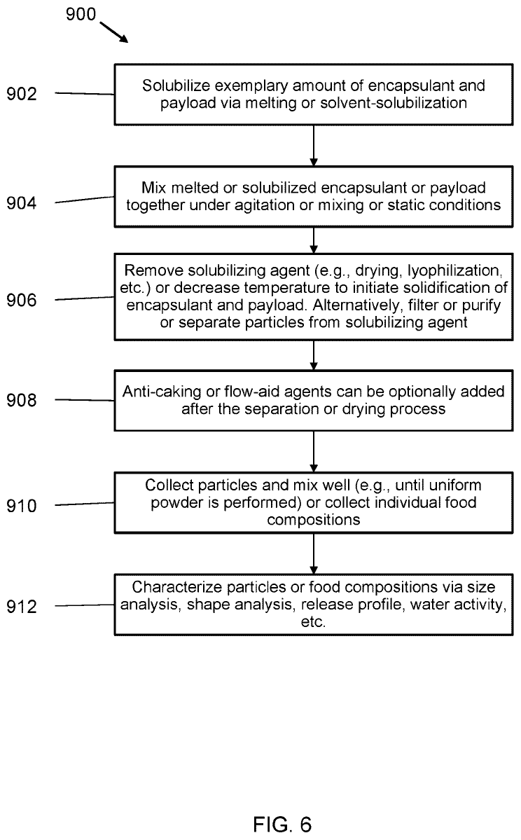

This example describes non-limiting processes of arranging one or more food component(s) as a matrix component to one or more food component(s) characterized as a solute component via melt-gelation. A schematic of an exemplary matrix formulation procedure, method, or protocol 900 is presented in FIG. 6. At step 902, the method 900 may include solubilizing an exemplary amount of encapsulant and payload via melting or solvent-solubilization. At step 904, the method 900 may include mixing melted or solubilized encapsulant or payload together under agitation or mixing or static conditions. At step 906, the method 900 may include removing the solubilizing agent (e.g., drying, lyophilization, etc.) or decreasing the temperature to initiate solidification of the encapsulant and payload. Alternatively, (or in addition), step 906 may include filtering, purifying and/or separating particles from the solubilizing agent. At step 908, the method 900 may include adding anti-caking or flow-aid agents after the separation and/or drying process(es). At step 910, the method 900 may include collecting particles and mixing (e.g., until uniform powder is achieved) and/or collecting individual food compositions. At step 912, the method 900 may include characterizing particles or food compositions via size analysis, shape analysis, release profile, water activity, etc.

In one non-limiting example, tastant composition(s) are prepared in matrix preparation using the procedure described below. Gelatin (10 g) is suspended in 100 mL of stirring deionized water and the suspension is heated to 65 °C. Following complete solubilization of the gelatin at elevated temperature, 2 g of sucrose powder are added and allowed to dissolve for 5 minutes. The resulting clear solution is poured into a polypropylene mold and allowed to cool for 1 hour at 20 °C. The density of the cooled gel is measured to be 0.87 g/cm³. The concentration of formulated tastant in this non-limiting embodiment, on a dry weight basis, is 100% (w/w).

### M. Example 5: Exemplary Dissolution Protocol

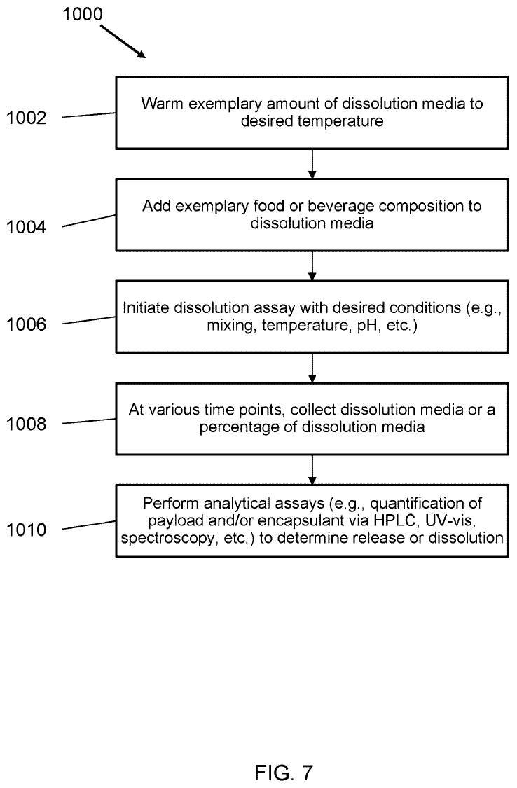

This example describes one non-limiting process of assessing the release (e.g., controlled release) of one or more food component(s) from one or more dissolution solvent(s). A schematic of an exemplary dissolution procedure, method, or protocol 1000 is presented in FIG. 7. At step 1002, the method 1000 may include warming an exemplary amount of dissolution media to a desired temperature. At step 1004, the method 1000 may include adding an exemplary food or beverage composition to the dissolution media. At step 1006, the method 1000 may include initiating dissolution assay with one or more desired conditions (e.g., via mixing, temperature, pH, etc.). At step 1008, the method 1000 may include collecting dissolution media and/or a percentage of dissolution media at various time points. At step 1010, the method 1000 may include performing analytical assays (e.g., quantification of payload and/or encapsulant via HPLC, UV-vis, spectroscopy, etc.) to determine release or dissolution characteristics.

In one non-limiting example, a tastant composition characterized as a core-shell preparation (e.g., Zein-coated amylose encapsulating sucrose) is assessed for controlled release in an aqueous dissolution solvent (e.g., 10 mM phosphate buffered saline, pH 7.4). 12 mL of 10 mM phosphate buffered saline are added to a polypropylene 15 mL centrifuge tube and allowed to equilibrate for 30 min while rotating at 10 rpm on a laboratory rotator. Exemplary core-shell preparations comprising Zein, sucrose, and amylose (500 mg) are added to the rotating tube. 100 μL aliquots are sampled at time points of 1 minute, 2 minutes, 5 minutes, 10 minutes, 15 minutes, 20 minutes, 30 minutes, 40 minutes, 50 minutes, and 60 minutes following addition of core-shell preparations and stored in 1.5 mL centrifuge tubes. The concentration of sucrose in collected aliquots is assayed using an enzymatic electrochemical method. Sucrose concentration, mass, and percent release is plotted with respect to incubation period to construct a release profile.

### N. Example 6: Exemplary Controlled Release Profiles

As provided herein, one or more tastant composition(s) is characterized by controlled release of one or more food component(s). Selection of release profile, as described herein, is intended to confer a benefit (as described herein) one or more animal(s). The following example depicts anticipated (e.g., theoretical) non-limiting release profiles exhibited by one or more tastant composition(s).

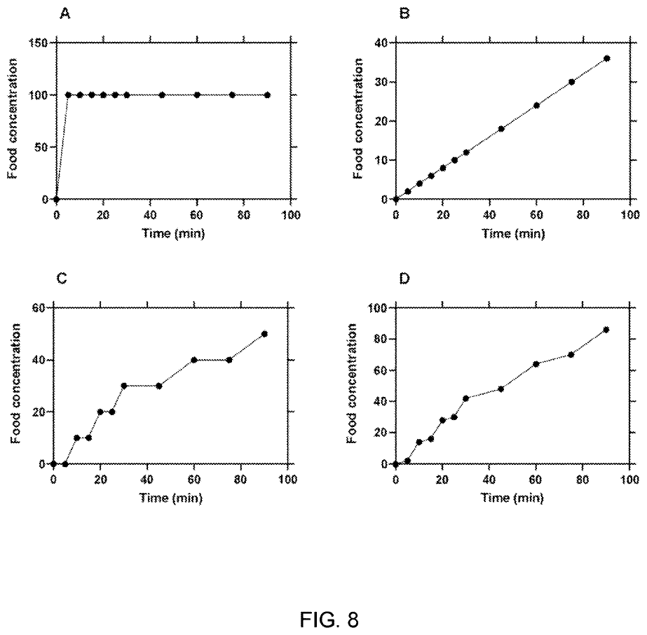

In one non-limiting example, the release of one or more food component(s) is characterized as a single bolus release, as measured by concentration present in one or more dissolution solvent(s) over time, as shown in FIG. 8A. In one non-limiting example, the release of one or more food component(s) is characterized as release with constant rate, as measured by concentration present in one or more dissolution solvent(s) over time, as shown in FIG. 8B. In one non-limiting example, the release of one or more food component(s) is characterized as multiple bolus dose (e.g., pulsatile) release, as measured by concentration present in one or more dissolution solvent(s) over time, as shown in FIG. 8C. In one non-limiting example, the release of one or more food component(s) is characterized as a combination of multiple bolus dose and constant release rate, as measured by concentration present in one or more dissolution solvent(s) over time, as shown in FIG. 8D.

### O. Example 7: Exemplary Controlled Release Profile from a Tastant Composition

Controlled release of one or more food component(s) from a formulated taste composition is demonstrated using the procedure described below.

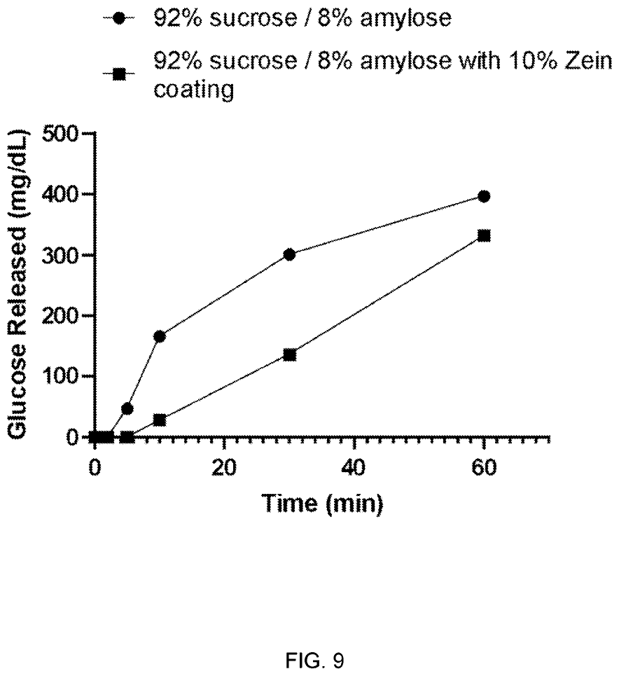

In one non-limiting example, sucrose-containing tastant composition(s) (500 mg) coated with Zein (see Example 2) were added to a 15 ml conical centrifuge tube filled (12 mL) with 10 mM phosphate buffered saline solution. The centrifuge tube was allowed to rotate at 10 rpm at 20 °C and 100 μL samples were collected every 15 minutes. Release of sucrose was quantified by a dual enzymatic electrochemical assay, first converting sucrose to glucose using Invertase from Yeast, followed by application to a glucometer. As shown in FIG. 9, the Zein coated sucrose particle preparations exhibited slower (<50 mg/dL) release of sucrose over 15 minutes relative to uncoated sucrose particle preparations (>150 mg/dL) over 15 minutes.

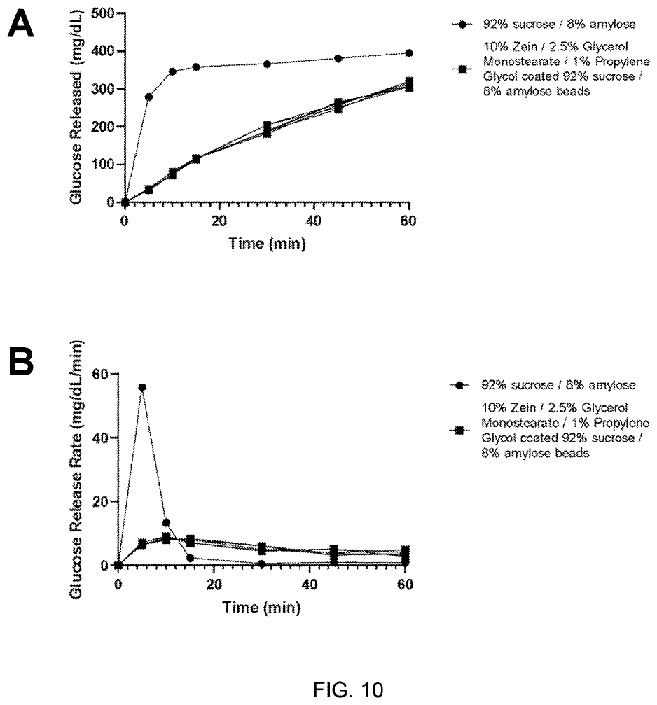

In another non-limiting example, sucrose-containing tastant composition(s) (500 mg) coated with, on a dry weight basis, 77% Zein (e.g., protein component), 21% Glycerol Monostearate (e.g., fat component), and 2% propylene glycol (e.g., excipient component) were added to a 15 mL conical centrifuge tube filled (12 mL) with 10 mM phosphate buffered saline solution. The centrifuge tube was allowed to rotate at 10 rpm at 20 °C and 100 μL samples were collected every 15 minutes. Release of sucrose was quantified by a dual enzymatic electrochemical assay, first converting sucrose to glucose using Invertase from Yeast, followed by application to a glucometer. As shown in FIG. 10A, the coated sucrose particle preparations exhibited slower (<50%) release of sucrose over 30 minutes relative to uncoated sucrose particle preparations (>90% in 10 minutes). Additionally, examination of release rate, shown in FIG. 10B, indicates that uncoated particle preparations exhibit bolus release while coated particle preparations exhibit constant sucrose release.

### P. Example 8: Incorporation of Tastant Composition(s) into Food and/or Beverage Products

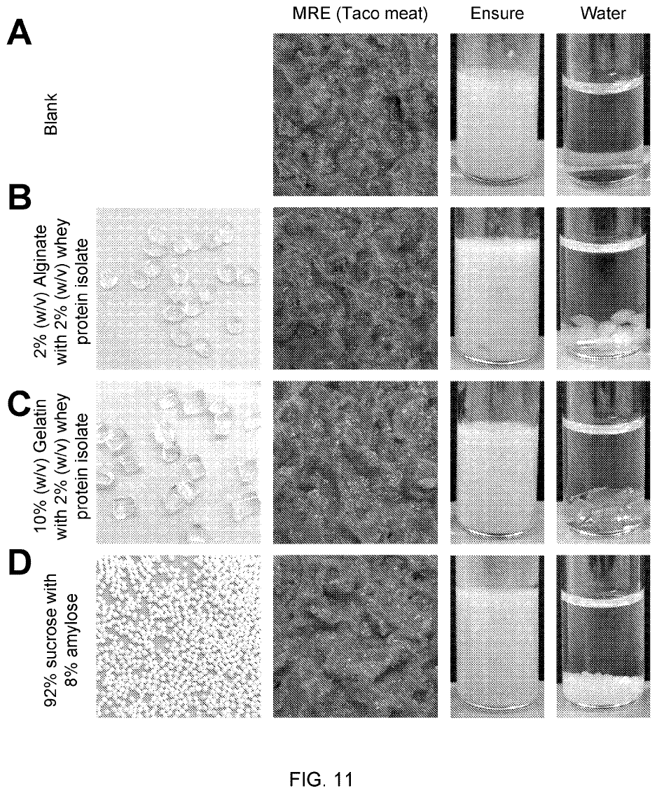

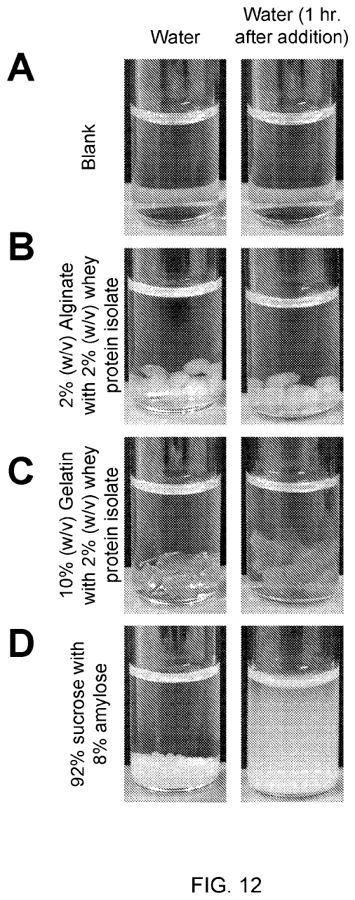

This example illustrates homogeneous mixtures of disclosed tastant composition(s) within food and/or beverage products (e.g., MRE, nutritional beverage, water) as demonstrated in FIGS. 11A-D. It is contemplated that non-limiting exemplary embodiments of tastant compositions can be homogeneously mixed with other food products such as freeze dried powder, protein powder, solid bars, domestic pet food (pellets), liquid shakes, pudding, etc. Homogenization can be achieved without additional processing aid or improved through addition of processing aid/excipients, through the use of mixing apparatuses such as a homogenizer, stand mixer, paddle blender, stir bar, spatula, etc. Without wishing to be bound by any particular theory, the present disclosure proposes that size characteristics and/or compositions of certain provided tastant composition(s) may surprisingly contribute desirable and/or useful attribute(s) to such particles, specifically including, for example, amenability to homogenous combination with other component(s). As shown in FIGS. 11B-D, incorporation of alginate beads, gelatin beads, each encapsulating sucrose, and/or sucrose-encapsulating beads into MRE and Ensure is homogeneous and associated with minimal change in visual appearance. In certain embodiments, incorporation of food composition(s) within one or more food and/or beverage products is associated with structural changes. In one non-limiting example (FIGS. 12A-D), food composition(s) are shown to change morphology over a 1-hour incubation period, with gelatin and alginate beads exhibiting expansion and sucrose-encapsulating beads exhibiting dissolution.

### Q. Example 9: Encapsulation of Carbohydrates

In certain embodiments, one or more taste component(s) characterized as a carbohydrate is or are encapsulated in one or more core-shell preparations and/or matrix preparations. In one exemplary embodiment, one or more carbohydrate(s) is or are encapsulated in a core-shell preparation further characterized as a particle preparation.

For example, in one non-limiting instance, a taste composition comprised of a carbohydrate (e.g., a solute component) further characterized as a monosaccharide is embedded within a carbohydrate (e.g., a matrix component) further characterized as a polysaccharide, demonstrating exemplary encapsulation of a carbohydrate. For example, in one non-limiting instance, a taste composition comprised of a carbohydrate (e.g., a solute component) further characterized as a polysaccharide is embedded within a carbohydrate (e.g., a matrix component) further characterized as a polysaccharide, demonstrating exemplary encapsulation of a carbohydrate. For example, in one non-limiting instance, a taste composition comprised of an encapsulated carbohydrate (e.g., a matrix preparation) is encapsulated by a polymer (e.g., excipient component) (e.g., a core-shell preparation). For example, in one non-limiting instance, a taste composition comprised of an encapsulated carbohydrate (e.g., a matrix preparation) is encapsulated by a protein (e.g., a core-shell preparation). In one non-limiting instance, a core-shell preparation is further characterized as a particle preparation.

FIG. 13 illustrates a comparison between gross morphologies of unencapsulated (FIG. 13A) and encapsulated (FIGS. 13B-E) carbohydrates. For example, in FIG. 13B, sucrose is dispersed within a wet amylose matrix, the slurry sprayed into cool air to generate particles of controlled diameter. The encapsulation of sucrose within amylose is calculated to be 92%, on a dry weight basis. For example, in FIG. 13B, particles comprising encapsulated sucrose (92% loading, 1 mm diameter) are further coated (e.g., spray pan coating) with a 90% (v/v) solution of Zein with a colorant (e.g., excipient component). Brightfield micrographs reveal increased surface roughness and a red coloring, indicative of successful coating. For example, in FIG. 13C, 14 g of glucose is added to 6 mL of a stirring 5% (w/v) pectin solution held at 110 °C and the resulting mixture is stirred for 3 minutes, or until all glucose is dissolved. 1.0 mL of 1 M citric acid in distilled water is added to the stirring mixture, which is further mixed for 15 seconds before pouring into molds coated with loose glucose crystals and setting for 1 hour at 20 °C. For example, in FIG. 13D, 100 mg of inulin (from dahlia tubers) is dissolved in 5 mL of distilled water and warmed to 60 °C while stirring. 5 mL of a 5% (w/v) solution of agarose at 130 °C is added to the stirring mixture, which is further mixed for 15 seconds before pouring into molds and setting for 1 hour at 20 °C. For example, in FIG. 13E, 10 mL of a stirring 20% (w/v) suspension of calcium caseinate is added to 10 mL of a stirring 60 °C mixture of 5% (w/v) solution of sodium alginate and 2% (w/v) inulin (from dahlia tuber). The resulting mixture is allowed to stir for 15 seconds before pouring into molds and setting for 1 hour at 20 °C. Unlike the free-flowing powder depicted in FIG. 13A, the formulations generated using the methods of manufacture outlined for FIG. 13C-E are cohesive particle preparation(s) indicating successful encapsulation.

### R. Example 10: Encapsulation of Proteins

In certain embodiments, one or more taste component(s) characterized as a protein is or are encapsulated in one or more core-shell preparations and/or matrix preparations. In one exemplary embodiment, one or more protein(s) is or are encapsulated in a core-shell preparation further characterized as a particle preparation.

For example, in one non-limiting instance, a taste composition comprised of a protein (e.g., a solute component) is embedded within a lipid (e.g., a matrix component), demonstrating exemplary encapsulation of a protein. For example, in one non-limiting instance, a taste composition comprised of a protein (e.g., a solute component) is embedded within a carbohydrate (e.g., a matrix component) further characterized as a polysaccharide, demonstrating exemplary encapsulation of a protein. For example, in one non-limiting instance, a taste composition comprised of an encapsulated protein (e.g., a matrix preparation) is encapsulated by a polymer (e.g., excipient component) (e.g., a core-shell preparation). For example, in one non-limiting instance, a taste composition comprised of an encapsulated protein (e.g., a matrix preparation) is encapsulated by a carbohydrate (e.g., a core-shell preparation). In one non-limiting instance, a core-shell preparation is further characterized as a particle preparation.

FIG. 14 illustrates a comparison between gross morphologies of unencapsulated (FIG. 14A, whey protein isolate) and encapsulated (FIG. 14B-D, encapsulated) protein. For example, in FIG. 14B, whey protein isolate powder is dispersed at 10000 rpm using a high-shear homogenizer within molten beeswax and the resulting dispersion is poured into a mold to set for 1 hour at 20 °C. For example, in FIG. 14C, whey protein isolate powder is dispersed at 10000 rpm using a high-shear homogenizer within molten hydrogenated soy oil and the resulting dispersion is poured into a mold to set for 1 hour at 20 °C. For example, in FIG. 14D, 5 mL of 5% (w/v) agarose solution at 130 °C is mixed with 5 mL of a solution comprising 20% (w/v) whey protein isolate and 2% (w/v) chitosan) at pH 5 and 60 °C. The resulting mixture is allowed to stir for 15 seconds before pouring into molds and setting for 1 hour at 20 °C. Unlike the free-flowing powder depicted in FIG. 14A, the formulations generated using the methods of manufacture outlined for FIG. 14B-D are cohesive particle preparation(s) indicating successful encapsulation.

### S. Example 11: Encapsulation of Lipids

In certain embodiments, one or more taste component(s) characterized as a lipid is or are encapsulated in one or more core-shell preparations and/or matrix preparations. In one exemplary embodiment, one or more lipid(s) is or are encapsulated in a core-shell preparation further characterized as a particle preparation.

For example, in one non-limiting instance, a taste composition comprised of a lipid (e.g., a solute component) is embedded within a lipid (e.g., a matrix component), demonstrating exemplary encapsulation of a lipid. For example, in one non-limiting instance, a taste composition comprised of a lipid (e.g., a solute component) is embedded within a carbohydrate (e.g., a matrix component) further characterized as a polysaccharide, demonstrating exemplary encapsulation of a lipid. For example, in one non-limiting instance, a taste composition comprised of an encapsulated lipid (e.g., a matrix preparation) is encapsulated by a polymer (e.g., excipient component) (e.g., a core-shell preparation). For example, in one non-limiting instance, a taste composition comprised of an encapsulated lipid (e.g., a matrix preparation) is encapsulated by a carbohydrate (e.g., a core-shell preparation). In one non-limiting instance, a core-shell preparation is further characterized as a particle preparation.

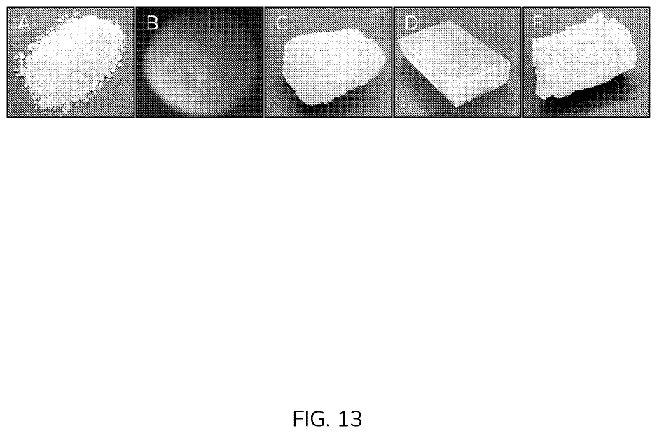

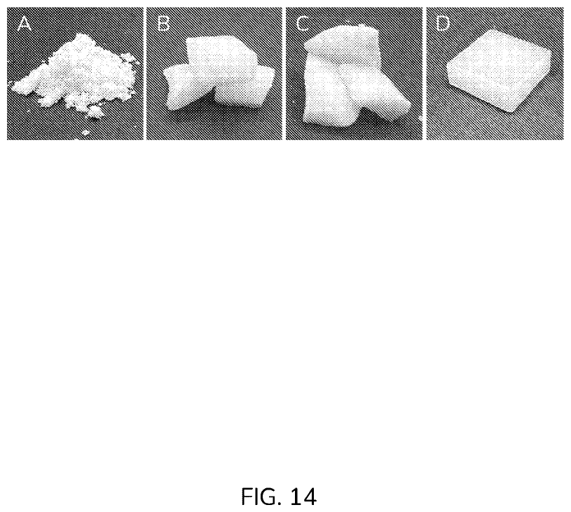

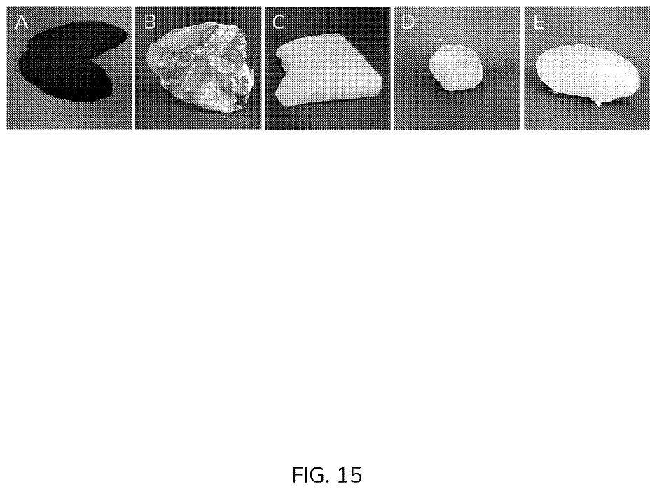

FIG. 15 illustrates a comparison between gross morphologies of unencapsulated (FIG. 15A, oleic acid) and encapsulated (FIG. 15B-E, encapsulated) lipid. For example, in FIG. 15B, 8 mL of oleic acid is heated, while stirring, to 130 °C, followed by the addition of 2.0 g of ethyl cellulose (100 cP). The mixture is kept stirring at 130 °C for 10 minutes, or until all solids are dissolved, and the resulting clear solution is then poured into an aluminum pan to set at 20 °C for 1 hour. For example, in FIG. 15C, 8 mL of oleic acid is heated, while stirring, to 90 °C, followed by the addition of 2.0 g of beeswax. The mixture is kept stirring at 90 °C for 10 minutes, or until all solids are dissolved, and the resulting clear solution is poured into an aluminum pan to set at 20 °C for 1 hour. For example, in FIG. 15D, 6.5 mL of oleic acid is heated, while stirring, to 130 °C, followed by the addition of 1.0 g of carnauba wax and 1.5 g of ethyl cellulose. The mixture is kept stirring at 130 °C for 10 minutes, or until all solids are dissolved, and 1.0 g of whey protein isolate is added. After 15 seconds of stirring, the suspension is poured into an aluminum pan and allowed to set at 20 °C for 1 hour. The resulting waxy solid is then immersed and wrapped in an interfacial thin film comprised of chitosan-polyphosphate and allowed to dry at 50 °C for 6 hours. For example, in FIG. 15E, core component(s) prepared as described in FIG. 15D are instead coated by dipping into a 15% (w/v) solution of cellulose acetate phthalate in acetone and drying under air at 40 °C. Unlike the loose oil depicted in FIG. 15B, the formulations generated using the methods of manufacture outlined for FIG. 15B-E are solid, cohesive particle preparation(s) indicating successful encapsulation.

### T. Example 12: Release of Carbohydrates from One or More Taste Composition(s)

In certain embodiments, one or more taste component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s).

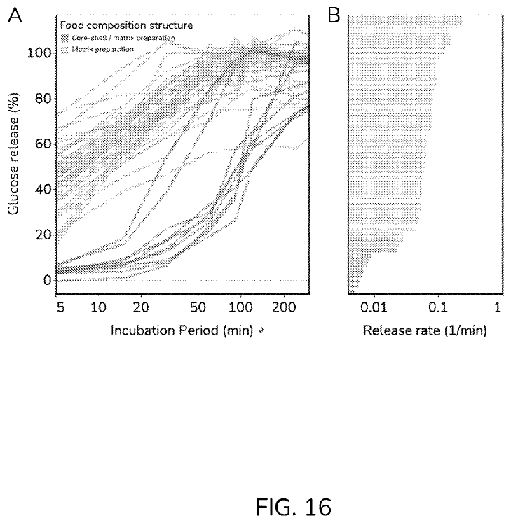

In some non-limiting instances, one or more taste composition(s) comprising carbohydrate(s) further characterized as core-shell preparation(s) and/or matrix preparation(s) provide a means of controlling carbohydrate release. In certain embodiments, the selection of one or more core component(s), shell component(s), and/or matrix component(s) and their relative concentration(s) provide a means of controlling release of carbohydrate(s). In one non-limiting embodiment (FIG. 16), the average release profiles (n=3) of an exemplary carbohydrate encapsulated within taste composition(s) comprising distinct core component(s), shell component(s), and/or matrix component(s) within a release environment comprising phosphate buffered saline, pH 7.4 at 37 °C are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 16 enable the selection of taste composition(s) conferring desirable release profile(s) upon one or more carbohydrates, for example, to reduce meal frequency in one or more mammal(s).

In some non-limiting instances, one or more taste composition(s) providing for 80% release of encapsulated carbohydrate within 30 minutes is or may be advantageous. In some non-limiting embodiments, release of 80% of encapsulated carbohydrate tastant(s) within 30 minutes is or may be beneficial for applications where immediate sweetness is desired. In some non-limiting instances, one or more taste composition(s) providing for 80% release of encapsulated carbohydrate within 100 minutes is or may be advantageous. In some non-limiting embodiments, release of 80% of encapsulated carbohydrate tastant(s) within 100 minutes is or may be beneficial for applications where long-lasting sweetness is desired. In some non-limiting instances, one or more taste composition(s) providing for 80% release of encapsulated carbohydrate within 240 minutes is or may be advantageous. In some non-limiting embodiments, release of 80% of encapsulated carbohydrate tastant(s) within 240 minutes is or may be beneficial for applications where sweet-masking is desired.

As shown in FIG. 16, the time required to reach 80% (w/w) release of encapsulated carbohydrate(s) can vary from ~7 minutes to >280 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 16 aid in the selection of desirable taste composition structure (e.g., core-shell preparation, matrix preparation, particle preparation). In some cases, the exemplary release profiles provided in FIG. 16 aid in the selection and relative concentration(s) of one or more core component(s), shell component(s), and/or matrix component(s).

As shown in FIG. 16, the release rate of glucose from one or more exemplary taste composition(s) varies substantially by taste composition structure (e.g., core-shell preparation, matrix preparation, particle preparation). Core-shell preparations wherein one or more core component(s) further comprise a matrix preparation generally offer slower release kinetics (<0.03 min⁻¹) relative to uncoated matrix preparations (>0.03 min⁻¹).

### U. Example 13: Release of Proteins from One or More Taste Composition(s)

In certain embodiments, one or more taste component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s).

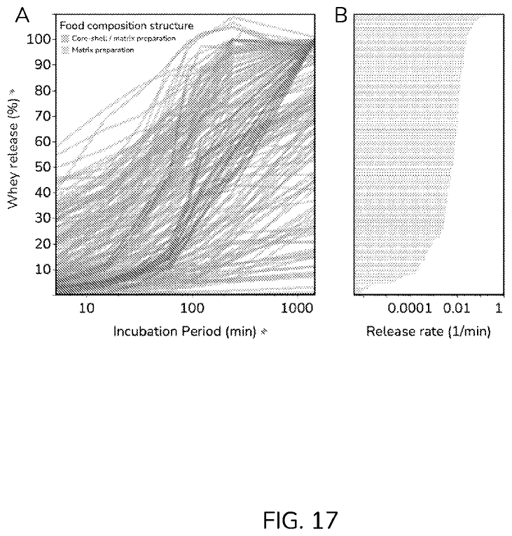

In some non-limiting instances, one or more taste composition(s) comprising protein(s) further characterized as core-shell preparation(s) and/or matrix preparation(s) provide a means of controlling protein release. In certain embodiments, the selection of one or more core component(s), shell component(s), and/or matrix component(s) and their relative concentration(s) provide a means of controlling release of protein(s). In one non-limiting embodiment (FIG. 17), the average release profiles (n=3) of an exemplary protein encapsulated within taste composition(s) comprising distinct core component(s), shell component(s), and/or matrix component(s) within a release environment comprising phosphate buffered saline, pH 7.4 at 37 °C are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 17 enable the selection of taste composition(s) conferring desirable release profile(s) upon one or more carbohydrates, for example, to reduce meal frequency in one or more mammal(s).

In some non-limiting instances, one or more taste composition(s) providing for 80% release of encapsulated protein within 60 minutes is or may be advantageous. In some non-limiting embodiments, release of 80% of encapsulated protein tastant(s) within 60 minutes is or may be beneficial for applications where immediate savory flavor is desired. In some non-limiting instances, one or more taste composition(s) providing for 80% release of encapsulated protein within 200 minutes is or may be advantageous. In some non-limiting embodiments, release of 80% of encapsulated protein tastant(s) within 200 minutes is or may be beneficial for applications where evolving tastant texture is desired. In some non-limiting instances, one or more taste composition(s) providing for 80% release of encapsulated protein within 1000 minutes is or may be advantageous. In some non-limiting embodiments, release of 80% of encapsulated protein tastant(s) within 1000 minutes is or may be beneficial for applications where savory-masking is desired.

As shown in FIG. 17, the time required to reach 80% (w/w) release of encapsulated protein(s) can vary from ~30 minutes to >1000 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 17 aid in the selection of desirable taste composition structure (e.g., core-shell preparation, matrix preparation, particle preparation). In some cases, the exemplary release profiles provided in FIG. 17 aid in the selection and relative concentration(s) of one or more core component(s), shell component(s), and/or matrix component(s).

As shown in FIG. 17, the release rate of protein from one or more exemplary taste composition(s) remains consistent regardless of taste composition structure (e.g., core-shell preparation, matrix preparation, particle preparation). Core-shell preparations wherein one or more core component(s) further comprise a matrix preparation offer comparable release kinetics (0.002-0.02 min⁻¹) relative to the majority of exemplary uncoated matrix preparations (0.001-0.03 min⁻¹).

### V. Example 14: Release of Lipids from One or More Taste Composition(s)

In certain embodiments, one or more taste component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s).

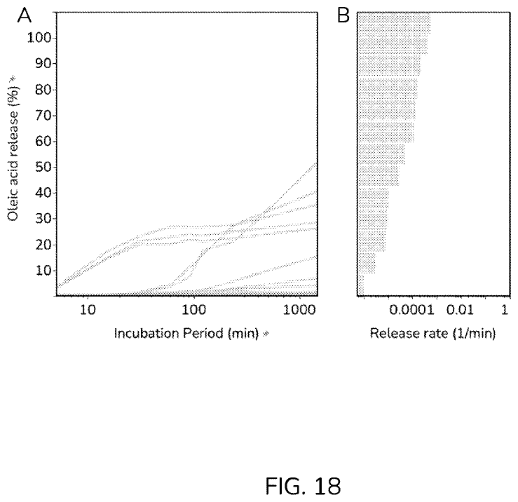

In some non-limiting instances, one or more taste composition(s) comprising lipid(s) further characterized as core-shell preparation(s) and/or matrix preparation(s) provide a means of controlling lipid release. In certain embodiments, the selection of one or more core component(s), shell component(s), and/or matrix component(s) and their relative concentration(s) provide a means of controlling release of lipid(s). In one non-limiting embodiment (FIG. 9), the average release profiles (n=3) of an exemplary lipid encapsulated within taste composition(s) comprising distinct core component(s), shell component(s), and/or matrix component(s) within a release environment comprising phosphate buffered saline, pH 7.4 at 37 °C are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 18 enable the selection of taste composition(s) conferring desirable release profile(s) upon one or more carbohydrates, for example, to reduce meal frequency in one or more mammal(s).

In some non-limiting instances, one or more taste composition(s) providing for 20% release of encapsulated lipid within 20 minutes is or may be advantageous. In some non-limiting embodiments, release of 20% of encapsulated lipid tastant(s) within 20 minutes is or may be beneficial for applications where immediate oily flavor is desired. In some non-limiting instances, one or more taste composition(s) providing for 20% release of encapsulated lipid within 200 minutes is or may be advantageous. In some non-limiting embodiments, release of 20% of encapsulated lipid tastant(s) within 200 minutes is or may be beneficial for applications where evolving tastant texture is desired. In some non-limiting instances, one or more taste composition(s) providing for 20% release of encapsulated lipid within 1000 minutes is or may be advantageous. In some non-limiting embodiments, release of 20% of encapsulated lipid tastant(s) within 1000 minutes is or may be beneficial for applications where oil-masking is desired.

As shown in FIG. 18, the time required to reach 20% (w/w) release of encapsulated lipid(s) can vary from ~30 minutes to >1000 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 18 aid in the selection of desirable taste composition structure (e.g., core-shell preparation, matrix preparation, particle preparation). In some cases, the exemplary release profiles provided in FIG. 18 aid in the selection and relative concentration(s) of one or more core component(s), shell component(s), and/or matrix component(s).

As shown in FIG. 18, the release rate of lipid from one or more exemplary taste composition(s) characterized as matrix preparation(s) varies depending on selected matrix component(s). Exemplary matrix preparation(s) comprising ethyl cellulose confer a release rate of ~0.001 min⁻¹, while matrix preparation(s) comprising sitosterol confer a release rate of ~0.000001 min⁻¹.

### W. Example 15: Encapsulation and Release of Taste Component(s)

In certain embodiments, one or more taste component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s). As illustrated in FIG. 15 and FIG. 18, an exemplary lipid encapsulated in provided taste composition(s) may be oleic acid. Additionally, in some embodiments, linoleic acid, docosahexaenoic acid, and/or eicosapentaenoic acid may be encapsulated and exhibit controlled release within and from provided taste composition(s), respectively.

In certain embodiments, one or more taste component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s). As illustrated in FIG. 14 and FIG. 17, an exemplary protein encapsulated in provided taste composition(s) may be whey protein. Additionally, in some embodiments, gelatin, collagen, casein, oat protein isolate, soy protein isolate, and/or pea protein isolate may be encapsulated and exhibit controlled release within and from provided taste composition(s), respectively.

In certain embodiments, one or more taste component(s) characterized as a polyphenol is or are encapsulated in one or more core-shell preparations and/or matrix preparations. In certain embodiments, the encapsulation of one or more polyphenol(s) in one or more matrix and/or core-shell preparation(s) is further characterized by the release of encapsulated polyphenol(s) in one or more release environment(s). In some instances, the release profile(s), as provided herein, of polyphenol(s) encapsulated in one or more matrix and/or core-shell preparation(s) illustrate controlled release of polyphenol(s).

For example, in one non-limiting instance, a taste composition comprised of a polyphenol (e.g., a solute component) is embedded within a protein (e.g., a shell component), demonstrating exemplary encapsulation of a polyphenol.

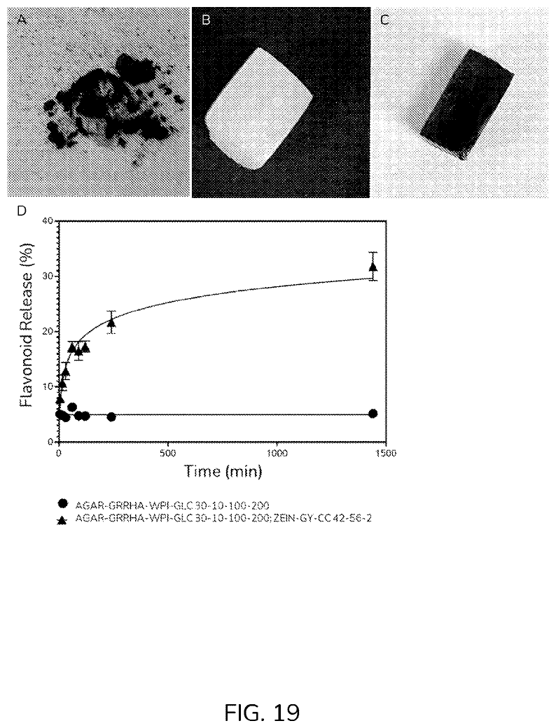

FIG. 19 illustrates a comparison between gross morphologies of unencapsulated (FIG. 19A, cyanidin chloride) and encapsulated (FIG. 19C, encapsulated) polyphenol. For example, an ethanol solution (90% (w/v)) of zein is prepared with the addition of 1% (w/w) cyanidin chloride to form a purple solution, the purple solution then applied to a matrix preparation comprising agarose and glucose (FIG. 19B) via paint coating. Unlike the loose powder depicted in FIG. 19A, the formulations generated using the methods of manufacture outlined are solid, cohesive particle preparation(s) with a smooth coating, indicating successful encapsulation.

In one non-limiting example, encapsulated polyphenol taste composition(s) demonstrate controlled release. For example, FIG. 19D illustrates a comparison in flavonoid release from a formulation containing encapsulated cyanidin chloride (3% (w/w) agarose, 1% (w/w) glycyrrhetinic acid, 10% (w/w) whey protein isolate, and 20% (w/w) glucose in the core, 42% (w/w) Zein, 56% (w/w) glycerol, and 2% (w/w) cyanidin chloride in the shell) (black triangles) and a formulation containing no cyanidin chloride (3% (w/w) agarose, 1% (w/w) glycyrrhetinic acid, 10% (w/w) whey protein isolate, and 20% (w/w) glucose in the core) (black circles). In this example, flavonoid releases from the exemplary taste composition(s), reaching 30% release by 24 hours in phosphate buffered saline, pH 7.4.

In certain embodiments, one or more taste component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s). As illustrated in FIG. 13 and FIG. 16, an exemplary carbohydrate encapsulated in provided taste composition(s) may be glucose. Additionally, in some embodiments, sucrose, tagatose, psicose, and/or isomaltulose may be encapsulated and exhibit controlled release within and from provided taste composition(s), respectively.

For example, in one non-limiting instance, a taste composition comprised of inulin (e.g., a solute component) is embedded within a carbohydrate (e.g., a matrix component), demonstrating exemplary encapsulation of a carbohydrate.

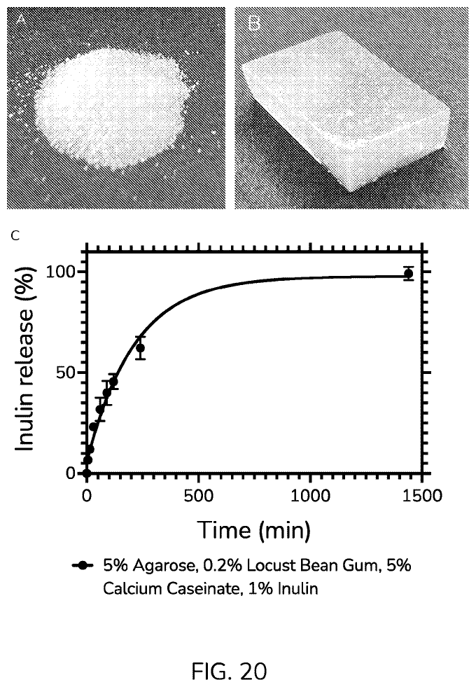

FIG. 20 illustrates a comparison between gross morphologies of unencapsulated (FIG. 20A, inulin) and encapsulated (FIG. 20B, encapsulated) carbohydrate. For example, an aqueous solution of 10% (w/w) inulin and 20% (w/w) glucose is prepared, followed by the addition of 3% (w/w) agarose powder. The mixture is heated to 75 °C to dissolve the agarose, which, upon cooling, forms a solid matrix preparation. Unlike the loose powder depicted in FIG. 20A, the formulations generated using the methods of manufacture outlined are solid, cohesive particle preparation(s) (FIG. 20B), indicating successful encapsulation.

In one non-limiting example, encapsulated carbohydrate taste composition(s) demonstrate controlled release. For example, FIG. 20C illustrates a carbohydrate release from a formulation containing encapsulated inulin. In this example, inulin releases from the exemplary taste composition(s) (5% (w/w) agarose, 0.2% (w/w) locust bean gum, 5% (w/w) calcium caseinate, and 1% (w/w) inulin), reaching 100% release by 24 hours in phosphate buffered saline, pH 7.4.

In certain embodiments, one or more taste component(s) characterized as a ketone is or are encapsulated in one or more core-shell preparations and/or matrix preparations. In certain embodiments, the encapsulation of one or more ketone(s) in one or more matrix and/or core-shell preparation(s) is further characterized by the release of encapsulated ketone(s) in one or more release environment(s). In some instances, the release profile(s), as provided herein, of ketone(s) encapsulated in one or more matrix and/or core-shell preparation(s) illustrate controlled release of ketone(s). In some embodiments, 3-hydroxybutyrate, acetoacetic acid, and/or 3-hydroxybutyl-3-hydroxybutyrate may be encapsulated and exhibit controlled release within and from provided taste composition(s), respectively.

### X. Example 16: Exemplary Formulations

Non-limiting exemplary embodiments in accordance with the present disclosure (e.g., exemplary formulations, e.g., exemplary compositions) are presented in Table 1.

TABLE 1
Exemplary Formulations

| Formulation | | Manufacturing | Manufacturing | Component | | Component |
|---|---|---|---|---|---|---|
| Entry | Formulation ID | Technique 1 | Technique 2 | Abbreviation | Component Name | wt % |
| 1 | 27STE- | Hot Melt High | | 27STE | 27-Stearin | 40.00% |
| | ACETEM- | Shear | | ACETEM | Acetic acid esters of mono- | 20.00% |
| | WPI_400-200- | Homogenization | | | and diglycerides | |
| | 400 | | | WPI | Whey Protein Isolate | 40.00% |
| 2 | 27STE- | Hot Melt High | | 27STE | 27-Stearin | 60.00% |
| | ALA_600-400 | Shear | | ALA | Linoleic Acid | 40.00% |
| | | Homogenization | | | | |
| 3 | 27STE-BSWX- | Hot Melt High | | 27STE | 27-Stearin | 60.00% |
| | ALA_600-200- | Shear | | ALA | Linoleic Acid | 20.00% |
| | 200 | Homogenization | | BSWX | Beeswax | 20.00% |
| 4 | 27STE-BSWX- | Hot Melt High | | 27STE | 27-Stearin | 40.00% |
| | WPI_400-200- | Shear | | BSWX | Beeswax | 20.00% |
| | 400 | Homogenization | | WPI | Whey Protein Isolate | 40.00% |
| 5 | 27STE- | Hot Melt High | | 27STE | 27-Stearin | 40.00% |
| | CARNW- | Shear | | CARNW | Carnauba Wax | 20.00% |
| | WPI_400-200- | Homogenization | | WPI | Whey Protein Isolate | 40.00% |
| | 400 | | | | | |
| 6 | 27STE- | Hot Melt High | | 27STE | 27-Stearin | 40.00% |
| | CHOLE- | Shear | | CHOLE | Cholesterol | 20.00% |
| | WPI_400-200- | Homogenization | | WPI | Whey Protein Isolate | 40.00% |
| | 400 | | | | | |
| 7 | 27STE- | Hot Melt High | | 27STE | 27-Stearin | 40.00% |
| | CITREM- | Shear | | CITREM | Citric Acid Esters of Mono | 20.00% |
| | WPI_400-200- | Homogenization | | | and Diglycerides | |
| | 400 | | | WPI | Whey Protein Isolate | 40.00% |
| 8 | 27STE- | Hot Melt High | | 27STE | 27-Stearin | 40.00% |
| | DMDN- | Shear | | DMDN | Dimodan | 20.00% |
| | WPI_400-200- | Homogenization | | WPI | Whey Protein Isolate | 40.00% |
| | 400 | | | | | |
| 9 | 27STE-EC:10- | Hot Melt High | | 27STE | 27-Stearin | 40.00% |
| | WPI_400-200- | Shear | | EC:10 | Ethyl Cellulose 10 cP | 20.00% |
| | 400 | Homogenization | | WPI | Whey Protein Isolate | 40.00% |
| 10 | 27STE-EC:22- | Hot Melt High | | 27STE | 27-Stearin | 40.00% |
| | WPI_400-200- | Shear | | EC:22 | Ethyl Cellulose 22 cP | 20.00% |
| | 400 | Homogenization | | WPI | Whey Protein Isolate | 40.00% |
| 11 | 27STE- | Hot Melt High | | 27STE | 27-Stearin | 30.00% |
| | EC:100- | Shear | | ACETEM | Acetic acid esters of mono- | 5.00% |
| | ACETEM- | Homogenization | | | and diglycerides | |
| | WPI_300-150- | | | EC:100 | Ethyl Cellulose 100 cP | 15.00% |
| | 50-500 | | | WPI | Whey Protein Isolate | 50.00% |
| 12 | 27STE- | Hot Melt High | | 27STE | 27-Stearin | 30.00% |
| | EC:100- | Shear | | ACETEM | Acetic acid esters of mono- | 4.00% |
| | ACETEM- | Homogenization | | | and diglycerides | |
| | WPI_300-160- | | | EC:100 | Ethyl Cellulose 100 cP | 16.00% |
| | 40-500 | | | WPI | Whey Protein Isolate | 50.00% |
| 13 | 27STE- | Hot Melt High | | 27STE | 27-Stearin | 30.00% |
| | EC:100- | Shear | | ACETEM | Acetic acid esters of mono- | 3.00% |
| | ACETEM- | Homogenization | | | and diglycerides | |
| | WPI_300-170- | | | EC:100 | Ethyl Cellulose 100 cP | 17.00% |
| | 30-500 | | | WPI | Whey Protein Isolate | 50.00% |
| 14 | 27STE- | Hot Melt High | | 27STE | 27-Stearin | 30.00% |
| | EC:100- | Shear | | ACETEM | Acetic acid esters of mono- | 2.00% |
| | ACETEM- | Homogenization | | | and diglycerides | |
| | WPI_300-180- | | | EC:100 | Ethyl Cellulose 100 cP | 18.00% |
| | 20-500 | | | WPI | Whey Protein Isolate | 50.00% |
| 15 | 27STE- | Hot Melt High | | 27STE | 27-Stearin | 30.00% |
| | EC:100- | Shear | | ACETEM | Acetic acid esters of mono- | 1.00% |
| | ACETEM- | Homogenization | | | and diglycerides | |
| | WPI_300-190- | | | EC:100 | Ethyl Cellulose 100 cP | 19.00% |
| | 10-500 | | | WPI | Whey Protein Isolate | 50.00% |
| 16 | 27STE- | Hot Melt | Hammer | 27STE | 27-Stearin | 30.00% |
| | EC:100- | Extrusion | Milling | ACETEM | Acetic acid esters of mono- | 3.00% |
| | ACETEM- | | | | and diglycerides | |
| | WPI-FITC | | | EC:100 | Ethyl Cellulose 100 cP | 17.00% |
| | BSA_300-170- | | | FITC BSA | FITC Bovine Serum Albumin | 1.00% |
| | 30-490-10 | | | WPI | Whey Protein Isolate | 49.00% |
| 17 | 27STE- | Hot Melt | | 27STE | 27-Stearin | 30.00% |
| | EC:100- | Extrusion | | EC:100 | Ethyl Cellulose 100 cP | 20.00% |
| | WPI_300-200- | | | WPI | Whey Protein Isolate | 50.00% |
| | 500 | | | | | |
| 18 | 27STE- | Hot Melt High | | 27STE | 27-Stearin | 85.00% |
| | EC:100- | Shear | | EC:100 | Ethyl Cellulose 100 cP | 5.00% |
| | WPI_850-50- | Homogenization | | WPI | Whey Protein Isolate | 10.00% |
| | 100 | | | | | |
| 19 | 27STE- | Hot Melt High | | 27STE | 27-Stearin | 90.00% |
| | EC:100- | Shear | | EC:100 | Ethyl Cellulose 100 cP | 5.00% |
| | WPI_900-50- | Homogenization | | WPI | Whey Protein Isolate | 5.00% |
| | 50 | | | | | |
| 20 | 27STE- | Hot Melt High | | 27STE | 27-Stearin | 40.00% |
| | EC:300- | Shear | | EC:300 | Ethyl Cellulose 300 cP | 20.00% |
| | WPI_400-200- | Homogenization | | WPI | Whey Protein Isolate | 40.00% |
| | 400 | | | | | |
| 21 | 27STE-F127- | Hot Melt High | | 27STE | 27-Stearin | 40.00% |
| | WPI_400-200- | Shear | | F127 | Pluronic F127, Poloxamer 407 | 20.00% |
| | 400 | Homogenization | | WPI | Whey Protein Isolate | 40.00% |
| 22 | 27STE-FOLA- | Hot Melt High | | 27STE | 27-Stearin | 40.00% |
| | WPI_400-200- | Shear | | FOLA | Folic Acid, Folate | 20.00% |
| | 400 | Homogenization | | WPI | Whey Protein Isolate | 40.00% |
| 23 | 27STE-G4414- | Hot Melt High | | 27STE | 27-Stearin | 30.00% |
| | ALA_300-300- | Shear | | ALA | Linoleic Acid | 40.00% |
| | 400 | Homogenization | | G4414 | Gelucire 44/14 | 30.00% |
| 24 | 27STE-G5914- | Hot Melt High | | 27STE | 27-Stearin | 30.00% |
| | ALA_300-300- | Shear | | ALA | Linoleic Acid | 40.00% |
| | 400 | Homogenization | | G5914 | Gelucire 59/14 | 30.00% |
| 25 | 27STE-GEL- | Hot Melt High | Hammer | 27STE | 27-Stearin | 60.00% |
| | QRCTN_600- | Shear | Milling | GLTN | Gelatin | 20.00% |
| | 200-200 | Homogenization | | QRCTN | Quercetin Hydrate | 20.00% |
| 26 | 27STE-GMO- | Hot Melt High | Hammer | 27STE | 27-Stearin | 60.00% |
| | QRCTN_600- | Shear | Milling | GMO | Glyceryl Monooleate | 20.00% |
| | 200-200 | Homogenization | | QRCTN | Quercetin Hydrate | 20.00% |
| 27 | 27STE-GMO- | Hot Melt High | | 27STE | 27-Stearin | 40.00% |
| | WPI_400-200- | Shear | | GMO | Glyceryl Monooleate | 20.00% |
| | 400 | Homogenization | | WPI | Whey Protein Isolate | 40.00% |
| 28 | 27STE-GMS- | Hot Melt High | | 27STE | 27-Stearin | 40.00% |
| | WPI_400-200- | Shear | | GMS | Glyceryl Monostearate | 20.00% |
| | 400 | Homogenization | | WPI | Whey Protein Isolate | 40.00% |
| 29 | 27STE-HBC- | Hot Melt High | | 27STE | 27-Stearin | 40.00% |
| | WPI_400-200- | Shear | | HBC | Hydroxybutyrate Calcium Salt | 20.00% |
| | 400 | Homogenization | | WPI | Whey Protein Isolate | 40.00% |
| 30 | 27STE- | Hot Melt High | | 27STE | 27-Stearin | 40.00% |
| | HBMG- | Shear | | HBMG | Hydroxybutyrate Magnesium | 20.00% |
| | WPI_400-200- | Homogenization | | WPI | Whey Protein Isolate | 40.00% |
| | 400 | | | | | |
| 31 | 27STE-HBNa- | Hot Melt High | | 27STE | 27-Stearin | 40.00% |
| | WPI_400-200- | Shear | | HBNa | Hydroxybutyate Sodium Salt | 20.00% |
| | 400 | Homogenization | | WPI | Whey Protein Isolate | 40.00% |
| 32 | 27STE-K188- | Shear | | 27STE | 27-Stearin | 60.00% |
| | ALA_600-200- | Hot Melt High | | ALA | Linoleic Acid | 20.00% |
| | 200 | Homogenization | | K188 | Koliphor 188 | 20.00% |
| 33 | 27STE-K188- | Hot Melt High | | 27STE | 27-Stearin | 40.00% |
| | WPI_400-200- | Shear | | K188 | Koliphor 188 | 20.00% |
| | 400 | Homogenization | | WPI | Whey Protein Isolate | 40.00% |
| 34 | 27STE- | Hot Melt High | | 27STE | 27-Stearin | 30.00% |
| | KRH40- | Shear | | ALA | Linoleic Acid | 40.00% |
| | ALA_300-300- | Homogenization | | KRH40 | Koliphor RH40 | 30.00% |
| | 400 | | | | | |
| 35 | 27STE- | Hot Melt High | | 27STE | 27-Stearin | 40.00% |
| | KRH40- | Shear | | KRH40 | Koliphor RH40 | 20.00% |
| | WPI_400-200- | Homogenization | | WPI | Whey Protein Isolate | 40.00% |
| | 400 | | | | | |
| 36 | 27STE- | Hot Melt High | | 27STE | 27-Stearin | 40.00% |
| | KS3550- | Shear | | KS3350 | Kollisoly 3550 | 20.00% |
| | WPI_400-200- | Homogenization | | WPI | Whey Protein Isolate | 40.00% |
| | 400 | | | | | |
| 37 | 27STE-LEC- | Hot Melt High | | 27STE | 27-Stearin | 40.00% |
| | WPI_400-200- | Shear | | LEC | Lecithin | 20.00% |
| | 400 | Homogenization | | WPI | Whey Protein Isolate | 40.00% |
| 38 | 27STE-LEC- | Hot Melt High | | 27STE | 27-Stearin | 80.00% |
| | WPI_800-150- | Shear | | LEC | Lecithin | 15.00% |
| | 50 | Homogenization | | WPI | Whey Protein Isolate | 5.00% |
| 39 | 27STE-LEC- | Hot Melt High | | 27STE | 27-Stearin | 85.00% |
| | WPI_850-50- | Shear | | LEC | Lecithin | 5.00% |
| | 100 | Homogenization | | WPI | Whey Protein Isolate | 10.00% |
| 40 | 27STE-LEC- | Hot Melt High | | 27STE | 27-Stearin | 90.00% |
| | WPI_900-50- | Shear | | LEC | Lecithin | 5.00% |
| | 50 | Homogenization | | WPI | Whey Protein Isolate | 5.00% |
| 41 | 27STE- | Hot Melt High | Hammer | 27STE | 27-Stearin | 60.00% |
| | LIPOID- | Shear | Milling | LIPOID | Phosphatidylcholine | 20.00% |
| | QRCTN_600- | Homogenization | | QRCTN | Quercetin Hydrate | 20.00% |
| | 200-200 | | | | | |
| 42 | 27STE- | Hot Melt High | | 27STE | 27-Stearin | 40.00% |
| | LIPOID- | Shear | | LIPOID | Phosphatidylcholine | 20.00% |
| | WPI_400-200- | Homogenization | | WPI | Whey Protein Isolate | 40.00% |
| | 400 | | | | | |
| 43 | 27STE-MFC- | Hot Melt High | | 27STE | 27-Stearin | 40.00% |
| | WPI_400-200- | Shear | | MFC | Multifunctional Corn Fiber | 20.00% |
| | 400 | Homogenization | | WPI | Whey Protein Isolate | 40.00% |
| 44 | 27STE- | Hot Melt High | | 27STE | 27-Stearin | 30.00% |
| | MYRJ52- | Shear | | ALA | Linoleic Acid | 40.00% |
| | ALA_300-300- | Homogenization | | MYRJ52 | Polyoxyethylene (40) stearate | 30.00% |
| | 400 | | | | | |
| 45 | 27STE- | Hot Melt High | | 27STE | 27-Stearin | 40.00% |
| | MYRJ52- | Shear | | MYRJ52 | Polyoxyethylene (40) stearate | 20.00% |
| | WPI_400-200- | Homogenization | | WPI | Whey Protein Isolate | 40.00% |
| | 400 | | | | | |
| 46 | 27STE- | Hot Melt High | | 27STE | 27-Stearin | 40.00% |
| | PANODAN- | Shear | | PANODAN | Mono- and diglycerides of | 20.00% |
| | WPI_400-200- | Homogenization | | | hydrogenated palm oil | |
| | 400 | | | WPI | Whey Protein Isolate | 40.00% |
| 47 | 27STE- | Hot Melt High | | 27STE | 27-Stearin | 40.00% |
| | PEG:8000- | Shear | | PEG:8000 | Polyethylene Glycol 8000 Da | 20.00% |
| | WPI_400-200- | Homogenization | | WPI | Whey Protein Isolate | 40.00% |
| | 400 | | | | | |
| 48 | 27STE- | Hot Melt High | | 27STE | 27-Stearin | 40.00% |
| | PEG:PPG- | Shear | | PEG:PPG | Poly(ethylene glycol)-block- | 20.00% |
| | WPI_400-200- | Homogenization | | | poly(propylene glycol)-block- | |
| | 400 | | | | poly(ethylene glycol) | |
| | | | | WPI | Whey Protein Isolate | 40.00% |
| 49 | 27STE-PGMS- | Hot Melt High | | 27STE | 27-Stearin | 40.00% |
| | WPI_400-200- | Shear | | PGMS | Propylene glycol monostearate | 20.00% |
| | 400 | Homogenization | | WPI | Whey Protein Isolate | 40.00% |
| 50 | 27STE-PGPR- | Hot Melt High | | 27STE | 27-Stearin | 40.00% |
| | WPI_400-200- | Shear | | PGPR | Polyglycerol Polyricinoleate | 20.00% |
| | 400 | Homogenization | | WPI | Whey Protein Isolate | 40.00% |
| 51 | 27STE-RG- | Hot Melt High | | 27STE | 27-Stearin | 40.00% |
| | WPI_400-200- | Shear | | RG | Rosin Gum | 20.00% |
| | 400 | Homogenization | | WPI | Whey Protein Isolate | 40.00% |
| 52 | 27STE-SITO- | Hot Melt High | | 27STE | 27-Stearin | 60.00% |
| | ALA_600-200- | Shear | | ALA | Linoleic Acid | 20.00% |
| | 200 | Homogenization | | SITO | Sitosterol | 20.00% |
| 53 | 27STE-SITO- | Hot Melt High | | 27STE | 27-Stearin | 60.00% |
| | ORY- | Shear | | ALA | Linoleic Acid | 20.00% |
| | ALA_600-120- | Homogenization | | ORY | gamma-Oryzanol | 8.00% |
| | 80-200 | | | SITO | Sitosterol | 12.00% |
| 54 | 27STE-SITO- | Hot Melt High | | 27STE | 27-Stearin | 60.00% |
| | ORY- | Shear | | ORY | gamma-Oryzanol | 15.00% |
| | WPI_600-150- | Homogenization | | SITO | Sitosterol | 15.00% |
| | 150-100 | | | WPI | Whey Protein Isolate | 10.00% |
| 55 | 27STE-SITO- | Hot Melt High | | 27STE | 27-Stearin | 65.00% |
| | ORY- | Shear | | ORY | gamma-Ory zanol | 28.50% |
| | WPI_650-15- | Homogenization | | SITO | Sitosterol | 1.50% |
| | 285-50 | | | WPI | Whey Protein Isolate | 5.00% |
| 56 | 27STE-SITO- | Hot Melt High | | 27STE | 27-Stearin | 65.00% |
| | ORY- | Shear | | ORY | gamma-Oryzanol | 24.00% |
| | WPI_650-60- | Homogenization | | SITO | Sitosterol | 6.00% |
| | 240-50 | | | WPI | Whey Protein Isolate | 5.00% |
| 57 | 27STE-SITO- | Hot Melt High | | 27STE | 27-Stearin | 70.00% |
| | ORY- | Shear | | ORY | gamma-Oryzanol | 12.50% |
| | WPI_700-125- | Homogenization | | SITO | Sitosterol | 12.50% |
| | 125-50 | | | WPI | Whey Protein Isolate | 5.00% |
| 58 | 27STE-SITO- | Hot Melt High | | 27STE | 27-Stearin | 75.00% |
| | ORY- | Shear | | ORY | gamma-Oryzanol | 10.00% |
| | WPI_750-100- | Homogenization | | SITO | Sitosterol | 10.00% |
| | 100-50 | | | WPI | Whey Protein Isolate | 5.00% |
| 59 | 27STE-SITO- | Hot Melt High | | 27STE | 27-Stearin | 40.00% |
| | WPI_400-200- | Shear | | SITO | Sitosterol | 20.00% |
| | 400 | Homogenization | | WPI | Whey Protein Isolate | 40.00% |
| 60 | 27STE-SITO- | Hot Melt High | | 27STE | 27-Stearin | 73.68% |
| | WPI_700-125- | Shear | | SITO | Sitosterol | 13.16% |
| | 125 | Homogenization | | WPI | Whey Protein Isolate | 13.16% |
| 61 | 27STE-SITO- | Hot Melt High | | 27STE | 27-Stearin | 75.00% |
| | WPI_750-125- | Shear | | SITO | Sitosterol | 12.50% |
| | 125 | Homogenization | | WPI | Whey Protein Isolate | 12.50% |
| 62 | 27STE-SP20- | Hot Melt High | | 27STE | 27-Stearin | 40.00% |
| | WPI_400-200- | Shear | | SP20 | Span 20: Sorbitan monolaurate | 20.00% |
| | 400 | Homogenization | | WPI | Whey Protein Isolate | 40.00% |
| 63 | 27STE-SP40- | Hot Melt High | | 27STE | 27-Stearin | 40.00% |
| | WPI_400-200- | Shear | | SP40 | Span 40: Sorbitan | 20.00% |
| | 400 | Homogenization | | | Monopalmitate | |
| | | | | WPI | Whey Protein Isolate | 40.00% |
| 64 | 27STE-SP60- | Hot Melt High | | 27STE | 27-Stearin | 30.00% |
| | ALA_300-300- | Shear | | ALA | Linoleic Acid | 40.00% |
| | 400 | Homogenization | | SP60 | Span 60: Sorbitan | 30.00% |
| | | | | | monostearate | |
| 65 | 27STE-SP60- | Hot Melt High | | 27STE | 27-Stearin | 40.00% |
| | WPI_400-200- | Shear | | SP60 | Span 60: Sorbitan | 20.00% |
| | 400 | Homogenization | | | monostearate | |
| | | | | WPI | Whey Protein Isolate | 40.00% |
| 66 | 27STE-SP65- | Hot Melt High | | 27STE | 27-Stearin | 40.00% |
| | WPI_400-200- | Shear | | SP65 | Span 65: Sorbitan Tristearate | 20.00% |
| | 400 | Homogenization | | WPI | Whey Protein Isolate | 40.00% |
| 67 | 27STE-SP80- | Hot Melt High | | 27STE | 27-Stearin | 40.00% |
| | WPI_400-200- | Shear | | SP80 | Span 80: Sorbitan Monooleate | 20.00% |
| | 400 | Homogenization | | WPI | Whey Protein Isolate | 40.00% |
| 68 | 27STE-SP85- | Hot Melt High | | 27STE | 27-Stearin | 60.00% |
| | ALA_600-200- | Shear | | ALA | Linoleic Acid | 20.00% |
| | 200 | Homogenization | | SP85 | Span 85: Sorbitan Trioleate | 20.00% |
| 69 | 27STE-SP85- | Hot Melt High | Hammer | 27STE | 27-Stearin | 60.00% |
| | QRCTN_600- | Shear | Milling | QRCTN | Quercetin Hydrate | 20.00% |
| | 200-200 | Homogenization | | SP85 | Span 85: Sorbitan Trioleate | 20.00% |
| 70 | 27STE-SP85- | Hot Melt High | | 27STE | 27-Stearin | 40.00% |
| | WPI_400-200- | Shear | | SP85 | Span 85: Sorbitan Trioleate | 20.00% |
| | 400 | Homogenization | | WPI | Whey Protein Isolate | 40.00% |
| 71 | 27STE-STEA- | Hot Melt High | Hammer | 27STE | 27-Stearin | 60.00% |
| | QRCTN_600- | Shear | Milling | QRCTN | Quercetin Hydrate | 20.00% |
| | 200-200 | Homogenization | | STEA | Stearic Acid | 20.00% |
| 72 | 27STE-STEA- | Hot Melt High | | 27STE | 27-Stearin | 40.00% |
| | WPI_400-200- | Shear | | STEA | Stearic Acid | 20.00% |
| | 400 | Homogenization | | WPI | Whey Protein Isolate | 40.00% |
| 73 | 27STE- | Hot Melt High | | 27STE | 27-Stearin | 40.00% |
| | THAMN- | Shear | | THAMN | Thiamine hydrochloride | 20.00% |
| | WPI_400-200- | Homogenization | | WPI | Whey Protein Isolate | 40.00% |
| | 400 | | | | | |
| 74 | 27STE-TSTE- | Hot Melt High | Hammer | 27STE | 27-Stearin | 60.00% |
| | QRCTN_600- | Shear | Milling | QRCTN | Quercetin Hydrate | 20.00% |
| | 200-200 | Homogenization | | TSTE | Tristearin | 20.00% |
| 75 | 27STE-TSTE- | Hot Melt High | | 27STE | 27-Stearin | 40.00% |
| | WPI_400-200- | Shear | | TSTE | Tristearin | 20.00% |
| | 400 | Homogenization | | WPI | Whey Protein Isolate | 40.00% |
| 76 | 27STE-TW20- | Hot Melt High | | 27STE | 27-Stearin | 40.00% |
| | WPI_400-200- | Shear | | TW20 | Tween 20: Polysorbate 20 | 20.00% |
| | 400 | Homogenization | | WPI | Whey Protein Isolate | 40.00% |
| 77 | 27STE-TW40- | Hot Melt High | | 27STE | 27-Stearin | 40.00% |
| | WPI_400-200- | Shear | | TW40 | Tween 40: Polysorbate 40 | 20.00% |
| | 400 | Homogenization | | WPI | Whey Protein Isolate | 40.00% |
| 78 | 27STE-TW80- | Hot Melt High | | 27STE | 27-Stearin | 40.00% |
| | WPI_400-200- | Shear | | TW80 | Tween 80: Polysorbate 80 | 20.00% |
| | 400 | Homogenization | | WPI | Whey Protein Isolate | 40.00% |
| 79 | 27STE-TW85- | Hot Melt High | | 27STE | 27-Stearin | 80.00% |
| | EC:100- | Shear | | EC:100 | Ethyl Cellulose 100 cP | 5.00% |
| | WPI_800-50- | Homogenization | | TW85 | Tween 85: Polyoxyethylene | 5.00% |
| | 50-100 | | | | sorbitan trioleate | |
| | | | | WPI | Whey Protein Isolate | 10.00% |
| 80 | 27STE-TW85- | Hot Melt High | | 27STE | 27-Stearin | 85.00% |
| | WPI_850-50- | Shear | | TW85 | Tween 85: Polyoxyethylene | 5.00% |
| | 100 | Homogenization | | | sorbitan trioleate | |
| | | | | WPI | Whey Protein Isolate | 10.00% |
| 81 | 27STE- | Hot Melt High | | 27STE | 27-Stearin | 90.00% |
| | WPI_900-100 | Shear | | WPI | Whey Protein Isolate | 10.00% |
| | | Homogenization | | | | |
| 82 | 27STE-WPI- | Hot Melt High | | 27STE | 27-Stearin | 15.00% |
| | OLEA_150- | Shear | | OLEA | Oleic Acid | 75.00% |
| | 100-750 | Homogenization | | WPI | Whey Protein Isolate | 10.00% |
| 83 | 27STE-WPI- | Hot Melt High | | 27STE | 27-Stearin | 20.00% |
| | OLEA_200- | Shear | | OLEA | Oleic Acid | 70.00% |
| | 100-700 | Homogenization | | WPI | Whey Protein Isolate | 10.00% |
| 84 | 27STE-WPI- | Hot Melt High | | 27STE | 27-Stearin | 20.00% |
| | OLEA_200- | Shear | | OLEA | Oleic Acid | 60.00% |
| | 200-600 | Homogenization | | WPI | Whey Protein Isolate | 20.00% |
| 85 | 27STE-WPI- | Hot Melt High | | 27STE | 27-Stearin | 40.00% |
| | OLEA_400- | Shear | | OLEA | Oleic Acid | 40.00% |
| | 200-400 | Homogenization | | WPI | Whey Protein Isolate | 20.00% |
| 86 | AGAR-ALG- | Aqueous | | AGAR | Agarose | 5.00% |
| | LBG- | Hydrogel | | ALG | Sodium Alginate | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 87 | AGAR-ALG- | Aqueous | | AGAR | Agarose | 5.00% |
| | LBG- | Hydrogel | | ALG | Sodium Alginate | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | ALG | Sodium Alginate | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 88 | AGAR-ALG- | Aqueous | Hammer | AGAR | Agarose | 47.62% |
| | LBG- | Hydrogel | Milling | ALG | Sodium Alginate | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 89 | AGAR-ARAG- | Aqueous | | AGAR | Agarose | 5.00% |
| | LBG- | Hydrogel | | ARAG | Ara Gum (product name) | 2.50% |
| | CCAS_50-25- | Formation | | CCAS | Calcium Caseinate | 5.00% |
| | 2-50 | | | LBG | Locust Bean Gum | 0.20% |
| | | | | WATER | Water | 87.30% |
| 90 | AGAR-ARAG- | Aqueous | | AGAR | Agarose | 5.00% |
| | LBG- | Hydrogel | | ARAG | Ara Gum (product name) | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 91 | AGAR-ARAG- | Aqueous | | AGAR | Agarose | 5.00% |
| | LBG- | Hydrogel | | ARAG | Ara Gum (product name) | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | ARAG | Ara Gum (product name) | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 92 | AGAR-C10- | Aqueous | | AGAR | Agarose | 5.00% |
| | LBG- | Hydrogel | | C10 | Sodium Decanoate | 2.50% |
| | CCAS_50-25- | Formation | | CCAS | Calcium Caseinate | 5.00% |
| | 2-50 | | | LBG | Locust Bean Gum | 0.20% |
| | | | | WATER | Water | 87.30% |
| 93 | AGAR-C10- | Aqueous | | AGAR | Agarose | 5.00% |
| | LBG- | Hydrogel | | C10 | Sodium Decanoate | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 94 | AGAR-C10- | Aqueous | | AGAR | Agarose | 5.00% |
| | LBG- | Hydrogel | | C10 | Sodium Decanoate | 1.00% |
| | hWPI_50-10-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 88.80% |
| 95 | AGAR-C10- | Aqueous | Hammer | AGAR | Agarose | 47.62% |
| | LBG- | Hydrogel | Milling | C10 | Sodium Decanoate | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 96 | AGAR-C10- | Aqueous | | AGAR | Agarose | 3.00% |
| | WPI_30-3-100 | Hydrogel | | C10 | Sodium Decanoate | 0.30% |
| | | Formation | | WATER | Water | 86.70% |
| | | | | WPI | Whey Protein Isolate | 10.00% |
| 97 | AGAR-C10- | Aqueous | | AGAR | Agarose | 3.00% |
| | WPI_30-30- | Hydrogel | | C10 | Sodium Decanoate | 3.00% |
| | 100 | Formation | | WATER | Water | 84.00% |
| | | | | WPI | Whey Protein Isolate | 10.00% |
| 98 | AGAR-C10- | Aqueous | | AGAR | Agarose | 3.00% |
| | WPI_30-40- | Hydrogel | | C10 | Sodium Decanoate | 4.00% |
| | 100 | Formation | | WATER | Water | 83.00% |
| | | | | WPI | Whey Protein Isolate | 10.00% |
| 99 | AGAR-C10- | Aqueous | | AGAR | Agarose | 3.00% |
| | WPI_30-100- | Hydrogel | | C10 | Sodium Decanoate | 10.00% |
| | 100 | Formation | | WATER | Water | 77.00% |
| | | | | WPI | Whey Protein Isolate | 10.00% |
| 100 | AGAR-C10- | Aqueous | | AGAR | Agarose | 3.00% |
| | WPI-GLC_30- | Hydrogel | | C10 | Sodium Decanoate | 0.10% |
| | 1-100-100 | Formation | | GLC | Glucose | 10.00% |
| | | | | WATER | Water | 76.90% |
| | | | | WPI | Whey Protein Isolate | 10.00% |
| 101 | AGAR-C10- | Aqueous | | AGAR | Agarose | 3.00% |
| | WPI-GLC_30- | Hydrogel | | C10 | Sodium Decanoate | 1.00% |
| | 10-100-100 | Formation | | GLC | Glucose | 10.00% |
| | | | | WATER | Water | 76.00% |
| | | | | WPI | Whey Protein Isolate | 10.00% |
| 102 | AGAR-C18- | Aqueous | | AGAR | Agarose | 5.00% |
| | LBG- | Hydrogel | | C18 | Sodium Oleate | 2.50% |
| | CCAS_50-25- | Formation | | CCAS | Calcium Caseinate | 5.00% |
| | 2-50 | | | LBG | Locust Bean Gum | 0.20% |
| | | | | WATER | Water | 87.30% |
| 103 | AGAR-C18- | Aqueous | | AGAR | Agarose | 5.00% |
| | LBG- | Hydrogel | | C18 | Sodium Oleate | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 104 | AGAR-C18- | Aqueous | | AGAR | Agarose | 5.00% |
| | LBG- | Hydrogel | | C18 | Sodium Oleate | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| 105 | AGAR-C18- | Aqueous | Hammer | AGAR | Agarose | 47.62% |
| | LBG- | Hydrogel | Milling | C18 | Sodium Oleate | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 106 | AGAR-C18- | Aqueous | | AGAR | Agarose | 3.00% |
| | WPI-GLC_30- | Hydrogel | | C18 | Sodium Oleate | 0.10% |
| | 1-100-100 | Formation | | GLC | Glucose | 10.00% |
| | | | | WATER | Water | 76.90% |
| | | | | WPI | Whey Protein Isolate | 10.00% |
| 107 | AGAR-C18- | Aqueous | | AGAR | Agarose | 3.00% |
| | WPI-GLC_30- | Hydrogel | | C18 | Sodium Oleate | 1.00% |
| | 10-100-100 | Formation | | GLC | Glucose | 10.00% |
| | | | | WATER | Water | 76.00% |
| | | | | WPI | Whey Protein Isolate | 10.00% |
| 108 | AGAR-CAP- | Aqueous | | AGAR | Agarose | 3.00% |
| | WPI-GLC_30- | Hydrogel | | CAP | Cellulose Acetate Phthalate | 0.10% |
| | 1-100-100 | Formation | | GLC | Glucose | 10.00% |
| | | | | WATER | Water | 76.90% |
| | | | | WPI | Whey Protein Isolate | 10.00% |
| 109 | AGAR-CAP- | Aqueous | | AGAR | Agarose | 3.00% |
| | WPI-GLC_30- | Hydrogel | | CAP | Cellulose Acetate Phthalate | 1.00% |
| | 10-100-100 | Formation | | GLC | Glucose | 10.00% |
| | | | | WATER | Water | 76.00% |
| | | | | WPI | Whey Protein Isolate | 10.00% |
| 110 | AGAR- | Aqueous | | AGAR | Agarose | 4.00% |
| | CCAS_40-100 | Hydrogel | | CCAS | Calcium Caseinate | 10.00% |
| | | Formation | | WATER | Water | 86.00% |
| | | Aqueous | | AGAR | Agarose | 28.57% |
| | | Hydrogel | | CCAS | Calcium Caseinate | 71.43% |
| | | Formation | Hammer | AGAR | Agarose | 28.57% |
| | | followed by | Milling | CCAS | Calcium Caseinate | 71.43% |
| | | Oven Drying | | | | |
| 111 | AGAR- | Aqueous | | AGAR | Agarose | 4.00% |
| | CCAS_40-200 | Hydrogel | | CCAS | Calcium Caseinate | 20.00% |
| | | Formation | | WATER | Water | 76.00% |
| | | Aqueous | Hammer | AGAR | Agarose | 16.67% |
| | | Hydrogel | Milling | CCAS | Calcium Caseinate | 83.33% |
| | | Formation | | | | |
| | | followed by | | | | |
| | | Oven Drying | | | | |
| 112 | AGAR- | Aqueous | | AGAR | Agarose | 5.00% |
| | CCAS_50-50 | Hydrogel | | CCAS | Calcium Caseinate | 5.00% |
| | | Formation | | WATER | Water | 90.00% |
| | | Aqueous | Hammer | AGAR | Agarose | 50.00% |
| | | Hydrogel | Milling | CCAS | Calcium Caseinate | 50.00% |
| | | Formation | | | | |
| | | followed by | | | | |
| | | Oven Drying | | | | |
| 113 | AGAR- | Aqueous | Hammer | AGAR | Agarose | 54.55% |
| | CCAS_60-50 | Hydrogel | Milling | CCAS | Calcium Caseinate | 45.45% |
| | | Formation | | | | |
| | | followed by | | | | |
| | | Oven Drying | | | | |
| 114 | AGAR-CHIHI- | Aqueous | Hammer | AGAR | Agarose | 39.37% |
| | LBG- | Hydrogel | Milling | CHIHI | Chitosan High Molecular | 19.69% |
| | hWPI_50-25-2- | Formation | | | Weight | |
| | 50 | followed by | | hWPI | Hydrolyzed Whey Protein | 39.37% |
| | | Oven Drying | | | Isolate | |
| | | | | LBG | Locust Bean Gum | 1.57% |
| 115 | AGAR-CHIHI- | Aqueous | Hammer | AGAR | Agarose | 47.62% |
| | LBG- | Hydrogel | Milling | CHIHI | Chitosan High Molecular | 2.86% |
| | INLN_50-3-2- | Formation | | | Weight | |
| | 50 | followed by | | INLN | Inulin | 47.62% |
| | | Oven Drying | | LBG | Locust Bean Gum | 1.90% |
| 116 | AGAR-CHIHI- | Aqueous | | AGAR | Agarose | 3.00% |
| | WPI-GLC_30- | Hydrogel | | CHIHI | Chitosan High Molecular | 0.10% |
| | 1-100-100 | Formation | | | Weight | |
| | | | | GLC | Glucose | 10.00% |
| | | | | WATER | Water | 76.90% |
| | | | | WPI | Whey Protein Isolate | 10.00% |
| 117 | AGAR-CHIHI- | Aqueous | | AGAR | Agarose | 3.00% |
| | WPI-GLC_30- | Hydrogel | | CHIHI | Chitosan High Molecular | 1.00% |
| | 10-100-100 | Formation | | | Weight | |
| | | | | GLC | Glucose | 10.00% |
| | | | | WATER | Water | 76.00% |
| | | | | WPI | Whey Protein Isolate | 10.00% |
| 118 | AGAR- | Aqueous | Hammer | AGAR | Agarose | 39.37% |
| | CHILO- | Hydrogel | Milling | CHILO | Chitosan Low Molecular | 9.84% |
| | KARG-LBG- | Formation | | | Weight | |
| | hWPI_50-12.5- | followed by | | hWPI | Hydrolyzed Whey Protein | 39.37% |
| | 12.5-2-50 | Oven Drying | | | Isolate | |
| | | | | KARG | Karaya Gum | 9.84% |
| | | | | LBG | Locust Bean Gum | 1.57% |
| 119 | AGAR- | Aqueous | | AGAR | Agarose | 5.00% |
| | CHILO-LBG- | Hydrogel | | CCAS | Calcium Caseinate | 5.00% |
| | CCAS_50-25- | Formation | | CHILO | Chitosan Low Molecular | 2.50% |
| | 2-50 | | | | Weight | |
| | | | | LBG | Locust Bean Gum | 0.20% |
| | | | | WATER | Water | 87.30% |
| 120 | AGAR- | Aqueous | | AGAR | Agarose | 5.00% |
| | CHILO-LBG- | Hydrogel | | CHILO | Chitosan Low Molecular | 0.30% |
| | hWPI_50-3-2- | Formation | | | Weight | |
| | 50 | | | hWPI | Hydrolyzed Whey Protein | 5.00% |
| | | | | | Isolate | |
| | | | | LBG | Locust Bean Gum | 0.20% |
| | | | | WATER | Water | 89.50% |
| 121 | AGAR- | Aqueous | | AGAR | Agarose | 5.00% |
| | CHILO-LBG- | Hydrogel | | CHILO | Chitosan Low Molecular | 2.50% |
| | hWPI_50-25-2- | Formation | | | Weight | |
| | 50 | | | hWPI | Hydrolyzed Whey Protein | 5.00% |
| | | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | CHILO | Chitosan Low Molecular | 19.69% |
| | | Formation | | | Weight | |
| | | followed by | | hWPI | Hydrolyzed Whey Protein | 39.37% |
| | | Oven Drying | | | Isolate | |
| | | | | LBG | Locust Bean Gum | 1.57% |
| 122 | AGAR- | Aqueous | Hammer | AGAR | Agarose | 47.62% |
| | CHILO-LBG- | Hydrogel | Milling | CHILO | Chitosan Low Molecular | 2.86% |
| | INLN_50-3-2- | Formation | | | Weight | |
| | 50 | followed by | | INLN | Inulin | 47.62% |
| | | Oven Drying | | LBG | Locust Bean Gum | 1.90% |
| 123 | AGAR- | Aqueous | Hammer | AGAR | Agarose | 39.37% |
| | CHILO- | Hydrogel | Milling | CHILO | Chitosan Low Molecular | 9.84% |
| | MGSO-LBG- | Formation | | | Weight | |
| | hWPI_50-12.5- | followed by | | hWPI | Hydrolyzed Whey Protein | 39.37% |
| | 12.5-2-50 | Oven Drying | | | Isolate | |
| | | | | LBG | Locust Bean Gum | 1.57% |
| | | | | MGSO | Magnesium Sulfate | 9.84% |
| 124 | AGAR- | Aqueous | Hammer | AGAR | Agarose | 39.37% |
| | CHILO- | Hydrogel | Milling | CHILO | Chitosan Low Molecular | 9.84% |
| | PEG:200-LBG- | Formation | | | Weight | |
| | hWPI_50-12.5- | followed by | | hWPI | Hydrolyzed Whey Protein | 39.37% |
| | 12.5-2-50 | Oven Drying | | | Isolate | |
| | | | | LBG | Locust Bean Gum | 1.57% |
| | | | | PEG:200 | Polyethylene Glycol 200 Da | 9.84% |
| 125 | AGAR- | Aqueous | Hammer | AGAR | Agarose | 39.37% |
| | CHILO-SUCC- | Hydrogel | Milling | CHILO | Chitosan Low Molecular | 9.84% |
| | LBG- | Formation | | | Weight | |
| | hWPI_50-12.5- | followed by | | hWPI | Hydrolyzed Whey Protein | 39.37% |
| | 12.5-2-50 | Oven Drying | | | Isolate | |
| | | | | LBG | Locust Bean Gum | 1.57% |
| | | | | SUCC | Succinic Acid | 9.84% |
| 126 | AGAR- | Aqueous | | AGAR | Agarose | 3.00% |
| | CHILO- | Hydrogel | | CHILO | Chitosan Low Molecular | 0.10% |
| | WPI_30-1- | Formation | | | Weight | |
| | 100 | | | WATER | Water | 86.90% |
| | | | | WPI | Whey Protein Isolate | 10.00% |
| 127 | AGAR- | Aqueous | | AGAR | Agarose | 3.00% |
| | CHILO- | Hydrogel | | CHILO | Chitosan Low Molecular | 3.00% |
| | WPI_30-30- | Formation | | | Weight | |
| | 100 | | | WATER | Water | 84.00% |
| | | | | WPI | Whey Protein Isolate | 10.00% |
| 128 | AGAR- | Aqueous | | AGAR | Agarose | 3.00% |
| | CHILO- | Hydrogel | | CHILO | Chitosan Low Molecular | 10.00% |
| | WPI_30-100- | Formation | | | Weight | |
| | 100 | | | WATER | Water | 77.00% |
| | | | | WPI | Whey Protein Isolate | 10.00% |
| 129 | AGAR- | Aqueous | Hammer | AGAR | Agarose | 39.37% |
| | CHONS-LBG- | Hydrogel | Milling | CHONS | Chondroitin Sulfate | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 130 | AGAR-CLLH- | Aqueous | | AGAR | Agarose | 5.00% |
| | LBG- | Hydrogel | | CCAS | Calcium Caseinate | 5.00% |
| | CCAS_50-25- | Formation | | CLLH | Calcium-1-lactate Hydrate | 2.50% |
| | 2-50 | | | LBG | Locust Bean Gum | 0.20% |
| | | | | WATER | Water | 87.30% |
| 131 | AGAR-CLLH- | Aqueous | | AGAR | Agarose | 5.00% |
| | LBG- | Hydrogel | | CLLH | Calcium-1-lactate Hydrate | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 132 | AGAR-CLLH- | Aqueous | | AGAR | Agarose | 5.00% |
| | LBG- | Hydrogel | | CLLH | Calcium-1-lactate Hydrate | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | CLLH | Calcium-1-lactate Hydrate | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 133 | AGAR-CLLH- | Aqueous | Hammer | AGAR | Agarose | 47.62% |
| | LBG- | Hydrogel | Milling | CLLH | Calcium-1-lactate Hydrate | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 134 | AGAR- | Aqueous | | AGAR | Agarose | 3.00% |
| | CMC:90-WPI- | Hydrogel | | CMC:90 | Sodium Carboxymethyl | 0.10% |
| | GLC_30-1- | Formation | | | Cellulose MW 90000 | |
| | 100-200 | | | GLC | Glucose | 20.00% |
| | | | | WATER | Water | 66.90% |
| | | | | WPI | Whey Protein Isolate | 10.00% |
| 135 | AGAR- | Aqueous | | AGAR | Agarose | 3.00% |
| | CMC:90-WPI- | Hydrogel | | CMC:90 | Sodium Carboxymethyl | 1.00% |
| | GLC_30-10- | Formation | | | Cellulose MW 90000 | |
| | 100-200 | | | GLC | Glucose | 20.00% |
| | | | | WATER | Water | 66.00% |
| | | | | WPI | Whey Protein Isolate | 10.00% |
| 136 | AGAR- | Aqueous | | AGAR | Agarose | 3.00% |
| | CMC:250- | Hydrogel | | CMC:250 | Sodium Carboxymethyl | 0.10% |
| | WPI-GLC_30- | Formation | | | Cellulose MW 250000 | |
| | 1-100-200 | | | GLC | Glucose | 20.00% |
| | | | | WATER | Water | 66.90% |
| | | | | WPI | Whey Protein Isolate | 10.00% |
| 137 | AGAR- | Aqueous | | AGAR | Agarose | 3.00% |
| | CMC:250- | Hydrogel | | CMC:250 | Sodium Carboxymethyl | 1.00% |
| | WPI-GLC_30- | Formation | | | Cellulose MW 250000 | |
| | 10-100-200 | | | GLC | Glucose | 20.00% |
| | | | | WATER | Water | 66.00% |
| | | | | WPI | Whey Protein Isolate | 10.00% |
| 138 | AGAR- | Aqueous | | AGAR | Agarose | 5.00% |
| | CMC:300- | Hydrogel | | CCAS | Calcium Caseinate | 5.00% |
| | LBG- | Formation | | CMC:300 | Sodium Carboxymethyl | 2.50% |
| | CCAS_50-25- | | | | Cellulose MW 300K | |
| | 2-50 | | | LBG | Locust Bean Gum | 0.20% |
| | | | | WATER | Water | 87.30% |
| 139 | AGAR- | Aqueous | Hammer | AGAR | Agarose | 39.37% |
| | CMC:300- | Hydrogel | Milling | CMC:300 | Sodium Carboxymethyl | 19.69% |
| | LBG- | Formation | | | Cellulose MW 300K | |
| | hWPI_50-25-2- | followed by | | hWPI | Hydrolyzed Whey Protein | 39.37% |
| | 50 | Oven Drying | | | Isolate | |
| | | | | LBG | Locust Bean Gum | 1.57% |
| 140 | AGAR- | Aqueous | | AGAR | Agarose | 5.00% |
| | CMC:300- | Hydrogel | | CMC:300 | Sodium Carboxymethyl | 3.00% |
| | LBG- | Formation | | | Cellulose MW 300K | |
| | INLN_50-30-2- | | | INLN | Inulin | 5.00% |
| | 50 | | | LBG | Locust Bean Gum | 0.20% |
| | | | | WATER | Water | 86.80% |
| | | Aqueous | Hammer | AGAR | Agarose | 37.88% |
| | | Hydrogel | Milling | CMC:300 | Sodium Carboxymethyl | 22.73% |
| | | Formation | | | Cellulose MW 300K | |
| | | followed by | | INLN | Inulin | 37.88% |
| | | Oven Drying | | LBG | Locust Bean Gum | 1.52% |
| 141 | AGAR- | Aqueous | | AGAR | Agarose | 3.00% |
| | CSCRM-LBG- | Hydrogel | | CCAS | Calcium Caseinate | 5.00% |
| | CCAS_30-5-3- | Formation | | CSCRM | Croscarmellose | 0.50% |
| | 50 | | | LBG | Locust Bean Gum | 0.30% |
| | | | | WATER | Water | 91.20% |
| | | Aqueous | Hammer | AGAR | Agarose | 34.09% |
| | | Hydrogel | Milling | CCAS | Calcium Caseinate | 56.82% |
| | | Formation | | CSCRM | Croscarmellose | 5.68% |
| | | followed by | | LBG | Locust Bean Gum | 3.41% |
| | | Oven Drying | | | | |
| 142 | AGAR- | Aqueous | Hammer | AGAR | Agarose | 39.37% |
| | CSCRM-LBG- | Hydrogel | Milling | CSCRM | Croscarmellose | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 143 | AGAR- | Aqueous | | AGAR | Agarose | 3.00% |
| | CSCRM-WPI- | Hydrogel | | CSCRM | Croscarmellose | 0.10% |
| | GLC_30-1- | Formation | | GLC | Glucose | 20.00% |
| | 100-200 | | | WATER | Water | 66.90% |
| | | | | WPI | Whey Protein Isolate | 10.00% |
| 144 | AGAR- | Aqueous | | AGAR | Agarose | 3.00% |
| | CSCRM-WPI- | Hydrogel | | CSCRM | Croscarmellosc | 1.00% |
| | GLC_30-10- | Formation | | GLC | Glucose | 20.00% |
| | 100-200 | | | WATER | Water | 66.00% |
| | | | | WPI | Whey Protein Isolate | 10.00% |
| 145 | AGAR-CURD- | Aqueous | | AGAR | Agarose | 5.00% |
| | LBG- | Hydrogel | | CURD | Curdlan | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 146 | AGAR-CURD- | Aqueous | | AGAR | Agarose | 5.00% |
| | LBG- | Hydrogel | | CURD | Curdlan | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | CURD | Curdlan | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 147 | AGAR-CURD- | Aqueous | Hammer | AGAR | Agarose | 47.62% |
| | LBG- | Hydrogel | Milling | CURD | Curdlan | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 148 | AGAR- | Aqueous | | AGAR | Agarose | 5.00% |
| | DOCST-LBG- | Hydrogel | | DOCST | Docusate Sodium | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 149 | AGAR- | Aqueous | | AGAR | Agarose | 5.00% |
| | DOCST-LBG- | Hydrogel | | DOCST | Docusate Sodium | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | DOCST | Docusate Sodium | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 150 | AGAR- | Aqueous | | AGAR | Agarose | 5.00% |
| | DOCST-LBG- | Hydrogel | | DOCST | Docusate Sodium | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| 151 | AGAR-EPO- | Aqueous | Hammer | AGAR | Agarose | 48.54% |
| | LBG- | Hydrogel | Milling | CCAS | Calcium Caseinate | 48.54% |
| | CCAS_50-1-2- | Formation | | EPO | Eudragit EPO | 0.97% |
| | 50 | followed by | | LBG | Locust Bean Gum | 1.94% |
| | | Oven Drying | | | | |
| 152 | AGAR-EPO- | Aqueous | Hammer | AGAR | Agarose | 46.73% |
| | LBG- | Hydrogel | Milling | CCAS | Calcium Caseinate | 46.73% |
| | CCAS_50-5-2- | Formation | | EPO | Eudragit EPO | 4.67% |
| | 50 | followed by | | LBG | Locust Bean Gum | 1.87% |
| | | Oven Drying | | | | |
| 153 | AGAR-EPO- | Aqueous | | AGAR | Agarose | 5.00% |
| | LBG- | Hydrogel | | EPO | Eudragit EPO | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 154 | AGAR-EPO- | Aqueous | | AGAR | Agarose | 5.00% |
| | LBG- | Hydrogel | | EPO | Eudragit EPO | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | EPO | Eudragit EPO | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 155 | AGAR-EPO- | Aqueous | Hammer | AGAR | Agarose | 47.62% |
| | LBG- | Hydrogel | Milling | EPO | Eudragit EPO | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 156 | AGAR-EPO- | Aqueous | | AGAR | Agarose | 3.00% |
| | WPI_30-1-100 | Hydrogel | | EPO | Eudragit EPO | 0.10% |
| | | Formation | | WATER | Water | 86.90% |
| | | | | WPI | Whey Protein Isolate | 10.00% |
| 157 | AGAR-EPO- | Aqueous | | AGAR | Agarose | 3.00% |
| | WPI_30-10- | Hydrogel | | EPO | Eudragit EPO | 1.00% |
| | 100 | Formation | | WATER | Water | 86.00% |
| | | | | WPI | Whey Protein Isolate | 10.00% |
| 158 | AGAR-EPO- | Aqueous | | AGAR | Agarose | 3.00% |
| | WPI_30-100- | Hydrogel | | EPO | Eudragit EPO | 10.00% |
| | 100 | Formation | | WATER | Water | 77.00% |
| | | | | WPI | Whey Protein Isolate | 10.00% |
| 159 | AGAR-EPO- | Aqueous | | AGAR | Agarosc | 3.00% |
| | WPI-GLC_30- | Hydrogel | | EPO | Eudragit EPO | 0.10% |
| | 1-100-100 | Formation | | GLC | Glucose | 10.00% |
| | | | | WATER | Water | 76.90% |
| | | | | WPI | Whey Protein Isolate | 10.00% |
| 160 | AGAR- | Aqueous | | AGAR | Agarose | 3.00% |
| | ETGALT-WPI- | Hydrogel | | ETGALT | Ethyl Gallate | 0.10% |
| | GLC_30-1- | Formation | | GLC | Glucose | 10.00% |
| | 100-100 | | | WATER | Water | 76.90% |
| | | | | WPI | Whey Protein Isolate | 10.00% |
| 161 | AGAR-F127- | Aqueous | | AGAR | Agarose | 5.00% |
| | LBG- | Hydrogel | | F127 | Pluronic F127, Poloxamer 407 | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 162 | AGAR-F127- | Aqueous | | AGAR | Agarose | 5.00% |
| | LBG- | Hydrogel | | F127 | Pluronic F127, Poloxamer 407 | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | F127 | Pluronic F127, Poloxamer 407 | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 163 | AGAR-F127- | Aqueous | Hammer | AGAR | Agarose | 47.62% |
| | LBG- | Hydrogel | Milling | F127 | Pluronic F127, Poloxamer 407 | 2.86% |
| | INLN_50-3-2- | Formation | | INLN | Inulin | 47.62% |
| | 50 | followed by | | LBG | Locust Bean Gum | 1.90% |
| | | Oven Drying | | | | |
| 164 | AGAR-FRUC- | Aqueous | | AGAR | Agarose | 5.00% |
| | WPI_50-200- | Hydrogel | | FRUC | Fructose | 20.00% |
| | 100 | Formation | | WATER | Water | 65.00% |
| | | | | WPI | Whey Protein Isolate | 10.00% |
| 165 | AGAR-G4414- | Aqueous | Hammer | AGAR | Agarosc | 46.73% |
| | LBG- | Hydrogel | Milling | CCAS | Calcium Caseinate | 46.73% |
| | CCAS_50-5-2- | Formation | | G4414 | Gelucire 44/14 | 4.67% |
| | 50 | followed by | | LBG | Locust Bean Gum | 1.87% |
| | | Oven Drying | | | | |
| 166 | AGAR-G4414- | Aqueous | | AGAR | Agarose | 5.00% |
| | LBG- | Hydrogel | | CCAS | Calcium Caseinate | 5.00% |
| | CCAS_50-50- | Formation | | G4414 | Gelucire 44/14 | 5.00% |
| | 2-50 | | | LBG | Locust Bean Gum | 0.20% |
| | | | | WATER | Water | 84.80% |
| | | Aqueous | Hammer | AGAR | Agarose | 32.89% |
| | | Hydrogel | Milling | CCAS | Calcium Caseinate | 32.89% |
| | | Formation | | G4414 | Gelucire 44/14 | 32.89% |
| | | followed by | | LBG | Locust Bean Gum | 1.32% |
| | | Oven Drying | | | | |
| 167 | AGAR-G4414- | Aqueous | | AGAR | Agarose | 5.00% |
| | LBG- | Hydrogel | | G4414 | Gelucire 44/14 | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 168 | AGAR-G4414- | Aqueous | | AGAR | Agarose | 5.00% |
| | LBG- | Hydrogel | | G4414 | Gelucire 44/14 | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | G4414 | Gelucire 44/14 | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 169 | AGAR-G4414- | Aqueous | | AGAR | Agarose | 5.00% |
| | LBG- | Hydrogel | | G4414 | Gelucire 44/14 | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| 170 | AGAR-G4414- | Aqueous | | AGAR | Agarose | 3.00% |
| | WPI-GLC_30- | Hydrogel | | G4414 | Gelucire 44/14 | 0.10% |
| | 1-100-100 | Formation | | GLC | Glucose | 10.00% |
| | | | | WATER | Water | 76.90% |
| | | | | WPI | Whey Protein Isolate | 10.00% |
| 171 | AGAR-G4414- | Aqueous | | AGAR | Agarose | 3.00% |
| | WPI-GLC_30- | Hydrogel | | G4414 | Gelucire 44/14 | 1.00% |
| | 10-100-100 | Formation | | GLC | Glucose | 10.00% |
| | | | | WATER | Water | 76.00% |
| | | | | WPI | Whey Protein Isolate | 10.00% |
| 172 | AGAR-G5013- | Aqueous | | AGAR | Agarose | 5.00% |
| | LBG- | Hydrogel | | G5013 | Gelucire 50/13 | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 173 | AGAR-G5013- | Aqueous | | AGAR | Agarose | 5.00% |
| | LBG- | Hydrogel | | G5013 | Gelucire 50/13 | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| 174 | AGAR-G5013- | Aqueous | | AGAR | Agarose | 3.00% |
| | WPI-GLC_30- | Hydrogel | | G5013 | Gelucirc 50/13 | 0.50% |
| | 5-100-200 | Formation | | GLC | Glucose | 20.00% |
| | | | | WATER | Water | 66.50% |
| | | | | WPI | Whey Protein Isolate | 10.00% |
| 175 | AGAR-G5013- | Aqueous | | AGAR | Agarose | 3.00% |
| | WPI-GLC_30- | Hydrogel | | G5013 | Gelucire 50/13 | 5.00% |
| | 50-100-200 | Formation | | GLC | Glucose | 20.00% |
| | | | | WATER | Water | 62.00% |
| | | | | WPI | Whey Protein Isolate | 10.00% |
| 176 | AGAR-G5914- | Aqueous | | AGAR | Agarose | 3.00% |
| | WPI-GLC_30- | Hydrogel | | G5914 | Gelucire 59/14 | 0.50% |
| | 5-100-200 | Formation | | GLC | Glucose | 20.00% |
| | | | | WATER | Water | 66.50% |
| | | | | WPI | Whey Protein Isolate | 10.00% |
| 177 | AGAR-G5914- | Aqueous | | AGAR | Agarose | 3.00% |
| | WPI-GLC_30- | Hydrogel | | G5914 | Gelucire 59/14 | 5.00% |
| | 50-100-200 | Formation | | GLC | Glucose | 20.00% |
| | | | | WATER | Water | 62.00% |
| | | | | WPI | Whey Protein Isolate | 10.00% |
| 178 | AGAR-GA- | Aqueous | | AGAR | Agarose | 5.00% |
| | LBG- | Hydrogel | | GA | Gallic Acid | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 179 | AGAR-GA- | Aqueous | | AGAR | Agarose | 5.00% |
| | LBG- | Hydrogel | | GA | Gallic Acid | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| 180 | AGAR- | Aqueous | Hammer | AGAR | Agarose | 39.37% |
| | GARAB-LBG- | Hydrogel | Milling | GARAB | Gum Arabic, Arabic Gum, | 19.69% |
| | hWPI_50-25-2- | Formation | | | Acacia Gum | |
| | 50 | followed by | | hWPI | Hydrolyzed Whey Protein | 39.37% |
| | | Oven Drying | | | Isolate | |
| | | | | LBG | Locust Bean Gum | 1.57% |
| 181 | AGAR- | Aqueous | | AGAR | Agarose | 5.00% |
| | GARAB-LBG- | Hydrogel | | GARAB | Gum Arabic, Arabic Gum, | 0.30% |
| | INLN_50-3-2- | Formation | | | Acacia Gum | |
| | 50 | | | INLN | Inulin | 5.00% |
| | | | | LBG | Locust Bean Gum | 0.20% |
| | | | | WATER | Water | 89.50% |
| 182 | AGAR-GCD- | Aqueous | Hammer | AGAR | Agarose | 46.73% |
| | LBG- | Hydrogel | Milling | CCAS | Calcium Caseinate | 46.73% |
| | CCAS_50-5-2- | Formation | | GCD | Gamma Cyclodextrin | 4.67% |
| | 50 | followed by | | LBG | Locust Bean Gum | 1.87% |
| | | Oven Drying | | | | |
| 183 | AGAR-GCD- | Aqueous | Hammer | AGAR | Agarose | 32.89% |
| | LBG- | Hydrogel | Milling | CCAS | Calcium Caseinate | 32.89% |
| | CCAS_50-50- | Formation | | GCD | Gamma Cyclodextrin | 32.89% |
| | 2-50 | followed by | | LBG | Locust Bean Gum | 1.32% |
| | | Oven Drying | | | | |
| 184 | AGAR-GCD- | Aqueous | | AGAR | Agarose | 5.00% |
| | LBG- | Hydrogel | | GCD | Gamma Cyclodextrin | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 185 | AGAR-GCD- | Aqueous | | AGAR | Agarose | 5.00% |
| | LBG- | Hydrogel | | GCD | Gamma Cyclodextrin | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | GCD | Gamma Cyclodextrin | 19.69% |
| | | Formation | | hWPI | Hydrolyzed Whey Protein | 39.37% |
| | | followed by | | | Isolate | |
| | | Oven Drying | | LBG | Locust Bean Gum | |
| 186 | AGAR- | Aqueous | | AGAR | Agarose | 5.00% |
| | GELLG-LBG- | Hydrogel | | GELLG | Gellan Gum | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 187 | AGAR- | Aqueous | Hammer | AGAR | Agarose | 39.37% |
| | GELLG-LBG- | Hydrogel | Milling | GELLG | Gellan Gum | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 188 | AGAR- | Aqueous | | AGAR | Agarose | 5.00% |
| | GELLG-LBG- | Hydrogel | | GELLG | Gellan Gum | 3.00% |
| | INLN_50-30-2- | Formation | | INLN | Inulin | 5.00% |
| | 50 | | | LBG | Locust Bean Gum | 0.20% |
| | | | | WATER | Water | 86.80% |
| | | Aqueous | Hammer | AGAR | Agarose | 37.88% |
| | | Hydrogel | Milling | GELLG | Gellan Gum | 22.73% |
| | | Formation | | INLN | Inulin | 37.88% |
| | | followed by | | LBG | Locust Bean Gum | 1.52% |
| | | Oven Drying | | | | |
| 189 | AGAR- | Aqueous | | AGAR | Agarose | 3.00% |
| | GELLG-WPI- | Hydrogel | | GELLG | Gellan Gum | 0.10% |
| | GLC_30-1- | Formation | | GLC | Glucose | 10.00% |
| | 100-100 | | | WATER | Water | 76.90% |
| | | | | WPI | Whey Protein Isolate | 10.00% |
| 190 | AGAR- | Aqueous | | AGAR | Agarose | 3.00% |
| | GELLG-WPI- | Hydrogel | | GELLG | Gellan Gum | 1.00% |
| | GLC_30-10- | Formation | | GLC | Glucose | 10.00% |
| | 100-100 | | | WATER | Water | 76.00% |
| | | | | WPI | Whey Protein Isolate | 10.00% |
| 191 | AGAR- | Aqueous | | AGAR | Agarose | 5.00% |
| | GHATG-LBG- | Hydrogel | | CCAS | Calcium Caseinate | 5.00% |
| | CCAS_50-25- | Formation | | GHATG | Ghatti Gum | 2.50% |
| | 2-50 | | | LBG | Locust Bean Gum | 0.20% |
| | | | | WATER | Water | 87.30% |
| 192 | AGAR- | Aqueous | | AGAR | Agarose | 5.00% |
| | GHATG-LBG- | Hydrogel | | GHATG | Ghatti Gum | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 193 | AGAR- | Aqueous | | AGAR | Agarose | 5.00% |
| | GHATG-LBG- | Hydrogel | | GHATG | Ghatti Gum | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| | | Aqueous | Hammer | AGAR | Agarose | 47.62% |
| | | Hydrogel | Milling | GHATG | Ghatti Gum | 2.86% |
| | | Formation | | INLN | Inulin | 47.62% |
| | | followed by | | LBG | Locust Bean Gum | 1.90% |
| | | Oven Drying | | | | |
| 194 | AGAR- | Aqueous | | AGAR | Agarose | 3.00% |
| | GHATG-WPI- | Hydrogel | | GHATG | Ghatti Gum | 0.10% |
| | GLC_30-1- | Formation | | GLC | Glucose | 10.00% |
| | 100-100 | | | WATER | Water | 76.90% |
| | | | | WPI | Whey Protein Isolate | 10.00% |
| 195 | AGAR- | Aqueous | | AGAR | Agarose | 3.00% |
| | GHATG-WPI- | Hydrogel | | GHATG | Ghatti Gum | 1.00% |
| | GLC_30-10- | Formation | | GLC | Glucose | 10.00% |
| | 100-100 | | | WATER | Water | 76.00% |
| | | | | WPI | Whey Protein Isolate | 10.00% |
| 196 | AGAR- | Aqueous | | AGAR | Agarose | 3.00% |
| | GHATG-WPI- | Hydrogel | | GHATG | Ghatti Gum | 1.00% |
| | GLC_30-10- | Formation | | GLC | Glucose | 10.00% |
| | 100-100; CT- | | | WATER | Water | 76.00% |
| | MC-GY_9-23- | | | WPI | Whey Protein Isolate | 10.00% |
| | 63 | | | | | |
| 197 | AGAR- | Aqueous | | AGAR | Agarose | 3.00% |
| | GHATG-WPI- | Hydrogel | | GHATG | Ghatti Gum | 1.00% |
| | GLC_30-10- | Formation | | GLC | Glucose | 10.00% |
| | 100-100; CT- | | | WATER | Water | 76.00% |
| | MC-PEG_9- | | | WPI | Whey Protein Isolate | 10.00% |
| | 23-63 | | | | | |
| 198 | AGAR- | Aqueous | | AGAR | Agarose | 3.00% |
| | GHATG-WPI- | Hydrogel | | GHATG | Ghatti Gum | 1.00% |
| | GLC_30-10- | Formation | | GLC | Glucose | 10.00% |
| | 100- | | | WATER | Water | 76.00% |
| | 100; PVAC-PG- | | | WPI | Whey Protein Isolate | 10.00% |
| | SA_40-40-20 | | | | | |
| 199 | AGAR- | Aqueous | | AGAR | Agarose | 3.00% |
| | GHATG-WPI- | Hydrogel | | GHATG | Ghatti Gum | 1.00% |
| | GLC_30-10- | Formation | | GLC | Glucose | 10.00% |
| | 100- | | | WATER | Water | 76.00% |
| | 100; PVAC-PG- | | | WPI | Whey Protein Isolate | 10.00% |
| | SA_44-44-12 | | | | | |
| 200 | AGAR- | Aqueous | Hammer | AGAR | Agarose | 39.37% |
| | GLUCS-LBG- | Hydrogel | Milling | GLUCS | Glucosamine Sulfate | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 201 | AGAR- | Aqueous | | AGAR | Agarose | 5.00% |
| | GLYCN-LBG- | Hydrogel | | CCAS | Calcium Caseinate | 5.00% |
| | CCAS_50-25- | Formation | | GLYCN | Glycine | 2.50% |
| | 2-50 | | | LBG | Locust Bean Gum | 0.20% |
| | | | | WATER | Water | 87.30% |
| 202 | AGAR- | Aqueous | | AGAR | Agarose | 5.00% |
| | GLYCN-LBG- | Hydrogel | | GLYCN | Glycine | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 203 | AGAR- | Aqueous | | AGAR | Agarose | 5.00% |
| | GLYCN-LBG- | Hydrogel | | GLYCN | Glycine | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | GLYCN | Glycine | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 204 | AGAR- | Aqueous | | AGAR | Agarose | 5.00% |
| | GLYCN-LBG- | Hydrogel | | GLYCN | Glycine | 0.30% |
| | INLN_50-3-2- | Formation | | NLN | Inulin | 5.00% |
| | 50 | | | LBG | Locust Bean Gum | 0.20% |
| | | | | WATER | Water | 89.50% |
| 205 | AGAR- | Aqueous | | AGAR | Agarose | 5.00% |
| | GRRHA-LBG- | Hydrogel | | GRRHA | Glycyrrhitic acid | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 206 | AGAR- | Aqueous | | AGAR | Agarose | 5.00% |
| | GRRHA-LBG- | Hydrogel | | GRRHA | Glycyrrhitic acid | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | GRRHA | Glycyrrhitic acid | 19.69% |
| | | Formation | | hWPI | Hydrolyzed Whey Protein | 39.37% |
| | | followed by | | | Isolate | |
| | | Oven Drying | | LBG | Locust Bean Gum | 1.57% |
| 207 | AGAR- | Aqueous | | AGAR | Agarose | 5.00% |
| | GRRHA-LBG- | Hydrogel | | GRRHA | Glycyrrhitic acid | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| 208 | AGAR- | Aqueous | | AGAR | Agarose | 3.00% |
| | GRRHA-WPI- | Hydrogel | | GLC | Glucose | 20.00% |
| | GLC_30-1- | Formation | | GRRHA | Glycyrrhitic acid | 0.10% |
| | 100-200 | | | WATER | Water | 66.90% |
| | | | | WPI | Whey Protein Isolate | 10.00% |
| 209 | AGAR- | Aqueous | | AGAR | Agarose | 3.00% |
| | GRRHA-WPI- | Hydrogel | | GLC | Glucose | 20.00% |
| | GLC_30-10- | Formation | | GRRHA | Glycyrrhitic acid | 1.00% |
| | 100-200 | | | WATER | Water | 66.00% |
| | | | | WPI | Whey Protein Isolate | 10.00% |
| 210 | AGAR- | Aqueous | | AGAR | Agarose | 5.00% |
| | GRRHZ-LBG- | Hydrogel | | GRRHZ | Dipotassium glycyrrhizinate | 0.30% |
| | hWPI_50-3-2- | Formation | | | hydrate | |
| | 50 | | | hWPI | Hydrolyzed Whey Protein | 5.00% |
| | | | | | Isolate | |
| | | | | LBG | Locust Bean Gum | 0.20% |
| | | | | WATER | Water | 89.50% |
| 211 | AGAR- | Aqueous | | AGAR | Agarose | 5.00% |
| | GRRHZ-LBG- | Hydrogel | | GRRHZ | Dipotassium glycyrrhizinate | 2.50% |
| | hWPI_50-25-2- | Formation | | | hydrate | |
| | 50 | | | hWPI | Hydrolyzed Whey Protein | 5.00% |
| | | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | GRRHZ | Dipotassium glycyrrhizinate | 19.69% |
| | | Formation | | | hydrate | |
| | | followed by | | hWPI | Hydrolyzed Whey Protein | 39.37% |
| | | Oven Drying | | | Isolate | |
| | | | | LBG | Locust Bean Gum | 1.57% |
| 212 | AGAR- | Aqueous | Hammer | AGAR | Agarose | 47.62% |
| | GRRHZ-LBG- | Hydrogel | Milling | GRRHZ | Dipotassium glycyrrhizinate | 2.86% |
| | INLN_50-3-2- | Formation | | | hydrate | |
| | 50 | followed by | | INLN | Inulin | 47.62% |
| | | Oven Drying | | LBG | Locust Bean Gum | 1.90% |
| 213 | AGAR- | Aqueous | Hammer | AGAR | Agarose | 39.37% |
| | HAP:5U- | Hydrogel | Milling | CHILO | Chitosan Low Molecular | 9.84% |
| | CHILO-LBG- | Formation | | | Weight | |
| | hWPI_50-12.5- | followed by | | HAP:5U | Hydroxyapatite 5 um | 9.84% |
| | 12.5-2-50 | Oven Drying | | hWPI | Hydrolyzed Whey Protein | 39.37% |
| | | | | | Isolate | |
| | | | | LBG | Locust Bean Gum | 1.57% |
| 214 | AGAR- | Aqueous | | AGAR | Agarose | 3.00% |
| | HAP:5U- | Hydrogel | | GHATG | Ghatti Gum | 0.30% |
| | GHATG-WPI- | Formation | | GLC | Glucose | 20.00% |
| | GLC_30-1-3- | | | HAP:5U | Hydroxyapatite 5 um | 0.10% |
| | 100-200 | | | WATER | Water | 66.60% |
| | | | | WPI | Whey Protein Isolate | 10.00% |
| 215 | AGAR- | Aqueous | | AGAR | Agarose | 3.00% |
| | HAP:5U- | Hydrogel | | GHATG | Ghatti Gum | 0.30% |
| | GHATG-WPI- | Formation | | GLC | Glucose | 20.00% |
| | GLC_30-10-3- | | | HAP:5U | Hydroxyapatite 5 um | 1.00% |
| | 100-200 | | | WATER | Water | 65.70% |
| | | | | WPI | Whey Protein Isolate | 10.00% |
| 216 | AGAR- | Aqueous | Hammer | AGAR | Agarose | 39.37% |
| | HAP:5U- | Hydrogel | Milling | HAP:5U | Hydroxyapatite 5 um | 9.84% |
| | KARG-LBG- | Formation | | hWPI | Hydrolyzed Whey Protein | 39.37% |
| | hWPI_50-12.5- | followed by | | | Isolate | |
| | 12.5-2-50 | Oven Drying | | KARG | Karaya Gum | 9.84% |
| | | | | LBG | Locust Bean Gum | 1.57% |
| 217 | AGAR- | Aqueous | Hammer | AGAR | Agarose | 46.73% |
| | HAP:5U-LBG- | Hydrogel | Milling | CCAS | Calcium Caseinate | 46.73% |
| | CCAS_50-5-2- | Formation | | HAP:5U | Hydroxyapatite 5 um | 4.67% |
| | 50 | followed by | | LBG | Locust Bean Gum | 1.87% |
| | | Oven Drying | | | | |
| 218 | AGAR- | Aqueous | | AGAR | Agarose | 5.00% |
| | HAP:5U-LBG- | Hydrogel | | CCAS | Calcium Caseinate | 5.00% |
| | CCAS_50-50- | Formation | | HAP:5U | Hydroxyapatite 5 um | 5.00% |
| | 2-50 | | | LBG | Locust Bean Gum | 0.20% |
| | | | | WATER | Water | 84.80% |
| | | Aqueous | Hammer | AGAR | Agarose | 32.89% |
| | | Hydrogel | Milling | CCAS | Calcium Caseinate | 32.89% |
| | | Formation | | HAP:5U | Hydroxyapatite 5 um | 32.89% |
| | | followed by | | LBG | Locust Bean Gum | 1.32% |
| | | Oven Drying | | | | |
| 219 | AGAR- | Aqueous | | AGAR | Agarose | 5.00% |
| | HAP:5U-LBG- | Hydrogel | | CHILO | Chitosan Low Molecular | 0.15% |
| | CHILO- | Formation | | | Weight | |
| | hWPI_50-1.5- | | | HAP:5U | Hydroxyapatite 5 um | 0.15% |
| | 2-1.5-50 | | | hWPI | Hydrolyzed Whey Protein | 5.00% |
| | | | | | Isolate | |
| | | | | LBG | Locust Bean Gum | 0.20% |
| | | | | WATER | Water | 89.50% |
| 220 | AGAR- | Aqueous | | AGAR | Agarose | 5.00% |
| | HAP:5U-LBG- | Hydrogel | | CHILO | Chitosan Low Molecular | 1.25% |
| | CHILO- | Formation | | | Weight | |
| | hWPI_50-12.5- | | | HAP:5U | Hydroxyapatite 5 um | 1.25% |
| | 2-12.5-50 | | | hWPI | Hydrolyzed Whey Protein | 5.00% |
| | | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | CHILO | Chitosan Low Molecular | 9.84% |
| | | Formation | | | Weight | |
| | | followed by | | HAP:5U | Hydroxyapatite 5 um | 9.84% |
| | | Oven Drying | | hWPI | Hydrolyzed Whey Protein | 39.37% |
| | | | | | Isolate | |
| | | | | LBG | Locust Bean Gum | 1.57% |
| 221 | AGAR- | Aqueous | | AGAR | Agarose | 5.00% |
| | HAP:5U-LBG- | Hydrogel | | HAP:5U | Hydroxyapatite 5 um | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 222 | AGAR- | Aqueous | | AGAR | Agarose | 5.00% |
| | HAP:5U-LBG- | Hydrogel | | HAP:5U | Hydroxyapatite 5 um | 2.50% |
| | hWPI_50-25-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| 223 | AGAR- | Aqueous | | AGAR | Agarose | 5.00% |
| | HAP:5U-LBG- | Hydrogel | | HAP:5U | Hydroxyapatite 5 um | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| | | Aqueous | Hammer | AGAR | Agarose | 47.62% |
| | | Hydrogel | Milling | HAP:5U | Hydroxyapatite 5 um | 2.86% |
| | | Formation | | INLN | Inulin | 47.62% |
| | | followed by | | LBG | Locust Bean Gum | 1.90% |
| | | Oven Drying | | | | |
| 224 | AGAR- | Aqueous | | AGAR | Agarose | 5.00% |
| | HAP:5U-LBG- | Hydrogel | | HAP:5U | Hydroxyapatite 5 um | 0.15% |
| | MGSO- | Formation | | hWPI | Hydrolyzed Whey Protein | 5.00% |
| | hWPI_50-1.5- | | | | Isolate | |
| | 2-1.5-50 | | | LBG | Locust Bean Gum | 0.20% |
| | | | | MGSO | Magnesium Sulfate | 0.15% |
| | | | | WATER | Water | 89.50% |
| 225 | AGAR- | Aqueous | | AGAR | Agarose | 5.00% |
| | HAP:5U-LBG- | Formation | | HAP:5U | Hydroxyapatite 5 um | 1.25% |
| | MGSO- | Hydrogel | | hWPI | Hydrolyzed Whey Protein | 5.00% |
| | hWPI_50-12.5- | | | | Isolate | |
| | 2-12.5-50 | | | LBG | Locust Bean Gum | 0.20% |
| | | | | MGSO | Magnesium Sulfate | 1.25% |
| | | | | WATER | Water | 87.30% |
| 226 | AGAR- | Aqueous | | AGAR | Agarose | 5.00% |
| | HAP:5U-LBG- | Hydrogel | | HAP:5U | Hydroxyapatite 5 um | 1.25% |
| | SUCC- | Formation | | hWPI | Hydrolyzed Whey Protein | 5.00% |
| | hWPI_50-12.5- | | | | Isolate | |
| | 2-12.5-50 | | | LBG | Locust Bean Gum | 0.20% |
| | | | | SUCC | Succinic Acid | 1.25% |
| | | | | WATER | Water | 87.30% |
| | | Aqueous | Hammer | AGAR | Agarose | 39.37% |
| | | Hydrogel | Milling | HAP:5U | Hydroxyapatite 5 um | 9.84% |
| | | Formation | | hWPI | Hydrolyzed Whey Protein | 39.37% |
| | | followed by | | | Isolate | |
| | | Oven Drying | | LBG | Locust Bean Gum | 1.57% |
| | | | | SUCC | Succinic Acid | 9.84% |
| 227 | AGAR- | Aqueous | Hammer | AGAR | Agarose | 39.37% |
| | HAP:5U- | Hydrogel | Milling | HAP:5U | Hydroxyapatite 5 um | 9.84% |
| | PEG:200-LBG- | Formation | | hWPI | Hydrolyzed Whey Protein | 39.37% |
| | hWPI_50-12.5- | followed by | | | Isolate | |
| | 12.5-2-50 | Oven Drying | | LBG | Locust Bean Gum | 1.57% |
| | | | | PEG:200 | Polyethylene Glycol 200 Da | 9.84% |
| 228 | AGAR- | Aqueous | | AGAR | Agarose | 3.00% |
| | HAP:5U- | Hydrogel | | HAP:5U | Hydroxyapatite 5 um | 1.00% |
| | WPI_30-10- | Formation | | WATER | Water | 86.00% |
| | 100 | | | WPI | Whey Protein Isolate | 10.00% |
| 229 | AGAR- | Aqueous | | AGAR | Agarose | 3.00% |
| | HAP:5U- | Hydrogel | | HAP:5U | Hydroxyapatite 5 um | 3.00% |
| | WPI_30-30- | Formation | | WATER | Water | 84.00% |
| | 100 | | | WPI | Whey Protein Isolate | 10.00% |
| 230 | AGAR- | Aqueous | | AGAR | Agarose | 3.00% |
| | HAP:5U- | Hydrogel | | HAP:5U | Hydroxyapatite 5 um | 10.00% |
| | WPI_30-100- | Formation | | WATER | Water | 77.00% |
| | 100 | | | WPI | Whey Protein Isolate | 10.00% |
| 231 | AGAR- | Aqueous | Hammer | AGAR | Agarose | 39.37% |
| | HAP:10U- | Hydrogel | Milling | HAP:10U | Hydroxyapatite 10 um | 19.69% |
| | LBG- | Formation | | hWPI | Hydrolyzed Whey Protein | 39.37% |
| | hWPI_50-25-2- | followed by | | | Isolate | |
| | 50 | Oven Drying | | LBG | Locust Bean Gum | 1.57% |
| 232 | AGAR- | Aqueous | Hammer | AGAR | Agarose | 39.37% |
| | HAP:200N- | Hydrogel | Milling | HAP:200N | Hydroxyapatite 200 nm | 19.69% |
| | LBG- | Formation | | hWPI | Hydrolyzed Whey Protein | 39.37% |
| | hWPI_50-25-2- | followed by | | | Isolate | |
| | 50 | Oven Drying | | LBG | Locust Bean Gum | 1.57% |
| 233 | AGAR-HEC- | Aqueous | Hammer | AGAR | Agarose | 39.37% |
| | LBG- | Hydrogel | Milling | HEC | Hydroxyethyl Cellulose | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 234 | AGAR- | Aqueous | | AGAR | Agarose | 5.00% |
| | HPBCD-LBG- | Hydrogel | | HPBCD | Hydroxypropyl-β-cyclodextrin | 0.30% |
| | hWPI_50-3-2- | Formation | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 235 | AGAR- | Aqueous | Hammer | AGAR | Agarose | 39.37% |
| | HPBCD-LBG- | Hydrogel | Milling | HPBCD | Hydroxypropyl-β-cyclodextrin | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 236 | AGAR- | Aqueous | | AGAR | Agarose | 5.00% |
| | HPBCD-LBG- | Hydrogel | | HPBCD | Hydroxypropyl-β-cyclodextrin | 0.30% |
| | INLN_50-3-2- | Formation | | INLN | Inulin | 5.00% |
| | 50 | | | LBG | Locust Bean Gum | 0.20% |
| | | | | WATER | Water | 89.50% |
| | | Aqueous | Hammer | AGAR | Agarose | 47.62% |
| | | Hydrogel | Milling | HPBCD | Hydroxypropyl-β-cyclodextrin | 2.86% |
| | | Formation | | INLN | Inulin | 47.62% |
| | | followed by | | LBG | Locust Bean Gum | 1.90% |
| | | Oven Drying | | | | |
| 237 | AGAR-HPC- | Aqueous | Hammer | AGAR | Agarose | 39.37% |
| | LBG- | Hydrogel | Milling | HPC | Hydroxypropyl Cellulose | 19.69% |
| | hWPI_50-25-2- | Formation | | hWPI | Hydrolyzed Whey Protein | 39.37% |
| | 50 | followed by | | | Isolate | |
| | | Oven Drying | | LBG | Locust Bean Gum | 1.57% |
| 238 | AGAR-HPMC- | Aqueous | Hammer | AGAR | Agarose | 35.09% |
| | LBG- | Hydrogel | Milling | CCAS | Calcium Caseinate | 43.86% |
| | CCAS_40-20- | Formation | | HPMC | Hydroxypropyl methylcellulose | 17.54% |
| | 4-50 | followed by | | | | |
| | | Oven Drying | | LBG | Locust Bean Gum | 3.51% |
| 239 | AGAR-HPMC- | Aqueous | | AGAR | Agarose | 3.00% |
| | WPI-GLC_30- | Hydrogel | | GLC | Glucose | 10.00% |
| | 1-100-100 | Formation | | HPMC | Hydroxypropyl methylcellulose | 0.10% |
| | | | | WATER | Water | 76.90% |
| | | | | WPI | Whey Protein Isolate | 10.00% |
| 240 | AGAR-HPMC- | Aqueous | | AGAR | Agarose | 3.00% |
| | WPI-GLC_30- | Hydrogel | | GLC | Glucose | 10.00% |
| | 10-100-100 | Formation | | HPMC | Hydroxypropyl methylcellulose | 1.00% |
| | | | | WATER | Water | 76.00% |
| | | | | WPI | Whey Protein Isolate | 10.00% |
| 241 | AGAR- | Aqueous | | AGAR | Agarose | 5.00% |
| | HPMC:50- | Hydrogel | | HPMC:50 | Hydroxypropyl methylcellulose | 0.30% |
| | LBG- | Formation | | | 50 cP | |
| | hWPI_50-3-2- | | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 242 | AGAR- | Aqueous | | AGAR | Agarose | 5.00% |
| | HPMC:100- | Hydrogel | | CCAS | Calcium Caseinate | 5.00% |
| | LBG- | Formation | | HPMC:100 | Hydroxypropyl methylcellulose | 2.50% |
| | CCAS_50-25- | | | | 100 cP | |
| | 2-50 | | | LBG | Locust Bean Gum | 0.20% |
| | | | | WATER | Water | 87.30% |
| 243 | AGAR- | Aqueous | | AGAR | Agarose | 5.00% |
| | HPMC:100- | Hydrogel | | HPMC:100 | Hydroxypropyl methylcellulose | 0.30% |
| | LBG- | Formation | | | 100 cP | |
| | hWPI_50-3-2- | | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 244 | AGAR- | Aqueous | | AGAR | Agarose | 5.00% |
| | HPMC:100- | Hydrogel | | HPMC:100 | Hydroxypropyl methylcellulose | 2.50% |
| | LBG- | Formation | | | 100 cP | |
| | hWPI_50-25-2- | | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | HPMC:100 | Hydroxypropyl methylcellulose | 19.69% |
| | | Formation | | | 100 cP | |
| | | followed by | | hWPI | Hydrolyzed Whey Protein | 39.37% |
| | | Oven Drying | | | Isolate | |
| | | | | LBG | Locust Bean Gum | 1.57% |
| 245 | AGAR- | Aqueous | | AGAR | Agarose | 5.00% |
| | HPMC:100- | Hydrogel | | HPMC:100 | Hydroxypropyl methylcellulose | 0.30% |
| | LBG- | Formation | | | 100 cP | |
| | INLN_50-3-2- | | | INLN | Inulin | 5.00% |
| | 50 | | | LBG | Locust Bean Gum | 0.20% |
| | | | | WATER | Water | 89.50% |
| | | Aqueous | Hammer | AGAR | Agarose | 47.62% |
| | | Hydrogel | Milling | HPMC:100 | Hydroxypropyl methylcellulose | 2.86% |
| | | Formation | | | 100 cP | |
| | | followed by | | INLN | Inulin | 47.62% |
| | | Oven Drying | | LBG | Locust Bean Gum | 1.90% |
| 246 | AGAR- | Aqueous | | AGAR | Agarose | 5.00% |
| | ICARR-LBG- | Hydrogel | | CCAS | Calcium Caseinate | 5.00% |
| | CCAS_50-50- | Formation | | ICARR | Iota Carrageenan | 5.00% |
| | 2-50 | | | LBG | Locust Bean Gum | 0.20% |
| | | | | WATER | Water | 84.80% |
| 247 | AGAR- | Aqueous | | AGAR | Agarose | 5.00% |
| | ICARR-LBG- | Hydrogel | | hWPI | Hydrolyzed Whey Protein | 5.00% |
| | hWPI_50-3-2- | Formation | | | Isolate | |
| | 50 | | | ICARR | Iota Carrageenan | 0.30% |
| | | | | LBG | Locust Bean Gum | 0.20% |
| | | | | WATER | Water | 89.50% |
| 248 | AGAR- | Aqueous | | AGAR | Agarose | 5.00% |
| | ICARR-LBG- | Hydrogel | | hWPI | Hydrolyzed Whey Protein | 5.00% |
| | hWPI_50-25-2- | Formation | | | Isolate | |
| | 50 | | | ICARR | Iota Carrageenan | 2.50% |
| | | | | LBG | Locust Bean Gum | 0.20% |
| | | | | WATER | Water | 87.30% |
| 249 | AGAR- | Aqueous | Hammer | AGAR | Agarose | 32.89% |
| | ICARR-LBG- | Hydrogel | Milling | hWPI | Hydrolyzed Whey Protein | 32.89% |
| | hWPI_50-50-2- | Formation | | | Isolate | |
| | 50 | followed by | | ICARR | Iota Carrageenan | 32.89% |
| | | Oven Drying | | LBG | Locust Bean Gum | 1.32% |
| 250 | AGAR- | Aqueous | | AGAR | Agarose | 3.00% |
| | ICARR-WPI- | Hydrogel | | GLC | Glucose | 10.00% |
| | GLC_30-1- | Formation | | ICARR | Iota Carrageenan | 0.10% |
| | 100-100 | | | WATER | Water | 76.90% |
| | | | | WPI | Whey Protein Isolate | 10.00% |
| 251 | AGAR- | Aqueous | | AGAR | Agarose | 3.00% |
| | ICARR-WPI- | Hydrogel | | GLC | Glucose | 10.00% |
| | GLC_30-10- | Formation | | ICARR | Iota Carrageenan | 1.00% |
| | 100-100 | | | WATER | Water | 76.00% |
| | | | | WPI | Whey Protein Isolate | 10.00% |
| 252 | AGAR-IP6- | Aqueous | | AGAR | Agarose | 5.00% |
| | LBG- | Hydrogel | | CCAS | Calcium Caseinate | 5.00% |
| | CCAS_50-50- | Formation | | IP6 | Phytic Acid Hyrdrate | 5.00% |
| | 2-50 | | | LBG | Locust Bean Gum | 0.20% |
| | | | | WATER | Water | 84.80% |
| 253 | AGAR-IP6- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | IP6 | Phytic Acid Hyrdrate | 0.30% |
| | | | | LBG | Locust Bean Gum | 0.20% |
| | | | | WATER | Water | 89.50% |
| 254 | AGAR-IP6- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | IP6 | Phytic Acid Hyrdrate | 2.50% |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | IP6 | Phytic Acid Hyrdrate | 19.69% |
| | | Oven Drying | | LBG | Locust Bean Gum | 1.57% |
| 255 | AGAR-IP6- | Aqueous | Hammer | AGAR | Agarose | 47.62% |
| | LBG- | Hydrogel | Milling | INLN | Inulin | 47.62% |
| | INLN_50-3-2- | Formation | | IP6 | Phytic Acid Hyrdrate | 2.86% |
| | 50 | followed by | | LBG | Locust Bean Gum | 1.90% |
| | | Oven Drying | | | | |
| 256 | AGAR-KARG | Aqueous | | AGAR | Agarose | 34.09% |
| | LBG- | Hydrogel | | CCAS | Calcium Caseinate | 56.82% |
| | CCAS_30-5-3- | Formation | | KARG | Karaya Gum | 5.68% |
| | 50 | followed by | | LBG | Locust Bean Gum | 3.41% |
| | | Oven Drying | | | | |
| 257 | AGAR-KARG- | Aqueous | | AGAR | Agarose | 3.00% |
| | LBG- | Hydrogel | | CCAS | Calcium Caseinate | 5.00% |
| | CCAS_30-50- | Formation | | KARG | Karaya Gum | 5.00% |
| | 3-50 | | | LBG | Locust Bean Gum | 0.30% |
| | | | | WATER | Water | 86.70% |
| | | Aqueous | Hammer | AGAR | Agarose | 22.56% |
| | | Hydrogel | Milling | CCAS | Calcium Caseinate | 37.59% |
| | | Formation | | KARG | Karaya Gum | 37.59% |
| | | followed by | | LBG | Locust Bean Gum | 2.26% |
| | | Oven Drying | | | | |
| 258 | AGAR-KARG- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | KARG | Karaya Gum | 19.69% |
| | | Oven Drying | | LBG | Locust Bean Gum | 1.57% |
| 259 | AGAR-KARG | Aqueous | Hammer | AGAR | Agarose | 39.37% |
| | PEG:200-LBG- | Hydrogel | Milling | hWPI | Hydrolyzed Whey Protein | 39.37% |
| | hWPI_50-12.5- | Formation | | | Isolate | |
| | 12.5-2-50 | followed by | | KARG | Karaya Gum | 9.84% |
| | | Oven Drying | | LBG | Locust Bean Gum | 1.57% |
| | | | | PEG:200 | Polyethylene Glycol 200 Da | 9.84% |
| 260 | AGAR-KARG- | Aqueous | | AGAR | Agarose | 5.00% |
| | WPI_50-10- | Hydrogel | | KARG | Karaya Gum | 1.00% |
| | 100 | Formation | | WATER | Water | 84.00% |
| | | | | WPI | Whey Protein Isolate | 10.00% |
| 261 | AGAR-KARG- | Aqueous | | AGAR | Agarose | 3.00% |
| | WPI-GLC_30- | Hydrogel | | GLC | Glucose | 10.00% |
| | 1-100-100 | Formation | | KARG | Karaya Gum | 0.10% |
| | | | | WATER | Water | 76.90% |
| | | | | WPI | Whey Protein Isolate | 10.00% |
| 262 | AGAR-KARG- | Aqueous | | AGAR | Agarose | 3.00% |
| | WPI-GLC_30- | Hydrogel | | GLC | Glucose | 10.00% |
| | 10-100-100 | Formation | | KARG | Karaya Gum | 1.00% |
| | | | | WATER | Water | 76.00% |
| | | | | WPI | Whey Protein Isolate | 10.00% |
| 263 | AGAR- | Aqueous | Hammer | AGAR | Agarose | 39.37% |
| | KCARR-LBG- | Hydrogel | Milling | hWPI | Hydrolyzed Whey Protein | 39.37% |
| | hWPI_50-25-2- | Formation | | | Isolate | |
| | 50 | followed by | | KCARR | Kappa Carrageenan | 19.69% |
| | | Oven Drying | | LBG | Locust Bean Gum | 1.57% |
| 264 | AGAR- | Aqueous | | AGAR | Agarose | 3.00% |
| | KCARR-LBG- | Hydrogel | | GLC | Glucose | 10.00% |
| | WPI-GLC_30- | Formation | | KCARR | Kappa Carrageenan | 0.10% |
| | 1-1-150-100 | | | LBG | Locust Bean Gum | 0.10% |
| | | | | WATER | Water | 71.80% |
| | | | | WPI | Whey Protein Isolate | 15.00% |
| 265 | AGAR- | Aqueous | | AGAR | Agarose | 3.00% |
| | KCARR-WPI- | Hydrogel | | GLC | Glucose | 10.00% |
| | GLC_30-1- | Formation | | KCARR | Kappa Carrageenan | 0.10% |
| | 100-100 | | | WATER | Water | 76.90% |
| | | | | WPI | Whey Protein Isolate | 10.00% |
| 266 | AGAR- | Aqueous | | AGAR | Agarose | 3.00% |
| | KCARR-WPI- | Hydrogel | | GLC | Glucose | 10.00% |
| | GLC_30-10- | Formation | | KCARR | Kappa Carrageenan | 1.00% |
| | 100-100 | | | WATER | Water | 76.00% |
| | | | | WPI | Whey Protein Isolate | 10.00% |
| 267 | AGAR-LBG- | Aqueous | | AGAR | Agarose | 3.00% |
| | CCAS_30-3-50 | Hydrogel | | CCAS | Calcium Caseinate | 5.00% |
| | | Formation | | LBG | Locust Bean Gum | 0.30% |
| | | | | WATER | Water | 91.70% |
| | | Aqueous | Hammer | AGAR | Agarose | 36.14% |
| | | Hydrogel | Milling | CCAS | Calcium Caseinate | 60.24% |
| | | Formation | | LBG | Locust Bean Gum | 3.61% |
| | | followed by | | | | |
| | | Oven Drying | | | | |
| 268 | AGAR-LBG- | Aqueous | | AGAR | Agarose | 5.00% |
| | CCAS_50-2-50 | Hydrogel | | CCAS | Calcium Caseinate | 5.00% |
| | | Formation | | LBG | Locust Bean Gum | 0.20% |
| | | | | WATER | Water | 89.80% |
| | | Aqueous | Hammer | AGAR | Agarose | 49.02% |
| | | Hydrogel | Milling | CCAS | Calcium Caseinate | 49.02% |
| | | Formation | | LBG | Locust Bean Gum | 1.96% |
| | | followed by | | | | |
| | | Oven Drying | | | | |
| 269 | AGAR-LBG- | Aqueous | | AGAR | Agarose | 5.00% |
| | CCAS- | Hydrogel | | CCAS | Calcium Caseinate | 5.00% |
| | INLN_50-2-50- | Formation | | INLN | Inulin | 1.00% |
| | 10 | | | LBG | Locust Bean Gum | 0.20% |
| | | | | WATER | Water | 88.80% |
| | | Aqueous | Hammer | AGAR | Agarose | 44.64% |
| | | Hydrogel | Milling | CCAS | Calcium Caseinate | 44.64% |
| | | Formation | | INLN | Inulin | 8.93% |
| | | followed by | | LBG | Locust Bean Gum | 1.79% |
| | | Oven Drying | | | | |
| 270 | AGAR-LBG- | Aqueous | | AGAR | Agarose | 5.00% |
| | hWPI_50-2-50 | Hydrogel | | hWPI | Hydrolyzed Whey Protein | 5.00% |
| | | Formation | | | Isolate | |
| | | | | LBG | Locust Bean Gum | 0.20% |
| | | | | WATER | Water | 89.80% |
| 271 | AGAR-LBG- | Aqueous | | AGAR | Agarose | 3.00% |
| | WPI-GLC_30- | Hydrogel | | GLC | Glucose | 10.00% |
| | 1-100-100 | Formation | | LBG | Locust Bean Gum | 0.10% |
| | | | | WATER | Water | 76.90% |
| | | | | WPI | Whey Protein Isolate | 10.00% |
| 272 | AGAR-LBG- | Aqueous | | AGAR | Agarose | 3.00% |
| | WPI-GLC_30- | Hydrogel | | GLC | Glucose | 10.00% |
| | 10-100-100 | Formation | | LBG | Locust Bean Gum | 1.00% |
| | | | | WATER | Water | 76.00% |
| | | | | WPI | Whey Protein Isolate | 10.00% |
| 273 | AGAR- | Aqueous | Hammer | AGAR | Agarose | 39.37% |
| | LCARR-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | LCARR | Lambda Carrageenan | 19.69% |
| 274 | AGAR-LEC- | Aqueous | Hammer | AGAR | Agarose | 27.78% |
| | LBG- | Hydrogel | Milling | CCAS | Calcium Caseinate | 34.72% |
| | CCAS_40-50- | Formation | | LBG | Locust Bean Gum | 2.78% |
| | 4-50 | followed by | | LEC | Lecithin | 34.72% |
| | | Oven Drying | | | | |
| 275 | AGAR-LEC- | Aqueous | | AGAR | Agarose | 5.00% |
| | LBG- | Hydrogel | | CCAS | Calcium Caseinate | 5.00% |
| | CCAS_50-25- | Formation | | LBG | Locust Bean Gum | 0.20% |
| | 2-50 | | | LEC | Lecithin | 2.50% |
| | | | | WATER | Water | 87.30% |
| 276 | AGAR-LEC- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | LEC | Lecithin | 0.30% |
| | | | | WATER | Water | 89.50% |
| 277 | AGAR-LEC- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | LEC | Lecithin | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | LEC | Lecithin | 19.69% |
| 278 | AGAR-MC:4- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | MC:4 | Methylcellulose 4 cP | 2.50% |
| | | | | WATER | Water | 87.30% |
| 279 | AGAR-MC:15- | Aqueous | | AGAR | Agarose | 3.00% |
| | GHATG-WPI- | Hydrogel | | GHATG | Ghatti Gum | 0.30% |
| | GLC_30-5-3- | Formation | | GLC | Glucose | 20.00% |
| | 100-200 | | | MC:15 | Methylcellulose 15 cP | 0.50% |
| | | | | WATER | Water | 66.20% |
| | | | | WPI | Whey Protein Isolate | 10.00% |
| 280 | AGAR-MC:15- | Aqueous | | AGAR | Agarose | 3.00% |
| | GHATG-WPI- | Hydrogel | | GHATG | Ghatti Gum | 0.30% |
| | GLC_30-50-3- | Formation | | GLC | Glucose | 20.00% |
| | 100-200 | | | MC:15 | Methylcellulose 15 cP | 5.00% |
| | | | | WATER | Water | 61.70% |
| | | | | WPI | Whey Protein Isolate | 10.00% |
| 281 | AGAR-MC:15- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | MC:15 | Methylcellulose 15 cP | 0.30% |
| | | | | WATER | Water | 89.50% |
| 282 | AGAR-MC:15- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | MC:15 | Methylcellulose 15 cP | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | MC:15 | Methylcellulose 15 cP | 19.69% |
| 283 | AGAR- | Aqueous | | AGAR | Agarose | 5.00% |
| | MC:4000- | Hydrogel | | CCAS | Calcium Caseinate | 5.00% |
| | LBG- | Formation | | LBG | Locust Bean Gum | 0.20% |
| | CCAS_50-25- | | | MC:4000 | Methylcellulose 4000 cP | 2.50% |
| | 2-50 | | | WATER | Water | 87.30% |
| 284 | AGAR- | Aqueous | Hammer | AGAR | Agarose | 39.37% |
| | MC:4000- | Hydrogel | Milling | hWPI | Hydrolyzed Whey Protein | 39.37% |
| | LBG- | Formation | | | Isolate | |
| | hWPI_50-25-2- | followed by | | LBG | Locust Bean Gum | 1.57% |
| | 50 | Oven Drying | | MC:4000 | Methylcellulose 4000 cP | 19.69% |
| 285 | AGAR- | Aqueous | Hammer | AGAR | Agarose | 47.62% |
| | MC:4000- | Hydrogel | Milling | INLN | Inulin | 47.62% |
| | LBG- | Formation | | LBG | Locust Bean Gum | 1.90% |
| | INLN_50-3-2- | followed by | | MC:4000 | Methylcellulose 4000 cP | 2.86% |
| | 50 | Oven Drying | | | | |
| 286 | AGAR-MGSO- | Aqueous | | AGAR | Agarose | 5.00% |
| | LBG- | Hydrogel | | CCAS | Calcium Caseinate | 5.00% |
| | CCAS_50-25- | Formation | | LBG | Locust Bean Gum | 0.20% |
| | 2-50 | | | MGSO | Magnesium Sulfate | 2.50% |
| | | | | WATER | Water | 87.30% |
| 287 | AGAR-MGSO- | Aqueous | | AGAR | Agarose | 5.00% |
| | LBG-CHILO- | Hydrogel | | CHILO | Chitosan Low Molecular | 0.15% |
| | hWPI_50-1.5- | Formation | | | Weight | |
| | 2-1.5-50 | | | hWPI | Hydrolyzed Whey Protein | 5.00% |
| | | | | | Isolate | |
| | | | | LBG | Locust Bean Gum | 0.20% |
| | | | | MGSO | Magnesium Sulfate | 0.15% |
| | | | | WATER | Water | 89.50% |
| 288 | AGAR-MGSO- | Aqueous | | AGAR | Agarose | 5.00% |
| | LBG-CHILO- | Hydrogel | | CHILO | Chitosan Low Molecular | 1.25% |
| | hWPI_50-12.5- | Formation | | | Weight | |
| | 2-12.5-50 | | | hWPI | Hydrolyzed Whey Protein | 5.00% |
| | | | | | Isolate | |
| | | | | LBG | Locust Bean Gum | 0.20% |
| | | | | MGSO | Magnesium Sulfate | 1.25% |
| | | | | WATER | Water | 87.30% |
| 289 | AGAR-MGSO- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | MGSO | Magnesium Sulfate | 0.30% |
| | | | | WATER | Water | 89.50% |
| 290 | AGAR-MGSO- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | MGSO | Magnesium Sulfate | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | MGSO | Magnesium Sulfate | 19.69% |
| 291 | AGAR-MGSO- | Aqueous | Hammer | AGAR | Agarose | 47.62% |
| | LBG- | Hydrogel | Milling | INLN | Inulin | 47.62% |
| | INLN_50-3-2- | Formation | | LBG | Locust Bean Gum | 1.90% |
| | 50 | followed by | | MGSO | Magnesium Sulfate | 2.86% |
| | | Oven Drying | | | | |
| 292 | AGAR-MNSO- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | MNSO | Manganse Sulfate | 19.69% |
| 293 | AGAR-NICO- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | NICO | Sodium Nicotinate | 19.69% |
| 294 | AGAR-OLEA- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | OLEA | Oleic Acid | 0.30% |
| | | | | WATER | Water | 89.50% |
| 295 | AGAR-OLEA- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | OLEA | Oleic Acid | 2.50% |
| | | | | WATER | Water | 87.30% |
| 296 | AGAR- | Aqueous | | AGAR | Agarose | 3.00% |
| | PAA:450- | Hydrogel | | CCAS | Calcium Caseinate | 5.00% |
| | LBG- | Formation | | LBG | Locust Bean Gum | 0.30% |
| | CCAS_30-10- | | | PAA:450 | Poly(acrylic acid) MW: 450000 | 1.00% |
| | 3-50 | | | WATER | Water | 90.70% |
| | | Aqueous | Hammer | AGAR | Agarosc | 32.26% |
| | | Hydrogel | Milling | CCAS | Calcium Caseinate | 53.76% |
| | | Formation | | LBG | Locust Bean Gum | 3.23% |
| | | followed by | | PAA:450 | Poly(acrylic acid) MW: 450000 | 10.75% |
| | | Oven Drying | | | | |
| 297 | AGAR- | Aqueous | | AGAR | Agarose | 3.00% |
| | PAA:450- | Hydrogel | | PAA:450 | Poly(acrylic acid) MW: 450000 | 0.30% |
| | WPI_30-3-100 | Formation | | WATER | Water | 86.70% |
| | | | | WPI | Whey Protein Isolate | 10.00% |
| 298 | AGAR- | Aqueous | | AGAR | Agarose | 3.00% |
| | PAA:450- | Hydrogel | | PAA:450 | Poly(acrylic acid) MW: 450000 | 2.00% |
| | WPI_30-20- | Formation | | WATER | Water | 85.00% |
| | 100 | | | WPI | Whey Protein Isolate | 10.00% |
| 299 | AGAR- | Aqueous | | AGAR | Agarose | 3.00% |
| | PAA:450- | Hydrogel | | PAA:450 | Poly(acrylic acid) MW: 450000 | 10.00% |
| | WPI_30-100- | Formation | | WATER | Water | 77.00% |
| | 100 | | | WPI | Whey Protein Isolate | 10.00% |
| 300 | AGAR- | Aqueous | | AGAR | Agarose | 3.00% |
| | PAA:450-WPI- | Hydrogel | | GLC | Glucose | 20.00% |
| | GLC_30-1- | Formation | | PAA:450 | Poly(acrylic acid) MW: 450000 | 0.10% |
| | 100-200 | | | WATER | Water | 66.90% |
| | | | | WPI | Whey Protein Isolate | 10.00% |
| 301 | AGAR- | Aqueous | | AGAR | Agarose | 3.00% |
| | PAA:450-WPI- | Hydrogel | | GLC | Glucose | 20.00% |
| | GLC_30-10- | Formation | | PAA:450 | Poly(acrylic acid) MW: 450000 | 1.00% |
| | 100-200 | | | WATER | Water | 66.00% |
| | | | | WPI | Whey Protein Isolate | 10.00% |
| 302 | AGAR- | Aqueous | Hammer | AGAR | Agarose | 39.37% |
| | PANTA-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | PANTA | Pantothenic Acid | 19.69% |
| 303 | AGAR- | Aqueous | | AGAR | Agarose | 5.00% |
| | PEG:12K- | Hydrogel | | hWPI | Hydrolyzed Whey Protein | 5.00% |
| | LBG- | Formation | | | Isolate | |
| | hWPI_50-3-2- | | | LBG | Locust Bean Gum | 0.20% |
| | 50 | | | PEG:12000 | Polyethylene Glycol 12000 Da | 0.30% |
| | | | | WATER | Water | 89.50% |
| 304 | AGAR- | Aqueous | Hammer | AGAR | Agarose | 39.37% |
| | PEG:12K- | Hydrogel | Milling | hWPI | Hydrolyzed Whey Protein | 39.37% |
| | LBG- | Formation | | | Isolate | |
| | hWPI_50-25-2- | followed by | | LBG | Locust Bean Gum | 1.57% |
| | 50 | Oven Drying | | PEG:12000 | Polyethylene Glycol 12000 Da | 19.69% |
| 305 | AGAR- | Aqueous | Hammer | AGAR | Agarose | 47.62% |
| | PEG:12K- | Hydrogel | Milling | INLN | Inulin | 47.62% |
| | LBG- | Formation | | LBG | Locust Bean Gum | 1.90% |
| | INLN_50-3-2- | followed by | | PEG:12000 | Polyethylene Glycol 12000 Da | 2.86% |
| | 50 | Oven Drying | | | | |
| 306 | AGAR- | Aqueous | | AGAR | Agarose | 5.00% |
| | PEG:200-LBG- | Hydrogel | | CCAS | Calcium Caseinate | 5.00% |
| | CCAS_50-50- | Formation | | LBG | Locust Bean Gum | 0.20% |
| | 2-50 | | | PEG:200 | Polyethylene Glycol 200 Da | 5.00% |
| | | | | WATER | Water | 84.80% |
| 307 | AGAR- | Aqueous | | AGAR | Agarosc | 5.00% |
| | PEG:200-LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | PEG:200 | Polyethylene Glycol 200 Da | 0.30% |
| | | | | WATER | Water | 89.50% |
| 308 | AGAR- | Aqueous | | AGAR | Agarose | 5.00% |
| | PEG:200-LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | PEG:200 | Polyethylene Glycol 200 Da | 2.50% |
| | | | | WATER | Water | 87.30% |
| 309 | AGAR- | Aqueous | Hammer | AGAR | Agarose | 32.89% |
| | PEG:200-LBG- | Hydrogel | Milling | hWPI | Hydrolyzed Whey Protein | 32.89% |
| | hWPI_50-50-2- | Formation | | | Isolate | |
| | 50 | followed by | | LBG | Locust Bean Gum | 1.32% |
| | | Oven Drying | | PEG:200 | Polyethylene Glycol 200 Da | 32.89% |
| 310 | AGAR- | Aqueous | | AGAR | Agarose | 5.00% |
| | PEG:2000- | Hydrogel | | CCAS | Calcium Caseinate | 5.00% |
| | LBG- | Formation | | LBG | Locust Bean Gum | 0.20% |
| | CCAS_50-25- | | | PEG:2000 | Polyethylene Glycol 2000 Da | 2.50% |
| | 2-50 | | | WATER | Water | 87.30% |
| 311 | AGAR- | Aqueous | | AGAR | Agarose | 5.00% |
| | PEG:2000- | Hydrogel | | hWPI | Hydrolyzed Whey Protein | 5.00% |
| | LBG- | Formation | | | Isolate | |
| | hWPI_50-3-2- | | | LBG | Locust Bean Gum | 0.20% |
| | 50 | | | PEG:2000 | Polyethylene Glycol 2000 Da | 0.30% |
| | | | | WATER | Water | 89.50% |
| 312 | AGAR- | Aqueous | | AGAR | Agarose | 5.00% |
| | PEG:2000- | Hydrogel | | hWPI | Hydrolyzed Whey Protein | 5.00% |
| | LBG- | Formation | | | Isolate | |
| | hWPI_50-25-2- | | | LBG | Locust Bean Gum | 0.20% |
| | 50 | | | PEG:2000 | Polyethylene Glycol 2000 Da | 2.50% |
| | | | | WATER | Water | 87.30% |
| 313 | AGAR- | Aqueous | | AGAR | Agarose | 5.00% |
| | PEG:12000- | Hydrogel | | hWPI | Hydrolyzed Whey Protein | 5.00% |
| | LBG- | Formation | | | Isolate | |
| | hWPI_50-25-2- | | | LBG | Locust Bean Gum | 0.20% |
| | 50 | | | PEG:12000 | Polyethylene Glycol 12000 Da | 2.50% |
| | | | | WATER | Water | 87.30% |
| 314 | AGAR-PGA- | Aqueous | | AGAR | Agarose | 3.00% |
| | GELLG-WPI- | Hydrogel | | GELLG | Gellan Gum | 0.30% |
| | GLC_30-10-3- | Formation | | GLC | Glucose | 20.00% |
| | 100-200 | | | PGA | Propylene gycol alginate | 1.00% |
| | | | | WATER | Water | 65.70% |
| | | | | WPI | Whey Protein Isolate | 10.00% |
| 315 | AGAR-PGA- | Aqueous | | AGAR | Agarose | 3.00% |
| | GHATG-WPI- | Hydrogel | | GHATG | Ghatti Gum | 0.30% |
| | GLC_30-10-3- | Formation | | GLC | Glucose | 20.00% |
| | 100-200 | | | PGA | Propylene gycol alginate | 1.00% |
| | | | | WATER | Water | 65.70% |
| | | | | WPI | Whey Protein Isolate | 10.00% |
| 316 | AGAR-PGA- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | PGA | Propylene gycol alginate | 0.30% |
| | | | | WATER | Water | 89.50% |
| 317 | AGAR-PGA- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | PGA | Propylene gycol alginate | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | PGA | Propylene gycol alginate | 19.69% |
| 318 | AGAR-PGA- | Aqueous | | AGAR | Agarose | 3.00% |
| | WPI-GLC_30- | Hydrogel | | GLC | Glucose | 20.00% |
| | 1-100-200 | Formation | | PGA | Propylene gycol alginate | 0.10% |
| | | | | WATER | Water | 66.90% |
| | | | | WPI | Whey Protein Isolate | 10.00% |
| 319 | AGAR-PGA- | Aqueous | | AGAR | Agarose | 3.00% |
| | WPI-GLC_30- | Hydrogel | | GLC | Glucose | 20.00% |
| | 10-100-200 | Formation | | PGA | Propylene gycol alginate | 1.00% |
| | | | | WATER | Water | 66.00% |
| | | | | WPI | Whey Protein Isolate | 10.00% |
| 320 | AGAR-PGA- | Aqueous | | AGAR | Agarose | 3.00% |
| | XGUM-WPI- | Hydrogel | | GLC | Glucose | 20.00% |
| | GLC_30-10-3- | Formation | | PGA | Propylene gycol alginate | 1.00% |
| | 100-200 | | | WATER | Water | 65.70% |
| | | | | WPI | Whey Protein Isolate | 10.00% |
| | | | | XGUM | Xanthan Gum | 0.30% |
| 321 | AGAR- | Aqueous | | AGAR | Agarose | 5.00% |
| | PHYTG-LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | PHYTG | Phytagel | 0.30% |
| | | | | WATER | Water | 89.50% |
| 322 | AGAR- | Aqueous | | AGAR | Agarose | 5.00% |
| | PHYTG-LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | PHYTG | Phytagel | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | PHYTG | Phytagel | 19.69% |
| 323 | AGAR- | Aqueous | Hammer | AGAR | Agarose | 47.62% |
| | PHYTG-LBG- | Hydrogel | Milling | INLN | Inulin | 47.62% |
| | INLN_50-3-2- | Formation | | LBG | Locust Bean Gum | 1.90% |
| | 50 | followed by | | PHYTG | Phytagel | 2.86% |
| | | Oven Drying | | | | |
| 324 | AGAR- | Aqueous | | AGAR | Agarose | 3.00% |
| | PHYTG-WPI- | Hydrogel | | GLC | Glucose | 20.00% |
| | GLC_30-1- | Formation | | PHYTG | Phytagel | 0.10% |
| | 100-200 | | | WATER | Water | 66.90% |
| | | | | WPI | Whey Protein Isolate | 10.00% |
| 325 | AGAR- | Aqueous | | AGAR | Agarose | 3.00% |
| | PHYTG-WPI- | Hydrogel | | GLC | Glucose | 20.00% |
| | GLC_30-10- | Formation | | PHYTG | Phytagel | 1.00% |
| | 100-200 | | | WATER | Water | 66.00% |
| | | | | WPI | Whey Protein Isolate | 10.00% |
| 326 | AGAR- | Aqueous | | AGAR | Agarose | 5.00% |
| | PLLYS-LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | PLLYS | Poly-L-Lysine Hydrobromide | 0.30% |
| | | | | WATER | Water | 89.50% |
| 327 | AGAR-PULL- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | PULL | Pullulan | 0.30% |
| | | | | WATER | Water | 89.50% |
| 328 | AGAR-PULL- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | PULL | Pullulan | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | PULL | Pullulan | 19.69% |
| 329 | AGAR- | Aqueous | | AGAR | Agarose | 3.00% |
| | PVP:1.3M- | Hydrogel | | GHATG | Ghatti Gum | 0.30% |
| | GHATG-WPI- | Formation | | GLC | Glucose | 20.00% |
| | GLC_30-1-3- | | | PVP:1300 | Poly(vinyl Pyrrolidone 1.3 | 0.10% |
| | 100-200 | | | | Mda | |
| | | | | WATER | Water | 66.60% |
| | | | | WPI | Whey Protein Isolate | 10.00% |
| 330 | AGAR- | Aqueous | | AGAR | Agarose | 3.00% |
| | PVP:1.3M- | Hydrogel | | GHATG | Ghatti Gum | 0.30% |
| | GHATG-WPI- | Formation | | GLC | Glucose | 20.00% |
| | GLC_30-10-3- | | | PVP:1300 | Poly(vinyl Pyrrolidone 1.3 | 1.00% |
| | 100-200 | | | | Mda | |
| | | | | WATER | Water | 65.70% |
| | | | | WPI | Whey Protein Isolate | 10.00% |
| 331 | AGAR- | Aqueous | | AGAR | Agarose | 5.00% |
| | PVP:1.3M- | Hydrogel | | CCAS | Calcium Caseinate | 5.00% |
| | LBG- | Formation | | LBG | Locust Bean Gum | 0.20% |
| | CCAS_50-25- | | | PVP:1300 | Poly(vinyl Pyrrolidone 1.3 | 2.50% |
| | 2-50 | | | | Mda | |
| | | | | WATER | Water | 87.30% |
| 332 | AGAR- | Aqueous | | AGAR | Agarose | 5.00% |
| | PVP:1.3M- | Hydrogel | | hWPI | Hydrolyzed Whey Protein | 5.00% |
| | LBG- | Formation | | | Isolate | |
| | hWPI_50-3-2- | | | LBG | Locust Bean Gum | 0.20% |
| | 50 | | | PVP:1300 | Poly(vinyl Pyrrolidone 1.3 | 0.30% |
| | | | | | Mda | |
| | | | | WATER | Water | 89.50% |
| 333 | AGAR- | Aqueous | | AGAR | Agarose | 5.00% |
| | PVP:1.3M- | Hydrogel | | hWPI | Hydrolyzed Whey Protein | 5.00% |
| | LBG- | Formation | | | Isolate | |
| | hWPI_50-10-2- | | | LBG | Locust Bean Gum | 0.20% |
| | 50 | | | PVP:1300 | Poly(vinyl Pyrrolidone 1.3 | 1.00% |
| | | | | | Mda | |
| | | | | WATER | Water | 88.80% |
| 334 | AGAR- | Aqueous | Hammer | AGAR | Agarose | 39.37% |
| | PVP:1.3M- | Hydrogel | Milling | hWPI | Hydrolyzed Whey Protein | 39.37% |
| | LBG- | Formation | | | Isolate | |
| | hWPI_50-25-2- | followed by | | LBG | Locust Bean Gum | 1.57% |
| | 50 | Oven Drying | | PVP:1300 | Poly(vinyl Pyrrolidone 1.3 | 19.69% |
| | | | | | Mda | |
| 335 | AGAR- | Aqueous | Hammer | AGAR | Agarose | 47.62% |
| | PVP:1.3M- | Hydrogel | Milling | INLN | Inulin | 47.62% |
| | LBG- | Formation | | LBG | Locust Bean Gum | 1.90% |
| | INLN_50-3-2- | followed by | | PVP:1300 | Poly(vinyl Pyrrolidone 1.3 | 2.86% |
| | 50 | Oven Drying | | | Mda | |
| 336 | AGAR- | Aqueous | | AGAR | Agarose | 3.00% |
| | PVP:10- | Hydrogel | | GHATG | Ghatti Gum | 0.30% |
| | GHATG-WPI- | Formation | | GLC | Glucose | 20.00% |
| | GLC_30-1-3- | | | PVP:10 | Poly(vinyl Pyrrolidone 10 kDa | 0.10% |
| | 100-200 | | | WATER | Water | 66.60% |
| | | | | WPI | Whey Protein Isolate | 10.00% |
| 337 | AGAR- | Aqueous | | AGAR | Agarose | 3.00% |
| | PVP:10- | Hydrogel | | GHATG | Ghatti Gum | 0.30% |
| | GHATG-WPI- | Formation | | GLC | Glucose | 20.00% |
| | GLC_30-10-3- | | | PVP:10 | Poly(vinyl Pyrrolidone 10 kDa | 1.00% |
| | 100-200 | | | WATER | Water | 65.70% |
| | | | | WPI | Whey Protein Isolate | 10.00% |
| 338 | AGAR- | Aqueous | | AGAR | Agarose | 5.00% |
| | PVP:10K- | Hydrogel | | CCAS | Calcium Caseinate | 5.00% |
| | LBG- | Formation | | LBG | Locust Bean Gum | 0.20% |
| | CCAS_50-25- | | | PVP:10 | Poly(vinyl Pyrrolidone 10 kDa | 2.50% |
| | 2-50 | | | WATER | Water | 87.30% |
| 339 | AGAR- | Aqueous | | AGAR | Agarose | 5.00% |
| | PVP:10K- | Hydrogel | | hWPI | Hydrolyzed Whey Protein | 5.00% |
| | LBG- | Formation | | | Isolate | |
| | hWPI_50-3-2- | | | LBG | Locust Bean Gum | 0.20% |
| | 50 | | | PVP:10 | Poly(vinyl Pyrrolidone 10 kDa | 0.30% |
| | | | | WATER | Water | 89.50% |
| 340 | AGAR- | Aqueous | | AGAR | Agarose | 5.00% |
| | PVP:10K- | Hydrogel | | hWPI | Hydrolyzed Whey Protein | 5.00% |
| | LBG- | Formation | | | Isolate | |
| | hWPI_50-25-2- | | | LBG | Locust Bean Gum | 0.20% |
| | 50 | | | PVP:10 | Poly(vinyl Pyrrolidone 10 kDa | 2.50% |
| | | | | WATER | Water | 87.30% |
| 341 | AGAR- | Aqueous | Hammer | AGAR | Agarose | 47.62% |
| | PVP:10K- | Hydrogel | Milling | INLN | Inulin | 47.62% |
| | LBG- | Formation | | LBG | Locust Bean Gum | 1.90% |
| | INLN_50-3-2- | followed by | | PVP:10 | Poly(vinyl Pyrrolidone 10 kDa | 2.86% |
| | 50 | Oven Drying | | | | |
| 342 | AGAR- | Aqueous | | AGAR | Agarose | 3.00% |
| | PVP:40- | Hydrogel | | PVP:40 | Poly(vinyl Pyrrolidone 40 kDa | 3.00% |
| | WPI_30-30- | Formation | | WATER | Water | 84.00% |
| | 100 | | | WPI | Whey Protein Isolate | 10.00% |
| 343 | AGAR- | Aqueous | | AGAR | Agarose | 5.00% |
| | PVP:1300- | Hydrogel | | PVP:1300 | Poly(vinyl Pyrrolidone 1.3 | 1.00% |
| | WPI_50-10- | Formation | | | Mda | |
| | 100 | | | WATER | Water | 84.00% |
| | | | | WPI | Whey Protein Isolate | 10.00% |
| 345 | AGAR- | Aqueous | Hammer | AGAR | Agarose | 39.37% |
| | QRCTN-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | QRCTN | Quercetin Hydrate | 19.69% |
| 346 | AGAR- | Aqueous | Hammer | AGAR | Agarose | 46.73% |
| | QUILL-LBG- | Hydrogel | Milling | CCAS | Calcium Caseinate | 46.73% |
| | CCAS_50-5-2- | Formation | | LBG | Locust Bean Gum | 1.87% |
| | 50 | followed by | | QUILL | Quillaia | 4.67% |
| | | Oven Drying | | | | |
| 347 | AGAR- | Aqueous | | AGAR | Agarose | 5.00% |
| | QUILL-LBG- | Hydrogel | | CCAS | Calcium Caseinate | 5.00% |
| | CCAS_50-50- | Formation | | LBG | Locust Bean Gum | 0.20% |
| | 2-50 | | | QUILL | Quillaia | 5.00% |
| | | | | WATER | Water | 84.80% |
| | | Aqueous | Hammer | AGAR | Agarose | 32.89% |
| | | Hydrogel | Milling | CCAS | Calcium Caseinate | 32.89% |
| | | Formation | | LBG | Locust Bean Gum | 1.32% |
| | | followed by | | QUILL | Quillaia | 32.89% |
| | | Oven Drying | | | | |
| 348 | AGAR- | Aqueous | | AGAR | Agarose | 3.00% |
| | QUILL- | Hydrogel | | QUILL | Quillaia | 1.00% |
| | WPI_30-10- | Formation | | WATER | Water | 86.00% |
| | 100 | | | WPI | Whey Protein Isolate | 10.00% |
| 349 | AGAR-RICO- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | RICO | Sodium Ricinoleate | 0.30% |
| | | | | WATER | Water | 89.50% |
| 350 | AGAR-RICO- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | RICO | Sodium Ricinoleate | 19.69% |
| 351 | AGAR-RICO- | Aqueous | Hammer | AGAR | Agarose | 47.62% |
| | LBG- | Hydrogel | Milling | INLN | Inulin | 47.62% |
| | INLN_50-3-2- | Formation | | LBG | Locust Bean Gum | 1.90% |
| | 50 | followed by | | RICO | Sodium Ricinoleate | 2.86% |
| | | Oven Drying | | | | |
| 352 | AGAR-RICO- | Aqueous | | AGAR | Agarose | 3.00% |
| | WPI-GLC_30- | Hydrogel | | GLC | Glucose | 20.00% |
| | 50-100-200 | Formation | | RICO | Sodium Ricinoleate | 5.00% |
| | | | | WATER | Water | 62.00% |
| | | | | WPI | Whey Protein Isolate | 10.00% |
| 353 | AGAR-ROSA- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | ROSA | Rosmarinic Acid | 19.69% |
| 354 | AGAR-RUTI- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | RUTI | Rutin Hydrate | 19.69% |
| 356 | AGAR- | Aqueous | | AGAR | Agarose | 5.00% |
| | SCMC:90- | Hydrogel | | CMC:90 | Sodium Carboxymethyl | 0.30% |
| | LBG- | Formation | | | Cellulose MW 90000 | |
| | hWPI_50-3-2- | | | hWPI | Hydrolyzed Whey Protein | 5.00% |
| | 50 | | | | Isolate | |
| | | | | LBG | Locust Bean Gum | 0.20% |
| | | | | WATER | Water | 89.50% |
| 357 | AGAR- | Aqueous | | AGAR | Agarose | 5.00% |
| | SCMC:90- | Hydrogel | | CMC:90 | Sodium Carboxymethyl | 2.50% |
| | LBG- | Formation | | | Cellulose MW 90000 | |
| | hWPI_50-25-2- | | | hWPI | Hydrolyzed Whey Protein | 5.00% |
| | 50 | | | | Isolate | |
| | | | | LBG | Locust Bean Gum | 0.20% |
| | | | | WATER | Water | 87.30% |
| | | Aqueous | Hammer | AGAR | Agarose | 39.37% |
| | | Hydrogel | Milling | CMC:90 | Sodium Carboxymethyl | 19.69% |
| | | Formation | | | Cellulose MW 90000 | |
| | | followed by | | hWPI | Hydrolyzed Whey Protein | 39.37% |
| | | Oven Drying | | | Isolate | |
| | | | | LBG | Locust Bean Gum | 1.57% |
| 358 | AGAR- | Aqueous | | AGAR | Agarose | 5.00% |
| | SCMC:90K- | Hydrogel | | CCAS | Calcium Caseinate | 5.00% |
| | LBG- | Formation | | CMC:90 | Sodium Carboxymethyl | 2.50% |
| | CCAS_50-25- | | | | Cellulose MW 90000 | |
| | 2-50 | | | LBG | Locust Bean Gum | 0.20% |
| | | | | WATER | Water | 87.30% |
| 359 | AGAR- | Aqueous | Hammer | AGAR | Agarose | 47.62% |
| | SCMC:90K- | Hydrogel | Milling | CMC:90 | Sodium Carboxymethyl | 2.86% |
| | LBG- | Formation | | | Cellulose MW 90000 | |
| | INLN_50-3-2- | followed by | | INLN | Inulin | 47.62% |
| | 50 | Oven Drying | | LBG | Locust Bean Gum | 1.90% |
| 360 | AGAR- | Aqueous | Hammer | AGAR | Agarose | 39.37% |
| | SEHPS-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | SEHPS | Sodium 3-[Ethyl(m- | 19.69% |
| | | | | | tolyl)amino]-2-hydroxy-1- | |
| | | | | | propanesulfonate Hydrate | |
| 361 | AGAR-SFC- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | SFC | Soluble Corn Fiber | 19.69% |
| 362 | AGAR-SIO2- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | SIO2 | Silicon Dioxide | 0.30% |
| | | | | WATER | Water | 89.50% |
| 363 | AGAR-SIO2- | Aqueous | Hammer | AGAR | Agarose | 39.37% |
| | LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | SIO2 | Silicon Dioxide | 19.69% |
| 364 | AGAR-SIO2- | Aqueous | Hammer | AGAR | Agarose | 47.62% |
| | LBG- | Hydrogel | Milling | INLN | Inulin | 47.62% |
| | INLN_50-3-2- | Formation | | LBG | Locust Bean Gum | 1.90% |
| | 50 | followed by | | SIO2 | Silicon Dioxide | 2.86% |
| | | Oven Drying | | | | |
| 365 | AGAR-SP60- | Aqueous | | AGAR | Agarose | 3.00% |
| | TW60-WPI- | Hydrogel | | GLC | Glucose | 20.00% |
| | GLC_30-3.3- | Formation | | SP60 | Span 60: Sorbitan | 0.33% |
| | 1.6-100-200 | | | | monostearate | |
| | | | | TW60 | Tween 60: Polysorbate 60 | 0.16% |
| | | | | WATER | Water | 66.51% |
| | | | | WPI | Whey Protein Isolate | 10.00% |
| 366 | AGAR-SP60- | Aqueous | | AGAR | Agarose | 3.00% |
| | TW60-WPI- | Hydrogel | | GLC | Glucose | 20.00% |
| | GLC_30-33- | Formation | | SP60 | Span 60: Sorbitan | 3.30% |
| | 16-100-200 | | | | monostearate | |
| | | | | TW60 | Tween 60: Polysorbate 60 | 1.60% |
| | | | | WATER | Water | 62.10% |
| | | | | WPI | Whey Protein Isolate | 10.00% |
| 367 | AGAR-SP60- | Aqueous | | AGAR | Agarose | 3.00% |
| | TW60-WPI- | Hydrogel | | GLC | Glucose | 20.00% |
| | GLC_30-33- | Formation | | SP60 | Span 60: Sorbitan | 3.30% |
| | 16-100- | | | | monostearate | |
| | 200; ZEIN-CIT- | | | TW60 | Tween 60: Polysorbate 60 | 1.60% |
| | LA_26-8-66 | | | WATER | Water | 62.10% |
| | | | | WPI | Whey Protein Isolate | 10.00% |
| 368 | AGAR-SP60- | Aqueous | | AGAR | Agarose | 3.00% |
| | TW60-WPI- | Hydrogel | | GLC | Glucose | 20.00% |
| | GLC_30-33- | Formation | | SP60 | Span 60: Sorbitan | 3.30% |
| | 16-100- | | | | monostearate | |
| | 200; ZEIN-CIT- | | | TW60 | Tween 60: Polysorbate 60 | 1.60% |
| | LA_28-18-54 | | | WATER | Water | 62.10% |
| | | | | WPI | Whey Protein Isolate | 10.00% |
| 369 | AGAR-SP60- | Aqueous | | AGAR | Agarose | 3.00% |
| | TW60-WPI- | Hydrogel | | GLC | Glucose | 20.00% |
| | GLC_30-33- | Formation | | SP60 | Span 60: Sorbitan | 3.30% |
| | 16-100- | | | | monostearate | |
| | 200; ZEIN-CIT- | | | TW60 | Tween 60: Polysorbate 60 | 1.60% |
| | LA_34-21-46 | | | WATER | Water | 62.10% |
| | | | | WPI | Whey Protein Isolate | 10.00% |
| 370 | AGAR-SP60- | Aqueous | | AGAR | Agarose | 3.00% |
| | TW60-WPI- | Hydrogel | | GLC | Glucose | 20.00% |
| | GLC_30-33- | Formation | | SP60 | Span 60: Sorbitan | 3.30% |
| | 16-100- | | | | monostearate | |
| | 200; ZEIN-CIT- | | | TW60 | Tween 60: Polysorbate 60 | 1.60% |
| | LA_40-12-48 | | | WATER | Water | 62.10% |
| | | | | WPI | Whey Protein Isolate | 10.00% |
| 371 | AGAR- | Aqueous | Hammer | AGAR | Agarose | 39.37% |
| | ST1500-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | STI500 | Starch 1500 by Colorcon | 19.69% |
| 372 | AGAR- | Aqueous | | AGAR | Agarose | 4.00% |
| | STI500- | Hydrogel | | CCAS | Calcium Caseinate | 5.00% |
| | CCAS_40-10- | Formation | | STI500 | Starch 1500 by Colorcon | 1.00% |
| | 50 | | | WATER | Water | 90.00% |
| | | Aqueous | Hammer | AGAR | Agarose | 40.00% |
| | | Hydrogel | Milling | CCAS | Calcium Caseinate | 50.00% |
| | | Formation | | STI500 | Starch 1500 by Colorcon | 10.00% |
| | | followed by | | | | |
| | | Oven Drying | | | | |
| 373 | AGAR-SUCC- | Aqueous | Hammer | AGAR | Agarose | 39.37% |
| | KARG-LBG- | Hydrogel | Milling | hWPI | Hydrolyzed Whey Protein | 39.37% |
| | hWPI_50-12.5- | Formation | | | Isolate | |
| | 12.5-2-50 | followed by | | KARG | Karaya Gum | 9.84% |
| | | Oven Drying | | LBG | Locust Bean Gum | 1.57% |
| | | | | SUCC | Succinic Acid | 9.84% |
| 374 | AGAR-SUCC- | Aqueous | | AGAR | Agarose | 5.00% |
| | LBG- | Hydrogel | | CCAS | Calcium Caseinate | 5.00% |
| | CCAS_50-25- | Formation | | LBG | Locust Bean Gum | 0.20% |
| | 2-50 | | | SUCC | Succinic Acid | 2.50% |
| | | | | WATER | Water | 87.30% |
| 375 | AGAR-SUCC- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | SUCC | Succinic Acid | 0.30% |
| | | | | WATER | Water | 89.50% |
| 376 | AGAR-SUCC- | Aqueous | | AGAR | Agarose | 5.00% |
| | LBG- | Hydrogel | | hWPI | Hydrolyzed Whey Protein | 5.00% |
| | hWPI_50-25-2- | Formation | | | Isolate | |
| | 50 | | | LBG | Locust Bean Gum | 0.20% |
| | | | | SUCC | Succinic Acid | 2.50% |
| | | | | WATER | Water | 87.30% |
| 377 | AGAR-SUCC- | Aqueous | Hammer | AGAR | Agarose | 39.37% |
| | MGSO-LBG- | Hydrogel | Milling | hWPI | Hydrolyzed Whey Protein | 39.37% |
| | hWPI_50-12.5- | Formation | | | Isolate | |
| | 12.5-2-50 | followed by | | LBG | Locust Bean Gum | 1.57% |
| | | Oven Drying | | MGSO | Magnesium Sulfate | 9.84% |
| | | | | SUCC | Succinic Acid | 9.84% |
| 378 | AGAR-SUCC- | Aqueous | Hammer | AGAR | Agarose | 39.37% |
| | PEG:200-LBG- | Hydrogel | Milling | hWPI | Hydrolyzed Whey Protein | 39.37% |
| | hWPI_50-12.5- | Formation | | | Isolate | |
| | 12.5-2-50 | followed by | | LBG | Locust Bean Gum | 1.57% |
| | | Oven Drying | | PEG:200 | Polyethylene Glycol 200 Da | 9.84% |
| | | | | SUCC | Succinic Acid | 9.84% |
| 379 | AGAR- | Aqueous | | AGAR | Agarose | 5.00% |
| | THAMN-LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | THAMN | Thiamine hydrochloride | 0.30% |
| | | | | WATER | Water | 89.50% |
| 380 | AGAR- | Aqueous | Hammer | AGAR | Agarose | 39.37% |
| | TRAGG-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | TRAGG | Tragacanth Gum | 19.69% |
| 381 | AGAR- | Aqueous | | AGAR | Agarose | 3.00% |
| | TRAGG-WPI- | Hydrogel | | GLC | Glucose | 20.00% |
| | GLC_30-1- | Formation | | TRAGG | Tragacanth Gum | 0.10% |
| | 100-200 | | | WATER | Water | 66.90% |
| | | | | WPI | Whey Protein Isolate | 10.00% |
| 382 | AGAR- | Aqueous | | AGAR | Agarose | 3.00% |
| | TRAGG-WPI- | Hydrogel | | GLC | Glucose | 20.00% |
| | GLC_30-10- | Formation | | TRAGG | Tragacanth Gum | 1.00% |
| | 100-200 | | | WATER | Water | 66.00% |
| | | | | WPI | Whey Protein Isolate | 10.00% |
| 383 | AGAR-TREH- | Aqueous | | AGAR | Agarose | 5.00% |
| | LBG- | Hydrogel | | CCAS | Calcium Caseinate | 5.00% |
| | CCAS_50-25- | Formation | | LBG | Locust Bean Gum | 0.20% |
| | 2-50 | | | TREH | Trehalose | 2.50% |
| | | | | WATER | Water | 87.30% |
| 384 | AGAR-TREH- | Aqueous | | AGAR | Agarose | 5.00% |
| | LBG- | Hydrogel | | hWPI | Hydrolyzed Whey Protein | 5.00% |
| | hWPI_50-3-2- | Formation | | | Isolate | |
| | 50 | | | LBG | Locust Bean Gum | 0.20% |
| | | | | TREH | Trehalose | 0.30% |
| | | | | WATER | Water | 89.50% |
| 385 | AGAR-TREH- | Aqueous | | AGAR | Agarose | 5.00% |
| | LBG- | Formation | | hWPI | Hydrolyzed Whey Protein | 5.00% |
| | hWPI_50-25-2- | Hydrogel | | | Isolate | |
| | 50 | | | LBG | Locust Bean Gum | 0.20% |
| | | | | TREH | Trehalose | 2.50% |
| | | | | WATER | Water | 87.30% |
| | | Aqueous | Hammer | AGAR | Agarose | 39.37% |
| | | Hydrogel | Milling | hWPI | Hydrolyzed Whey Protein | 39.37% |
| | | Formation | | | Isolate | |
| | | followed by | | LBG | Locust Bean Gum | 1.57% |
| | | Oven Drying | | TREH | Trehalose | 19.69% |
| 386 | AGAR-TSTE- | Aqueous | | AGAR | Agarose | 3.00% |
| | WPI-GLC_30- | Hydrogel | | GLC | Glucose | 10.00% |
| | 1-100-100 | Formation | | TSTE | Tristearin | 0.10% |
| | | | | WATER | Water | 76.90% |
| | | | | WPI | Whey Protein Isolate | 10.00% |
| 387 | AGAR-TSTE- | Aqueous | | AGAR | Agarose | 3.00% |
| | WPI-GLC_30- | Hydrogel | | GLC | Glucose | 10.00% |
| | 10-100-100 | Formation | | TSTE | Tristearin | 1.00% |
| | | | | WATER | Water | 76.00% |
| | | | | WPI | Whey Protein Isolate | 10.00% |
| 388 | AGAR-TW60- | Aqueous | | AGAR | Agarose | 5.00% |
| | WPI_50-10- | Hydrogel | | TW60 | Tween 60: Polysorbate 60 | 1.00% |
| | 100 | Formation | | WATER | Water | 84.00% |
| | | | | WPI | Whey Protein Isolate | 10.00% |
| 389 | AGAR-VC18- | Aqueous | | AGAR | Agarose | 5.00% |
| | WPI_50-20- | Hydrogel | | VC18 | Ascorbyl Palmitate | 2.00% |
| | 100 | Formation | | WATER | Water | 83.00% |
| | | | | WPI | Whey Protein Isolate | 10.00% |
| 390 | AGAR- | Aqueous | | AGAR | Agarose | 2.00% |
| | WPI_20-100 | Hydrogel | | WATER | Water | 88.00% |
| | | Formation | | WPI | Whey Protein Isolate | 10.00% |
| 391 | AGAR- | Aqueous | | AGAR | Agarose | 5.00% |
| | WPI_50-100 | Hydrogel | | WATER | Water | 85.00% |
| | | Formation | | WPI | Whey Protein Isolate | 10.00% |
| 392 | AGAR-WPI- | Aqueous | | AGAR | Agarose | 3.00% |
| | GLC_30-100- | Hydrogel | | GLC | Glucose | 20.00% |
| | 200 | Formation | | WATER | Water | 67.00% |
| | | | | WPI | Whey Protein Isolate | 10.00% |
| 393 | AGAR- | Aqueous | Hammer | AGAR | Agarose | 39.37% |
| | XGUM-LBG- | Hydrogel | Milling | hWPI | Hydrolyzed Whey Protein | 39.37% |
| | hWPI_50-25-2- | Formation | | | Isolate | |
| | 50 | followed by | | LBG | Locust Bean Gum | 1.57% |
| | | Oven Drying | | XGUM | Xanthan Gum | 19.69% |
| 394 | ALG- | Spray Dried | | ALG | Sodium Alginate | 61.54% |
| | CCAS_20-12.5 | Microparticles | | CCAS | Calcium Caseinate | 38.46% |
| 395 | ALG- | Aqueous | | ALG | Sodium Alginate | 3.20% |
| | CCAS_32-20 | Hydrogel | | CCAS | Calcium Caseinate | 2.00% |
| | | Formation | | WATER | Water | 94.80% |
| 396 | ALG-CHILO- | Aqueous | | ALG | Sodium Alginate | 3.20% |
| | CCAS_32-12- | Hydrogel | | CCAS | Calcium Caseinate | 2.00% |
| | 20 | Formation | | CHILO | Chitosan Low Molecular | 1.20% |
| | | | | | Weight | |
| | | | | WATER | Water | 93.60% |
| 397 | ALG-CHILO- | Aqueous | | ALG | Sodium Alginate | 1.60% |
| | GLC- | Hydrogel | | CHILO | Chitosan Low Molecular | 1.00% |
| | INLN_16-10- | Formation | | | Weight | |
| | 200-50 | | | GLC | Glucose | 20.00% |
| | | | | INLN | Inulin | 5.00% |
| | | | | WATER | Water | 72.40% |
| 398 | ALG-CMC:90- | Aqueous | | ALG | Sodium Alginate | 3.20% |
| | CCAS_32-8-20 | Hydrogel | | CCAS | Calcium Caseinate | 2.00% |
| | | Formation | | CMC:90 | Sodium Carboxymethyl | 0.80% |
| | | | | | Cellulose MW 90000 | |
| | | | | WATER | Water | 94.00% |
| | | Spray Dried | | ALG | Sodium Alginate | 53.33% |
| | | Microparticles | | CCAS | Calcium Caseinate | 33.33% |
| | | | | CMC:90 | Sodium Carboxymethyl | 13.33% |
| | | | | | Cellulose MW 90000 | |
| 399 | ALG-G4414- | Aqueous | | ALG | Sodium Alginate | 1.60% |
| | GLC- | Hydrogel | | G4414 | Gelucire 44/14 | 4.00% |
| | INLN_16-40- | Formation | | GLC | Glucose | 15.00% |
| | 150-35 | | | INLN | Inulin | 3.50% |
| | | | | WATER | Water | 75.90% |
| 400 | ALG-GARAB- | Aqueous | | ALG | Sodium Alginate | 1.60% |
| | GLC- | Hydrogel | | GARAB | Gum Arabic, Arabic Gum, | 1.00% |
| | INLN_16-10- | Formation | | | Acacia Gum | |
| | 150-35 | | | GLC | Glucose | 15.00% |
| | | | | INLN | Inulin | 3.50% |
| | | | | WATER | Water | 78.90% |
| 401 | ALG-GLC- | Aqueous | | ALG | Sodium Alginate | 1.60% |
| | INLN_16-200- | Hydrogel | | GLC | Glucose | 20.00% |
| | 50 | Formation | | INLN | Inulin | 5.00% |
| | | | | WATER | Water | 73.40% |
| 402 | ALG-HAP:5U- | Aqueous | | ALG | Sodium Alginate | 1.60% |
| | GLC- | Hydrogel | | GLC | Glucose | 15.00% |
| | INLN_16-40- | Formation | | HAP:5U | Hydroxyapatite 5 um | 4.00% |
| | 150-35 | | | INLN | Inulin | 3.50% |
| | | | | WATER | Water | 75.90% |
| 403 | ALG-HPMC- | Aqueous | | ALG | Sodium Alginate | 1.60% |
| | GLC- | Hydrogel | | GLC | Glucose | 15.00% |
| | INLN_16-4- | Formation | | HPMC | Hydroxypropyl methylcellulose | 0.40% |
| | 150-35 | | | INLN | Inulin | 3.50% |
| | | | | WATER | Water | 79.50% |
| 404 | ALG- | Aqueous | | ALG | Sodium Alginate | 1.60% |
| | HPMC:4000- | Hydrogel | | GLC | Glucose | 15.00% |
| | GLC- | Formation | | HPMC:4000 | Hydroxypropyl methylcellulose | 0.40% |
| | INLN_16-4- | | | | 4000 cP | |
| | 150-35 | | | INLN | Inulin | 3.50% |
| | | | | WATER | Water | 79.50% |
| 405 | ALG-KARG- | Aqueous | | ALG | Sodium Alginate | 1.60% |
| | GLC- | Hydrogel | | GLC | Glucose | 15.00% |
| | INLN_16-4- | Formation | | INLN | Inulin | 3.50% |
| | 150-35 | | | KARG | Karaya Gum | 0.40% |
| | | | | WATER | Water | 79.50% |
| 406 | ALG-KRH40- | Aqueous | | ALG | Sodium Alginate | 1.60% |
| | GLC- | Hydrogel | | GLC | Glucose | 15.00% |
| | INLN_16-40- | Formation | | INLN | Inulin | 3.50% |
| | 150-35 | | | KRH40 | Koliphor RH40 | 4.00% |
| | | | | WATER | Water | 75.90% |
| 407 | ALG-MC- | Aqueous | | ALG | Sodium Alginate | 1.60% |
| | GLC- | Hydrogel | | GLC | Glucose | 15.00% |
| | INLN_16-32- | Formation | | INLN | Inulin | 3.50% |
| | 150-35 | | | MC | Methylcellulose | 3.20% |
| | | | | WATER | Water | 76.70% |
| 408 | ALG- | Aqueous | | ALG | Sodium Alginate | 1.60% |
| | PVP:1.3M- | Hydrogel | | GLC | Glucose | 15.00% |
| | GLC- | Formation | | INLN | Inulin | 3.50% |
| | INLN_16-10- | | | PVP:1300 | Poly(vinyl Pyrrolidone 1.3 | 1.00% |
| | 150-35 | | | | Mda | |
| | | | | WATER | Water | 78.90% |
| 409 | ALG-SUCC- | Spray Dried | | ALG | Sodium Alginate | 40.00% |
| | hWPI_20-10- | Microparticles | | hWPI | Hydrolyzed Whey Protein | 40.00% |
| | 20 | | | | Isolate | |
| | | | | SUCC | Succinic Acid | 20.00% |
| 410 | ALG-TW85- | Aqueous | | ALG | Sodium Alginate | 1.60% |
| | GLC- | Hydrogel | | GLC | Glucose | 15.00% |
| | INLN_16-40- | Formation | | INLN | Inulin | 3.50% |
| | 150-35 | | | TW85 | Tween 85: Polyoxyethylene | 4.00% |
| | | | | | sorbitan trioleate | |
| | | | | WATER | Water | 75.90% |
| 411 | BSWX-27STE- | Hot Melt High | | 27STE | 27-Stearin | 20.00% |
| | WPI_400-200- | Shear | | BSWX | Beeswax | 40.00% |
| | 400 | Homogenization | | WPI | Whey Protein Isolate | 40.00% |
| 412 | BSWX- | Hot Melt High | | ACETEM | Acetic acid esters of mono- | 20.00% |
| | ACETEM- | Shear | | | and diglycerides | |
| | WPI_400-200- | Homogenization | | BSWX | Beeswax | 40.00% |
| | 400 | | | WPI | Whey Protein Isolate | 40.00% |
| 413 | BSWX- | Hot Melt High | | ACETEM | Acetic acid esters of mono- | 15.00% |
| | ACETEM- | Shear | | | and diglycerides | |
| | WPI_750-150- | Homogenization | | BSWX | Beeswax | 75.00% |
| | 100 | | | WPI | Whey Protein Isolate | 10.00% |
| 414 | BSWX- | Hot Melt High | | ACETEM | Acetic acid esters of mono- | 13.64% |
| | ACETEM- | Shear | | | and diglycerides | |
| | WPI_850-150- | Homogenization | | BSWX | Beeswax | 77.27% |
| | 100 | | | WPI | Whey Protein Isolate | 9.09% |
| 415 | BSWX- | Hot Melt High | | BSWX | Beeswax | 40.00% |
| | CHOLE- | Shear | | CHOLE | Cholesterol | 20.00% |
| | WPI_400-200- | Homogenization | | WPI | Whey Protein Isolate | 40.00% |
| | 400 | | | | | |
| 416 | BSWX- | Hot Melt High | | BSWX | Beeswax | 40.00% |
| | CITRA- | Shear | | CITRA | Citric Acid | 20.00% |
| | WPI_400-200- | Homogenization | | WPI | Whey Protein Isolate | 40.00% |
| | 400 | | | | | |
| 417 | BSWX- | Hot Melt High | | BSWX | Beeswax | 40.00% |
| | CITREM- | Shear | | CITREM | Citric Acid Esters of Mono | 20.00% |
| | WPI_400-200- | Homogenization | | | and Diglycerides | |
| | 400 | | | WPI | Whey Protein Isolate | 40.00% |
| 418 | BSWX- | Hot Melt High | | BSWX | Beeswax | 75.00% |
| | CITREM- | Shear | | CITREM | Citric Acid Esters of Mono | 15.00% |
| | WPI_750-150- | Homogenization | | | and Diglycerides | |
| | 100 | | | WPI | Whey Protein Isolate | 10.00% |
| 419 | BSWX- | Hot Melt High | | BSWX | Beeswax | 40.00% |
| | DMDN- | Shear | | DMDN | Dimodan | 20.00% |
| | WPI_400-200- | Homogenization | | WPI | Whey Protein Isolate | 40.00% |
| | 400 | | | | | |
| 420 | BSWX- | Hot Melt High | | BSWX | Beeswax | 85.00% |
| | DMDN- | Shear | | DMDN | Dimodan | 5.00% |
| | WPI_850-50- | Homogenization | | WPI | Whey Protein Isolate | 10.00% |
| | 100 | | | | | |
| 421 | BSWX- | Hot Melt High | | BSWX | Beeswax | 77.27% |
| | DMDN- | Shear | | DMDN | Dimodan | 13.64% |
| | WPI_850-150- | Homogenization | | WPI | Whey Protein Isolate | 9.09% |
| | 100 | | | | | |
| 422 | BSWX-EC:22- | Hot Melt High | | BSWX | Beeswax | 40.00% |
| | WPI_400-200- | Shear | | EC:22 | Ethyl Cellulose 22 cP | 20.00% |
| | 400 | Homogenization | | WPI | Whey Protein Isolate | 40.00% |
| 423 | BSWX- | Hot Melt High | Hammer | BSWX | Beeswax | 40.00% |
| | EC:100- | Shear | Milling | EC:100 | Ethyl Cellulose 100 cP | 10.00% |
| | WPI_400-100- | Homogenization | | WPI | Whey Protein Isolate | 50.00% |
| | 500 | | | | | |
| 424 | BSWX- | Hot Melt High | | BSWX | Beeswax | 40.00% |
| | EC:100- | Shear | | EC:100 | Ethyl Cellulose 100 cP | 20.00% |
| | WPI_400-200- | Homogenization | | WPI | Whey Protein Isolate | 40.00% |
| | 400 | | | | | |
| 425 | BSWX- | Hot Melt High | | BSWX | Beeswax | 15.00% |
| | EC:100-WPI- | Shear | | EC:100 | Ethyl Cellulose 100 cP | 5.00% |
| | OLEA_150-50 | Homogenization | | OLEA | Oleic Acid | 70.00% |
| | 100-700 | | | WPI | Whey Protein Isolate | 10.00% |
| 426 | BSWX- | Hot Melt High | | BSWX | Beeswax | 40.00% |
| | EC:300- | Shear | | EC:300 | Ethyl Cellulose 300 cP | 20.00% |
| | WPI_400-200- | Homogenization | | WPI | Whey Protein Isolate | 40.00% |
| | 400 | | | | | |
| 427 | BSWX-F127- | Hot Melt High | | BSWX | Beeswax | 40.00% |
| | WPI_400-200- | Shear | | F127 | Pluronic F127, Poloxamer 407 | 20.00% |
| | 400 | Homogenization | | WPI | Whey Protein Isolate | 40.00% |
| 428 | BSWX-FOLA- | Hot Melt High | | BSWX | Beeswax | 40.00% |
| | WPI_400-200- | Shear | | FOLA | Folic Acid, Folate | 20.00% |
| | 400 | Homogenization | | WPI | Whey Protein Isolate | 40.00% |
| 429 | BSWX-GMO- | Hot Melt High | | BSWX | Beeswax | 40.00% |
| | WPI_400-200- | Shear | | GMO | Glyceryl Monooleate | 20.00% |
| | 400 | Homogenization | | WPI | Whey Protein Isolate | 40.00% |
| 430 | BSWX-HBC- | Hot Melt High | | BSWX | Beeswax | 40.00% |
| | WPI_400-200- | Shear | | HBC | Hydroxybutyrate Calcium Salt | 20.00% |
| | 400 | Homogenization | | WPI | Whey Protein Isolate | 40.00% |
| 431 | BSWX- | Hot Melt High | | BSWX | Beeswax | 40.00% |
| | HBMG- | Shear | | HBMG | Hydroxybutyrate Magnesium | 20.00% |
| | WPI_400-200- | Homogenization | | WPI | Whey Protein Isolate | 40.00% |
| | 400 | | | | | |
| 432 | BSWX-HBNA- | Hot Melt High | | BSWX | Beeswax | 40.00% |
| | WPI_400-200- | Shear | | HBNA | Hydroxybutryate Sodium Salt | 20.00% |
| | 400 | Homogenization | | WPI | Whey Protein Isolate | 40.00% |
| 433 | BSWX-K188- | Hot Melt High | | BSWX | Beeswax | 40.00% |
| | WPI_400-200- | Shear | | K188 | Koliphor 188 | 20.00% |
| | 400 | Homogenization | | WPI | Whey Protein Isolate | 40.00% |
| 434 | BSWX-K188- | Hot Melt High | | BSWX | Beeswax | 75.00% |
| | WPI_750-150- | Shear | | K188 | Koliphor 188 | 15.00% |
| | 100 | Homogenization | | WPI | Whey Protein Isolate | 10.00% |
| 435 | BSWX-K188- | Hot Melt High | | BSWX | Beeswax | 77.27% |
| | WPI_850-150- | Shear | | K188 | Koliphor 188 | 13.64% |
| | 100 | Homogenization | | WPI | Whey Protein Isolate | 9.09% |
| 436 | BSWX- | Hot Melt High | | BSWX | Beeswax | 40.00% |
| | KRH40- | Shear | | KRH40 | Koliphor RH40 | 20.00% |
| | WPI_400-200- | Homogenization | | WPI | Whey Protein Isolate | 40.00% |
| | 400 | | | | | |
| 437 | BSWX- | Hot Melt High | | BSWX | Beeswax | 40.00% |
| | KS3350- | Shear | | KS3350 | Kollisolv 3550 | 20.00% |
| | WPI_400-200- | Homogenization | | WPI | Whey Protein Isolate | 40.00% |
| | 400 | | | | | |
| 438 | BSWX-LEC- | Hot Melt High | | BSWX | Beeswax | 40.00% |
| | WPI_400-200- | Shear | | LEC | Lecithin | 20.00% |
| | 400 | Homogenization | | WPI | Whey Protein Isolate | 40.00% |
| 439 | BSWX-LEC- | Hot Melt High | | BSWX | Beeswax | 75.00% |
| | WPI_750-150- | Shear | | LEC | Lecithin | 15.00% |
| | 100 | Homogenization | | WPI | Whey Protein Isolate | 10.00% |
| 440 | BSWX-LEC- | Hot Melt High | | BSWX | Beeswax | 80.00% |
| | WPI_800-150- | Shear | | LEC | Lecithin | 15.00% |
| | 50 | Homogenization | | WPI | Whey Protein Isolate | 5.00% |
| 441 | BSWX- | Aqueous | Hammer | BSWX | Beeswax | 40.00% |
| | LIPOID- | Hydrogel | Milling | LIPOID | Phosphatidylcholine | 20.00% |
| | WPI_400-200- | Formation | | WPI | Whey Protein Isolate | 40.00% |
| | 400 | followed by | | | | |
| | | Oven Drying | | | | |
| | | Hot Melt High | | BSWX | Beeswax | 40.00% |
| | | Shear | | LIPOID | Phosphatidylcholine | 20.00% |
| | | Homogenization | | WPI | Whey Protein Isolate | 40.00% |
| 442 | BSWX- | Hot Melt High | | BSWX | Beeswax | 40.00% |
| | MYRJ52- | Shear | | MYRJ52 | Polyoxyethylene (40) stearate | 20.00% |
| | WPI_400-200- | Homogenization | | WPI | Whey Protein Isolate | 40.00% |
| | 400 | | | | | |
| 443 | BSWX- | Hot Melt High | | BSWX | Beeswax | 40.00% |
| | PANODAN- | Shear | | PANODAN | Mono- and diglycerides of | 20.00% |
| | WPI_400-200- | Homogenization | | | hydrogenated palm oil | |
| | 400 | | | WPI | Whey Protein Isolate | 40.00% |
| 444 | BSWX- | Hot Melt High | | BSWX | Beeswax | 40.00% |
| | PEG:8000- | Shear | | PEG:8000 | Polyethylene Glycol 8000 Da | 20.00% |
| | WPI_400-200- | Homogenization | | WPI | Whey Protein Isolate | 40.00% |
| | 400 | | | | | |
| 445 | BSWX- | Hot Melt High | | BSWX | Beeswax | 40.00% |
| | PEG:PPG- | Shear | | PEG:PPG | Poly(ethylene glycol)-block- | 20.00% |
| | WPI_400-200- | Homogenization | | | poly(propylene glycol)-block- | |
| | 400 | | | | poly(ethylene glycol) | |
| | | | | WPI | Whey Protein Isolate | 40.00% |
| 446 | BSWX-PGMS- | Hot Melt High | | BSWX | Beeswax | 40.00% |
| | WPI_400-200- | Shear | | PGMS | Propylene glycol monostearate | 20.00% |
| | 400 | Homogenization | | WPI | Whey Protein Isolate | 40.00% |
| 447 | BSWX-PGPR- | Hot Melt High | | BSWX | Beeswax | 40.00% |
| | WPI_400-200- | Shear | | PGPR | Polyglycerol Polyricinoleate | 20.00% |
| | 400 | Homogenization | | WPI | Whey Protein Isolate | 40.00% |
| 448 | BSWX-PGPR- | Hot Melt High | | BSWX | Beeswax | 75.00% |
| | WPI_750-150- | Shear | | PGPR | Polyglycerol Polyricinoleate | 15.00% |
| | 100 | Homogenization | | WPI | Whey Protein Isolate | 10.00% |
| 449 | BSWX-PGPR- | Hot Melt High | | BSWX | Beeswax | 77.27% |
| | WPI_850-150- | Shear | | PGPR | Polyglycerol Polyricinoleate | 13.64% |
| | 100 | Homogenization | | WPI | Whey Protein Isolate | 9.09% |
| 450 | BSWX-SITO- | Hot Melt High | | BSWX | Beeswax | 40.00% |
| | WPI_400-200- | Shear | | SITO | Sitosterol | 20.00% |
| | 400 | Homogenization | | WPI | Whey Protein Isolate | 40.00% |
| 451 | BSWX-SP20- | Hot Melt High | | BSWX | Beeswax | 40.00% |
| | WPI_400-200- | Shear | | SP20 | Span 20: Sorbitan monolaurate | 20.00% |
| | 400 | Homogenization | | WPI | Whey Protein Isolate | 40.00% |
| 452 | BSWX-SP40- | Hot Melt High | | BSWX | Beeswax | 40.00% |
| | WPI_400-200- | Shear | | SP40 | Span 40: Sorbitan | 20.00% |
| | 400 | Homogenization | | | Monopalmitate | |
| | | | | WPI | Whey Protein Isolate | 40.00% |
| 453 | BSWX-SP60- | Hot Melt High | | BSWX | Beeswax | 40.00% |
| | WPI_400-200- | Shear | | SP60 | Span 60: Sorbitan | 20.00% |
| | 400 | Homogenization | | | monostearate | |
| | | | | WPI | Whey Protein Isolate | 40.00% |
| 454 | BSWX-SP60- | Hot Melt High | | BSWX | Beeswax | 85.00% |
| | WPI_850-50- | Shear | | SP60 | Span 60: Sorbitan | 5.00% |
| | 100 | Homogenization | | | monostearate | |
| | | | | WPI | Whey Protein Isolate | 10.00% |
| 455 | BSWX-SP80- | Hot Melt High | | BSWX | Beeswax | 40.00% |
| | WPI_400-200- | Shear | | SP80 | Span 80: Sorbitan Monooleate | 20.00% |
| | 400 | Homogenization | | WPI | Whey Protein Isolate | 40.00% |
| 456 | BSWX-SP85- | Hot Melt High | | BSWX | Beeswax | 40.00% |
| | WPI_400-200- | Shear | | SP85 | Span 85: Sorbitan Trioleate | 20.00% |
| | 400 | Homogenization | | WPI | Whey Protein Isolate | 40.00% |
| 457 | BSWX-SP85- | Hot Melt High | | BSWX | Beeswax | 75.00% |
| | WPI_750-150- | Shear | | SP85 | Span 85: Sorbitan Trioleate | 15.00% |
| | 100 | Homogenization | | WPI | Whey Protein Isolate | 10.00% |
| 458 | BSWX-STEA- | Hot Melt High | | BSWX | Beeswax | 40.00% |
| | WPI_400-200- | Shear | | STEA | Stearic Acid | 20.00% |
| | 400 | Homogenization | | WPI | Whey Protein Isolate | 40.00% |
| 459 | BSWX- | Hot Melt High | | BSWX | Beeswax | 40.00% |
| | THAMN- | Shear | | THAMN | Thiamine hydrochloride | 20.00% |
| | WPI_400-200- | Homogenization | | WPI | Whey Protein Isolate | 40.00% |
| | 400 | | | | | |
| 460 | BSWX-TSTE- | Hot Melt High | | BSWX | Beeswax | 40.00% |
| | WPI_400-200- | Shear | | TSTE | Tristearin | 20.00% |
| | 400 | Homogenization | | WPI | Whey Protein Isolate | 40.00% |
| 461 | BSWX-TW21- | Hot Melt High | | BSWX | Beeswax | 40.00% |
| | WPI_400-200- | Shear | | TW21 | Tween 21: Polysorbate 21 | 20.00% |
| | 400 | Homogenization | | WPI | Whey Protein Isolate | 40.00% |
| 462 | BSWX-TW40- | Hot Melt High | | BSWX | Beeswax | 40.00% |
| | WPI_400-200- | Shear | | TW40 | Tween 40: Polysorbate 40 | 20.00% |
| | 400 | Homogenization | | WPI | Whey Protein Isolate | 40.00% |
| 463 | BSWX-TW65- | Hot Melt High | | BSWX | Beeswax | 40.00% |
| | WPI_400-200- | Shear | | TW65 | Tween 65: Polysorbate 65 | 20.00% |
| | 400 | Homogenization | | WPI | Whey Protein Isolate | 40.00% |
| 464 | BSWX-TW80- | Hot Melt High | | BSWX | Beeswax | 40.00% |
| | WPI_400-200- | Shear | | TW80 | Tween 80: Polysorbate 80 | 20.00% |
| | 400 | Homogenization | | WPI | Whey Protein Isolate | 40.00% |
| 465 | BSWX-TW80- | Hot Melt High | | BSWX | Beeswax | 75.00% |
| | WPI_750-150- | Shear | | TW80 | Tween 80: Polysorbate 80 | 15.00% |
| | 100 | Homogenization | | WPI | Whey Protein Isolate | 10.00% |
| 466 | BSWX-TW80- | Hot Melt High | | BSWX | Beeswax | 85.00% |
| | WPI_850-50- | Shear | | TW80 | Tween 80: Polysorbate 80 | 5.00% |
| | 100 | Homogenization | | WPI | Whey Protein Isolate | 10.00% |
| 467 | BSWX-TW85- | Hot Melt High | | BSWX | Beeswax | 80.00% |
| | EC:100- | Shear | | EC:100 | Ethyl Cellulose 100 cP | 5.00% |
| | WPI_800-50- | Homogenization | | TW85 | Tween 85: Polyoxyethylene | 5.00% |
| | 50-100 | | | | sorbitan trioleate | |
| | | | | WPI | Whey Protein Isolate | 10.00% |
| 468 | BSWX-TW85- | Hot Melt High | | BSWX | Beeswax | 75.00% |
| | WPI_750-150- | Shear | | TW85 | Tween 85: Polyoxyethylene | 15.00% |
| | 100 | Homogenization | | | sorbitan trioleate | |
| | | | | WPI | Whey Protein Isolate | 10.00% |
| 469 | BSWX-TW85- | Hot Melt High | | BSWX | Beeswax | 80.00% |
| | WPI_800-150- | Shear | | TW85 | Tween 85: Polyoxyethylene | 15.00% |
| | 50 | Homogenization | | | sorbitan trioleate | |
| | | | | WPI | Whey Protein Isolate | 5.00% |
| 470 | BSWX-TW85- | Hot Melt High | | BSWX | Beeswax | 85.00% |
| | WPI_850-50- | Shear | | TW85 | Tween 85: Polyoxyethylene | 5.00% |
| | 100 | Homogenization | | | sorbitan trioleate | |
| | | | | WPI | Whey Protein Isolate | 10.00% |
| 471 | BSWX-TW85- | Hot Melt High | | BSWX | Beeswax | 90.00% |
| | WPI_900-50- | Shear | | TW85 | Tween 85: Polyoxyethylene | 5.00% |
| | 50 | Homogenization | | | sorbitan trioleate | |
| | | | | WPI | Whey Protein Isolate | 5.00% |
| 472 | BSWX- | Hot Melt High | | BSWX | Beeswax | 90.00% |
| | WPI_900-100 | Shear | | WPI | Whey Protein Isolate | 10.00% |
| | | Homogenization | | | | |
| 473 | BSWX-WPI- | Hot Melt High | | BSWX | Beeswax | 15.00% |
| | OLEA_150- | Shear | | OLEA | Oleic Acid | 75.00% |
| | 100-750 | Homogenization | | WPI | Whey Protein Isolate | 10.00% |
| 474 | BSWX-WPI- | Hot Melt High | | BSWX | Beeswax | 20.00% |
| | OLEA_200- | Shear | | OLEA | Oleic Acid | 70.00% |
| | 100-700 | Homogenization | | WPI | Whey Protein Isolate | 10.00% |
| 475 | BSWX-WPI- | Hot Melt High | | BSWX | Beeswax | 20.00% |
| | TOLE_200- | Shear | | TOLE | Triolein | 70.00% |
| | 100-700 | Homogenization | | WPI | Whey Protein Isolate | 10.00% |
| 476 | CANDW- | Hot Melt High | | CANDW | Candelilla wax | 85.00% |
| | EC:100- | Shear | | EC:100 | Ethyl Cellulose 100 cP | 5.00% |
| | WPI_850-50- | Homogenization | | WPI | Whey Protein Isolate | 10.00% |
| | 100 | | | | | |
| 477 | CANDW- | Hot Melt High | | CANDW | Candelilla wax | 75.00% |
| | GEL50- | Shear | | WPI | Whey Protein Isolate | 10.00% |
| | WPI_750-150- | Homogenization | | | | |
| | 100 | | | | | |
| 478 | CANDW- | Hot Melt High | | CANDW | Candelilla wax | 80.00% |
| | GEL50- | Shear | | WPI | Whey Protein Isolate | 5.00% |
| | WPI_800-150- | Homogenization | | | | |
| | 50 | | | | | |
| 479 | CANDW- | Hot Melt High | | CANDW | Candelilla wax | 85.00% |
| | GEL50- | Shear | | WPI | Whey Protein Isolate | 10.00% |
| | WPI_850-50- | Homogenization | | | | |
| | 100 | | | | | |
| 480 | CANDW-WPI- | Hot Melt High | | CANDW | Candelilla wax | 15.00% |
| | OLEA_150- | Shear | | OLEA | Oleic Acid | 75.00% |
| | 100-750 | Homogenization | | WPI | Whey Protein Isolate | 10.00% |
| 481 | CANDW-WPI- | Hot Melt High | | CANDW | Candelilla wax | 20.00% |
| | OLEA_200- | Shear | | OLEA | Oleic Acid | 65.00% |
| | 150-650 | Homogenization | | WPI | Whey Protein Isolate | 15.00% |
| 482 | CANDW-WPI- | Hot Melt High | | CANDW | Candelilla wax | 20.00% |
| | TOLE_200- | Shear | | TOLE | Triolein | 70.00% |
| | 100-700 | Homogenization | | WPI | Whey Protein Isolate | 10.00% |
| 483 | CARNW-EC- | Hot Melt High | | CARNW | Carnauba Wax | 10.00% |
| | WPI- | Shear | | EC:100 | Ethyl Cellulose 100 cP | 15.00% |
| | OLEA_100- | Homogenization | | OLEA | Oleic Acid | 65.00% |
| | 150-100- | | | WPI | Whey Protein Isolate | 10.00% |
| | 650; CAP | | | | | |
| 484 | CARNW-EC- | Hot Melt High | | CARNW | Carnauba Wax | 10.00% |
| | WPI- | Shear | | EC:100 | Ethyl Cellulose 100 cP | 15.00% |
| | OLEA_100- | Homogenization | | OLEA | Oleic Acid | 65.00% |
| | 150-100- | | | WPI | Whey Protein Isolate | 10.00% |
| | 650; EPO | | | | | |
| 485 | CARNW- | Spray Dried | Fluidized Bed | CARNW | Carnauba Wax | 24.51% |
| | EC:100-STEA- | Microparticles | Coating | EC:100 | Ethyl Cellulose 100 cP | 6.45% |
| | FOLA- | | | EC:300 | Ethyl Cellulose 300 cP | 12.00% |
| | WPI_24.51- | | | FOLA | Folic Acid, Folate | 1.29% |
| | 6.45-6.45-1.29- | | | L100 | Eurgagit Control | 20.00% |
| | 25.8; EC-L100- | | | NT | Sodium Alginate | 3.50% |
| | NT-12-20-3.5 | | | STEA | Stearic Acid | 6.45% |
| | | | | WPI | Whey Protein Isolate | 25.80% |
| 486 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20-400 | | | WPI | Whey Protein Isolate | 40.00% |
| | | Spray Dried | | CARNW | Carnauba Wax | 38.00% |
| | | Microparticles | | EC:100 | Ethyl Cellulose 100 cP | 10.00% |
| | | | | FOLA | Folic Acid, Folate | 2.00% |
| | | | | STEA | Stearic Acid | 10.00% |
| | | | | WPI | Whey Protein Isolate | 40.00% |
| 487 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.5 | | | | | |
| 488 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.6 | | | | | |
| 489 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.7 | | | | | |
| 490 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.8 | | | | | |
| 491 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.9 | | | | | |
| 492 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.10 | | | | | |
| 493 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.11 | | | | | |
| 494 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.12 | | | | | |
| 495 | CARNW- | Hot Melt High | Hammer | CARNW | Carnauba Wax | 38.00% |
| | EC:100-STEA- | Shear | Milling | EC:100 | Ethyl Cellulose 100 cP | 10.00% |
| | FOLA- | Homogenization | | FOLA | Folic Acid, Folate | 2.00% |
| | WPI_380-100- | | | STEA | Stearic Acid | 10.00% |
| | 100-20- | | | WPI | Whey Protein Isolate | 40.00% |
| | 400; EC:100- | | | | | |
| | L100- | | | | | |
| | NSEnt_12-20- | | | | | |
| | 3.13 | | | | | |
| 496 | CARNW- | Hot Melt High | | CARNW | Carnauba Wax | 10.00% |
| | EC:100-WPI- | Shear | | EC:100 | Ethyl Cellulose 100 cP | 15.00% |
| | OLEA_100- | Homogenization | | OLEA | Oleic Acid | 65.00% |
| | 150-100-650 | | | WPI | Whey Protein Isolate | 10.00% |
| 497 | CARNW- | Hot Melt High | Hammer | CARNW | Carnauba Wax | 50.00% |
| | hWPI_500-500 | Shear | Milling | hWPI | Hydrolyzed Whey Protein | 50.00% |
| | | Homogenization | | | Isolate | |
| 498 | CARNW-LEC- | Hot Melt High | | CARNW | Carnauba Wax | 80.00% |
| | WPI_800-150- | Shear | | LEC | Lecithin | 15.00% |
| | 50 | Homogenization | | WPI | Whey Protein Isolate | 5.00% |
| 499 | CARNW-LEC- | Hot Melt High | | CARNW | Carnauba Wax | 85.00% |
| | WPI_850-50- | Shear | | LEC | Lecithin | 5.00% |
| | 100 | Homogenization | | WPI | Whey Protein Isolate | 10.00% |
| 500 | CARNW- | Hot Melt High | Hammer | CARNW | Carnauba Wax | 50.00% |
| | WPI_500-500 | Shear | Milling | WPI | Whey Protein Isolate | 50.00% |
| | | Homogenization | | | | |
| 501 | CARNW-WPI- | Hot Melt High | | CARNW | Carnauba Wax | 15.00% |
| | OLEA_150- | Shear | | OLEA | Oleic Acid | 75.00% |
| | 100-750 | Homogenization | | WPI | Whey Protein Isolate | 10.00% |
| 502 | CARNW-WPI- | Hot Melt High | | CARNW | Carnauba Wax | 20.00% |
| | OLEA_200- | Shear | | OLEA | Oleic Acid | 70.00% |
| | 100-700 | Homogenization | | WPI | Whey Protein Isolate | 10.00% |
| 503 | CCAS | Unmodified | | CCAS | Calcium Caseinate | |
| | | Payload | | | | |
| 504 | CEW- | Hot Melt High | | ACETEM | Acetic acid esters of mono- | 15.00% |
| | ACETEM- | Shear | | | and diglycerides | |
| | WPI_750-150- | Homogenization | | CEW | Cetyl Esters Wax | 75.00% |
| | 100 | | | WPI | Whey Protein Isolate | 10.00% |
| 505 | CEW- | Hot Melt High | | CEW | Cetyl Esters Wax | 75.00% |
| | CITREM- | Shear | | CITREM | Citric Acid Esters of Mono | 15.00% |
| | WPI_750-150- | Homogenization | | | and Diglycerides | |
| | 100 | | | WPI | Whey Protein Isolate | 10.00% |
| 506 | CEW- | Hot Melt High | | CEW | Cetyl Esters Wax | 77.27% |
| | CITREM- | Shear | | CITREM | Citric Acid Esters of Mono | 13.64% |
| | WPI_850-150- | Homogenization | | | and Diglycerides | |
| | 100 | | | WPI | Whey Protein Isolate | 9.09% |
| 507 | CEW-DMDN- | Hot Melt High | | CEW | Cetyl Esters Wax | 75.00% |
| | WPI_750-150- | Shear | | DMDN | Dimodan | 15.00% |
| | 100 | Homogenization | | WPI | Whey Protein Isolate | 10.00% |
| 508 | CEW-DMDN- | Hot Melt High | | CEW | Cetyl Esters Wax | 77.27% |
| | WPI_850-150- | Shear | | DMDN | Dimodan | 13.64% |
| | 100 | Homogenization | | WPI | Whey Protein Isolate | 9.09% |
| 509 | CEW-EC:100- | Hot Melt High | | CEW | Cetyl Esters Wax | 75.00% |
| | WPI_750-150- | Shear | | EC:100 | Ethyl Cellulose 100 cP | 15.00% |
| | 100 | Homogenization | | WPI | Whey Protein Isolate | 10.00% |
| 510 | CEW-EC:100- | Hot Melt High | | CEW | Cetyl Esters Wax | 80.00% |
| | WPI_800-150- | Shear | | EC:100 | Ethyl Cellulose 100 cP | 15.00% |
| | 50 | Homogenization | | WPI | Whey Protein Isolate | 5.00% |
| 511 | CEW-EC:100- | Hot Melt High | | CEW | Cetyl Esters Wax | 85.00% |
| | WPI_850-50- | Shear | | EC:100 | Ethyl Cellulose 100 cP | 5.00% |
| | 100 | Homogenization | | WPI | Whey Protein Isolate | 10.00% |
| 512 | CEW-EC:100- | Hot Melt High | | CEW | Cetyl Esters Wax | 90.00% |
| | WPI_900-50- | Shear | | EC:100 | Ethyl Cellulose 100 cP | 5.00% |
| | 50 | Homogenization | | WPI | Whey Protein Isolate | 5.00% |
| 513 | CEW-GEL50- | Hot Melt High | | CEW | Cetyl Esters Wax | 75.00% |
| | WPI_750-150- | Shear | | | | |
| | 100 | Homogenization | | WPI | Whey Protein Isolate | 10.00% |
| 514 | CEW-GEL50- | Hot Melt High | | CEW | Cetyl Esters Wax | 80.00% |
| | WPI_800-150- | Shear | | | | |
| | 50 | Homogenization | | WPI | Whey Protein Isolate | 5.00% |
| 515 | CEW-GEL50- | Hot Melt High | | CEW | Cetyl Esters Wax | 85.00% |
| | WPI_850-50- | Shear | | WPI | Whey Protein Isolate | 10.00% |
| | 100 | Homogenization | | | | |
| 516 | CEW-GEL50- | Hot Melt High | | CEW | Cetyl Esters Wax | 90.00% |
| | WPI_900-50- | Shear | | WPI | Whey Protein Isolate | 5.00% |
| | 50 | Homogenization | | | | |
| 517 | CEW-KARG- | Hot Melt High | | CEW | Cetyl Esters Wax | 80.00% |
| | WPI_800-150- | Shear | | KARG | Karaya Gum | 15.00% |
| | 50 | Homogenization | | WPI | Whey Protein Isolate | 5.00% |
| 518 | CEW-LEC- | Hot Melt High | | CEW | Cetyl Esters Wax | 75.00% |
| | WPI_750-150- | Shear | | LEC | Lecithin | 15.00% |
| | 100 | Homogenization | | WPI | Whey Protein Isolate | 10.00% |
| 519 | CEW-LEC- | Hot Melt High | | CEW | Cetyl Esters Wax | 90.00% |
| | WPI_900-50- | Shear | | LEC | Lecithin | 5.00% |
| | 50 | Homogenization | | WPI | Whey Protein Isolate | 5.00% |
| 520 | CEW-PGPR- | Hot Melt High | | CEW | Cetyl Esters Wax | 75.00% |
| | WPI_750-150- | Shear | | PGPR | Polyglycerol Polyricinoleate | 15.00% |
| | 100 | Homogenization | | WPI | Whey Protein Isolate | 10.00% |
| 521 | CEW-SESO- | Hot Melt High | | CEW | Cetyl Esters Wax | 75.00% |
| | WPI_750-150- | Shear | | SESO | Sesame Oil | 15.00% |
| | 100 | Homogenization | | WPI | Whey Protein Isolate | 10.00% |
| 522 | CEW-SESO- | Hot Melt High | | CEW | Cetyl Esters Wax | 80.00% |
| | WPI_800-150- | Shear | | SESO | Sesame Oil | 15.00% |
| | 50 | Homogenization | | WPI | Whey Protein Isolate | 5.00% |
| 523 | CEW-SESO- | Hot Melt High | | CEW | Cetyl Esters Wax | 85.00% |
| | WPI_850-50- | Shear | | SESO | Sesame Oil | 5.00% |
| | 100 | Homogenization | | WPI | Whey Protein Isolate | 10.00% |
| 524 | CEW-SESO- | Hot Melt High | | CEW | Cetyl Esters Wax | 90.00% |
| | WPI_900-50- | Shear | | SESO | Sesame Oil | 5.00% |
| | 50 | Homogenization | | WPI | Whey Protein Isolate | 5.00% |
| 525 | CEW-SITO- | Hot Melt High | | CEW | Cetyl Esters Wax | 70.00% |
| | WPI_700-200- | Shear | | SITO | Sitosterol | 20.00% |
| | 100 | Homogenization | | WPI | Whey Protein Isolate | 10.00% |
| 526 | CEW-SP40- | Hot Melt High | | CEW | Cetyl Esters Wax | 75.00% |
| | WPI_750-150- | Shear | | SP40 | Span 40: Sorbitan | 15.00% |
| | 100 | Homogenization | | | Monopalmitate | |
| | | | | WPI | Whey Protein Isolate | 10.00% |
| 527 | CEW-SP40- | Hot Melt High | | CEW | Cetyl Esters Wax | 90.00% |
| | WPI_900-50- | Shear | | SP40 | Span 40: Sorbitan | 5.00% |
| | 50 | Homogenization | | | Monopalmitate | |
| | | | | WPI | Whey Protein Isolate | 5.00% |
| 528 | CEW-SP80- | Hot Melt High | | CEW | Cetyl Esters Wax | 75.00% |
| | WPI_750-150- | Shear | | SP80 | Span 80: Sorbitan Monooleate | 15.00% |
| | 100 | Homogenization | | WPI | Whey Protein Isolate | 10.00% |
| 529 | CEW-SP80- | Hot Melt High | | CEW | Cetyl Esters Wax | 90.00% |
| | WPI_900-50- | Shear | | SP80 | Span 80: Sorbitan Monooleate | 5.00% |
| | 50 | Homogenization | | WPI | Whey Protein Isolate | 5.00% |
| 530 | CEW-TW85- | Hot Melt High | | CEW | Cetyl Esters Wax | 75.00% |
| | WPI_750-150- | Shear | | TW85 | Tween 85: Polyoxyethylene | 15.00% |
| | 100 | Homogenization | | | sorbitan trioleate | |
| | | | | WPI | Whey Protein Isolate | 10.00% |
| 531 | CEW-WPI- | Hot Melt High | | CEW | Cetyl Esters Wax | 20.00% |
| | TOLE_200- | Shear | | TOLE | Triolein | 70.00% |
| | 100-700 | Homogenization | | WPI | Whey Protein Isolate | 10.00% |
| 532 | CHILO-GENI- | Aqueous | | CHILO | Chitosan Low Molecular | 1.80% |
| | WPI_18-2-100 | Hydrogel | | | Weight | |
| | | Formation | | GENI | Genipin | 0.20% |
| | | | | WATER | Water | 88.00% |
| | | | | WPI | Whey Protein Isolate | 10.00% |
| 533 | CHILO- | Aqueous | | CHILO | Chitosan Low Molecular | 1.20% |
| | WPI_12-100 | Hydrogel | | | Weight | |
| | | Formation | | WATER | Water | 88.80% |
| | | | | WPI | Whey Protein Isolate | 10.00% |
| | | Hot Melt High | | CHILO | Chitosan Low Molecular | 10.71% |
| | | Shear | | | Weight | |
| | | Homogenization | | WPI | Whey Protein Isolate | 89.29% |
| 534 | CHOLE-WPI- | Hot Melt High | | CHOLE | Cholesterol | 20.00% |
| | OLEA_200- | Shear | | OLEA | Oleic Acid | 70.00% |
| | 100-700 | Homogenization | | WPI | Whey Protein Isolate | 10.00% |
| 535 | COCOW- | Hot Melt High | | COCOW | Coconut Oil | 75.00% |
| | EC:100- | Shear | | EC:100 | Ethyl Cellulose 100 cP | 15.00% |
| | WPI_750-150- | Homogenization | | WPI | Whey Protein Isolate | 10.00% |
| | 100 | | | | | |
| 536 | COCOW- | Hot Melt High | | COCOW | Coconut Oil | 80.00% |
| | EC:100- | Shear | | EC:100 | Ethyl Cellulose 100 cP | 15.00% |
| | WPI_800-150- | Homogenization | | WPI | Whey Protein Isolate | 5.00% |
| | 50 | | | | | |
| 537 | COCOW- | Hot Melt High | | COCOW | Coconut Oil | 85.00% |
| | EC:100- | Shear | | EC:100 | Ethyl Cellulose 100 cP | 5.00% |
| | WPI_850-50- | Homogenization | | WPI | Whey Protein Isolate | 10.00% |
| | 100 | | | | | |
| 538 | COCOW- | Hot Melt High | | COCOW | Coconut Oil | 85.00% |
| | SESO- | Shear | | SESO | Sesame Oil | 5.00% |
| | WPI_850-50- | Homogenization | | WPI | Whey Protein Isolate | 10.00% |
| | 100 | | | | | |
| 539 | COCOW- | Hot Melt High | | COCOW | Coconut Oil | 90.00% |
| | SESO- | Shear | | SESO | Sesame Oil | 5.00% |
| | WPI_900-50- | Homogenization | | WPI | Whey Protein Isolate | 5.00% |
| | 50 | | | | | |
| 540 | DRITEX- | Hot Melt High | Hammer | ALA | Linoleic Acid | 20.00% |
| | CARNW- | Shear | Milling | BSWX | Beeswax | 25.00% |
| | BSWX- | Homogenization | | CARNW | Carnauba Wax | 10.00% |
| | ALA_450-100- | | | | | |
| | 250-200 | | | DRITEX | Dritex Shortening Flakes | 45.00% |
| 541 | DRITEX- | Hot Melt High | Hammer | BSWX | Beeswax | 25.00% |
| | CARNW- | Shear | Milling | CARNW | Carnauba Wax | 10.00% |
| | BSWX- | Homogenization | | DRITEX | Dritex Shortening Flakes | 45.00% |
| | QRCTN_450- | | | QRCTN | Quercetin Hydrate | 20.00% |
| | 100-250-200 | | | | | |
| 542 | DRITEX- | Hot Melt High | Hammer | ALA | Linoleic Acid | 20.00% |
| | CARNW- | Shear | Milling | CARNW | Carnauba Wax | 10.00% |
| | CHOLE- | Homogenization | | CHOLE | Cholesterol | 25.00% |
| | ALA_450-100- | | | DRITEX | Dritex Shortening Flakes | 45.00% |
| | 250-200 | | | | | |
| 543 | DRITEX- | Hot Melt High | Hammer | CARNW | Carnauba Wax | 10.00% |
| | CARNW- | Shear | Milling | CHOLE | Cholesterol | 25.00% |
| | CHOLE- | Homogenization | | DRITEX | Dritex Shortening Flakes | 45.00% |
| | QRCTN_450- | | | QRCTN | Quercetin Hydrate | 20.00% |
| | 100-250-200 | | | | | |
| 544 | DRITEX- | Hot Melt High | Hammer | ALA | Linoleic Acid | 20.00% |
| | CARNW- | Shear | Milling | CARNW | Carnauba Wax | 10.00% |
| | EC:100- | Homogenization | | DRITEX | Dritex Shortening Flakes | 45.00% |
| | ALA_450-100- | | | EC:100 | Ethyl Cellulose 100 cP | 25.00% |
| | 250-200 | | | | | |
| 545 | DRITEX | Hot Melt High | Hammer | CARNW | Carnauba Wax | 10.00% |
| | CARNW- | Shear | Milling | DRITEX | Dritex Shortening Flakes | 45.00% |
| | EC:100- | Homogenization | | EC:100 | Ethyl Cellulose 100 cP | 25.00% |
| | QRCTN_450- | | | QRCTN | Quercetin Hydrate | 20.00% |
| | 100-250-200 | | | | | |
| 546 | DRITEX- | Hot Melt High | Hammer | ALA | Linoleic Acid | 20.00% |
| | CARNW- | Shear | Milling | CARNW | Carnauba Wax | 10.00% |
| | FOLA- | Homogenization | | DRITEX | Dritex Shortening Flakes | 45.00% |
| | ALA_450-100- | | | FOLA | Folic Acid, Folate | 25.00% |
| | 250-200 | | | | | |
| 547 | DRITEX- | Hot Melt High | Hammer | CARNW | Carnauba Wax | 10.00% |
| | CARNW- | Shear | Milling | DRITEX | Dritex Shortening Flakes | 45.00% |
| | FOLA- | Homogenization | | FOLA | Folic Acid, Folate | 25.00% |
| | QRCTN_450- | | | QRCTN | Quercetin Hydrate | 20.00% |
| | 100-250-200 | | | | | |
| 548 | DRITEX- | Hot Melt High | Hammer | ALA | Linoleic Acid | 20.00% |
| | CARNW- | Shear | Milling | CARNW | Carnauba Wax | 10.00% |
| | K188- | Homogenization | | DRITEX | Dritex Shortening Flakes | 45.00% |
| | ALA_450-100- | | | K188 | Koliphor 188 | |
| | 250-200 | | | | | 25.00% |
| 549 | DRITEX- | Hot Melt High | Hammer | CARNW | Carnauba Wax | 10.00% |
| | CARNW- | Shear | Milling | DRITEX | Dritex Shortening Flakes | 45.00% |
| | K188- | Homogenization | | K188 | Koliphor 188 | 25.00% |
| | QRCTN_450- | | | QRCTN | Quercetin Hydrate | 20.00% |
| | 100-250-200 | | | | | |
| 550 | DRITEX- | Hot Melt High | Hammer | CARNW | Carnauba Wax | 10.00% |
| | CARNW-LEC- | Shear | Milling | DRITEX | Dritex Shortening Flakes | 45.00% |
| | QRCTN_450- | Homogenization | | LEC | Lecithin | 25.00% |
| | 100-250-200 | | | QRCTN | Quercetin Hydrate | 20.00% |
| 551 | DRITEX- | Hot Melt High | Hammer | ALA | Linoleic Acid | 20.00% |
| | CARNW- | Shear | Milling | CARNW | Carnauba Wax | 10.00% |
| | PGMS- | Homogenization | | DRITEX | Dritex Shortening Flakes | 45.00% |
| | ALA_450-100- | | | PGMS | Propylene glycol monostearate | 25.00% |
| | 250-200 | | | | | |
| 552 | DRITEX- | Hot Melt High | Hammer | CARNW | Carnauba Wax | 10.00% |
| | CARNW- | Shear | Milling | DRITEX | Dritex Shortening Flakes | 45.00% |
| | PGMS- | Homogenization | | PGMS | Propylene glycol monostearate | 25.00% |
| | QRCTN_450- | | | QRCTN | Quercetin Hydrate | 20.00% |
| | 100-250-200 | | | | | |
| 553 | DRITEX- | Hot Melt High | Hammer | ALA | Linoleic Acid | 20.00% |
| | CARNW- | Shear | Milling | CARNW | Carnauba Wax | 10.00% |
| | SITO- | Homogenization | | DRITEX | Dritex Shortening Flakes | 45.00% |
| | ALA_450-100- | | | SITO | Sitosterol | 25.00% |
| | 250-200 | | | | | |
| 554 | DRITEX- | Hot Melt High | Hammer | ALA | Linoleic Acid | 20.00% |
| | CARNW- | Shear | Milling | CARNW | Carnauba Wax | 10.00% |
| | STEA- | Homogenization | | DRITEX | Dritex Shortening Flakes | 45.00% |
| | ALA_450-100- | | | STEA | Stearic Acid | 25.00% |
| | 250-200 | | | | | |
| 555 | DRITEX- | Hot Melt High | Hammer | CARNW | Carnauba Wax | 10.00% |
| | CARNW- | Shear | Milling | DRITEX | Dritex Shortening Flakes | 45.00% |
| | STEA- | Homogenization | | QRCTN | Quercetin Hydrate | 20.00% |
| | QRCTN_450- | | | STEA | Stearic Acid | 25.00% |
| | 100-250-200 | | | | | |
| 556 | DRITEX- | Hot Melt High | | CHOLE | Cholesterol | 20.00% |
| | CHOLE- | Shear | | DRITEX | Dritex Shortening Flakes | 40.00% |
| | WPI_400-200- | Homogenization | | WPI | Whey Protein Isolate | 40.00% |
| | 400 | | | | | |
| 557 | DRITEX- | Hot Melt High | | DRITEX | Dritex Shortening Flakes | 40.00% |
| | EC:100- | Shear | | EC:100 | Ethyl Cellulose 100 cP | 20.00% |
| | WPI_400-200- | Homogenization | | WPI | Whey Protein Isolate | 40.00% |
| | 400 | | | | | |
| 558 | DRITEX-F127- | Hot Melt High | | DRITEX | Dritex Shortening Flakes | 40.00% |
| | WPI_400-200- | Shear | | F127 | Pluronic F127, Poloxamer 407 | 20.00% |
| | 400 | Homogenization | | WPI | Whey Protein Isolate | 40.00% |
| 560 | DRITEX- | Hot Melt High | | DRITEX | Dritex Shortening Flakes | 40.00% |
| | FOLA- | Shear | | FOLA | Folic Acid, Folate | 20.00% |
| | WPI_400-200- | Homogenization | | WPI | Whey Protein Isolate | 40.00% |
| | 400 | | | | | |
| 561 | DRITEX- | Hot Melt High | | DRITEX | Dritex Shortening Flakes | 40.00% |
| | MYRJ52- | Shear | | MYRJ52 | Polyoxyethylene (40) stearate | 20.00% |
| | WPI_400-200- | Homogenization | | WPI | Whey Protein Isolate | 40.00% |
| | 400 | | | | | |
| 562 | DRITEX- | Hot Melt High | | DRITEX | Dritex Shortening Flakes | 40.00% |
| | SITO- | Shear | | SITO | Sitosterol | 20.00% |
| | WPI_400-200- | Homogenization | | WPI | Whey Protein Isolate | 40.00% |
| | 400 | | | | | |
| 563 | DRITEX- | Hot Melt High | | DRITEX | Dritex Shortening Flakes | 40.00% |
| | TW40- | Shear | | TW40 | Tween 40: Polysorbate 40 | 20.00% |
| | WPI_400-200- | Homogenization | | WPI | Whey Protein Isolate | 40.00% |
| | 400 | | | | | |
| 564 | DRITEX- | Hot Melt High | | DRITEX | Dritex Shortening Flakes | 40.00% |
| | TW80- | Shear | | TW80 | Tween 80: Polysorbate 80 | 20.00% |
| | WPI_400-200- | Homogenization | | WPI | Whey Protein Isolate | 40.00% |
| | 400 | | | | | |
| 565 | DTPS-TW85- | Hot Melt High | | DTPS | | 86.96% |
| | WPI_800-20- | Shear | | TW85 | Tween 85: Polyoxyethylene | 2.17% |
| | 100 | Homogenization | | | sorbitan trioleate | |
| | | | | WPI | Whey Protein Isolate | 10.87% |
| 566 | EC:22-WPI- | Hot Melt High | | EC:22 | Ethyl Cellulose 22 cP | 20.00% |
| | OLEA_200- | Shear | | OLEA | Oleic Acid | 70.00% |
| | 100-700 | Homogenization | | WPI | Whey Protein Isolate | 10.00% |
| 567 | EC:100-SIO2- | Hot Melt High | | EC:100 | Ethyl Cellulose 100 cP | 15.00% |
| | WPI- | Shear | | OLEA | Oleic Acid | 60.00% |
| | OLEA_150-50- | Homogenization | | SIO2 | Silicon Dioxide | 5.00% |
| | 200-600 | | | WPI | Whey Protein Isolate | 20.00% |
| 568 | EC:100-WPI- | Hot Melt High | | EC:100 | Ethyl Cellulose 100 cP | 10.00% |
| | OLEA_100- | Shear | | OLEA | Oleic Acid | 80.00% |
| | 100-800 | Homogenization | | WPI | Whey Protein Isolate | 10.00% |
| 569 | EC:100-WPI- | Hot Melt High | | EC:100 | Ethyl Cellulose 100 cP | 15.00% |
| | OLEA_150- | Shear | | OLEA | Olcic Acid | 75.00% |
| | 100-750 | Homogenization | | WPI | Whey Protein Isolate | 10.00% |
| 570 | EC:100-WPI- | Hot Melt High | | EC:100 | Ethyl Cellulose 100 cP | 20.00% |
| | OLEA_200- | Shear | | OLEA | Oleic Acid | 60.00% |
| | 200-600 | Homogenization | | WPI | Whey Protein Isolate | 20.00% |
| 571 | EC:100-WPI- | Hot Melt High | | EC:100 | Ethyl Cellulose 100 cP | 20.00% |
| | OLEA_200- | Shear | | OLEA | Oleic Acid | 55.00% |
| | 250-550 | Homogenization | | WPI | Whey Protein Isolate | 25.00% |
| 572 | EC:100-WPI- | Hot Melt High | | EC:100 | Ethyl Cellulose 100 cP | 20.00% |
| | OLEA_200- | Shear | | OLEA | Oleic Acid | 50.00% |
| | 300-500 | Homogenization | | WPI | Whey Protein Isolate | 30.00% |
| 573 | EC:100-WPI- | Hot Melt High | | EC:100 | Ethyl Cellulose 100 cP | 25.00% |
| | OLEA_250- | Shear | | OLEA | Oleic Acid | 65.00% |
| | 100-650 | Homogenization | | WPI | Whey Protein Isolate | 10.00% |
| 574 | EC:300-WPI- | Hot Melt High | | EC:300 | Ethyl Cellulose 300 cP | 20.00% |
| | OLEA_200- | Shear | | OLEA | Oleic Acid | 70.00% |
| | 100-700 | Homogenization | | WPI | Whey Protein Isolate | 10.00% |
| 575 | GLTN-LBG- | Aqueous | | GLTN | Gelatin | 5.00% |
| | INLN_50-2-50 | Hydrogel | | INLN | Inulin | 5.00% |
| | | Formation | | LBG | Locust Bean Gum | 0.20% |
| | | | | WATER | Water | 89.80% |
| | | Aqueous | Hammer | GLTN | Gelatin | 49.02% |
| | | Hydrogel | Milling | INLN | Inulin | 49.02% |
| | | Formation | | LBG | Locust Bean Gum | 1.96% |
| | | followed by | | | | |
| | | Oven Drying | | | | |
| 576 | GLTN-LBG- | Aqueous | | GLTN | Gelatin | 10.00% |
| | INLN_100-2- | Hydrogel | | INLN | Inulin | 5.00% |
| | 50 | Formation | | LBG | Locust Bean Gum | 0.20% |
| | | | | WATER | Water | 84.80% |
| | | Aqueous | Hammer | GLTN | Gelatin | 65.79% |
| | | Hydrogel | Milling | INLN | Inulin | 32.89% |
| | | Formation | | LBG | Locust Bean Gum | 1.32% |
| | | followed by | | | | |
| | | Oven Drying | | | | |
| 577 | GMO-EC:100- | Hot Melt High | | EC:100 | Ethyl Cellulose 100 cP | 15.00% |
| | WPI- | Shear | | GMO | Glyceryl Monooleate | 5.00% |
| | OLEA_50-150- | Homogenization | | OLEA | Oleic Acid | 70.00% |
| | 100-700 | | | WPI | Whey Protein Isolate | 10.00% |
| 578 | GMS-EC:100- | Hot Melt High | | EC:100 | Ethyl Cellulose 100 cP | 15.00% |
| | WPI- | Shear | | GMS | Glyceryl Monostearate | 5.00% |
| | OLEA_50-150- | Homogenization | | OLEA | Oleic Acid | 70.00% |
| | 100-700 | | | WPI | Whey Protein Isolate | 10.00% |
| 579 | hWPI | Unmodified | | hWPI | Hydrolyzed Whey Protein | |
| | | Payload | | | Isolate | |
| 580 | INLN | Unmodified | | INLN | Inulin | |
| | | Payload | | | | |
| 581 | K188-WPI- | Hot Melt High | | K188 | Koliphor 188 | 25.00% |
| | OLEA_250- | Shear | | OLEA | Oleic Acid | 65.00% |
| | 100-650 | Homogenization | | WPI | Whey Protein Isolate | 10.00% |
| 582 | KCARR-KCL- | Aqueous | | INLN | Inulin | 5.00% |
| | LBG- | Hydrogel | | KCARR | Kappa Carrageenan | 5.00% |
| | INLN_50-5-2- | Formation | | KCL | Potassium Chloride | 0.50% |
| | 50 | | | LBG | Locust Bean Gum | 0.20% |
| | | | | WATER | Water | 89.30% |
| | | Aqueous | Hammer | INLN | Inulin | 46.73% |
| | | Hydrogel | Milling | KCARR | Kappa Carrageenan | 46.73% |
| | | Formation | | KCL | Potassium Chloride | 4.67% |
| | | followed by | | LBG | Locust Bean Gum | 1.87% |
| | | Oven Drying | | | | |
| 583 | KCARR-KCL- | Aqueous | | INLN | Inulin | 5.00% |
| | LBG- | Hydrogel | | KCARR | Kappa Carrageenan | 5.00% |
| | INLN_50-15-2- | Formation | | KCL | Potassium Chloride | 1.50% |
| | 50 | | | LBG | Locust Bean Gum | 0.20% |
| | | | | WATER | Water | 88.30% |
| | | Aqueous | Hammer | INLN | Inulin | 42.74% |
| | | Hydrogel | Milling | KCARR | Kappa Carrageenan | 42.74% |
| | | Formation | | KCL | Potassium Chloride | 12.82% |
| | | followed by | | LBG | Locust Bean Gum | 1.71% |
| | | Oven Drying | | | | |
| 584 | KCARR-KCL- | Aqueous | | INLN | Inulin | 5.00% |
| | LBG- | Hydrogel | | KCARR | Kappa Carrageenan | 5.00% |
| | INLN_50-25-2- | Formation | | KCL | Potassium Chloride | 2.50% |
| | 50 | | | LBG | Locust Bean Gum | 0.20% |
| | | | | WATER | Water | 87.30% |
| | | Aqueous | Hammer | INLN | Inulin | 39.37% |
| | | Hydrogel | Milling | KCARR | Kappa Carrageenan | 39.37% |
| | | Formation | | KCL | Potassium Chloride | 19.69% |
| | | followed by | | LBG | Locust Bean Gum | 1.57% |
| | | Oven Drying | | | | |
| 585 | LEC-EC:100- | Hot Melt High | | EC:100 | Ethyl Cellulose 100 cP | 15.00% |
| | WPI- | Shear | | LEC | Lecithin | 5.00% |
| | OLEA_50-150- | Homogenization | | OLEA | Oleic Acid | 70.00% |
| | 100-700 | | | WPI | Whey Protein Isolate | 10.00% |
| 586 | MCAS- | Granulation, | Fluidized Bed | EC:300 | Ethyl Cellulose 300 cP | 12.00% |
| | STRTB-LAC- | Cold Extrusion, | Coating | NLN | Inulin | 9.93% |
| | INLN_33.1- | and | | L100 | Eurgagit Control | 20.00% |
| | 13.24-9.93- | Spheronization | | LAC | D-Lactose | 9.93% |
| | 9.93; EC-L100- | | | MCAS | Micellar Casein | 33.10% |
| | NT-12-20-1.8 | | | NT | Sodium Alginate | 1.80% |
| | | | | STRTB | StarTab by Colorcon | 13.24% |
| 587 | MCAS- | Granulation, | | INLN | Inulin | 15.00% |
| | STRTB-LAC- | Cold Extrusion, | | LAC | D-Lactose | 15.00% |
| | INLN_50-20- | and | | MCAS | Micellar Cascin | 50.00% |
| | 15-15 | Spheronization | | STRTB | StarTab by Colorcon | 20.00% |
| 588 | MCC- | Granulation, | Fluidized Bed | DFLO | dry flo by ingrdeion | 2.35% |
| | HPC:33L- | Cold Extrusion, | Coating | EC:300 | Ethyl Cellulose 300 cP | 16.46% |
| | DFLO-INLN- | and | | FITCINLN | FITC Inulin | 0.94% |
| | FITCINLN_50- | Spheronization | | HPC:33L | Hydroxypropyl Cellulose | 2.35% |
| | 2.85-2.85- | | | | Grade 33L | |
| | 21.66-1.14; EC- | | | HPMC | Hydroxypropyl methylcellulose | 14.81% |
| | HPMC-NT-20- | | | INLN | Inulin | 17.83% |
| | 18-5 | | | MCC | Microcrystalline Cellulose | 41.15% |
| | | | | NT | Sodium Alginate | 4.12% |
| 589 | MCC- | Granulation, | Fluidized Bed | CHILO | Chitosan Low Molecular | 3.75% |
| | HPC:33L- | Cold Extrusion, | Coating | | Weight | |
| | DFLO-INLN- | and | | DFLO | dry flo by ingrdeion | 4.05% |
| | FITCINLN_50- | Spheronization | | EC:300 | Ethyl Cellulose 300 cP | 8.90% |
| | 4.32-4.32- | | | FITCINLN | FITC Inulin | 1.62% |
| | 32.87-1.73; EC- | | | HPC:33L | Hydroxypropyl Cellulose | 4.05% |
| | CHILO-9.5-4 | | | | Grade 33L | |
| | | | | INLN | Inulin | 30.79% |
| | | | | MCC | Microcrystalline Cellulose | 46.84% |
| 590 | MCC- | Granulation, | | DFLO | dry flo by ingrdeion | 5.00% |
| | HPC:33L- | Cold Extrusion, | | FITCINLN | FITC Inulin | 2.00% |
| | DFLO-INLN- | and | | HPC:33L | Hydroxypropyl Cellulose | 5.00% |
| | FITCINLN_50- | Spheronization | | | Grade 33L | |
| | 5-5-38-2 | | | INLN | Inulin | 38.00% |
| | | | | MCC | Microcrystalline Cellulose | 50.00% |
| 591 | MCC-LAC- | Granulation, | | LAC | D-Lactose | 20.00% |
| | MCAS_2-1-2 | Cold Extrusion, | | | | |
| | | and | | MCAS | Micellar Casein | 40.00% |
| | | Spheronization | | MCC | Microcrystalline Cellulose | 40.00% |
| 592 | MCC-LAC- | Granulation, | Fluidized Bed | EC:300 | Ethyl Cellulose 300 cP | 5.00% |
| | MCAS_38-19- | Cold Extrusion, | Coating | LAC | D-Lactose | 19.00% |
| | 38; EC-5 | and | | MCAS | Micellar Casein | 38.00% |
| | | Spheronization | | MCC | Microcrystalline Cellulose | 38.00% |
| 593 | PEG:PPG- | Hot Melt High | | OLEA | Oleic Acid | 65.00% |
| | WPI- | Shear | | PEG:PPG | Poly(ethylene glycol)-block- | 25.00% |
| | OLEA_250- | Homogenization | | | poly(propylene glycol)-block- | |
| | 100-650 | | | | poly(ethylene glycol) | |
| | | | | WPI | Whey Protein Isolate | 10.00% |
| 594 | PEG:PPG- | Hot Melt High | | OLEA | Oleic Acid | 60.00% |
| | WPI- | Shear | | PEG:PPG | Poly(ethylene glycol)-block- | 30.00% |
| | OLEA_300- | Homogenization | | | poly(propylene glycol)-block- | |
| | 100-600 | | | | poly(ethylene glycol) | |
| | | | | WPI | Whey Protein Isolate | 10.00% |
| 595 | QRCTN | Unmodified | | QRCTN | Quercetin Hydrate | |
| | | Payload | | | | |
| 596 | RBW-EC:100- | Hot Melt High | | EC:100 | Ethyl Cellulose 100 cP | 15.00% |
| | WPI- | Shear | | OLEA | Oleic Acid | 70.00% |
| | OLEA_50-150- | Homogenization | | RBW | Rice Bran Wax | 5.00% |
| | 100-700 | | | WPI | Whey Protein Isolate | 10.00% |
| 597 | RBW-K188- | Hot Melt High | | K188 | Koliphor 188 | 15.00% |
| | WPI_750-150- | Shear | | RBW | Rice Bran Wax | 75.00% |
| | 100 | Homogenization | | WPI | Whey Protein Isolate | 10.00% |
| 598 | RBW-K188- | Hot Melt High | | K188 | Koliphor 188 | 5.00% |
| | WPI_850-50- | Shear | | RBW | Rice Bran Wax | 85.00% |
| | 100 | Homogenization | | WPI | Whey Protein Isolate | 10.00% |
| 599 | RBW-SP80- | Hot Melt High | | RBW | Rice Bran Wax | 75.00% |
| | WPI_750-150- | Shear | | SP80 | Span 80: Sorbitan Monooleate | 15.00% |
| | 100 | Homogenization | | WPI | Whey Protein Isolate | 10.00% |
| 600 | RBW-TW80- | Hot Melt High | | RBW | Rice Bran Wax | 75.00% |
| | WPI_750-150- | Shear | | TW80 | Tween 80: Polysorbate 80 | 15.00% |
| | 100 | Homogenization | | WPI | Whey Protein Isolate | 10.00% |
| 601 | RBW-WPI- | Hot Melt High | | OLEA | Oleic Acid | 80.00% |
| | OLEA_100- | Shear | | RBW | Rice Bran Wax | 10.00% |
| | 100-800 | Homogenization | | WPI | Whey Protein Isolate | 10.00% |
| 602 | RBW-WPI- | Hot Melt High | | OLEA | Oleic Acid | 70.00% |
| | OLEA_200- | Shear | | RBW | Rice Bran Wax | 20.00% |
| | 100-700 | Homogenization | | WPI | Whey Protein Isolate | 10.00% |
| 603 | RBW-WPI- | Hot Melt High | | OLEA | Oleic Acid | 60.00% |
| | OLEA_200- | Shear | | RBW | Rice Bran Wax | 20.00% |
| | 200-600 | Homogenization | | WPI | Whey Protein Isolate | 20.00% |
| 604 | RBW-WPI- | Hot Melt High | | OLEA | Oleic Acid | 50.00% |
| | OLEA_200- | Shear | | RBW | Rice Bran Wax | 20.00% |
| | 300-500 | Homogenization | | WPI | Whey Protein Isolate | 30.00% |
| 605 | RBW-WPI- | Hot Melt High | | OLEA | Oleic Acid | 65.00% |
| | OLEA_250- | Shear | | RBW | Rice Bran Wax | 25.00% |
| | 100-650 | Homogenization | | WPI | Whey Protein Isolate | 10.00% |
| 606 | SESO-LEC- | Hot Melt High | | EC:100 | Ethyl Cellulose 100 cP | 5.00% |
| | EC:100- | Shear | | LEC | Lecithin | 15.00% |
| | WPI_750-150- | Homogenization | | SESO | Sesame Oil | 75.00% |
| | 50-50 | | | WPI | Whey Protein Isolate | 5.00% |
| 607 | SIO2-WPI- | Hot Melt High | | OLEA | Oleic Acid | 85.00% |
| | OLEA_50-100- | Shear | | SIO2 | Silicon Dioxide | 5.00% |
| | 850 | Homogenization | | WPI | Whey Protein Isolate | 10.00% |
| 608 | SIO2-WPI- | Hot Melt High | | OLEA | Oleic Acid | 82.50% |
| | OLEA_75-100- | Shear | | SIO2 | Silicon Dioxide | 7.50% |
| | 825 | Homogenization | | WPI | Whey Protein Isolate | 10.00% |
| 609 | SITO-ORY- | Hot Melt High | | EC:100 | Ethyl Cellulose 100 cP | 10.00% |
| | EC:100-WPI- | Shear | | OLEA | Oleic Acid | 70.00% |
| | OLEA_60-40- | Homogenization | | ORY | gamma-Oryzanol | 4.00% |
| | 100-100-700 | | | SITO | Sitosterol | 6.00% |
| | | | | WPI | Whey Protein Isolate | 10.00% |
| 610 | SITO-ORY- | Hot Melt High | | OLEA | Oleic Acid | 80.00% |
| | WPI- | Shear | | ORY | gamma-Oryzanol | 6.00% |
| | OLEA_40-60- | Homogenization | | SITO | Sitosterol | 5.00% |
| | 100-800 | | | WPI | Whey Protein Isolate | 10.00% |
| 611 | SITO-ORY- | Hot Melt High | | OLEA | Oleic Acid | 80.00% |
| | WPI- | Shear | | ORY | gamma-Oryzanol | 4.00% |
| | OLEA_60-40- | Homogenization | | SITO | Sitosterol | 5.00% |
| | 100-800 | | | WPI | Whey Protein Isolate | 10.00% |
| 612 | SOYW- | Hot Melt High | | SOYW | Soy Wax | 75.00% |
| | GEL50- | Shear | | WPI | Whey Protein Isolate | 10.00% |
| | WPI_750-150- | Homogenization | | | | |
| | 100 | | | | | |
| 613 | SOYW-K188- | Hot Melt High | | K188 | Koliphor 188 | 15.00% |
| | WPI_750-150- | Shear | | SOYW | Soy Wax | 75.00% |
| | 100 | Homogenization | | WPI | Whey Protein Isolate | 10.00% |
| 614 | SOYW-K188- | Hot Melt High | | K188 | Koliphor 188 | 5.00% |
| | WPI_850-50- | Shear | | SOYW | Soy Wax | 85.00% |
| | 100 | Homogenization | | WPI | Whey Protein Isolate | 10.00% |
| 615 | SOYW-LEC- | Hot Melt High | | LEC | Lecithin | 15.00% |
| | WPI_800-150- | Shear | | SOYW | Soy Wax | 80.00% |
| | 50 | Homogenization | | WPI | Whey Protein Isolate | 5.00% |
| 616 | SOYW-LEC- | Hot Melt High | | LEC | Lecithin | 5.00% |
| | WPI_900-50- | Shear | | SOYW | Soy Wax | 90.00% |
| | 50 | Homogenization | | WPI | Whey Protein Isolate | 5.00% |
| 617 | SOYW-SESO- | Hot Melt High | | SESO | Sesame Oil | 5.00% |
| | WPI_900-50- | Shear | | SOYW | Soy Wax | 90.00% |
| | 50 | Homogenization | | WPI | Whey Protein Isolate | 5.00% |
| 618 | SOYW-TW80- | Hot Melt High | | SOYW | Soy Wax | 85.00% |
| | WPI_850-50- | Shear | | TW80 | Tween 80: Polysorbate 80 | 5.00% |
| | 100 | Homogenization | | WPI | Whey Protein Isolate | 10.00% |
| 619 | SOYW-TW85- | Hot Melt High | | EC:100 | Ethyl Cellulose 100 cP | 5.00% |
| | EC:100- | Shear | | SOYW | Soy Wax | 80.00% |
| | WPI_800-50- | Homogenization | | TW85 | Tween 85: Polyoxyethylene | 5.00% |
| | 50-100 | | | | sorbitan trioleate | |
| | | | | WPI | Whey Protein Isolate | 10.00% |
| 620 | SOYW-TW85- | Hot Melt High | | SOYW | Soy Wax | 85.00% |
| | WPI_850-50- | Shear | | TW85 | Tween 85: Polyoxyethylene | 5.00% |
| | 100 | Homogenization | | | sorbitan trioleate | |
| | | | | WPI | Whey Protein Isolate | 10.00% |
| 621 | SOYW-WPI- | Hot Melt High | | OLEA | Oleic Acid | 75.00% |
| | OLEA_150- | Shear | | SOYW | Soy Wax | 15.00% |
| | 100-750 | Homogenization | | WPI | Whey Protein Isolate | 10.00% |
| 622 | SP60-EC:100- | Hot Melt High | | EC:100 | Ethyl Cellulose 100 cP | 15.00% |
| | WPI- | Shear | | OLEA | Oleic Acid | 70.00% |
| | OLEA_50-150- | Homogenization | | SP60 | Span 60: Sorbitan | 5.00% |
| | 100-700 | | | | monostearate | |
| | | | | WPI | Whey Protein Isolate | 10.00% |
| 623 | SP60-WPI- | Hot Melt High | | OLEA | Oleic Acid | 70.00% |
| | OLEA_200- | Shear | | SP60 | Span 60: Sorbitan | 20.00% |
| | 100-700 | Homogenization | | | monostearate | |
| | | | | WPI | Whey Protein Isolate | 10.00% |
| 624 | STRTB-LAC- | Granulation, | Fluidized Bed | HPMCas | Hydroxypropylmethylcellulose | 25.00% |
| | MCAS- | Cold Extrusion, | Coating | | Acetate Succinate | |
| | INLN_18.25- | and | | INLN | Inulin | 3.65% |
| | 10.95-40.15- | Spheronization | | LAC | D-Lactose | 10.95% |
| | 3.65; NT- | | | MCAS | Micellar Casein | 40.15% |
| | HPMCas-2-25 | | | NT | Sodium Alginate | 2.00% |
| | | | | STRTB | StarTab by Colorcon | 18.25% |
| 625 | STRTB-LAC- | Granulation, | Fluidized Bed | HPMCas | Hydroxypropylmethylcellulose | 14.00% |
| | MCAS- | Cold Extrusion, | Coating | | Acetate Succinate | |
| | INLN_20-12- | and | | INLN | Inulin | 4.00% |
| | 44-4; HMPCas- | Spheronization | | LAC | D-Lactose | 12.00% |
| | NT-14-6 | | | MCAS | Micellar Casein | 44.00% |
| | | | | NT | Sodium Alginate | 6.00% |
| | | | | STRTB | StarTab by Colorcon | 20.00% |
| 626 | STRTB-LAC- | Granulation, | Fluidized Bed | HPMCas | Hydroxypropylmethylcellulose | 14.00% |
| | MCAS- | Cold Extrusion, | Coating | | Acetate Succinate | |
| | INLN_20-12- | and | | INLN | Inulin | 4.00% |
| | 44-4; HPMCas- | Spheronization | | LAC | D-Lactose | 12.00% |
| | NT-14-6 | | | MCAS | Micellar Casein | 44.00% |
| | | | | NT | Sodium Alginate | 6.00% |
| | | | | STRTB | StarTab by Colorcon | 20.00% |
| 627 | STRTB-LAC- | Granulation, | Fluidized Bed | HPMCas | Hydroxypropylmethylcellulose | 15.00% |
| | MCAS- | Cold Extrusion, | Coating | | Acetate Succinate | |
| | INLN_20.75- | and | | INLN | Inulin | 4.15% |
| | 12.45-45.65- | Spheronization | | LAC | D-Lactose | 12.45% |
| | 4.15; HPMCas- | | | MCAS | Micellar Casein | 45.65% |
| | NT-15-2 | | | NT | Sodium Alginate | 2.00% |
| | | | | STRTB | StarTab by Colorcon | 20.75% |
| 628 | STRTB-LAC- | Granulation, | Fluidized Bed | EC:300 | Ethyl Cellulose 300 cP | 3.00% |
| | MCAS- | Cold Extrusion, | Coating | HPMCas | Hydroxypropylmethylcellulose | 10.00% |
| | INLN_21.75- | and | | | Acetate Succinate | |
| | 13.05-47.85- | Spheronization | | INLN | Inulin | 4.35% |
| | 4.35; EC- | | | LAC | D-Lactose | 13.05% |
| | HPMCas-3-10 | | | MCAS | Micellar Casein | 47.85% |
| | | | | STRTB | StarTab by Colorcon | 21.75% |
| 629 | STRTB-LAC- | Granulation, | Fluidized Bed | HPMCas | Hydroxypropylmethylcellulose | 10.00% |
| | MCAS- | Cold Extrusion, | Coating | | Acetate Succinate | |
| | INLN_21.75- | and | | INLN | Inulin | 4.35% |
| | 13.05-47.85- | Spheronization | | LAC | D-Lactose | 13.05% |
| | 4.35; HPMCas- | | | MCAS | Micellar Casein | 47.85% |
| | PVAC-10-3 | | | PVAC | Polyvinyl Acetate | 3.00% |
| | | | | STRTB | StarTab by Colorcon | 21.75% |
| 630 | STRTB-LAC- | Granulation, | Fluidized Bed | EC:300 | Ethyl Cellulose 300 cP | 8.00% |
| | MCAS- | Cold Extrusion, | Coating | HPMC | Hydroxypropyl methylcellulose | 4.00% |
| | INLN_22-13.2- | and | | INLN | Inulin | 4.40% |
| | 48.4-4.4; EC- | Spheronization | | LAC | D-Lactose | 13.20% |
| | HPMC-8-4 | | | MCAS | Micellar Casein | 48.40% |
| | | | | STRTB | StarTab by Colorcon | 22.00% |
| 631 | STRTB-LAC- | Granulation, | Fluidized Bed | EC:300 | Ethyl Cellulose 300 cP | 8.00% |
| | MCAS- | Cold Extrusion, | Coating | HPMC | Hydroxypropyl methylcellulose | 4.00% |
| | INLN_22-13.2- | and | | INLN | Inulin | 4.40% |
| | 48.4- | Spheronization | | LAC | D-Lactose | 13.20% |
| | 4.4; HPMC-EC- | | | MCAS | Micellar Casein | 48.40% |
| | 4-8 | | | STRTB | StarTab by Colorcon | 22.00% |
| 632 | STRTB-LAC- | Granulation, | Fluidized Bed | HPMCas | Hydroxypropylmethylcellulose | 10.00% |
| | MCAS- | Cold Extrusion, | Coating | | Acetate Succinate | |
| | INLN_22-13.2- | and | | INLN | Inulin | 4.35% |
| | 48.4- | Spheronization | | LAC | D-Lactose | 13.05% |
| | 4.4; HPMCas- | | | MCAS | Micellar Casein | 47.85% |
| | PVAC-10-3 | | | PVAC | Polyvinyl Acetate | 3.00% |
| | | | | STRTB | StarTab by Colorcon | 21.75% |
| 633 | STRTB-LAC- | Granulation, | Fluidized Bed | INLN | Inulin | 4.40% |
| | MCAS- | Cold Extrusion, | Coating | LAC | D-Lactose | 13.20% |
| | INLN_22-13.2- | and | | MCAS | Micellar Cascin | 48.40% |
| | 48.4-4.4; NT- | Spheronization | | NT | Sodium Alginate | 7.00% |
| | Shellac-7-5 | | | STRTB | StarTab by Colorcon | 22.00% |
| 634 | STRTB-LAC- | Granulation, | Fluidized Bed | INLN | Inulin | 4.49% |
| | MCAS- | Cold Extrusion, | Coating | LAC | D-Lactose | 12.89% |
| | INLN_22-13.2- | and | | MCAS | Micellar Casein | 49.41% |
| | 50.6-4.6; NT- | Spheronization | | NT | Sodium Alginate | 6.84% |
| | Shellac-7-5 | | | STRTB | StarTab by Colorcon | 21.48% |
| 635 | STRTB-LAC- | Granulation, | Fluidized Bed | INLN | Inulin | 4.60% |
| | MCAS- | Cold Extrusion, | Coating | LAC | D-Lactose | 13.80% |
| | INLN_23-13.8- | and | | MCAS | Micellar Casein | 50.60% |
| | 50.6- | Spheronization | | NT | Sodium Alginate | 4.00% |
| | 4.6; Shellac - | | | STRTB | StarTab by Colorcon | 23.00% |
| | NT-4-4 | | | | | |
| 636 | STRTB-LAC- | Granulation, | | INLN | Inulin | 5.00% |
| | MCAS- | Cold Extrusion, | | LAC | D-Lactose | 15.00% |
| | INLN_25-15- | and | | MCAS | Micellar Casein | 55.00% |
| | 55-5 | Spheronization | | STRTB | StarTab by Colorcon | 25.00% |
| 637 | STRTB-LAC- | Granulation, | Fluidized Bed | EC:300 | Ethyl Cellulose 300 cP | 8.00% |
| | MCAS- | Cold Extrusion, | Coating | HPMC | Hydroxypropyl methylcellulose | 4.00% |
| | INLN_25-15- | and | | INLN | Inulin | 4.40% |
| | 55-5; HPMC- | Spheronization | | LAC | D-Lactose | 13.20% |
| | EC-4-8 | | | MCAS | Micellar Casein | 48.40% |
| | | | | STRTB | StarTab by Colorcon | 22.00% |
| 638 | TSTE-EC:100- | Hot Melt High | | EC:100 | Ethyl Cellulose 100 cP | 5.00% |
| | WPI_850-50- | Shear | | TSTE | Tristearin | 85.00% |
| | 100 | Homogenization | | WPI | Whey Protein Isolate | 10.00% |
| 639 | TW80-EC:100- | Hot Melt High | | EC:100 | Ethyl Cellulose 100 cP | 15.00% |
| | WPI- | Shear | | OLEA | Oleic Acid | 70.00% |
| | OLEA_50-150- | Homogenization | | TW80 | Tween 80: Polysorbate 80 | 5.00% |
| | 100-700 | | | WPI | Whey Protein Isolate | 10.00% |
| 640 | TW85-EC:100- | Hot Melt High | | EC:100 | Ethyl Cellulose 100 cP | 15.00% |
| | WPI- | Shear | | OLEA | Oleic Acid | 70.00% |
| | OLEA_50-150- | Homogenization | | TW85 | Tween 85: Polyoxyethylene | 5.00% |
| | 100-700 | | | | sorbitan trioleate | |
| | | | | WPI | Whey Protein Isolate | 10.00% |
| 641 | WPI | Unmodified | | WPI | Whey Protein Isolate | |
| | | Payload | | | | |
| 642 | WPI_1000 | Unmodified | | WPI | Whey Protein Isolate | |
| | | Payload | | | | |
| 643 | ALG-SUCC- | Spray Dry | | ALG | Sodium Alginate | 22.00% |
| | hWPI_22-11- | Microparticles | | SUCC | Succinic Acid | 11.00% |
| | 66 | | | hWPI | Hydrolyzed Whey Protein | 66.00% |
| | | | | | Isolate | |
| 644 | HPMC:100- | Spray Dry | | HPMC:100 | Hydroxypropyl Methylcellulose | 19.00% |
| | MTG-WPI_19- | Microparticles | | | 100 cP | |
| | 1-80 | | | MTG | Microbial Transglutaminase | 1.00% |
| | | | | WPI | Whey Protein Isolate | 80.00% |
| 645 | ALG-SUCC- | Spray Dry | | ALG | Sodium Alginate | 35.00% |
| | CACO3- | Microparticles | | SUCC | Succinic Acid | 17.00% |
| | HPMC:40- | | | CACO3 | Calcium Carbonate | 3.00% |
| | INUL_35-17-3- | | | HPMC:40 | Hydroxypropyl Methylcellulose | 9.00% |
| | 9-36 | | | | 40 cP | |
| | | | | INUL | Inulin | 36.00% |

### Y. Example 17: Exemplary Multiple-Layer Core-Shell Preparation Establishing a Means of Controlling Payload Release

The following non-limiting example describes one or more multiple-layer core-shell preparations comprising one or more protein(s) and one or more polysaccharide(s). In an unexpected result, the spatial orientation of one or more layer(s) comprising one or more core-shell preparation(s) was found to be a means of controlling the release of one or more protein(s) from one or more core-shell preparation(s). Moreover, in an unexpected result, an inner shell comprising an exemplary polysaccharide Hypromellose, with a viscosity of 100 cP, and outer shell comprising a different exemplary polysaccharide, Ethyl cellulose, was found to enable faster release than an inner shell comprising an exemplary polysaccharide, Ethyl cellulose, and an outer shell comprising Hypromellose.

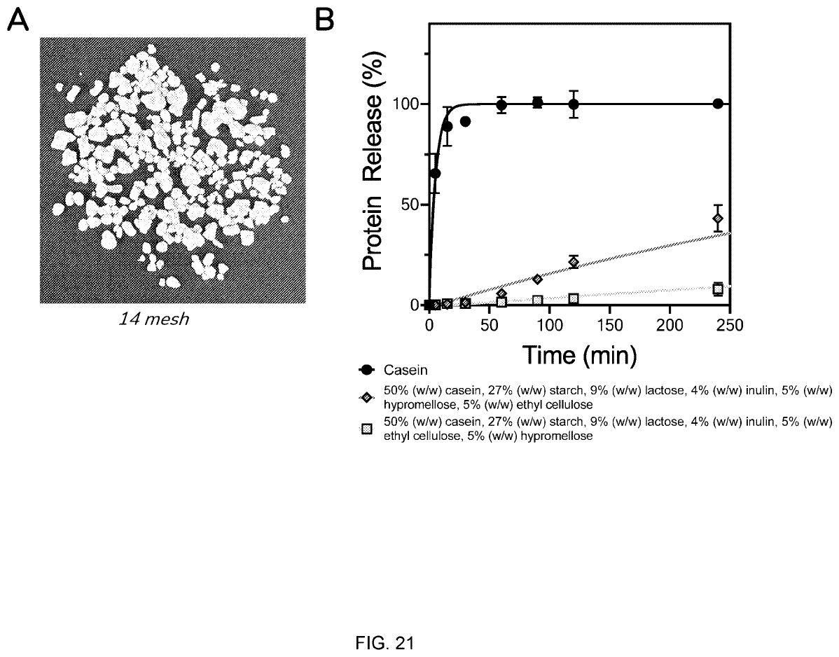

In this non-limiting example, a powdered mixture of 55% micellar casein, 30% directly compressible starch, 10% lactose, and 5% inulin was granulated using a Caleva Multi-Lab, followed by extrusion and spheronization via 1 mm×1 mm dies with constant addition of Dry-Flo starch. The resulting spherical particles were dried in an oven at 45 °C for 16 hours and passed through a 14-mesh sieve. Individual free particles were weighed and loaded into a VFC-LAB Micro FLO-COATER (Freund Vector) and sprayed with either a 10% (w/v) Ethyl cellulose in ethanol solution followed by a 2% (w/v) Hypromellose solution in water (Coating A) or a 2% (w/v) Hypromellose solution in water followed by a 10% (w/v) Ethyl cellulose in ethanol solution (Coating B). In each case, a 5% coating weight gain was targeted for each layer, resulting in a total 10% weight gain coating. The final concentration of all constituents in the particle preparation was 50% (w/w) casein, 27% (w/w) starch, 9% (w/w) lactose, 4% (w/w) inulin, 5% (w/w) Hypromellose, and 5% (w/w) ethyl cellulose. Nice (9) 15 mL centrifuge tubes were filled with PBS at 37 °C. To 3 tubes each was added either 55 mg of micellar casein, 100 mg of casein particles with Coating A, or 100 mg of casein particles with Coating B. As shown in FIG. 21A, formulated core-shell particles comprising protein exhibit a spherical morphology with a 14-mesh size. As shown in FIG. 21B, the release of unformulated micellar casein was rapid in PBS, with nearly complete release after 5 minutes. In contrast, protein particles with either Coating A or Coating B substantially delayed release with less than 50% release even after 4 hours of incubation with PBS. Importantly, Coating B was found to delay release relative to Coating A, despite being composed of the same materials, indicating that spatial orientation of shell(s) can a means of controlling payload release.

### Z. Example 18: Exemplary Matrix Preparation Exhibiting pH-Controlled Release of Protein(s)

The following non-limiting example describes one or more matrix preparations comprising one or more protein(s) and one or more polysaccharide(s) further characterized as pH-responsive. As provided herein, one or more pH-responsive polysaccharide(s) exhibited one or more change(s) upon exposure to varying pH. In the following non-limiting example, sodium alginate was one or more pH-responsive polysaccharides.

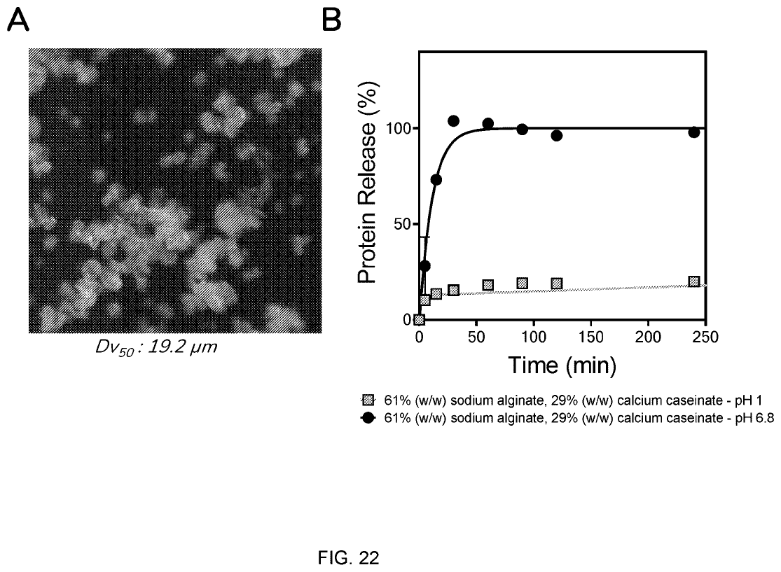

In this non-limiting example, a suspension comprising 2% (w/v) sodium alginate, 4% (w/v) calcium caseinate, 0.15% (w/v) calcium hydrogen phosphate, and 1% (w/v) succinic acid in distilled water was prepared and the pH was adjusted to 8 using ammonium hydroxide. In an unexpected result, passing said suspension through a Buchi B-290 Spray Dryer equipped with an ultrasonic nozzle with an inlet temperature of 90 °C, nozzle temperature of 50 °C, and outlet temperature of 40 °C yielded solid spherical particles (FIG. 22A) comprising sodium alginate and calcium caseinate. Particle size analysis of said spherical particles indicates an average particle diameter, Dv₅₀, of 19.2 μm. Three (3) 15 mL centrifuge tubes were filled with simulated gastric fluid (SGF) at 37 °C, with a pH of 1. Three (3) 15 mL centrifuge tubes were filled with simulated intestinal fluid (SIF) at 37 °C, with a pH of 6.8. 60 mg of spray-dried casein-containing particles were added to each tube. As shown in FIG. 22B, the release of casein from these particles was rapid in SIF, with complete release after only 20 minutes; in contrast, less than 25% of encapsulated casein was released from these particles even after more than 4 hours of incubation in SGF.

### AA. Example 19: Exemplary Matrix Preparation Exhibiting Sustained Release of Fatty Acid in One or More Release Environment(s)

The following non-limiting example describes one or more matrix preparations comprising one or more fatty acid(s) and one or more lipid(s). As provided herein, one or more release environment(s) was comprised of one or more component(s) simulating digestive condition(s) of the gastrointestinal tract of one or more mammal(s). Without wishing to be bound by any particular theory, it is contemplated that the release and/or absorption of one or more payload(s) further characterized as one or more fatty acid(s) may be mediated by bile salt(s), for example, sodium taurocholate.

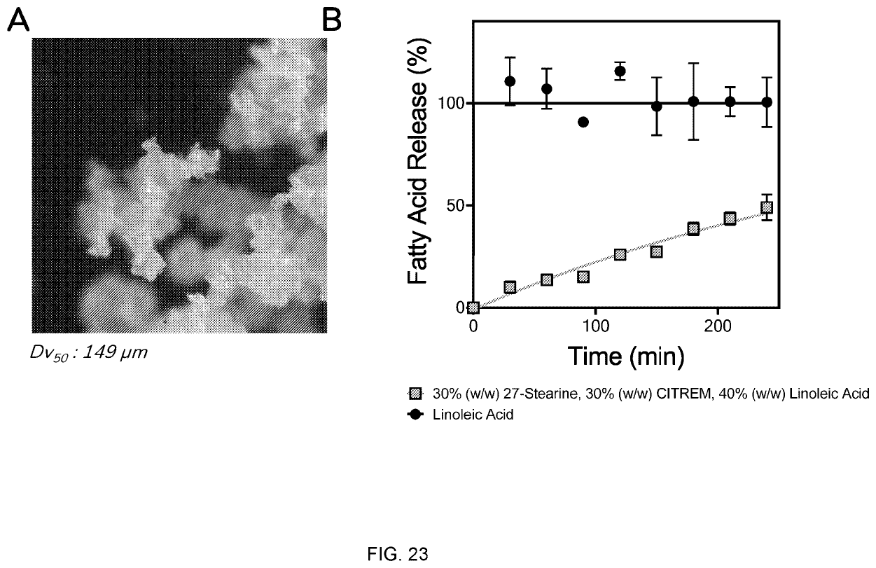

The following non-limiting example demonstrates one or more matrix preparation comprising one or more fatty acid(s) resistant to release and/or absorption in a bile salt-rich environment simulating digestive condition(s) of the gastrointestinal tract of one or more mammal(s). A mixture of 40% (w/w) linoleic acid, 30% (w/w) 27-Stearine, and 30% (w/w) CITREM was heated to 80 °C while stirring to allow for complete mixing, followed by cooling at 4 °C for 1 hour. The resulting solid mixture was cryo-milled at −192 °C with a 500 μm mesh filter; particle size analysis of the collected powder (FIG. 23A) indicates an average particle diameter, Dv₅₀, of 149 μm. Six (6) 15 mL centrifuge tubes were filled with simulated intestinal fluid at 37 °C with 0.2% (w/v) sodium taurocholate. Formulated linoleic acid microparticles were added to 3 of these 6 tubes, while unformulated linoleic acid was added to the remaining 3 tubes. As shown in FIG. 23B, unformulated linoleic acid was rapidly emulsified in the bile-salt rich simulated intestinal fluid indicating rapid release in a simulated duodenum environment. In contrast, formulated linoleic acid resists emulsification, with only 50% of loaded fatty acid released by 4 hours.

### BB. Example 20: Exemplary Core-Shell Preparation Exhibiting pH-Responsive Release of Carbohydrate(s)

The following non-limiting example describes one or more core-shell preparation(s) comprising a core further comprising carbohydrate and multiple shells further comprising carbohydrate(s). One or more shell layer(s) was found to confer pH responsiveness towards said core-shell preparation(s).

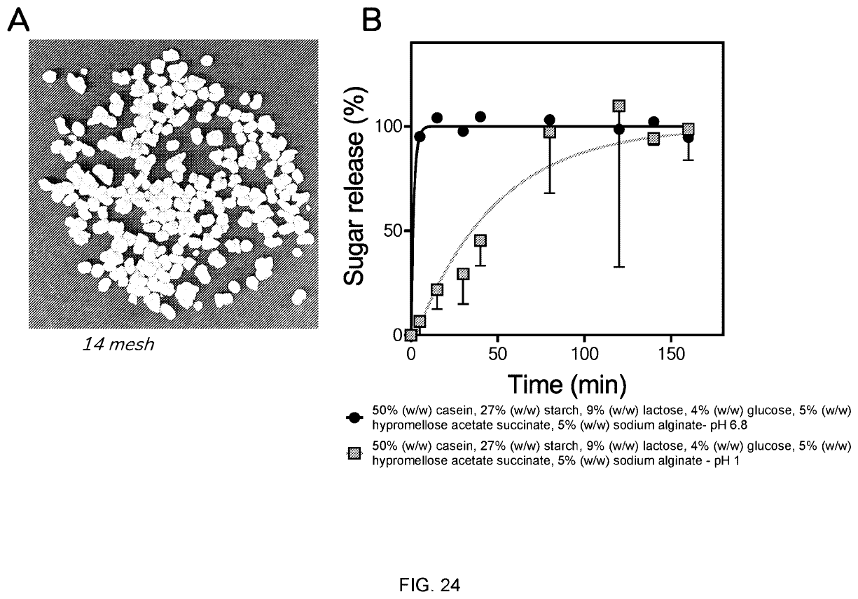

In this non-limiting example, a powdered mixture of 55% micellar casein, 30% directly compressible starch, 10% lactose, and 5% glucose was granulated using a Caleva Multi-Lab, followed by extrusion and spheronization via 1 mm×1 mm dies with constant addition of Dry-Flo starch. The resulting spherical particles were dried in an oven at 45 °C for 16 hours and passed through a 14-mesh sieve. Individual free particles were weighed and loaded into a VFC-LAB Micro FLO-COATER (Freund Vector) and sprayed with a 10% (w/v) hypromellose acetate succinate dispersion in water followed by a 2% (w/v) sodium alginate solution in water. A 5% coating weight gain was targeted for each layer, resulting in a total 10% weight gain coating for glucose-containing microparticles. The final concentration of all constituents in the particle preparation was 50% (w/w) casein, 27% (w/w) starch, 9% (w/w) lactose, 4% (w/w) glucose, 5% (w/w) hypromellose acetate succinate, and 5% (w/w) sodium alginate. Three (3) 15 mL centrifuge tubes were filled with simulated gastric fluid (SGF) at 37 °C, with a pH of 1. Three (3) 15 mL centrifuge tubes were filled with simulated intestinal fluid (SIF) at 37 °C, with a pH of 6.8. 180 mg of coated glucose-containing particles were added to each tube (FIG. 24A). As shown in FIG. 24B, the release of glucose from these particles was rapid in SIF, with complete release after only 5 minutes; in contrast, complete release of encapsulated glucose was delayed to 60 minutes of incubation in SGF.

### CC. Example 21: Exemplary Core-Shell Preparation Exhibiting pH-Responsive Release of Protein(s)

The following non-limiting example describes one or more core-shell preparation(s) comprising a core further comprised of protein and multiple shells further comprising carbohydrate(s). One or more shell layer(s) is found to confer pH responsiveness towards said core-shell preparation(s).

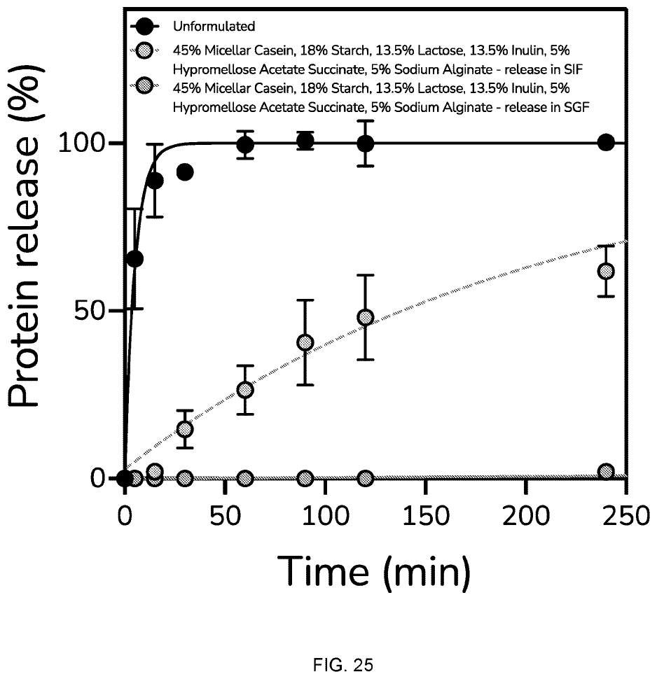

In this non-limiting example, a powdered mixture of 50% micellar casein, 20% directly compressible starch, 15% lactose, and 15% inulin was granulated using a Caleva Multi-Lab, followed by extrusion and spheronization via 1 mm×1 mm dies with constant addition of Dry-Flo starch. The resulting spherical particles were dried in an oven at 45 °C for 16 hours and passed through a 14-mesh sieve. Individual free particles were weighed and loaded into a VFC-LAB Micro FLO-COATER (Freund Vector) and sprayed with a 10% (w/v) hypromellose acetate succinate dispersion in water followed by a 2% (w/v) sodium alginate solution in water. A 5% coating weight gain was targeted for each layer, resulting in a total 10% weight gain. The final concentration of all constituents in the particle preparation was 45% (w/w) micellar casein, 18% (w/w) starch, 13.5% (w/w) lactose, 13.5% (w/w) inulin, 5% (w/w) hypromellose acetate succinate, and 5% (w/w) sodium alginate. Three (3) 15 mL centrifuge tubes were filled with simulated gastric fluid (SGF) at 37 °C, with a pH of 1. Three (3) 15 mL centrifuge tubes were filled with simulated intestinal fluid (SIF) at 37 °C, with a pH of 6.8. As shown in FIG. 25, the release of protein from these particles was steady in SIF, with 50% release after only 4 hours; in contrast, negligible release of encapsulated protein was observed following 4 hours of incubation in SGF.

### DD. Example 22: Exemplary Core-Shell Preparations Derived from Several Manufacturing Processes and Incorporation of Particle Preparations into Commercial Products

The following non-limiting example illustrates particle preparation(s) deriving from methods of manufacture of one or more tastant composition(s). One or more methods of manufacture of one or more tastant composition(s) is or may be selected to provide for desired characteristic(s) exhibited by particle preparation(s). For example, one or more methods of manufacture is or may be employed to generate particle(s) exhibiting one or more size distributions. In some cases, one or more size distribution(s) resulting from one or more methods of manufacture may be ascertained using microscopy. For example, one or more methods of manufacture is or may be employed to generate particle(s) exhibiting one or more size distributions. In some cases, one or more size distribution(s) resulting from one or more methods of manufacture may be ascertained using laser diffraction particle size analysis. Without wishing to be bound by any particular theory, it is contemplated that size distribution(s) exhibited by one or more particle preparation(s) are particularly advantageous for homogenous mixing within food and/or beverage product matrices. Without wishing to be bound by any particular theory, it is contemplated that size distribution(s) exhibited by one or more particle preparation(s) are particularly advantageous for minimizing sensory impact for consumers.

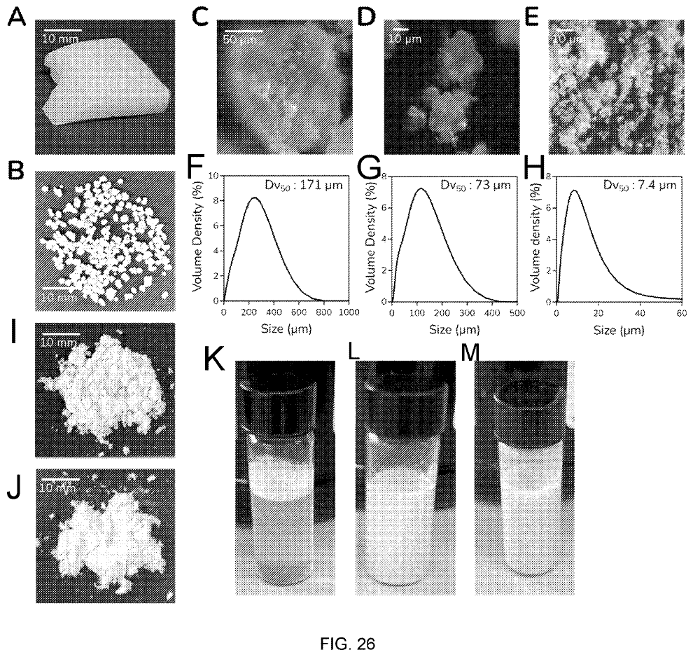

In this non-limiting example, several particle preparation(s) were generated using one or more methods of manufacture, with commensurate microscopy and particle size analysis data. Methods of manufacture comprising hot high shear homogenization of matrix component(s) and payload component(s) yielded solid “bars”, of which one non-limiting example is provided in FIG. 26A. The provided “bar” was macroscopic, with a diameter of 20 mm, and had a composition of 60% (w/w) oleic acid, 20% (w/w) ethyl cellulose 100 cP, and 20% (w/w) whey protein. Methods of manufacture comprising granulation, extrusion, and spheronization of matrix component(s) and payload component(s) yielded solid pellets, of which one non-limiting example is provided in FIG. 26B. The provided pellets were macroscopic, with a diameter of 1 mm, and had a composition of 50% (w/w) casein, 27% (w/w) starch, 9% (w/w) lactose, 4% (w/w) inulin, 5% (w/w) Hypromellose, and 5% (w/w) ethyl cellulose. Methods of manufacture comprising hot melt extrusion and hammer milling of matrix component(s) and payload component(s) yielded a coarse powder, of which one non-limiting example is provided in FIG. 26C. The provided pellets were microscopic, with an average diameter, Dv₅₀, of 171 μm, and had a composition of 50% (w/w) whey, 30% (w/w) 27 Stearine, and 20% (w/w) ethyl cellulose 100 cP. Methods of manufacture comprising hot melt extrusion and hammer milling of matrix component(s) and payload component(s) yielded a coarse powder, of which one non-limiting example is provided in FIG. 26D. The provided pellets were microscopic, with an average diameter, Dv₅₀, of 171 μm, and had a composition of 40% (w/w) whey, 40% (w/w) 27 Stearine, and 20% (w/w) calcium hydroxybutyrate. Methods of manufacture comprising spray drying of matrix component(s) and payload component(s) yielded a fine powder, of which one non-limiting example is provided in FIG. 26E. The provided powder was microscopic, with an average diameter, Dv₅₀, of 7.4 μm, and had a composition of 40% (w/w) whey, 40% (w/w) sodium alginate, and 20% (w/w) succinic acid. Incorporation of spheronized particles (FIG. 26B) into commercial whey protein powder (Muscle Milk, Pepsi) exhibits poor integration (FIG. 26I) in contrast to incorporation of spray dried particle preparation(s) (FIG. 26E) into commercial whey protein powder (Muscle Milk, Pepsi), illustrated in FIG. 26J, where no differences in texture or color were observed. Incorporation of milled preparation(s) (FIG. 26D) into liquids, illustrated in FIGS. 26K-26M, was challenging, leading to particle agglomeration at the liquid-air interface (FIG. 26K). Inclusion of 5% soybean lecithin improved mixing of formulation (FIG. 26L), and facilitated uniform incorporation into commercial enteral feed formula (Nutren® 1.0, Nestlé) (FIG. 26M).

### EE. Example 23: Exemplary High Payload Microparticle Preparations

This example shows that microparticle preparations can be manufactured having high percentages (e.g., at least 10%, at least 15%, at least 20%, at least 25%, at least 30%, at least 40%, at least 50%, at least 60%, at least 70%, at least 80%, or at least 90% w/w) of food component.

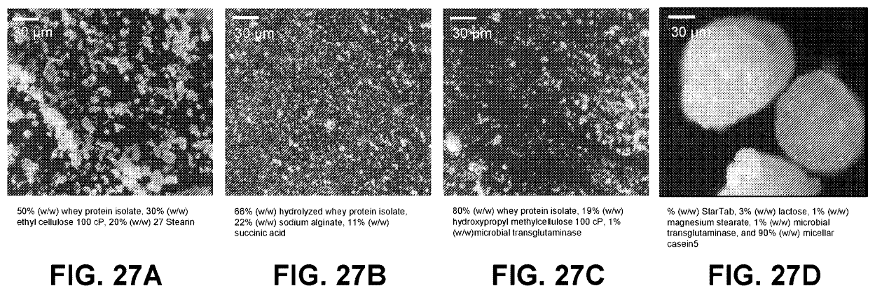

FIG. 27A shows a microscopic image of an exemplary microparticle preparation incorporating, on a dry weight basis, 50% (w/w) whey protein isolate, 30% (w/w) ethyl cellulose 100 cP, and 20% (w/w) 27 Stearin.

To manufacture the microparticle preparation shown in FIG. 27A, 30 g of 27 Stearin was melted at 150 °C on a hot plate, followed by addition of 20 g of ethyl cellulose 100 cP. The mixture was (i) stirred using a magnetic stir bar for at least 30 minutes; (ii) cooled to at least −50 °C, −78 °C, −150 °C, or −196 °C; and (iii) milled using an IKA M10 hammer mill equipped with a 1000 μm, 750 μm, 500 μm, 250 μm, and/or 100 μm screen filter. The fine powder (50 g) was mixed with 50 g of whey protein isolate powder in a sealed glass bottle and the mixed powders were added to a Thermo Scientific Haake MiniLab3 extruder with the extrusion chamber set to at least at 140 °C, 145 °C, 150 °C, 155 °C, or 160 °C. The collected extrudate was milled using an IKA M10 hammer mill equipped with a 1000 μm, 750 μm, 500 μm, 250 μm, or 100 μm screen filter.

FIG. 27B shows a microscopic image of an exemplary microparticle preparation incorporating, on a dry weight basis, 66% (w/w) hydrolyzed whey protein isolate, 22% (w/w) sodium alginate, and 12% (w/w) succinic acid.

To manufacture the microparticle preparation shown in FIG. 27B, 22 g of sodium alginate was dissolved in 900 mL of water overnight at 40 °C, followed by the dissolution of 66 g of hydrolyzed whey protein isolate and 12 g of succinic acid. The pH of the solution was adjusted to at least 7.2, at least 7.4, at least 7.6, at least 7.8, at least 8.0, at least 8.2, or at least 8.4 using ammonium hydroxide. The solution was then spray-dried using a Buchi B-290 benchtop spray drier with inlet temperature at least 120 °C, at least 125 °C, at least 130 °C, at least 135 °C, at least 140 °C, or at least 145 °C; flow rate at 20%; and sweep gas at 414 L/h.

FIG. 27C shows a microscopic image of an exemplary microparticle preparation incorporating, on a dry weight basis, 80% (w/w) whey protein isolate, 19% (w/w) hydroxypropyl methylcellulose 100 cP, and 1% (w/w) microbial transglutaminase (1000 U/g).

To manufacture the microparticle preparation shown in FIG. 27C, 19 g of hydroxypropyl methylcellulose 100 cP was dissolved in 900 mL of water at 40 °C, followed by the dissolution of 80 g of whey protein isolate and 1 g of microbial transglutaminase (1000 U/g). The solution was then spray-dried using a Buchi B-290 benchtop spray drier with inlet temperature at least 120 °C, at least 125 °C, at least 130 °C, at least 135 °C, at least 140 °C, or at least 145 °C; flow rate at 20%; and sweep gas at 414 L/h.

FIG. 27D shows a microscopic image of an exemplary microparticle preparation incorporating, on a dry weight basis, 90% (w/w) micellar casein, 5% (w/w) StarTab, 3% (w/w) lactose, 1% (w/w) magnesium stearate, and 1% (w/w) microbial transglutaminase.

To manufacture the microparticle preparation shown in FIG. 27D, 10 g of total formulation was added into a Caleva Multi Lab instrument granulating bowl (Caleva Process Solutions Ltd., Dorset, England). 4 mL of Milli-Q water was added to the granulating bowl while granulating screws mixed the formulation at 35 rpm. Once a homogenous, granulated paste was formed, the formulation was extruded at 100 rpm using a 1×1 mm die attachment before spheronizing at 700 rpm. Once individual pellets had formed, DryFlo (Ingredion, Westchester, IL) was added during the spheronization process to prevent agglomeration. Resulting microparticle pellets were dried overnight in a drying oven (model UN 110, Mammert Gmbh, Schwabach, Germany) set at 60 °C.

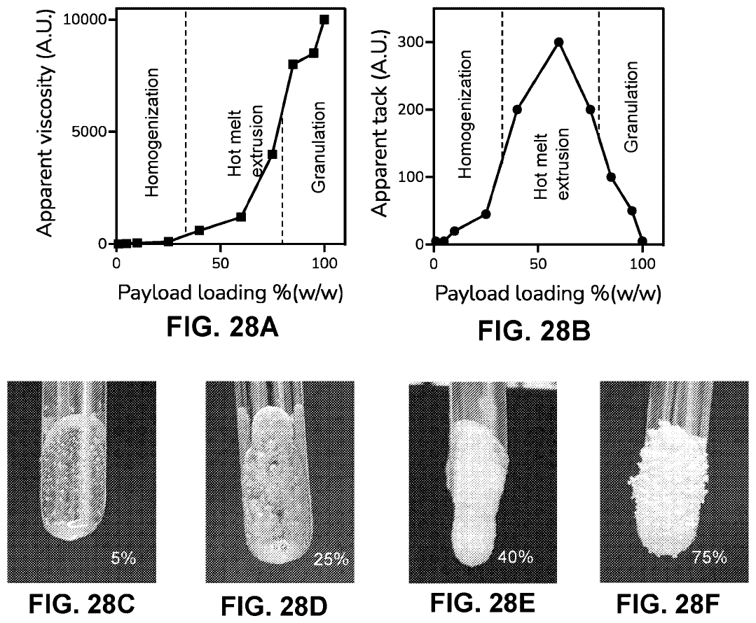

FIG. 28A-28B are theoretical data plots showing a non-linear increase in viscosity with increasing concentrations of food component payload (FIG. 28A). Increasing concentrations of food component payload are also associated with increased stickiness (i.e., tack; FIG. 28B).

FIG. 28C-28F are images of preparations of 27 stearin mixed with whey protein isolate powder at ratios of 95:5, 75:25, 60:40, and 25:75 (% w/w on a dry weight basis). Powder mixtures were thoroughly mixed by vortexing then heated with overhead stirring (250 rpm) to 90 °C on a hot plate. Following melting and dispersion of the whey protein isolate, samples were removed via spatula and the mixture was allowed to freely flow from the spatula tip. Mixtures with higher loading of whey protein isolate quickly resemble putty, precluding the use of certain formulation techniques while enabling others. At 5% (FIG. 28C) and 25% (w/w) (FIG. 28D) food component (e.g., payload) loading, the preparation is viscous and sticky allowing for prilling/homogenization. At 40% (w/w) (FIG. 28E) food component loading, the consistency is paste-like and overhead stirring or hot melt extrusion may be necessary for manufacturing. At 75% (w/w) (FIG. 28F) food component loading, the preparation is a powder.

### FF. Example 24: Incorporation of Exemplary Microparticle Preparations into Food Compositions

This example shows that microparticle preparations incorporating different co-excipients have different physical characteristics that may or may not be conducive for integrating the preparations into particular food compositions.

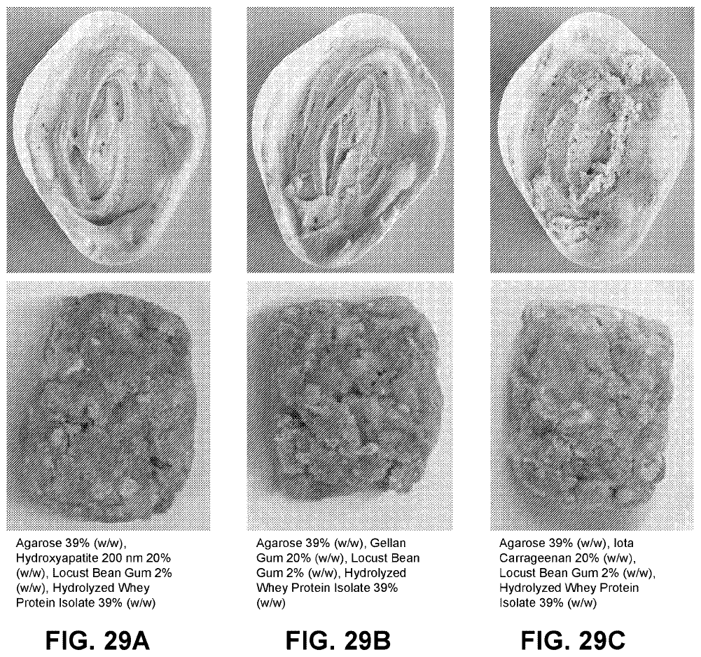

FIG. 29A shows an image of an exemplary microparticle preparation having, on a dry weight basis, 39% (w/w) agarose, 39% (w/w) hydrolyzed whey protein isolate, 2% (w/w) locust bean gum, and 20% (w/w) hydroxyapatite mixed in Chobani® yogurt (top panel) or a Clif™ bar (bottom panel).

To manufacture the microparticle preparation shown in FIG. 29A, 20 g of hydroxyapatite 200 nm particles was dissolved in 780 mL of 10 mM phosphate buffered saline (PBS), followed by the dissolution of 39 g of hydrolyzed whey protein isolate. 39 g of agarose powder and 2 g of locust bean gum powder were then homogenously dispersed within the mixture using an overhead stirrer. The mixture was then heated to 95 °C, until agarose and locust bean gum was completely dissolved. The mixture was allowed to cool to 15 °C, 20 °C, or 25 °C then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The microparticle preparation was mixed at 10% (w/w) into Chobani® yogurt (FIG. 29A, top panel) or Clif™ bar (FIG. 29A, bottom panel). No textural or color differences were observed when incorporated into Chobani® yogurt or Clif™ bar food products.

FIG. 29B shows an image of an exemplary microparticle preparation having, on a dry weight basis, 39% (w/w) agarose, 39% (w/w) hydrolyzed whey protein isolate, 2% (w/w) locust bean gum, and 20% (w/w) gellan gum mixed in Chobani® yogurt (top panel) or a Clif™ bar (bottom panel).

To manufacture the microparticle preparation shown in FIG. 29B, 20 g of gellan gum was dissolved in 780 mL of 10 mM phosphate buffered saline (PBS), followed by the dissolution of 39 g of hydrolyzed whey protein isolate. 39 g of agarose powder and 2 g of locust bean gum powder were then homogenously dispersed within the mixture using an overhead stirrer. The mixture was then heated to 95 °C, until agarose and locust bean gum was completely dissolved. The mixture was allowed to cool to 15 °C, 20 °C, or 25 °C then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The microparticle preparation was mixed at 10% (w/w) into Chobani® yogurt (FIG. 29B, top panel) or Clif™ bar (FIG. 29B, bottom panel). No textural or color differences were observed when incorporated into Chobani® yogurt or Clif™ bar food products.

FIG. 29C shows an image of an exemplary microparticle preparation having, on a dry weight basis, 39% (w/w) agarose, 39% (w/w) hydrolyzed whey protein isolate, 2% (w/w) locust bean gum, and 20% (w/w) iota carrageenan mixed in Chobani® yogurt (top panel) or a Clif™ bar (bottom panel).

To manufacture the microparticle preparation shown in FIG. 29C, 20 g of iota carrageenan was dissolved in 780 mL of 10 mM phosphate buffered saline (PBS), followed by the dissolution of 39 g of hydrolyzed whey protein isolate. 39 g of agarose powder and 2 g of locust bean gum powder were then homogenously dispersed within the mixture using an overhead stirrer. The mixture was then heated to 95 °C, until agarose and locust bean gum was completely dissolved. The mixture was allowed to cool to 15 °C, 20 °C, or 25 °C then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The microparticle preparation was mixed at 10% (w/w) into Chobani® yogurt (FIG. 29C, top panel) or Clif™ bar (FIG. 29C, bottom panel). Unlike the preparations in FIG. 29A and FIG. 29B, preparations including iota carrageenan as a co-excipient caused observable textural and color changes when incorporated into Chobani® yogurt or Clif™ bar food products.

### GG. Example 25: Manufacturing Processes Influence Incorporation of Microparticle Preparations into Food Products

This example shows that some manufacturing processes result in microparticle preparations having physical characteristics that may or may not be conducive for integrating the preparations into particular food compositions.

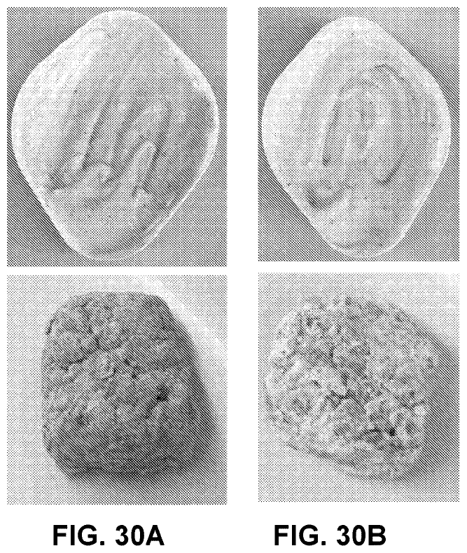

FIG. 30A shows an image of an exemplary microparticle preparation having, on a dry weight basis, 50% (w/w) whey protein isolate, 20% (w/w) ethyl cellulose 100 cP, and 30% (w/w) 27 Stearin prepared by hot melt extrusion and mixed in Chobani® yogurt (top panel) or a Clif™ bar (bottom panel).

To manufacture the microparticle preparation shown in FIG. 30A, 30 g of 27 Stearin was melted at 150 °C on a hot plate, followed by the addition of 20 g of ethyl cellulose 100 cP. The mixture was stirred using a magnetic stir bar for at least 30 minutes then cooled to at least −50 °C, −78 °C, −150 °C, or −196 °C and milled using an IKA M10 hammer mill equipped with a 1000 μm, 750 μm, 500 μm, 250 μm, or 100 μm screen filter. The fine powder (50 g) was mixed with 50 g of whey protein isolate powder in a sealed glass bottle and the mixed powders were added to a Thermo Scientific Haake MiniLab3 extruder with extrusion chamber set at least at 140 °C, 145 °C, 150 °C, 155 °C, and/or 160 °C. The collected extrudate was milled using an IKA M10 hammer mill equipped with a 1000 μm, 750 μm, 500 μm, 250 μm, and/or 100 μm screen filter. The microparticle preparation was mixed at 10% (w/w) into Chobani® yogurt (FIG. 30A, top panel) or Clif™ bar (FIG. 30A, bottom panel). No textural or color differences were observed when incorporated into Chobani® yogurt or Clif™ bar food products.

FIG. 30B shows an image of an exemplary microparticle preparation having the same composition as the preparation of FIG. 30A but prepared by dispersion via high shear homogenization and mixed in Chobani® yogurt (top panel) or a Clif™ bar (bottom panel).

To manufacture the microparticle preparation shown in FIG. 30A, 30 g of 27 Stearin was melted at 150 °C on a hot plate, followed by the addition of 20 g ethyl cellulose 100 cP in small portions with high shear homogenization. The mixture was stirred using an overhead stirrer for at least 30 minutes, then 50 g of whey protein isolate was added to the stirring mixture. The mixture was subsequently cooled to at least −50 °C, −78 °C, −150 °C, and/or −196 °C and milled using an IKA M10 hammer mill equipped with a 1000 μm, 750 μm, 500 μm, 250 μm, and/or 100 μm screen filter. The microparticle preparation was mixed at 10% (w/w) into Chobani® yogurt (FIG. 30B, top panel) or Clif™ bar (FIG. 30B, bottom panel). Unlike the preparation in FIG. 30A, a preparation prepared via dispersion caused observable textural and color changes when incorporated into Chobani® yogurt or Clif™ bar food products.

### HH. Example 26: Microparticle Preparation Coatings Influence Incorporation of Microparticle Preparations into Food Products

This example shows that the addition of some coatings can result in microparticle preparations having physical characteristics that may or may not be conducive for integrating the preparations into particular food compositions.

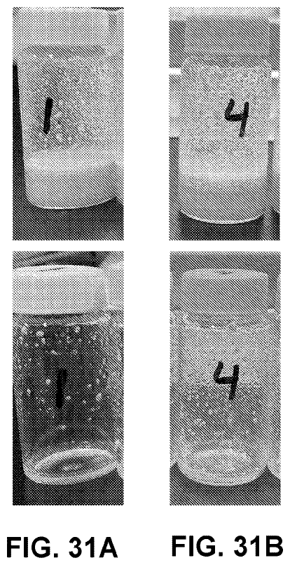

FIG. 31A shows an image of an exemplary microparticle preparation having a core including, on a dry weight basis, 19% (w/w) carnauba wax, 5% (w/w) ethyl cellulose 100 cP, 5% (w/w) stearic acid, 1% (w/w) folic acid, 20% (w/w) whey protein isolate; and a coating including, on a dry weight basis, 29.5% (w/w) ethyl cellulose, 17.5% (w/w) Eudragit control, and 3% sodium alginate, and mixed with MuscleMilk™ protein shake.

To manufacture the microparticle preparation shown in FIG. 31A, 80 g of whey protein isolate was dissolved in 720 mL of distilled water then spray-dried using a Buchi B-290 benchtop spray drier with inlet temperature at least 120 °C, at least 125 °C, at least 130 °C, at least 135 °C, at least 140 °C, or at least 145 °C; flow rate at 20%; and sweep gas at 414 L/h. The recovered yield was 50%, 38 g of carnauba wax was melted at 150 °C on a hot plate, followed by the addition of 10 g ethyl cellulose 100 cP in small portions via high shear homogenization. The mixture was stirred using an overhead stirrer for at least 30 minutes, then 10 g of stearic acid, 2 g of folic acid, and 40 g of spray dried whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, and/or 100 μm screen filter. Particles were subsequently coated using 3 layers: ethyl cellulose 300 cP (final 29.5% (w/w)), Eudragit control (final 17.5% (w/w)), and sodium alginate (final 3% (w/w)). The fluid bed parameters were as follows: Spray on/off: 0.8/0.8, 50 revolutions per minute, pump rev: 6 seconds, inlet temp: 50 °C. Spraying occurred until 20% (w/w) of ethyl cellulose 300 cP was added to the particles, consistently monitoring the fluidization of the particles. All tubing was cleaned by first pumping ethanol, then water, through the tubing at 60 revolutions per minute. Next, 100 ml of Eudragit L100 solution was placed on a scale to track coating weight in grams as spraying occurred. The fluid bed parameters were as follows: Spray on/off: 0.8/0.8, 50 revolutions per minute, pump rev: 6 seconds, inlet temp: 30 °C. Spraying occurred until 12% (w/w) of Eudragit L100 was added to the particles. All tubing was cleaned by pumping water through the tubing at 60 revolutions per minute. Next, a solution of 2% (w/w) NS Enteric in 100 mL of water was prepared on a hot plate, stirring at 400 revolutions per minute at 100 °C for 30 mins, or until the NS Enteric appear solubilized. The NS Enteric solution was placed on a scale and to track coating weight in grams as spraying occurs. The fluid bed parameters were as follows: Spray on/off: 0.0/0.0, 15 revolutions per minute, pump rev: 5 seconds, inlet temp: 80 °C. Spraying occurred until 2.5% (w/w) of NS Enteric was added to the particles, consistently monitoring the fluidization of the particles.

FIG. 31B shows an image of an exemplary microparticle preparation having a core including, on a dry weight basis, 38% (w/w) carnauba wax, 10% (w/w) ethyl cellulose 100 cP, 10% (w/w) stearic acid, 2% (w/w) folic acid, 40% (w/w) whey protein isolate; without coating, and mixed with MuscleMilk™ protein shake.

To manufacture the microparticle preparation shown in FIG. 31B, 80 g of whey protein isolate was dissolved in 720 mL of distilled water then spray-dried using a Buchi B-290 benchtop spray drier with an inlet temperature at least 120 °C, at least 125 °C, at least 130 °C, at least 135 °C, at least 140 °C, or at least 145 °C; flow rate at 20%; and sweep gas at 414 L/h. The recovered yield was 50%, 38 g of carnauba wax was melted at 150 °C on a hot plate, followed by the addition of 10 g ethyl cellulose 100 cP in small portions via high shear homogenization. The mixture was stirred using an overhead stirrer for at least 30 minutes, then 10 g of stearic acid, 2 g of folic acid, and 40 g of spray dried whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter.

As shown in FIG. 31A, in the presence of coating, microparticle preparations incorporated into MuscleMilk™ protein shake (top panel) with minimal loss of microparticle preparation resulting from adhering of particles to the walls of the storage container. In contrast, microparticle preparations manufactured without coating did not incorporate into MuscleMilk™ protein shake (FIG. 31B, top panel) and resulted in substantial loss of microparticle preparation due to particle adhering to the walls of the storage container.

### II. Example 27: Physical Characteristics of Exemplary Microparticle Preparation Formulations and their Incorporation into Various Food Compositions

This example shows the physical characteristics of exemplary microparticle preparations and their incorporation into Chobani® yogurt, water, or Clif™ bar

FIGS. 32A-32F show the physical characteristics of an exemplary microparticle preparation having, on a dry weight basis, 50% (w/w) whey protein isolate, 47% (w/w) beeswax, and 3% Tween 85.

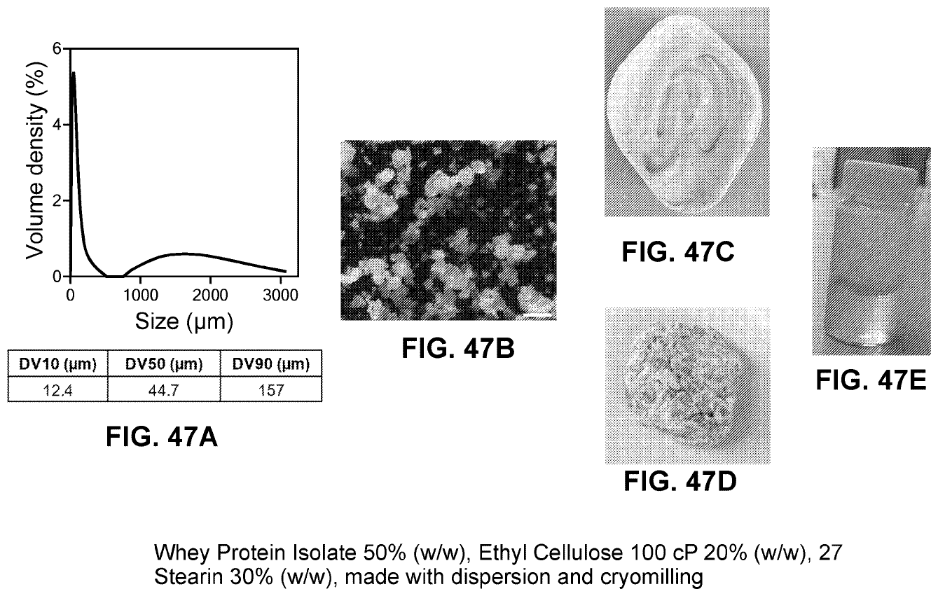

To manufacture the microparticle preparation shown in FIGS. 32A-32F, 47 g of white beeswax was melted at 80 °C on a hot plate, followed by addition of 3 g of Tween 85. The mixture was cooled to at least −50 °C, −78 °C, −150 °C, or −196 °C and milled using an IKA M10 hammer mill equipped with a 1000 μm, 750 μm, 500 μm, 250 μm, or 100 μm screen filter. The fine powder (50 g) was mixed with 50 g of whey protein isolate powder in a sealed glass bottle and the mixed powders were added to a Thermo Scientific Haake MiniLab3 extruder with extrusion chamber set at least at 30 °C, 35 °C, 40 °C, 45 °C, or 50 °C. The collected extrudate was cooled to −196 °C and milled using an IKA M10 hammer mill equipped with a 1000 μm, 750 μm, 500 μm, 250 μm, or 100 μm screen filter. The yield of recovered particles was 34%, with 5 unit processes and 0 g of generated waste.

As shown in FIG. 32A, particle size analysis indicated Dv10, Dv50, and Dv90 values of 32.1 μm, 131 μm, and 338 μm, respectively. As shown in the microscope image and photographic image of FIG. 32B and FIG. 32C, respectively, the particles were polydisperse, cream white in color, and had a jagged morphology. When 10% (w/w) of microparticle preparation was incorporated into Chobani® yogurt (FIG. 32D) or Clif™ bar (FIG. 32E), no textural or color alterations of the food product was observed. When 10% (w/w) of microparticle preparation was incorporated into water, microparticles were well distributed (FIG. 32F).

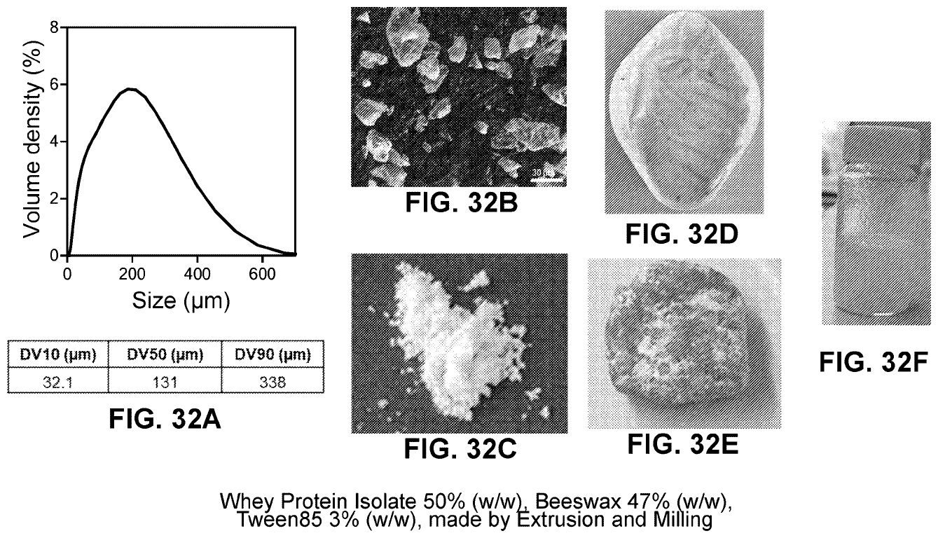

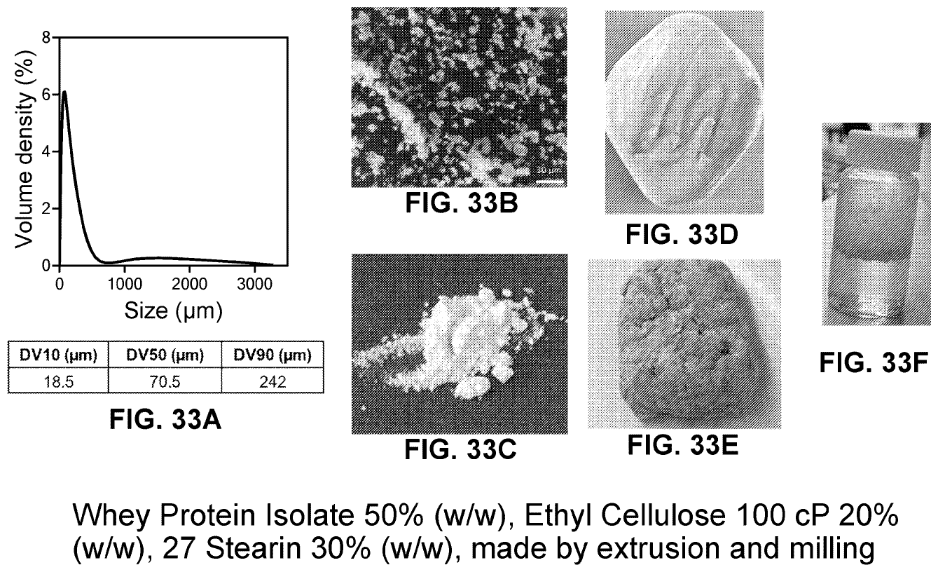

FIGS. 33A-33F show the physical characteristics of an exemplary microparticle preparation having, on a dry weight basis, 50% (w/w) whey protein isolate, 20% (w/w) ethyl cellulose 100 cP, and 30% (w/w) 27 Stearin.

To manufacture the microparticle preparation shown in FIGS. 33A-33F, 30 g of 27 Stearin was melted at 150 °C on a hot plate, followed by the addition of 20 g of ethyl cellulose 100 cP. The mixture was stirred using a magnetic stir bar for at least 30 minutes, then cooled to at least −50 °C, −78 °C, −150 °C, or −196 °C and milled using an IKA M10 hammer mill equipped with a 1000 μm, 750 μm, 500 μm, 250 μm, or 100 μm screen filter. The resulting fine powder (50 g) was mixed with 50 g of whey protein isolate powder in a sealed glass bottle and the mixed powders were added to a Thermo Scientific Haake MiniLab3 extruder with an extrusion chamber set at least at 140 °C, 145 °C, 150 °C, 155 °C, or 160 °C. The collected extrudate was milled using an IKA M10 hammer mill equipped with a 1000 μm, 750 μm, 500 μm, 250 μm, or 100 μm screen filter. The yield of recovered particles was 56%, with 5 unit processes and 0 g of generated waste.

As shown in FIG. 33A, particle size analysis indicated Dv10, Dv50, and Dv90 values of 18.5 μm, 70.5 μm, and 242 μm, respectively. As shown in the microscope image and photographic image of FIG. 33B and FIG. 33C, respectively, the particles were polydisperse, burnt orange in color, and had a jagged morphology. When 10% (w/w) of microparticle preparation was incorporated into Chobani® yogurt (FIG. 33D) or Clif™ bar (FIG. 33E), no textural or color alterations of the food product was observed. When 10% (w/w) of microparticle preparation was mixed with water, microparticles did not incorporate (FIG. 33F).

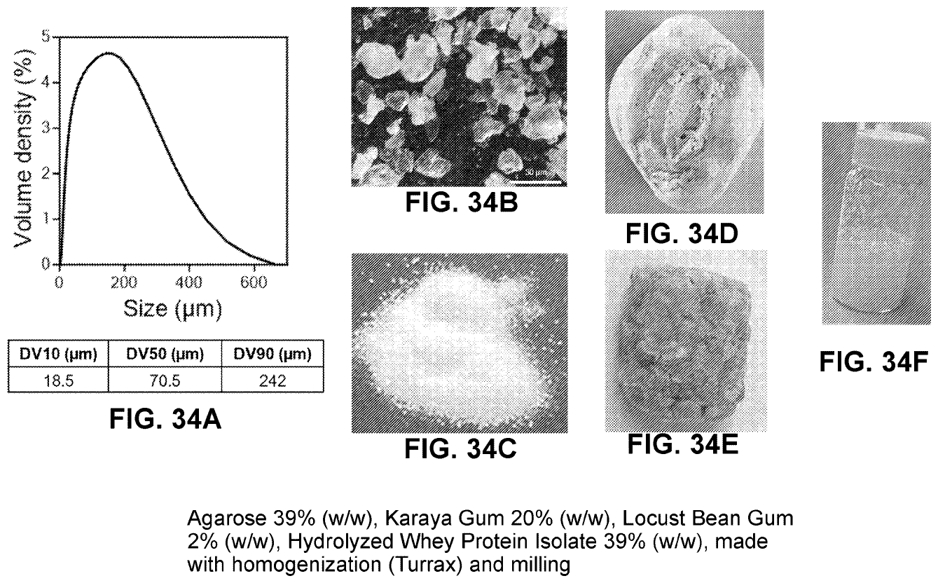

FIGS. 34A-34F show the physical characteristics of an exemplary microparticle preparation having, on a dry weight basis, 39% (w/w) agarose, 20% (w/w) iota carrageenan, 2% (w/w) locust bean gum, and 39% (w/w) hydrolyzed whey protein isolate.

To manufacture the microparticle preparation shown in FIGS. 34A-34F, 20 g of iota carrageenan was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 90%, with 3 unit processes and 780 g of generated waste water (e.g., evaporated).

As shown in FIG. 34A, particle size analysis indicated Dv10, Dv50, and Dv90 values of 45.6 μm, 137 μm, and 304 μm, respectively. As shown in the microscope image and photographic image of FIG. 34B and FIG. 34C, respectively, the particles were polydisperse, cream white in color, and had a jagged morphology. When 10% (w/w) of microparticle preparation was incorporated into Chobani® yogurt (FIG. 34D) or Clif™ bar (FIG. 34E), no textural or color alterations of the food product was observed. When 10% (w/w) of microparticle preparation was incorporated into water, microparticles were well distributed (FIG. 34F).

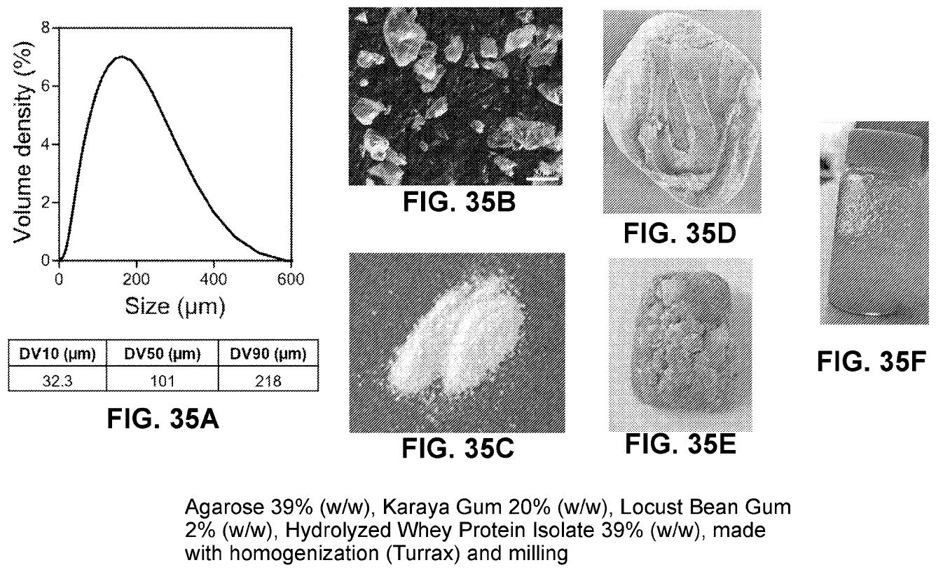

FIGS. 35A-35F show the physical characteristics of an exemplary microparticle preparation having, on a dry weight basis, 39% (w/w) agarose, 20% (w/w) karaya gum, 2% (w/w) locust bean gum, and 39% (w/w) hydrolyzed whey protein isolate.

To manufacture the microparticle preparation shown in FIGS. 35A-35F, 20 g of karaya gum was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 69%, with 3 unit processes and 780 g of generated waste water (e.g., evaporated).

As shown in FIG. 35A, particle size analysis indicated Dv10, Dv50, and Dv90 values of 32.3 μm, 101 μm, and 218 μm, respectively. As shown in the microscope image and photographic image of FIG. 35B and FIG. 35C, respectively, the particles were polydisperse, cream white in color, and had a jagged morphology. When 10% (w/w) of microparticle preparation was incorporated into Chobani® yogurt (FIG. 35D) or Clif™ bar (FIG. 35E), no textural or color alterations of the food product was observed. When 10% (w/w) of microparticle preparation was incorporated into water, microparticles were well distributed (FIG. 35F).

FIGS. 36A-36F show the physical characteristics of an exemplary microparticle preparation having, on a dry weight basis, 39% (w/w) agarose, 20% (w/w) methyl cellulose 4000 cP, 2% (w/w) locust bean gum, and 39% (w/w) hydrolyzed whey protein isolate.

To manufacture the microparticle preparation shown in FIGS. 36A-36F, 20 g of methyl cellulose 4000 cP was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 89%, with 3 unit processes and 780 g of generated waste water (e.g., evaporated).

As shown in FIG. 36A, particle size analysis indicated Dv10, Dv50, and Dv90 values of 53.7 μm, 156 μm, and 345 μm, respectively. As shown in the microscope image and photographic image of FIG. 36B and FIG. 36C, respectively, the particles were polydisperse, cream white in color, and had a jagged morphology. When 10% (w/w) of microparticle preparation was incorporated into Chobani® yogurt (FIG. 36D) or Clif™ bar (FIG. 36E), no textural or color alterations of the food product was observed. When 10% (w/w) of microparticle preparation was incorporated into water, microparticles were well distributed (FIG. 36F).

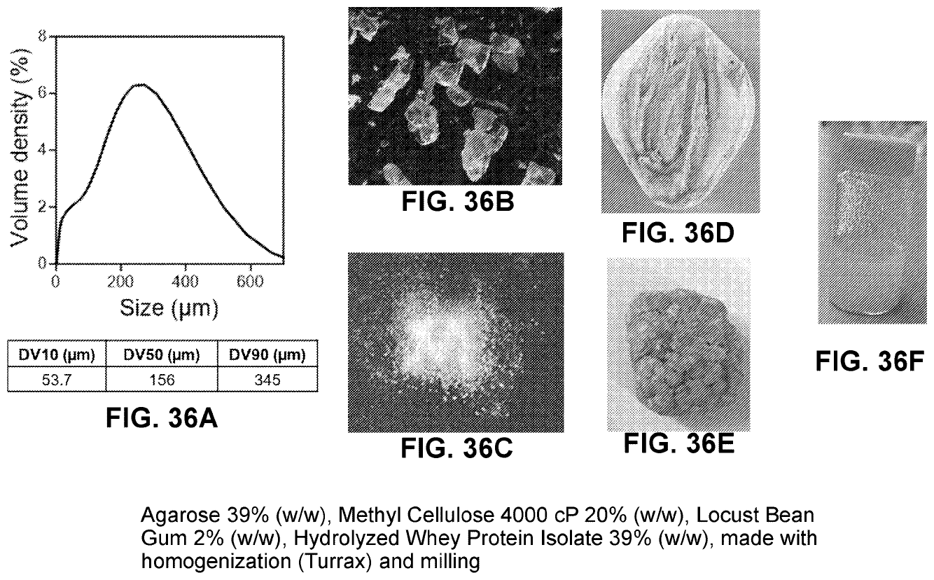

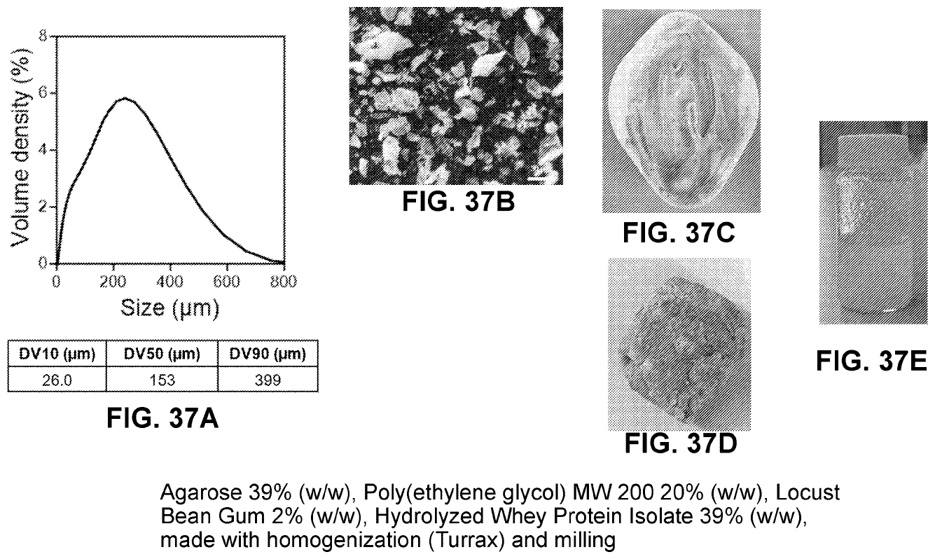

FIGS. 37A-37E show the physical characteristics of an exemplary microparticle preparation having, on a dry weight basis, 39% (w/w) agarose, 20% (w/w) poly(ethylene glycol), 2% (w/w) locust bean gum, and 39% (w/w) hydrolyzed whey protein isolate.

To manufacture the microparticle preparation shown in FIGS. 37A-37E, 20 g of poly(ethylene glycol) was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 82%, with 3 unit processes and 780 g of generated waste water (e.g., evaporated).

As shown in FIG. 37A, particle size analysis indicated Dv10, Dv50, and Dv90 values of 26.0 μm, 153 μm, and 399 μm, respectively. As shown in the microscope image of FIG. 37B, the particles were polydisperse, cream white in color, and had a jagged morphology. When 10% (w/w) of microparticle preparation was incorporated into Chobani® yogurt (FIG. 37C) or Clif™ bar (FIG. 37D), no textural or color alterations of the food product was observed. When 10% (w/w) of microparticle preparation was incorporated into water, microparticles were well distributed (FIG. 37E).

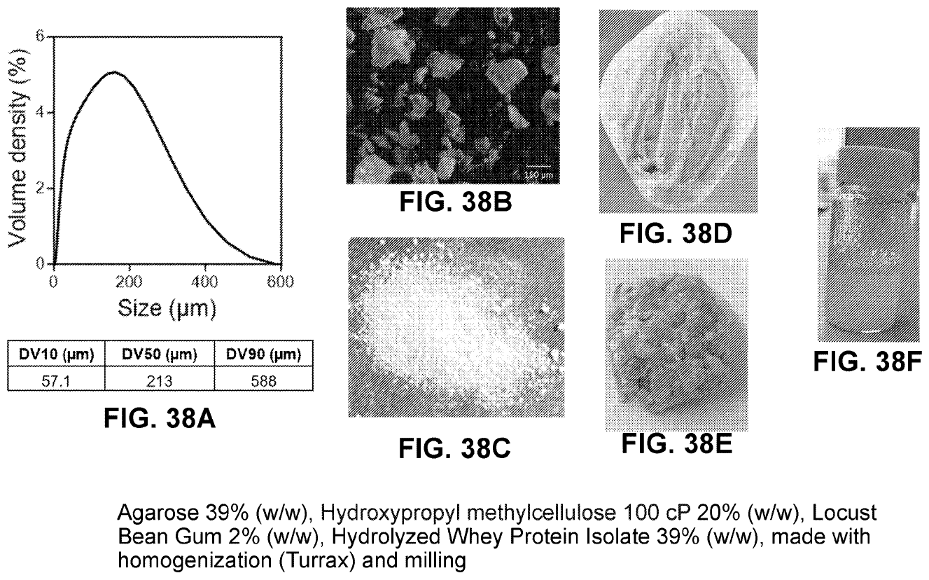

FIGS. 38A-38F show the physical characteristics of an exemplary microparticle preparation having, on a dry weight basis, 39% (w/w) agarose, 20% (w/w) hydroxypropyl methylcellulose 100 cP, 2% (w/w) locust bean gum, and 39% (w/w) hydrolyzed whey protein isolate.

To manufacture the microparticle preparation shown in FIGS. 38A-38F, 20 g of hydroxypropyl methylcellulose was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 91%, with 3 unit processes and 780 g of generated waste water (e.g., evaporated).

As shown in FIG. 38A, particle size analysis indicated Dv10, Dv50, and Dv90 values of 57.1 μm, 213 μm, and 588 μm, respectively. As shown in the microscope image and photographic image of FIG. 38B and FIG. 38C, respectively, the particles were polydisperse, cream white in color, and had a jagged morphology. When 10% (w/w) of microparticle preparation was incorporated into Chobani® yogurt (FIG. 38D) or Clif™ bar (FIG. 38E), no textural or color alterations of the food product was observed. When 10% (w/w) of microparticle preparation was incorporated into water, microparticles were well distributed (FIG. 38F).

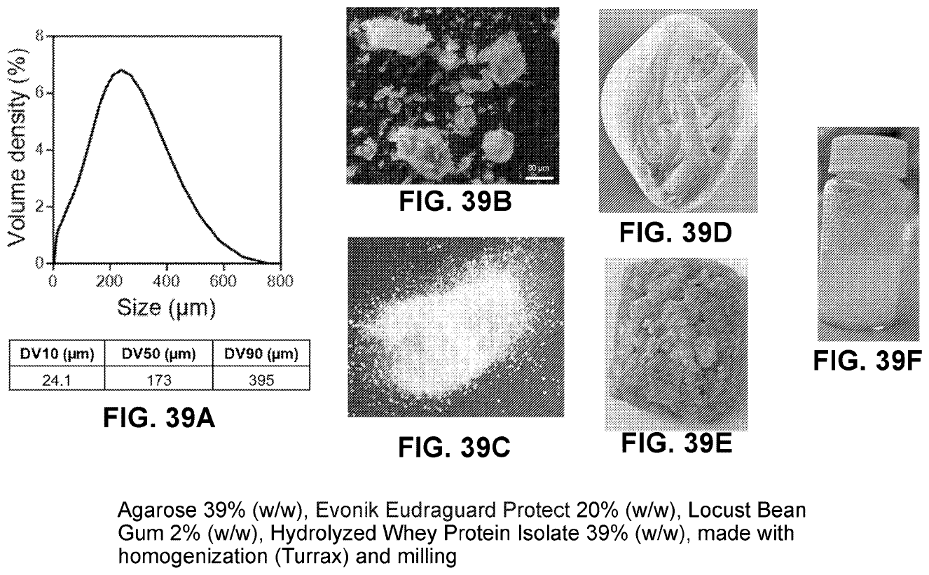

FIGS. 39A-39F show the physical characteristics of an exemplary microparticle preparation having, on a dry weight basis, 39% (w/w) agarose, 20% (w/w) Evonik Eudraguard Protect™, 2% (w/w) locust bean gum, and 39% (w/w) hydrolyzed whey protein isolate.

To manufacture the microparticle preparation shown in FIGS. 39A-39F, 20 g of Eudraguard Protect™ was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 61 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 100%, with 3 unit processes and 780 g of generated waste water and acetic acid (e.g., evaporated).

As shown in FIG. 39A, particle size analysis indicated Dv10, Dv50, and Dv90 values of 24.1 μm, 173 μm, and 395 μm, respectively. As shown in the microscope image and photographic image of FIG. 39B and FIG. 39C, respectively, the particles were polydisperse, light yellow in color, and had a jagged morphology. When 10% (w/w) of microparticle preparation was incorporated into Chobani® yogurt (FIG. 39D) or Clif™ bar (FIG. 39E), no textural or color alterations of the food product was observed. When 10% (w/w) of microparticle preparation was incorporated into water, microparticles were well distributed (FIG. 39F).

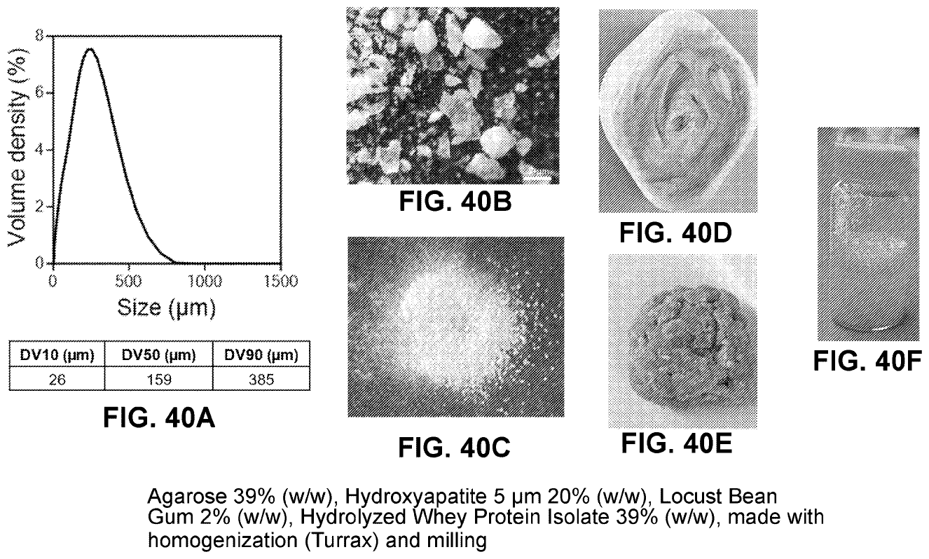

FIGS. 40A-40F show the physical characteristics of an exemplary microparticle preparation having, on a dry weight basis, 39% (w/w) agarose, 20% (w/w) hydroxyapatite 5 μm, 2% (w/w) locust bean gum, and 39% (w/w) hydrolyzed whey protein isolate.

To manufacture the microparticle preparation shown in FIGS. 40A-40F, 20 g of hydroxyapatite 5 μm particles was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 62 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 100%, with 3 unit processes and 780 g of generated waste water (e.g., evaporated).

As shown in FIG. 40A, particle size analysis indicated Dv10, Dv50, and Dv90 values of 26 μm, 159 μm, and 385 μm, respectively. As shown in the microscope image and photographic image of FIG. 40B and FIG. 40C, respectively, the particles were polydisperse, cream white in color, and had a jagged morphology. When 10% (w/w) of microparticle preparation was incorporated into Chobani® yogurt (FIG. 40D) or Clif™ bar (FIG. 40E), no textural or color alterations of the food product was observed. When 10% (w/w) of microparticle preparation was incorporated into water, microparticles were well distributed (FIG. 40F).

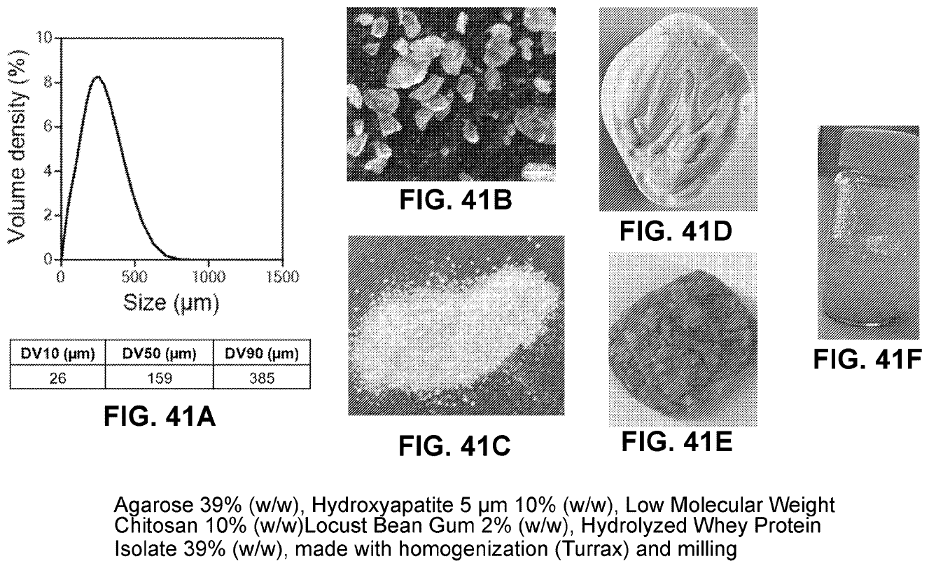

FIGS. 41A-41F show the physical characteristics of an exemplary microparticle preparation having, on a dry weight basis, 39% (w/w) agarose, 10% (w/w) hydroxyapatite 5 μm, 10% (w/w) low molecular weight chitosan, 2% (w/w) locust bean gum, and 39% (w/w) hydrolyzed whey protein isolate.

To manufacture the microparticle preparation shown in FIGS. 41A-41F, 10 g of hydroxyapatite 5 μm particles and 10 g of low molecular weight chitosan was dissolved in 780 mL of 10 mM PBS overnight at 4 °C, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 63 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 100%, with 3 unit processes and 780 g of generated waste water and acetic acid (e.g., evaporated).

As shown in FIG. 41A, particle size analysis indicated Dv10, Dv50, and Dv90 values of 34.3 μm, 171 μm, and 383 μm, respectively. As shown in the microscope image and photographic image of FIG. 41B and FIG. 41C, respectively, the particles were polydisperse, light yellow in color, and had a jagged morphology. When 10% (w/w) of microparticle preparation was incorporated into Chobani® yogurt (FIG. 41D) or Clif™ bar (FIG. 41E), no textural or color alterations of the food product was observed. When 10% (w/w) of microparticle preparation was incorporated into water, microparticles were well distributed (FIG. 41F).

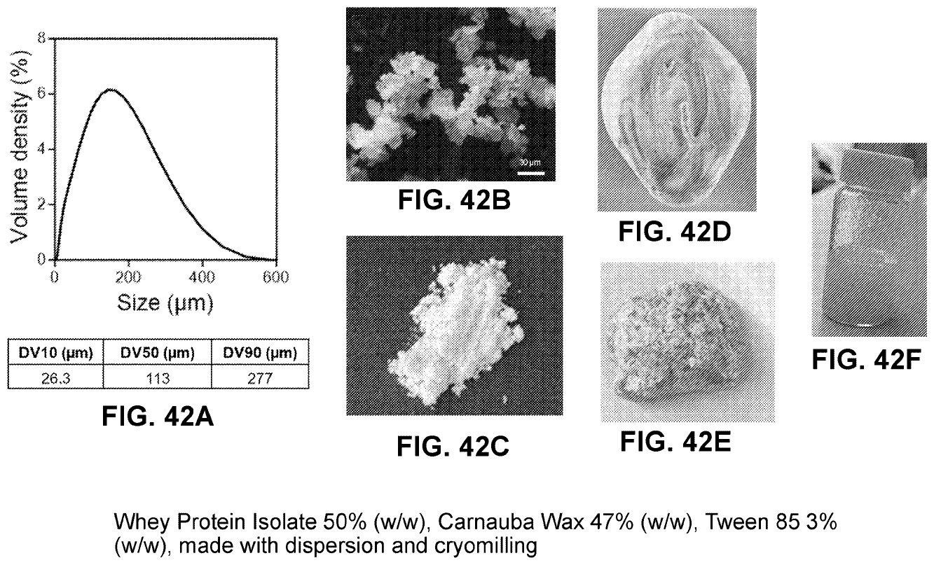

FIGS. 42A-42F show the physical characteristics of an exemplary microparticle preparation having, on a dry weight basis, 50% (w/w) whey protein isolate, 47% (w/w) carnauba wax, and 3% (w/w) Tween 85.

To manufacture the microparticle preparation shown in FIGS. 42A-42F, 47 g of carnauba wax was melted at 80 °C on a hot plate, followed by addition of 3 g Tween 85. The mixture was stirred using an overhead stirrer for at least 30 minutes, then 50 g of whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter. The yield of recovered particles was 59%, with 2 unit processes and 0 g of generated waste.

As shown in FIG. 42A, particle size analysis indicated Dv10, Dv50, and Dv90 values of 26.3 μm, 113 μm, and 277 μm, respectively. As shown in the microscope image and photographic image of FIG. 42B and FIG. 42C, respectively, the particles were polydisperse, cream white in color, and had a jagged morphology. When 10% (w/w) of microparticle preparation was incorporated into Chobani® yogurt (FIG. 42D) or Clif™ bar (FIG. 42E), no textural or color alterations of the food product was observed. When 10% (w/w) of microparticle preparation was incorporated into water, microparticles were well distributed (FIG. 42F).

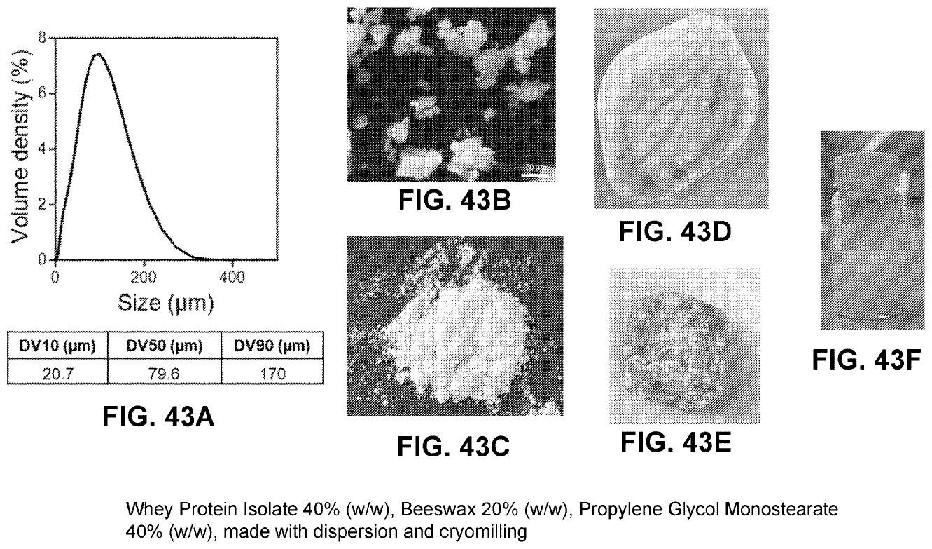

FIGS. 43A-43F show the physical characteristics of an exemplary microparticle preparation having, on a dry weight basis, 40% (w/w) whey protein isolate, 20% (w/w) beeswax, and 40% (w/w) glycol monostearate.

To manufacture the microparticle preparation shown in FIGS. 43A-43F, 20 g of white beeswax was melted at 80 °C on a hot plate, followed by addition of 40 g of propylene glycol monostearate. The mixture was stirred using an overhead stirrer for at least 30 minutes, then 40 g whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter. The yield of recovered particles was 44%, with 2 unit processes and 0 g of generated waste.

As shown in FIG. 43A, particle size analysis indicated Dv10, Dv50, and Dv90 values of 20.7 μm, 79.6 μm, and 170 μm, respectively. As shown in the microscope image and photographic image of FIG. 43B and FIG. 43C, respectively, the particles were polydisperse, cream white in color, and had a jagged morphology. When 10% (w/w) of microparticle preparation was incorporated into Chobani® yogurt (FIG. 43D) or Clif™ bar (FIG. 43E), no textural or color alterations of the food product was observed. When 10% (w/w) of microparticle preparation was incorporated into water, microparticles were well distributed (FIG. 43F).

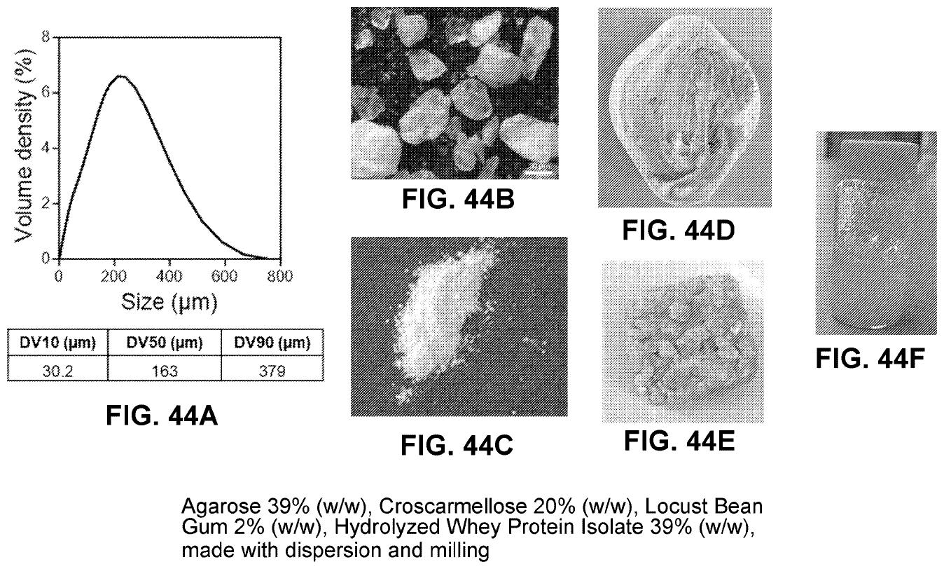

FIGS. 44A-44F show the physical characteristics of an exemplary microparticle preparation having, on a dry weight basis, 39% (w/w) agarose, 20% (w/w) croscarmellose, 2% (w/w) locust bean gum, and 39% (w/w) hydrolyzed whey protein isolate.

To manufacture the microparticle preparation shown in FIGS. 44A-44F, 20 g of croscarmellose sodium was dissolved in 780 mL of 10 mM PBS, followed by dissolution of 39 g of hydrolyzed whey protein isolate. 39 g of agarose powder and 2 g of locust bean gum powder were dispersed within the mixture using an overhead stirrer. The suspension was then heated to 95 °C, until the agarose and locust bean gum were completely dissolved. The molten mixture was allowed to cool to 15 °C, 20 °C, or 25 °C and then transferred to an aluminum sheet to be stored at either 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 89%, with 3 unit processes and 780 g of generated waste water (e.g., evaporated).

As shown in FIG. 44A, particle size analysis indicated Dv10, Dv50, and Dv90 values of 30.2 μm, 163 μm, and 379 μm, respectively. As shown in the microscope image and photographic image of FIG. 44B and FIG. 44C, respectively, the particles were polydisperse, cream white in color, and had a jagged morphology. When 10% (w/w) of microparticle preparation was incorporated into Chobani® yogurt (top left panel) or Clif™ bar (bottom panel), no textural or color alterations of the food product was observed. When 10% (w/w) of microparticle preparation was incorporated into water, microparticles were well distributed (FIG. 44F).

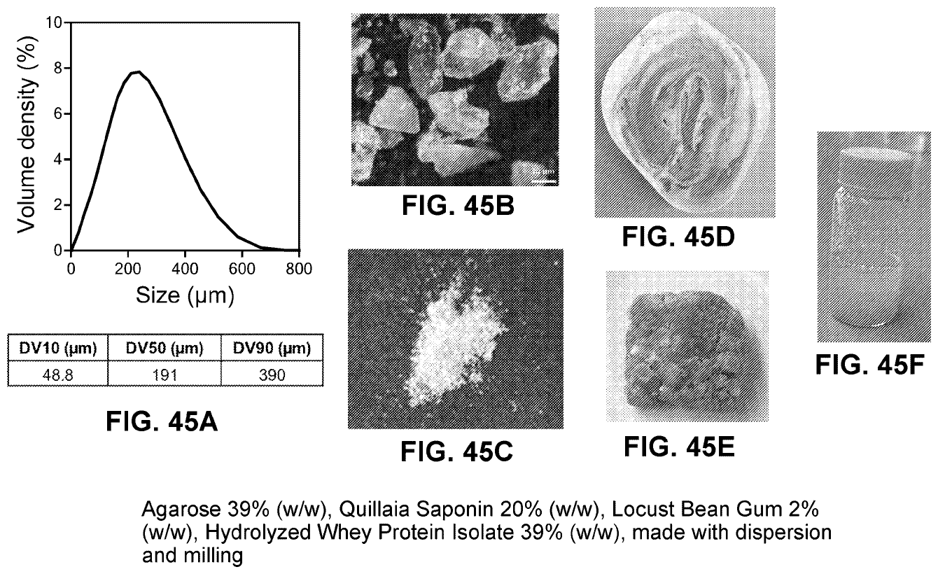

FIGS. 45A-45F show the physical characteristics of an exemplary microparticle preparation having, on a dry weight basis, 39% (w/w) agarose, 20% (w/w) quillaia saponin, 2% (w/w) locust bean gum, and 39% (w/w) hydrolyzed whey protein isolate.

To manufacture the microparticle preparation shown in FIGS. 45A-45F, 20 g of Quillaia saponin was dissolved in 780 mL of 10 mM PBS, followed by dissolution of 39 g of hydrolyzed whey protein isolate. 39 g of agarose powder and 2 g of locust bean gum powder were dispersed within the mixture using an overhead stirrer. The suspension was then heated to 95 °C, until the agarose and locust bean gum were completely dissolved. The molten mixture was allowed to cool to 15 °C, 20 °C, or 25 °C and then transferred to an aluminum sheet to be stored at either 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 83%, with 3 unit processes and 780 g of generated waste water (e.g., evaporated).

As shown in FIG. 45A, particle size analysis indicated Dv10, Dv50, and Dv90 values of 48.8 μm, 191 μm, and 390 μm, respectively. As shown in the microscope image and photographic image of FIG. 45B and FIG. 45C, respectively, the particles were polydisperse, tan in color, and had a jagged morphology. When 10% (w/w) of microparticle preparation was incorporated into Chobani® yogurt (FIG. 45D) or Clif™ bar (FIG. 45E), no textural or color alterations of the food product was observed. When 10% (w/w) of microparticle preparation was incorporated into water, microparticles were well distributed (FIG. 45F).

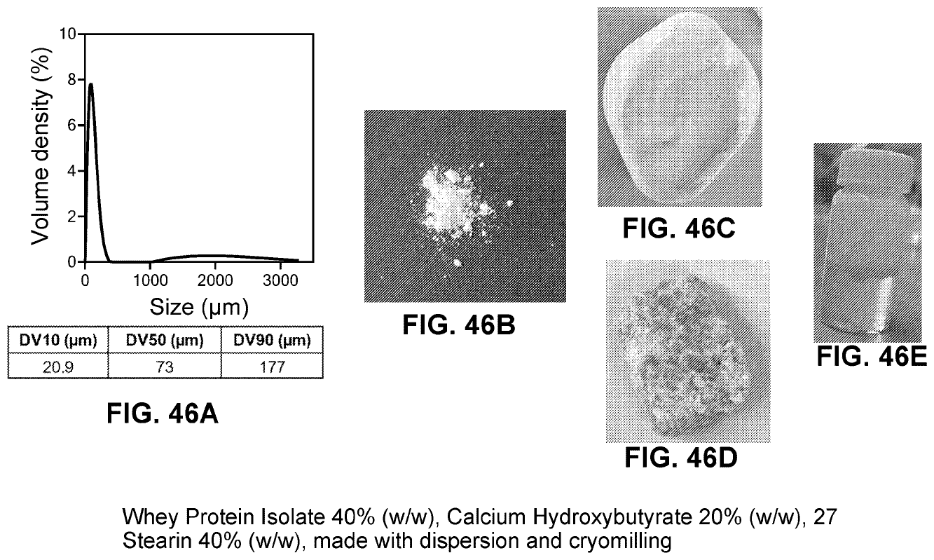

FIGS. 46A-46E show the physical characteristics of an exemplary microparticle preparation having, on a dry weight basis, 40% (w/w) whey protein isolate, 20% (w/w) calcium hydroxybutyrate, and 40% (w/w) stearin 27.

To manufacture the microparticle preparation shown in FIGS. 46A-46E, 40 g of 27 stearin was melted at 80 °C on a hot plate, followed by addition of 20 g calcium hydroxybutyrate in small portions via high shear homogenization. The mixture was stirred using an overhead stirrer for at least 30 minutes, then 40 g of whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter. The yield of recovered particles was 60%, with 2 unit processes and 0 g of generated waste.

As shown in FIG. 46A, particle size analysis indicated Dv10, Dv50, and Dv90 values of 20.0 μm, 73 μm, and 177 μm, respectively. As shown in the photographic image of FIG. 46B, the particles were polydisperse and cream white in color. When 10% (w/w) of microparticle preparation was incorporated into Chobani® yogurt (FIG. 46C) or Clif™ bar (FIG. 46D), significant adverse textural and/or color alterations of the food product was observed. When 10% (w/w) of microparticle preparation was mixed with water, microparticles did not incorporate (FIG. 46E).

FIGS. 47A-47E show the physical characteristics of an exemplary microparticle preparation having, on a dry weight basis, 50% (w/w) whey protein isolate, 20% (w/w) ethyl cellulose 100 cP, and 30% (w/w) 27 Stearin.

To manufacture the microparticle preparation shown in FIGS. 47A-47E, 30 g of 27 stearin was melted at 150 °C on a hot plate, followed by addition of 20 g ethyl cellulose 100 cP via high shear homogenization. The mixture was stirred using an overhead stirrer for at least 30 minutes, then 50 g of whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter. The yield of recovered particles was 44%, with 2 unit processes and 0 g of generated waste.

As shown in FIG. 47A, particle size analysis indicated Dv10, Dv50, and Dv90 values of 12.4 μm, 44.7 μm, and 157 μm, respectively. As shown in the microscope image of FIG. 47B, the particles were polydisperse, cream white in color, and had a jagged morphology. When 10% (w/w) of microparticle preparation was incorporated into Chobani® yogurt (FIG. 47C) or Clif™ bar (FIG. 47D), significant textural and/or color alterations of the food product was observed. When 10% (w/w) of microparticle preparation was mixed with water, microparticles did not incorporate (FIG. 47E).

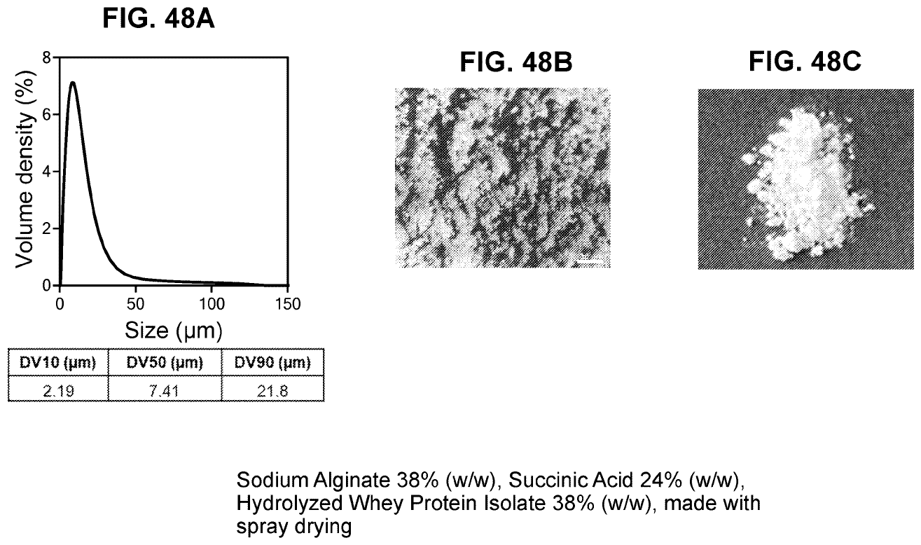

FIGS. 48A-48C show the physical characteristics of an exemplary microparticle preparation having, on a dry weight basis, 38% (w/w) sodium alginate, 24% (w/w) succinic acid, and 38% (w/w) hydrolyzed whey protein isolate.

To manufacture the microparticle preparation shown in FIGS. 48A-48C, 38 g of sodium alginate was dissolved in 900 mL of water overnight at 40 °C, followed by dissolution of 24 g of succinic acid, followed by dissolution of 38 g of hydrolyzed whey protein isolate. The pH of the solution was adjusted to at least 7.2, at least 7.4, at least 7.6, at least 7.8, at least 8.0, at least 8.2, or at least 8.4 using ammonium hydroxide. The solution was then spray-dried using a Buchi B-290 benchtop spray drier with inlet temperature at least 120 °C, at least 125 °C, at least 130 °C, at least 135 °C, at least 140 °C, or at least 145 °C; low rate at 20%; and sweep gas at 414 L/h. The yield of recovered particles was 60%, with 1 unit process and 900 g of generated waste water (e.g., evaporated).

As shown in FIG. 48A, particle size analysis indicated Dv10, Dv50, and Dv90 values of 2.19 μm, 7.41 μm, and 21.8 μm, respectively. As shown in the microscope image and photographic image of FIG. 48B and FIG. 48C, respectively, the particles were polydisperse, white in color, and had a spherical morphology.

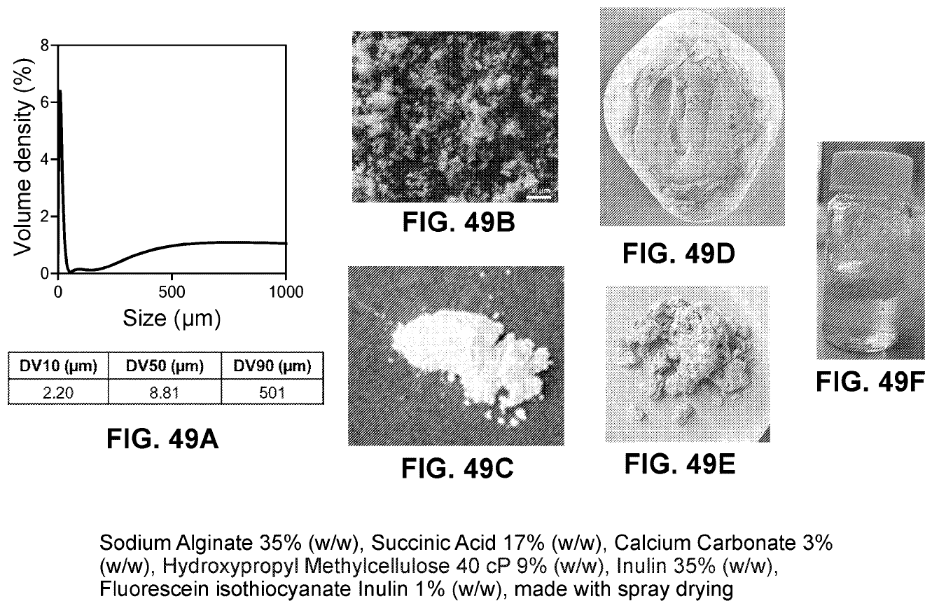

FIGS. 49A-49F show the physical characteristics of an exemplary microparticle preparation having, on a dry weight basis, 35% (w/w) sodium alginate, 17% (w/w) succinic acid, 3% (w/w) calcium carbonate, 9% (w/w) hydroxypropyl methylcellulose 40 cP, 35% (w/w) inulin, and 1% (w/w) fluorescein isothiocyanate inulin.

To manufacture the microparticle preparation shown in FIGS. 49A-49F, 35 g of sodium alginate and 9 g of hydroxypropyl methylcellulose 40 cP were dissolved in 900 mL of water overnight at 20 °C, followed by dissolution of 17 g of succinic acid, followed by 35 g of inulin. The pH of the solution was adjusted to at least 7.2, at least 7.4, at least 7.6, at least 7.8, at least 8.0, at least 8.2, or at least 8.4 using ammonium hydroxide. 3 g of calcium phosphate monobasic was added to the solution. The solution was then spray-dried using a Buchi B-290 benchtop spray drier with an inlet temperature of at least 120 °C, at least 125 °C, at least 130 °C, at least 135 °C, at least 140 °C, or at least 145 °C; flow rate at 20%; and sweep gas at 414 L/h. The yield of recovered particles was 71%, with 1 unit process and 900 g of generated waste water (e.g., evaporated).

As shown in FIG. 49A, particle size analysis indicated Dv10, Dv50, and Dv90 values of 2.20 μm, 8.81 μm, and 501 μm, respectively. As shown in the microscope image and photographic image of FIG. 49B and FIG. 49C, respectively, the particles were polydisperse, white in color, and had a spherical morphology. When 10% (w/w) of microparticle preparation was incorporated into Chobani® yogurt (FIG. 49D) or Clif™ bar (FIG. 49E), significant adverse textural and/or color alterations of the food product was observed. When 10% (w/w) of microparticle preparation was incorporated into water, microparticles did not incorporate (FIG. 49F).

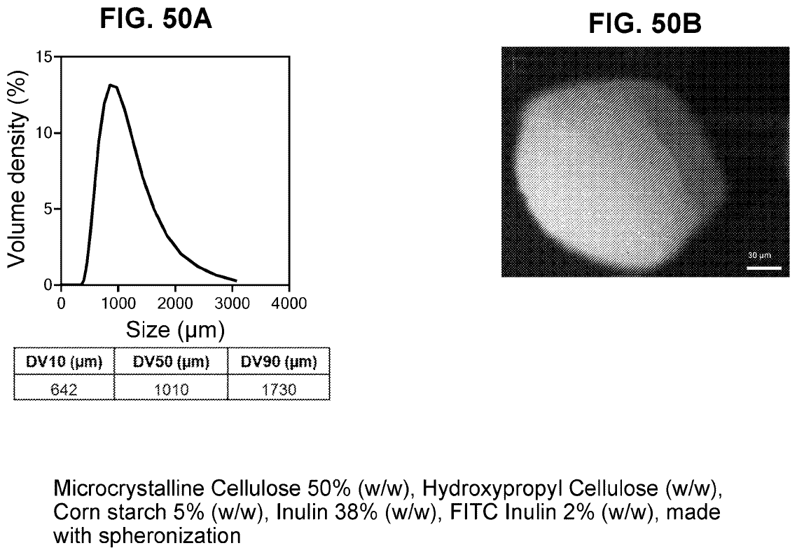

FIGS. 50A-50B show the physical characteristics of an exemplary microparticle preparation having, on a dry weight basis, 50% (w/w) microcrystalline cellulose, 5% (w/w) hydroxypropyl cellulose, 5% (w/w) corn starch, 38% (w/w) inulin, and 2% (w/w) fluorescein isothiocyate inulin.

To manufacture the microparticle preparation shown in FIGS. 50A-50B, 40 g of inulin, 50 g of microcrystalline cellulose, 5 g of hydroxypropyl cellulose grade SSL, and 5 g of corn starch were combined in a wet granulation apparatus with 5 mL of water followed by granulation using a twin-screw mixer. The granulated mixture was then passed through circular dies of 1 mm diameter to yield extrudate that was subsequently spheronized using a rotating disc. The spheronized particles were collected and allowed to dry in a 50 °C oven overnight. The yield of recovered particles was 52%, with 2 unit processes and 5 g of generated waste water (e.g., evaporated).

As shown in FIG. 50A, particle size analysis indicated Dv10, Dv50, and Dv90 values of 642 μm, 1010 μm, and 1730 μm, respectively. As shown in the microscope image of FIG. 50B, the particles were polydisperse, white in color, and had a spherical morphology.

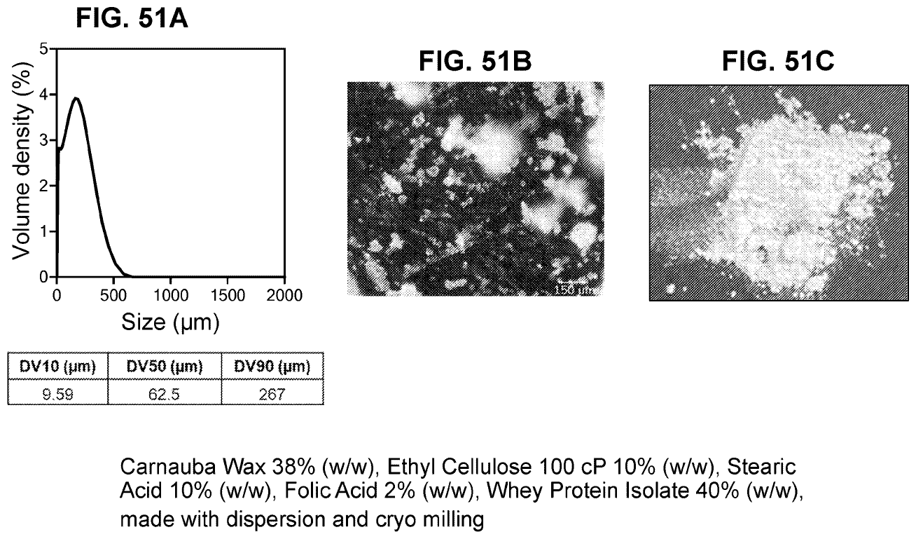

FIGS. 51A-51C show the physical characteristics of an exemplary microparticle preparation having, on a dry weight basis, 38% (w/w) carnauba wax, 10% (w/w) ethyl cellulose 100 cP, 10% (w/w) stearic acid, 2% (w/w) folic acid, and 40% (w/w) whey protein isolate.

To manufacture the microparticle preparation shown in FIGS. 51A-51C, 80 g of whey protein isolate was dissolved in 720 mL of distilled water then spray-dried using a Buchi B-290 benchtop spray drier with an inlet temperature of at least 120 °C, at least 125 °C, at least 130 °C, at least 135 °C, at least 140 °C, or at least 145 °C; flow rate at 20%; and sweep gas at 414 L/h. The recovered yield was 50%, 38 g of carnauba wax was melted at 150 °C on a hot plate, followed by addition of 10 g of ethyl cellulose 100 cP in small portions via high shear homogenization. The mixture was stirred using an overhead stirrer for at least 30 minutes, and 10 g of stearic acid, 2 g of folic acid, and 40 g of spray dried whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, or 100 μm screen filter. The yield of recovered particles was 27%, with 3 unit processes and 720 g of aqueous waste.

As shown in FIG. 51A, particle size analysis indicated Dv10, Dv50, and Dv90 values of 9.59 μm, 62.5 μm, and 267 μm, respectively. As shown in the microscope image and photographic image of FIG. 51B and FIG. 51C, respectively, the particles were polydisperse, cream white in color, and had a jagged morphology.

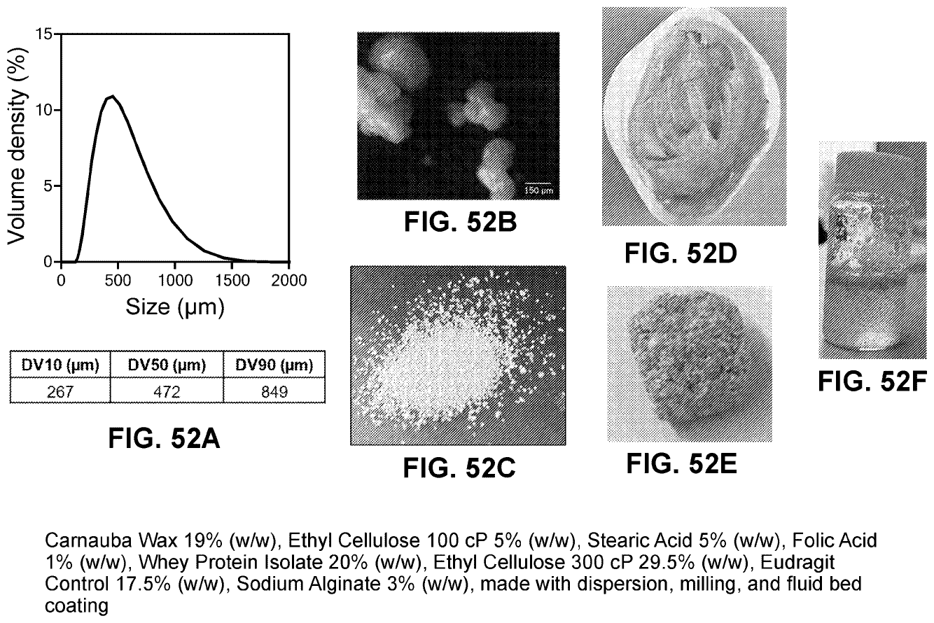

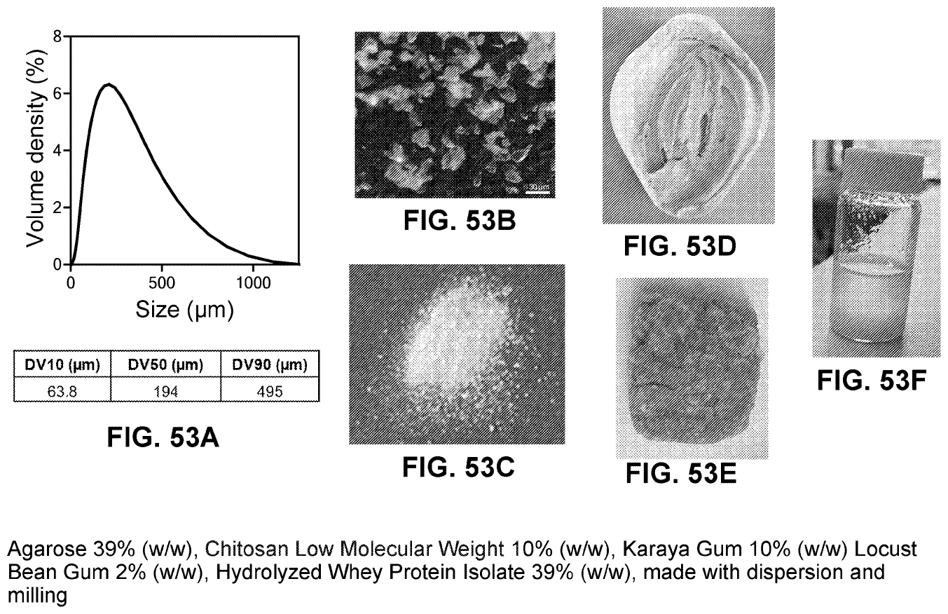

FIGS. 52A-52F show the physical characteristics of an exemplary microparticle preparation having, on a dry weight basis, 19% (w/w) carnauba wax, 5% (w/w) ethyl cellulose 100 cP, 5% (w/w) stearic acid, 1% (w/w) folic acid, 20% (w/w) whey protein isolate, 29.5% (w/w) ethylcellulose 300 cP, 17.5% (w/w) Eudragit control, and 3% (w/w) sodium alginate.

To manufacture the microparticle preparation shown in FIGS. 52A-52F, 80 g of whey protein isolate was dissolved in 720 mL of distilled water then spray-dried using a Buchi B-290 benchtop spray drier with inlet temperature at least 120 °C, at least 125 °C, at least 130 °C, at least 135 °C, at least 140 °C, or at least 145 °C; flow rate at 20%; and sweep gas at 414 L/h. The recovered yield was 50%, 38 g of carnauba wax was melted at 150 °C on a hot plate, followed by the addition of 10 g ethyl cellulose 100 cP in small portions via high shear homogenization. The mixture was stirred using an overhead stirrer for at least 30 minutes, then 10 g of stearic acid, 2 g of folic acid, and 40 g of spray dried whey protein isolate was added to the mixture. The mixture was subsequently cooled to at least −50 °C, −78 °C, −150 °C, or −196 °C and milled using an IKA M10 hammer mill equipped with a 1000 μm, 750 μm, 500 μm, 250 μm, and/or 100 μm screen filter. Particles were subsequently coated using 3 layers: ethyl cellulose 300 cP (final 29.5% (w/w)), Eudragit control (final 17.5% (w/w)), and sodium alginate (final 3% (w/w)). The fluid bed parameters were as follows: Spray on/off: 0.8/0.8, 50 revolutions per minute, pump rev: 6 seconds, inlet temp: 50 °C. Spraying occurred until 20% (w/w) of ethyl cellulose 300 cP was added to the particles, consistently monitoring the fluidization of the particles. All tubing was cleaned by first pumping ethanol, then water, through the tubing at 60 revolutions per minute. Next, 100 ml of Eudragit L100 solution was placed on a scale to track coating weight in grams as spraying occurred. The fluid bed parameters were as follows: Spray on/off: 0.8/0.8, 50 revolutions per minute, pump rev: 6 seconds, inlet temp: 30 °C. Spraying occurred until 12% (w/w) of Eudragit L100 was added to the particles. All tubing was cleaned by pumping water through the tubing at 60 revolutions per minute. Next, a solution of 2% (w/w) sodium alginate in 100 mL of water was prepared on a hot plate, stirring at 400 revolutions per minute at 100 °C for 30 mins, or until the NS Enteric appear solubilized. The NS Enteric solution was placed on a scale and to track coating weight in grams as spraying occurs. The fluid bed parameters were as follows: Spray on/off: 0.0/0.0, 15 revolutions per minute, pump rev: 5 seconds, inlet temp: 80 °C. Spraying occurred until 2.5% (w/w) of NS Enteric was added to the particles, consistently monitoring the fluidization of the particles. The yield of recovered particles was 12%, with 6 unit processes and 2100 g of generated waste.

As shown in FIG. 52A, particle size analysis indicated Dv10, Dv50, and Dv90 values of 267 μm, 472 μm, and 849 μm, respectively. As shown in the microscope image and photographic image of FIG. 52B and FIG. 52C, respectively, the particles were aggregated, tan in color, and had a smooth morphology. When 10% (w/w) of microparticle preparation was incorporated into Chobani® yogurt (FIG. 52D) or Clif™ bar (FIG. 52E), significant adverse textural and/or color alterations of the food product was observed. When 10% (w/w) of microparticle preparation was mixed with water, microparticles did not incorporate (FIG. 52F, top right panel).

FIGS. 53A-53F show the physical characteristics of an exemplary microparticle preparation having, on a dry weight basis, 39% (w/w) agarose, 10% (w/w) chitosan low molecular weight, 10% (w/w) karaya gum, 2% (w/w) locust bean gum, and 39% (w/w) hydrolyzed whey protein isolate.

To manufacture the microparticle preparation shown in FIGS. 53A-53F, 10 g of low molecular weight chitosan was dissolved in 780 mL of acetic acid, followed by dissolution of 39 g of hydrolyzed whey protein isolate. 10 g of karaya gum, 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 750 μm, 500 μm, 250 μm, or 100 μm screen filter. The yield of recovered particles was 99%, with 3 unit processes and 780 g of generated waste water and acetic acid (e.g., evaporated).

As shown in FIG. 53A, particle size analysis indicated Dv10, Dv50, and Dv90 values of 63.8 μm, 194 μm, and 495 μm, respectively. As shown in the microscope image and photographic image of FIG. 53B and FIG. 53C, respectively, the particles were polydisperse, light yellow in color, and had a jagged morphology. When 10% (w/w) of microparticle preparation was incorporated into Chobani® yogurt (FIG. 53D) or Clif™ bar (FIG. 53E), no textural or color alterations of the food product was observed.

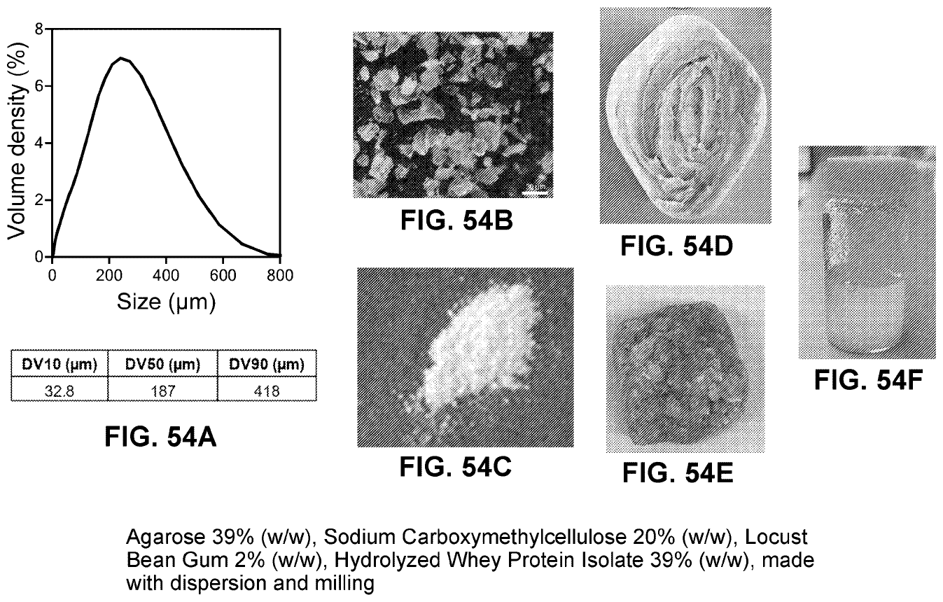

FIGS. 54A-54F show the physical characteristics of an exemplary microparticle preparation having, on a dry weight basis, 39% (w/w) agarose, 20% (w/w) sodium carboxymethylcellulose, 2% (w/w) locust bean gum, and 39% (w/w) hydrolyzed whey protein isolate.

To manufacture the microparticle preparation shown in FIGS. 54A-54F, 20 g of sodium carboxymethylcellulose was dissolved in 780 mL of 10 mM PBS, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 760 μm, 500 μm, 250 μm, or 100 μm screen filter. The yield of recovered particles was 87%, with 3 unit processes and 780 g of generated waste water (e.g., evaporated).

As shown in FIG. 54A, particle size analysis indicated Dv10, Dv50, and Dv90 values of 32.8 μm, 187 μm, and 418 μm, respectively. As shown in the microscope image and photographic image of FIG. 54B and FIG. 54C, respectively, the particles were polydisperse, cream white in color, and had a jagged morphology. When 10% (w/w) of microparticle preparation was incorporated into Chobani® yogurt (FIG. 54D) or Clif™ bar (FIG. 54E), no textural or color alterations of the food product was observed. When 10% (w/w) of microparticle preparation was incorporated into water, microparticles were well distributed (FIG. 54F).

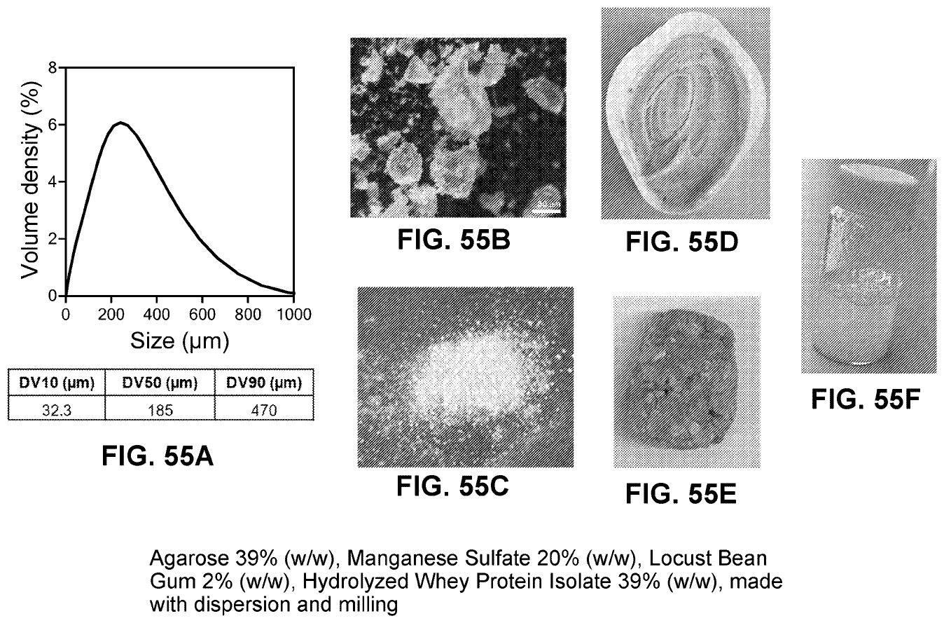

FIGS. 55A-55F show the physical characteristics of an exemplary microparticle preparation having, on a dry weight basis, 39% (w/w) agarose, 20% (w/w) manganese sulfate, 2% (w/w) locust bean gum, and 39% (w/w) hydrolyzed whey protein isolate.

To manufacture the microparticle preparation shown in FIGS. 55A-55F, 20 g of manganese sulfate was dissolved in 780 mL of 10 mM PBS, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 770 μm, 500 μm, 250 μm, or 100 μm screen filter. The yield of recovered particles was 73%, with 3 unit processes and 780 g of generated waste water (e.g., evaporated).

As shown in FIG. 55A, particle size analysis indicated Dv10, Dv50, and Dv90 values of 32.3 μm, 185 μm, and 470 μm, respectively. As shown in the microscope image and photographic image of FIG. 55B and FIG. 55C, respectively, the particles were polydisperse, cream white in color, and had a jagged morphology. When 10% (w/w) of microparticle preparation was incorporated into Chobani® yogurt (FIG. 55D) or Clif™ bar (FIG. 55E), no textural or color alterations of the food product was observed. When 10% (w/w) of microparticle preparation was incorporated into water, microparticles were well distributed (FIG. 55F).

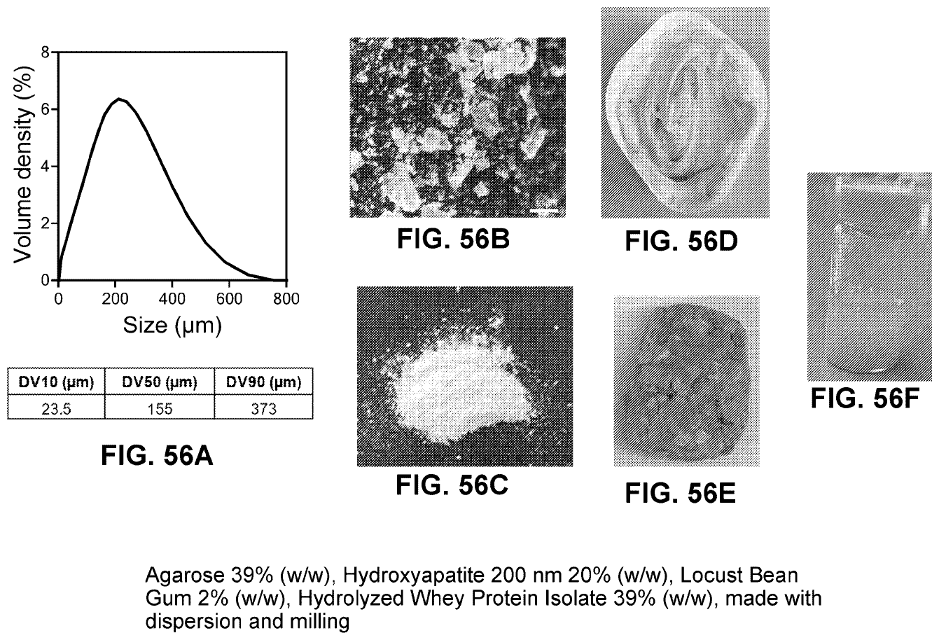

FIGS. 56A-56F show the physical characteristics of an exemplary microparticle preparation having, on a dry weight basis, 39% (w/w) agarose, 20% (w/w) hydroxyapatite 200 nm, 2% (w/w) locust bean gum, and 39% (w/w) hydrolyzed whey protein isolate.

To manufacture the microparticle preparation shown in FIGS. 56A-56F, 20 g of hydroxyapatite 200 nm particles were dissolved in 780 mL of 10 mM PBS, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 780 μm, 500 μm, 250 μm, or 100 μm screen filter. The yield of recovered particles was 100%, with 3 unit processes and 780 g of generated waste water (e.g., evaporated).

As shown in FIG. 56A, particle size analysis indicated Dv10, Dv50, and Dv90 values of 23.5 μm, 155 μm, and 373 μm, respectively. As shown in the microscope image and photographic image of FIG. 56B and FIG. 56C, respectively, the particles were polydisperse, cream white in color, and had a jagged morphology. When 10% (w/w) of microparticle preparation was incorporated into Chobani® yogurt (FIG. 56D) or Clif™ bar (FIG. 56E), no textural or color alterations of the food product was observed. When 10% (w/w) of microparticle preparation was incorporated into water, microparticles were well distributed (FIG. 56F).

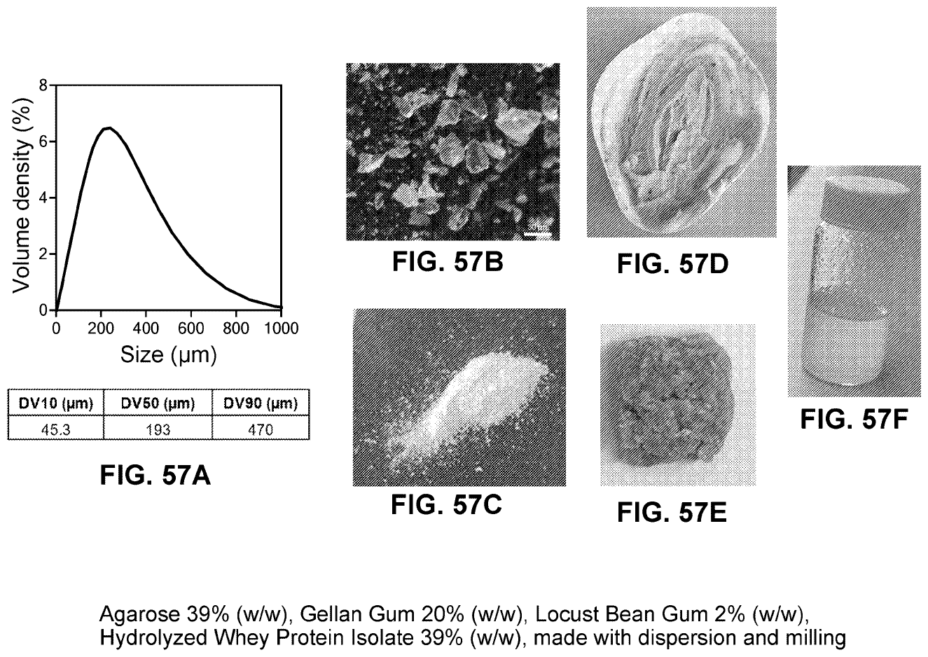

FIGS. 57A-57F show the physical characteristics of an exemplary microparticle preparation having, on a dry weight basis, 39% (w/w) agarose, 20% (w/w) gellan gum, 2% (w/w) locust bean gum, and 39% (w/w) hydrolyzed whey protein isolate.

To manufacture the microparticle preparation shown in FIGS. 57A-57F, 20 g of gellan gum was dissolved in 780 mL of 10 mM PBS, followed by dissolution of 39 g of hydrolyzed whey protein isolate. 39 g of agarose powder and 2 g of locust bean gum powder were then added to the mixture using an overhead stirrer. The suspension was then heated to 95 °C until the agarose and locust bean gum were completely dissolved. The molten mixture was allowed to cool to 15 °C, 20 °C, or 25 °C and then transferred to an aluminum sheet to be stored at 40 °C, 50 °C, 60 °C, or 70 °C overnight. The resulting dry chips were milled using an IKA M10 hammer mill equipped with a 1000 μm, 790 μm, 500 μm, 250 μm, or 100 μm screen filter. The yield of recovered particles was 84%, with 3 unit processes and 780 g of generated waste water (e.g., evaporated).

As shown in FIG. 57A, particle size analysis indicated Dv10, Dv50, and Dv90 values of 45.3 μm, 193 μm, and 470 μm, respectively. As shown in the microscope image and photographic image of FIG. 57B and FIG. 57C, respectively, the particles were polydisperse, cream white in color, and had a jagged morphology. When 10% (w/w) of microparticle preparation was incorporated into Chobani® yogurt (FIG. 57D) or Clif™ bar (FIG. 57E), no textural or color alterations of the food product was observed. When 10% (w/w) of microparticle preparation was incorporated into water, microparticles were well distributed (FIG. 57F).

### JJ. Example 28: Microparticle Preparation Excipients can Interfere with Assays Quantifying Food Components

This example shows that some microparticle preparation excipients can interfere with the quantification of one or more food components in standard protein quantification assays.

To determine excipients that potentially interfere with the measurement of protein concentration in solution, each exemplary excipient was prepared at three concentrations (target concentration, 3× below target concentration, and 3× above target concentration) according to Table 2, with a fixed concentration of isolated whey protein (2000 μg/ml) and mixed in PBS.

TABLE 2
Exemplary excipient concentrations

| | | | Conc. 3x | Target | Conc. 3x |
|---|---|---|---|---|---|
| Excipient | | | below | Conc. | above |
| Abbreviation | Excipient | Classification | (mg/ml) | (mg/ml) | (mg/ml) |
| AGAR | Agarose | Polysaccharide | 1.67 | 5 | 15 |
| ALG | Alginate | Polysaccharide | 1.07 | 3.2 | 9.6 |
| C10 | Sodium Decanoate | Fatty acid | 1 | 3 | 9 |
| CHILO | Chitosan Low Molecular | Polysaccharide | 1 | 3 | 9 |
| | Weight | | | | |
| CMC: 90 | Sodium Carboxymethyl | Polysaccharide | 0.67 | 2 | 6 |
| | Cellulose MW: 90000 | | | | |
| ETGALT | Ethyl Gallate | Polyphenol | 0.33 | 1 | 3 |
| FITC INLN | FITC Inulin | Fluorescent | 0.33 | 1 | 3 |
| | | compound | | | |
| HDB | 3-Hydroxybutyrate | Ketone | 0.33 | 1 | 3 |
| GLC | Glucose | Sugar | 6.67 | 20 | 60 |
| GLNL | Gluconolactone | Reducing agent | 0.33 | 1 | 3 |
| GRRHZ | Dipotassium | Terpene | 0.33 | 1 | 3 |
| | Glycyrrhizin Hydrate | | | | |
| HPMC | Hydroxypropyl | Polysaccharide | 0.33 | 1 | 3 |
| | Methylcellulose | | | | |
| INLN | Inulin | Payload | 1.67 | 5 | 15 |
| LBG | Locust Bean Gum | Gum | 0.33 | 1 | 3 |
| LEC | Lecithin | Surfactant | 5 | 15 | 45 |
| OLEA | Oleic Acid | Payload | 25 | 75 | 22.5 |
| PAA: 450 | Poly(acrylic acid) MW | Polymer | 0.67 | 2 | 6 |
| | 450000 | | | | |
| PHYTA | Phytic Acid | Chelates calcium | 2.33 | 7 | 21 |
| | | and copper | | | |
| SP60 | Span 60 | Surfactant, | 1.67 | 5 | 15 |
| | | oleogelator | | | |
| TANN | Tannic Acid | Polyphenol | 3.33 | 1 | 3 |
| TW80 | Tween 80 | Surfactant | 5 | 15 | 45 |
| CACO3 | Calcium Carbonate | Mineral | 0.83 | 2.5 | 7.5 |
| CCAS | Calcium Caseinate | Protein | 3.33 | 10 | 30 |
| WPI | Whey Protein Isolate | Protein | 3.33 | 10 | 30 |
| SMS | Sucrose Monostearate | Surfactant | 1 | 3 | 9 |
| STI: 500 | Pre-gelatinized maize | Complex | 0.33 | 1 | 3 |
| | starch | carbohydrate | | | |

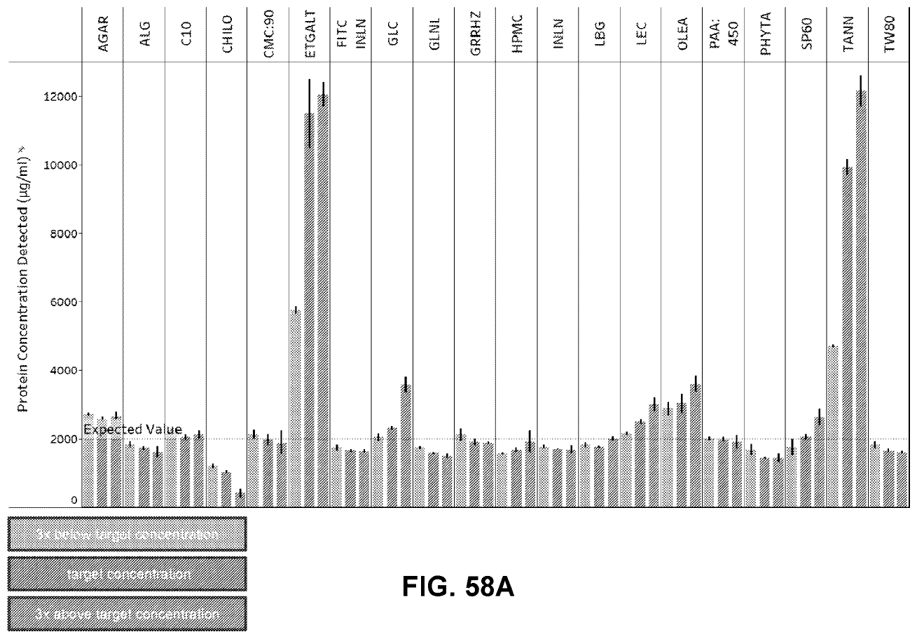

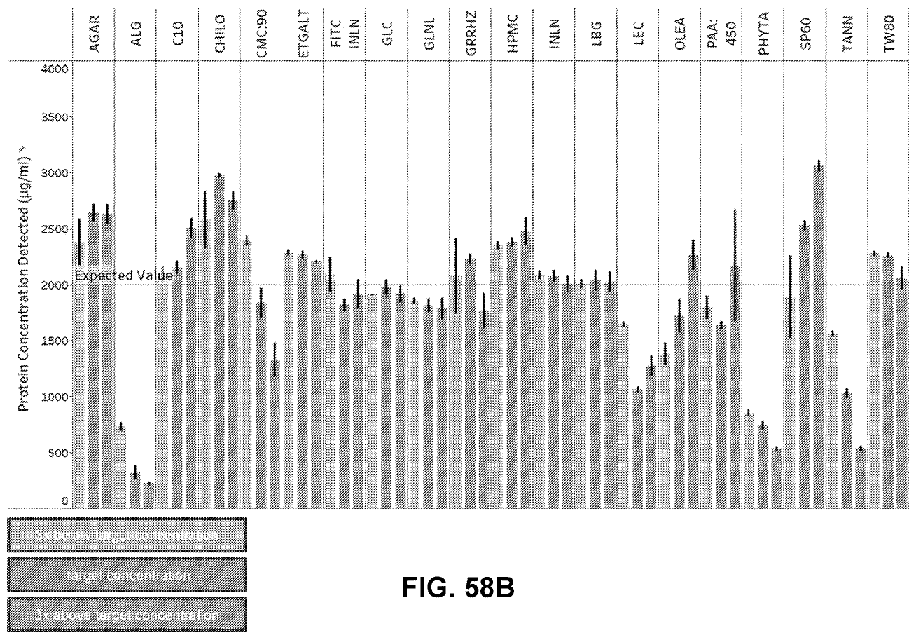

A standard bicinchoninic assay (Thermo Scientific, Waltham, MA) was performed to determine protein concentration according to the manufacturer's instructions. As shown in FIG. 58A, chitosan, ethyl gallate, and tannic acid were found to interfere with the quantification of isolated whey protein.

Alternatively, a Pierce™ 660 assay (Thermo Scientific, Waltham, MA) was performed to determine protein concentration according to the manufacturer's instructions. As shown in FIG. 58B, chitosan, alginate, lecithin, phytic acid, tannic acid, and span 60 were found to interfere with the quantification of isolated whey protein.

To determine excipients that potentially interfere with the measurement of glucose concentration in solution, each exemplary excipient was prepared at three concentrations (target concentration, 3× below target concentration, and 3× above target concentration) according to Table 2, with a fixed concentration of glucose (3.6 μg/ml) and mixed in PBS.

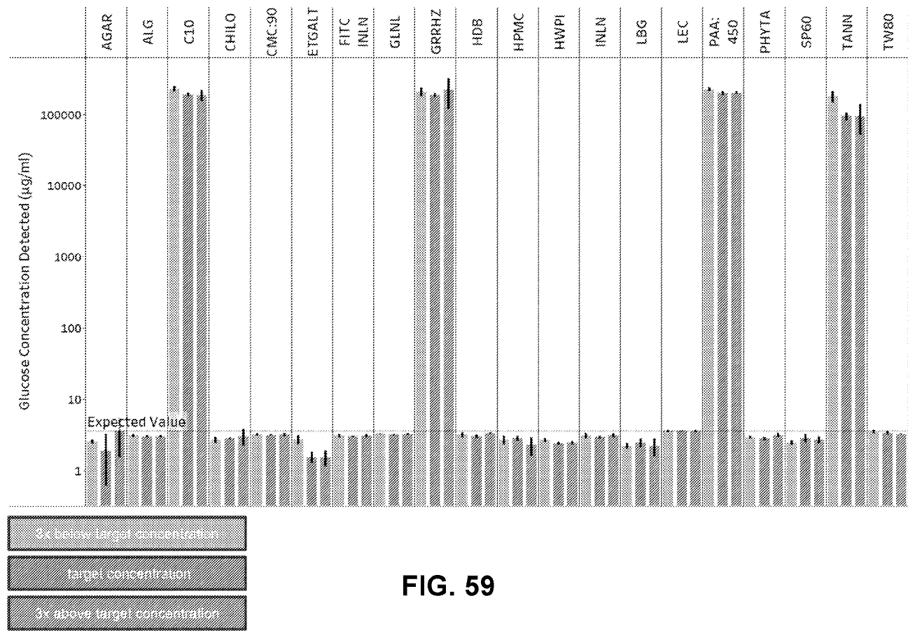

A glucose oxidase amplex red assay (Thermo Scientific, Waltham, MA) was performed according to the manufacturer's instructions. As shown in FIG. 59, sodium decanoate, dipotassium glycyrrhizin hydrate, poly(acrylic) acid MW: 450000, and tannic acid were found to interfere with the quantification of glucose.

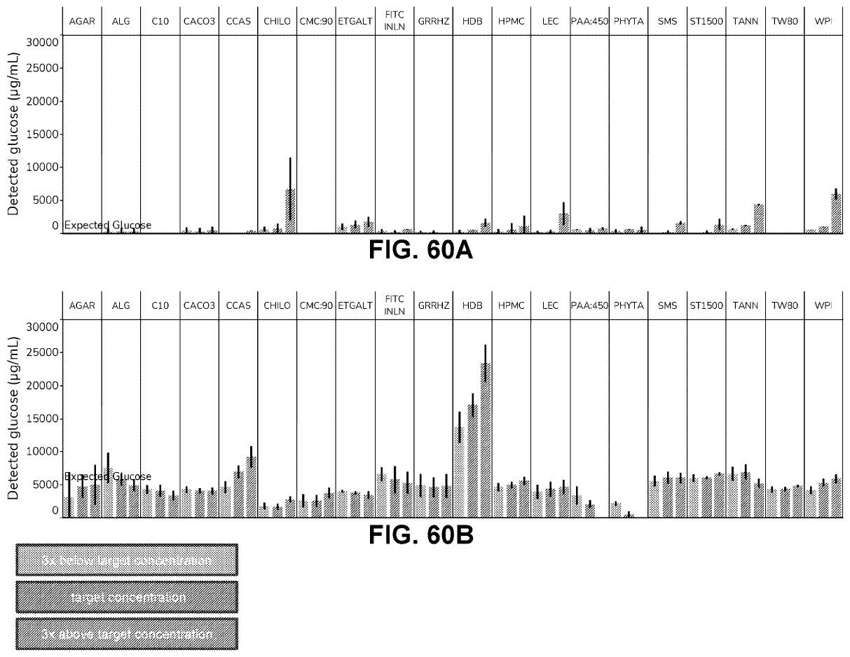

Alternatively, a dinitrosalicylic (DNS) assay was performed. In brief, DNS reagent was prepared in 40 mL Milli-Q water with 400 mg DNS (Sigma-Aldrich, St. Louis, MO), 400 mg NaOH (Thermo Scientific, Waltham, MA), and 20 mg sodium sulfite (Sigma-Aldrich, St. Louis, MO). Rochelle's salt (Sigma-Aldrich, St. Louis, MO) was prepared by dissolving 8 g in 20 mL Milli-Q water. 120 μL of the glucose standard or sample was added to an assay plate with 80 μL of the DNS reagent. The plate was sealed and heated at 80 °C for 10-12 minutes. The plate was allowed to cool briefly before 33 μL of Rochelle's salt was added to each well and the plate was read on a plate reader at an absorbance of 540 nm. As shown in FIG. 60A and FIG. 60B, low molecular weight chitosan, calcium hydroxybutyrate, poly(acrylic acid) 450 kDa, and phytic acid were found to interfere with the quantification of glucose.

To determine excipients that potentially interfere with the measurement of fatty acid concentration in solution, each exemplary excipient was prepared at three concentrations (target concentration, 3× below target concentration, and 3× above target concentration) according to Table 2, with a fixed concentration of linoleic acid (1872 μg/ml), docosahexaenoic acid (2300 μ/ml) or eicosapentaenoic acid (1512 μg/ml) and mixed in PBS.

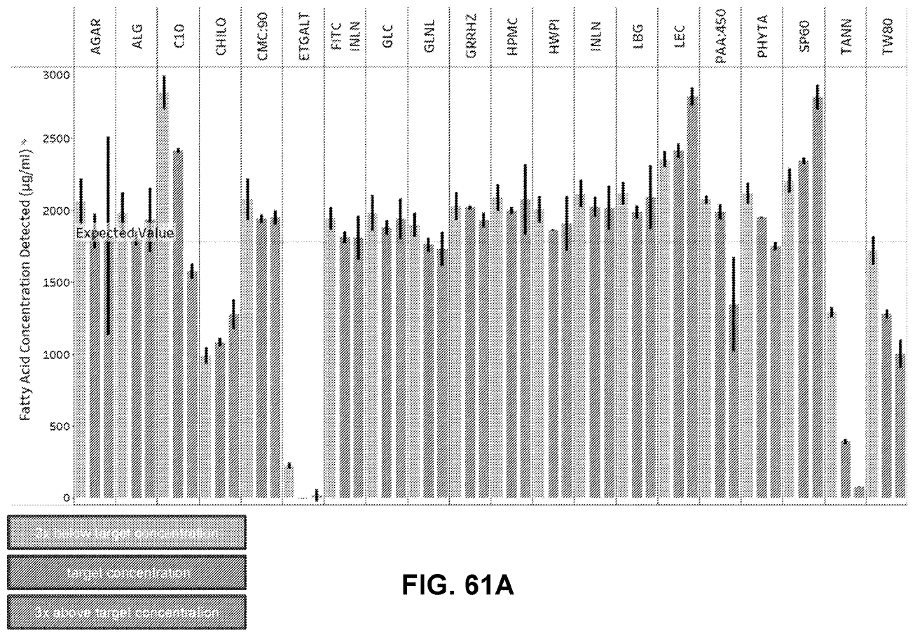

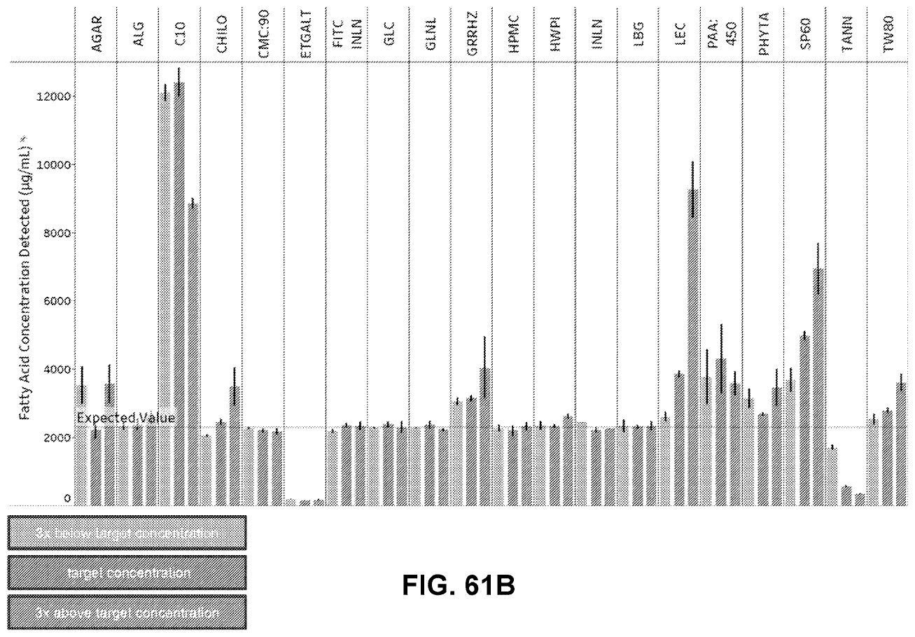

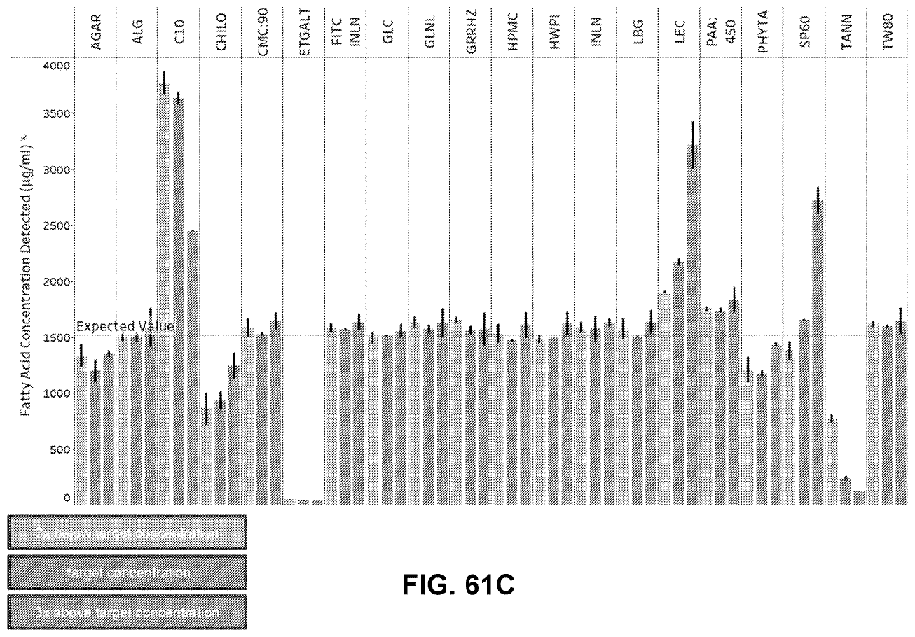

A non-esterified fatty acid Wako (HR-2) assay (Fujifilm, Tokyo, JP) was performed to determine fatty acid concentration according to the manufacturer's instructions but modified by using 10% bovine serum albumin as the assay buffer. As shown in FIG. 61A, Chitosan, ethyl gallate, lecithin, span 60, tannic acid, and tween 80 were found to interfere with the quantification of linoleic acid. As shown in FIG. 61B, ethyl gallate, span 60, and tannic acid were found to interfere with the quantification of docosahexaenoic acid. As shown in FIG. 61C, chitosan, ethyl gallate, lecithin, phytic acid, and tannic acid were found to interfere with the quantification of eicosapentaenoic acid.

To determine excipients that potentially interfere with the measurement of prebiotic (e.g., inulin) in solution, each exemplary excipient was prepared at three concentrations (target concentration, 3× below target concentration, and 3× above target concentration) according to Table 2, with a fixed concentration of FITC inulin (250 μg/ml) and mixed in PBS.

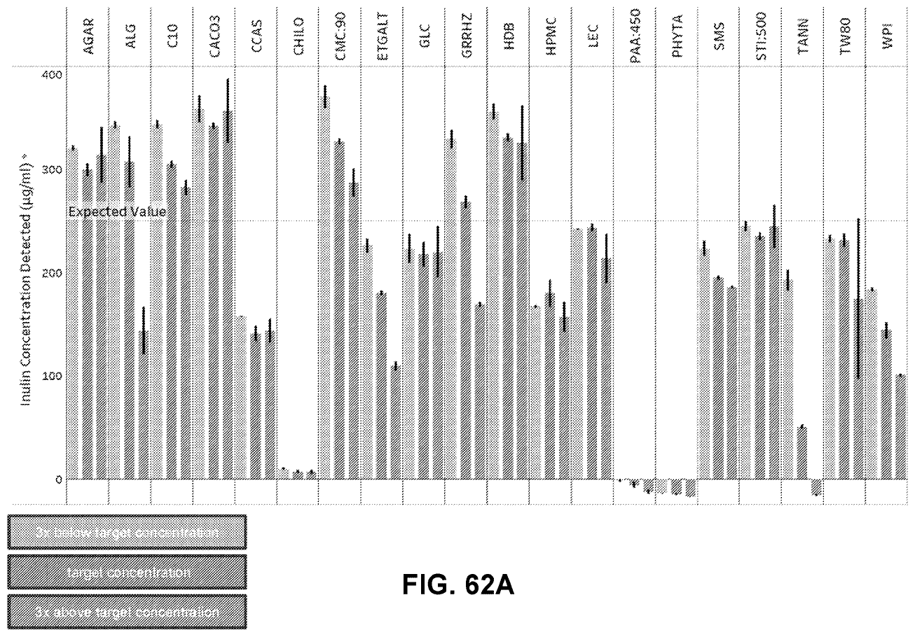

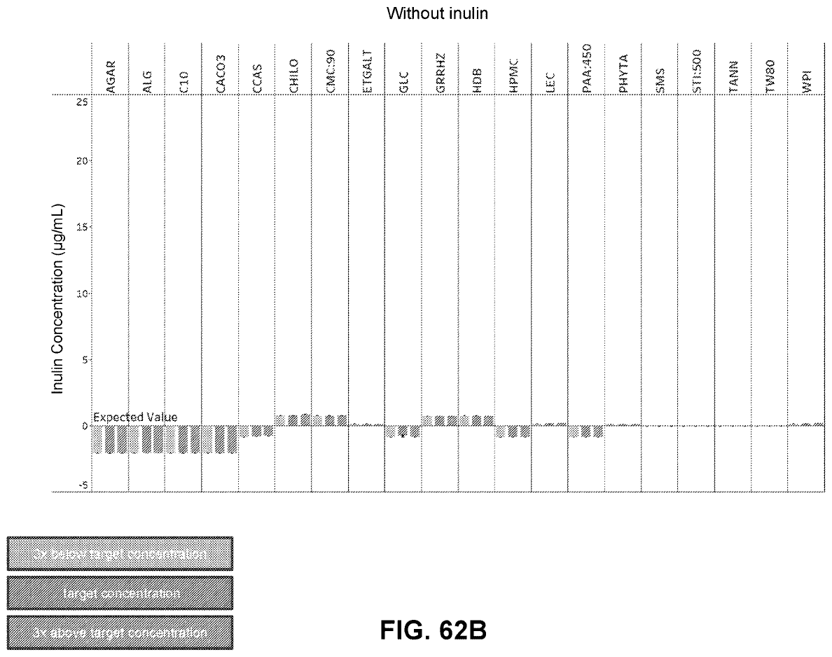

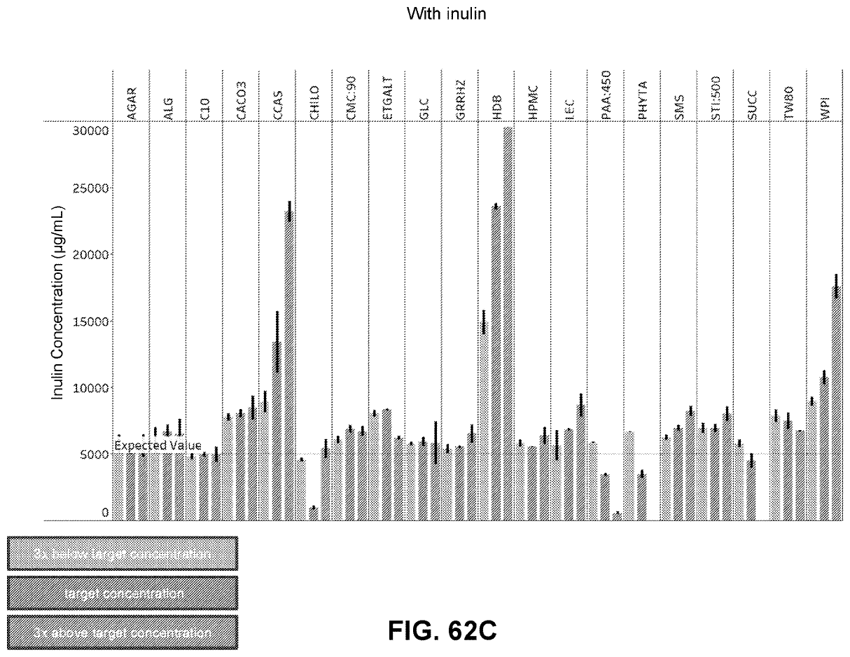

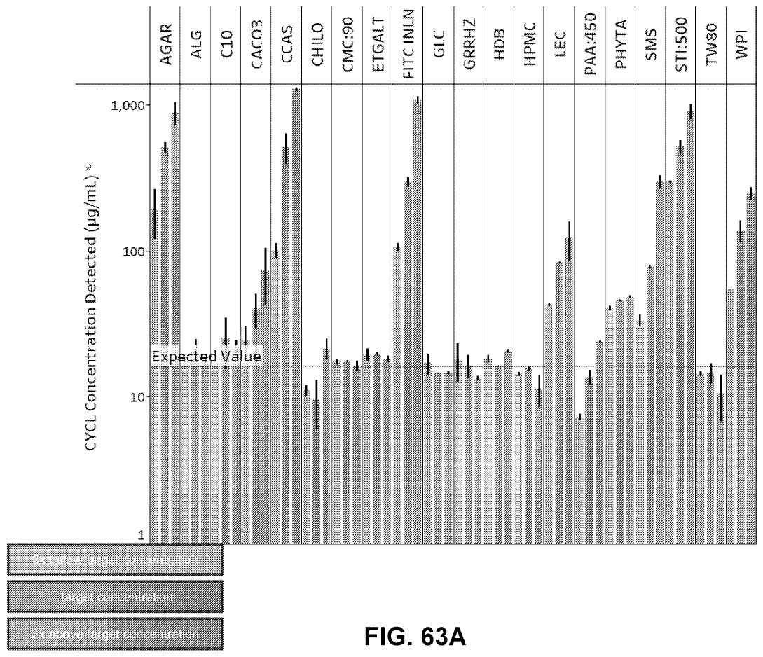

A fluorometric FITC inulin assay was performed to quantify inulin in the presence of excipients. As shown in FIG. 62A, calcium caseinate, chitosan, ethyl gallate at increasing concentrations, hydroxybutyrate, polyacrylic acid, phytic acid, tannic acid, and whey protein isolate were found to interfere with the quantification of inulin.

Alternatively, a dinitrosalicylic (DNS) assay was performed. In brief, DNS reagent was prepared in 40 mL Milli-Q water with 400 mg DNS (Sigma-Aldrich, St. Louis, MO), 400 mg NaOH (Thermo Scientific, Waltham, MA), and 20 mg sodium sulfite (Sigma-Aldrich, St. Louis, MO). Rochelle's salt (Sigma-Aldrich, St. Louis, MO) was prepared by dissolving 8 g in 20 mL Milli-Q water. To perform the assay, inulin was first hydrolyzed to fructose by incubating with inulinase (Aspergillus niger, Sigma, St. Louis, MO). 95 μL of inulin standard or sample was added to an assay plate. 25 μL of the 25 U/mL inulinase was added to each well and allowed to incubate at 37 °C for 30 minutes. 80 μL of the DNS reagent was then added to each well. The plate was sealed and heated at 80 °C for 10-12 minutes. The plate was allowed to cool briefly before 33 μL of Rochelle's salt was added to each well and the plate is read on a plate reader at an absorbance of 540 nm. As shown in FIG. 62A and FIG. 62B, various excipients, including sodium alginate, calcium caseinate, low molecular weight chitosan, ethyl gallate, 450 kDa poly(acrylic acid), phytic acid, tannic acid, and whey protein isolate, were found to interfere with the quantification of inulin, a determination of interfering being established as when the detected inulin concentration differed from the expected value exceeds a threshold value of a factor.

To determine excipients that potentially interfere with the measurement of flavonoids (e.g., cyanidin chloride, quercitin, rutin, tannic acid) in solution, each exemplary excipient was prepared at three concentrations (target concentration, 3× below target concentration, and 3× above target concentration) according to Table 2, with a fixed concentration of cyanidin chloride, quercitin, rutin, or tannic acid (18.5 μg/mL, 18.5 μg/mL, 40 μg/mL, and 1000 μg/mL, respectively) and mixed in PBS.

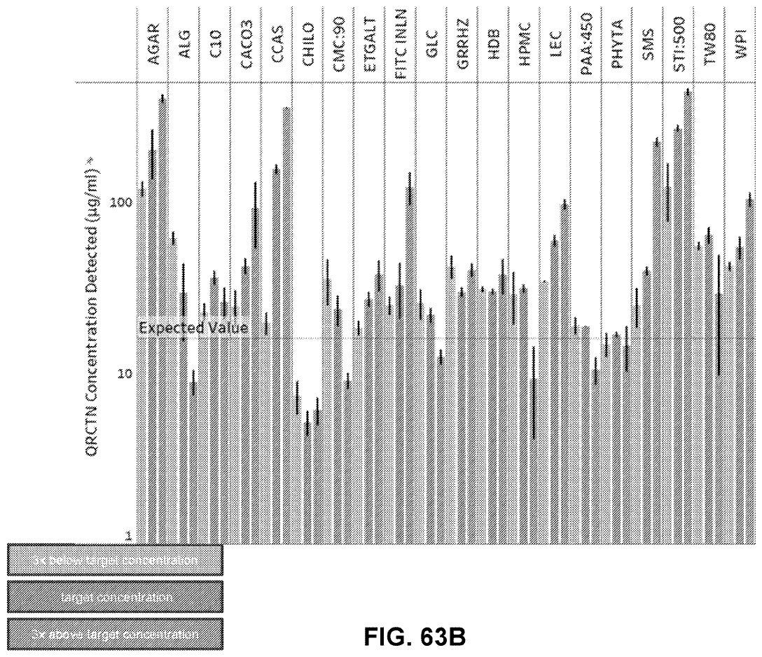

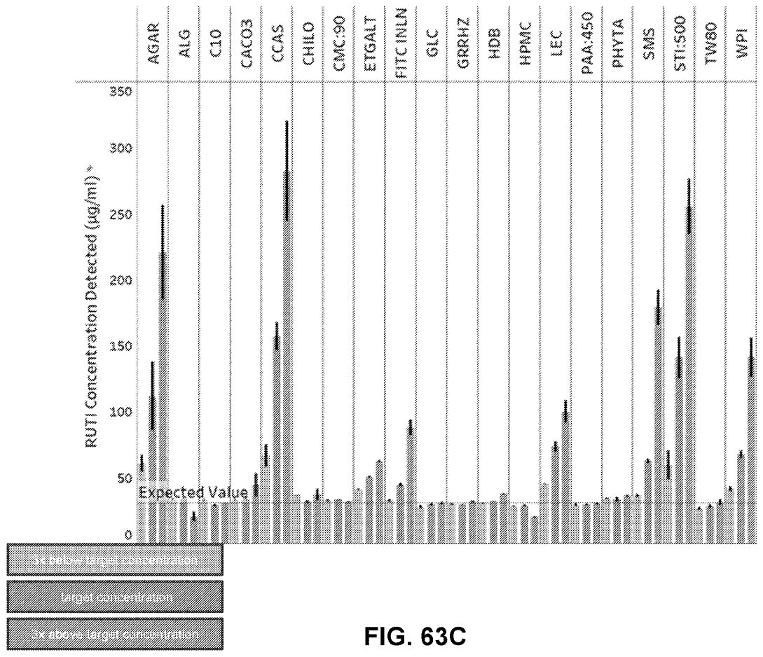

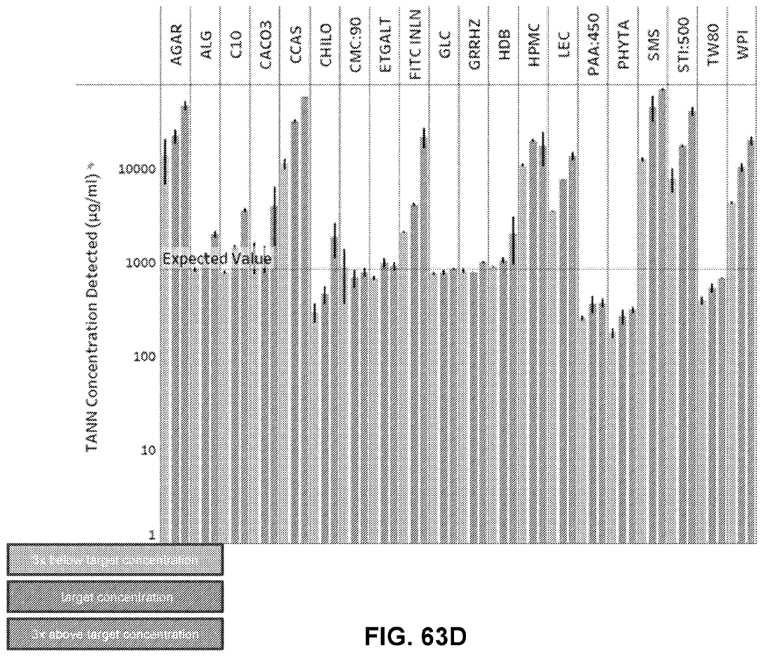

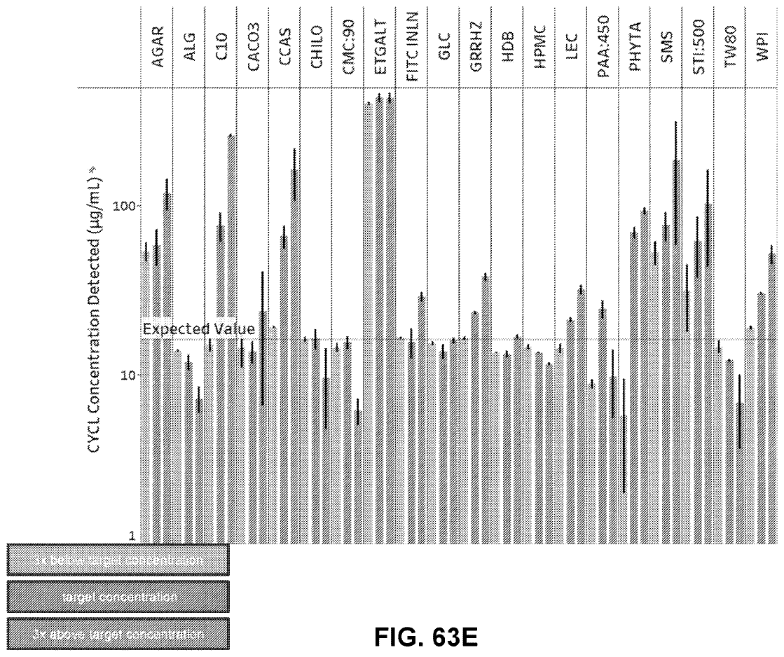

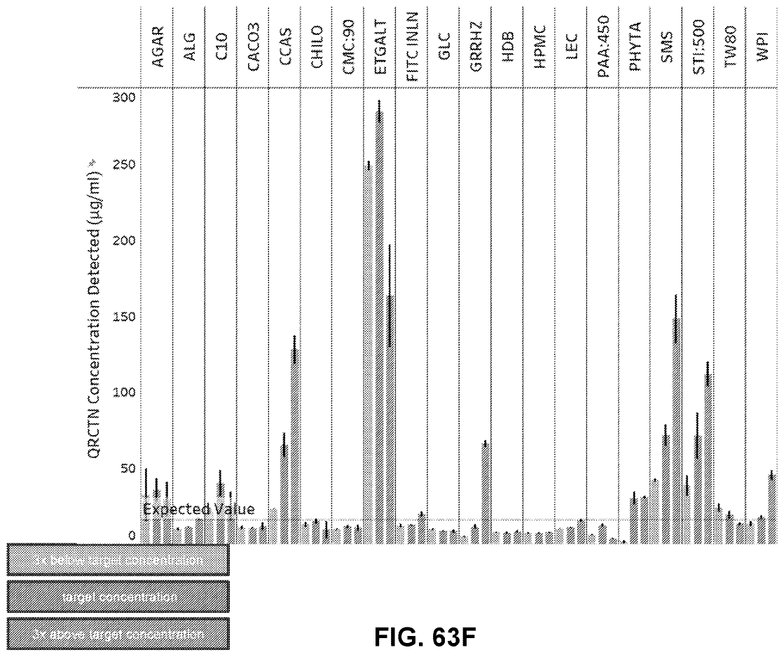

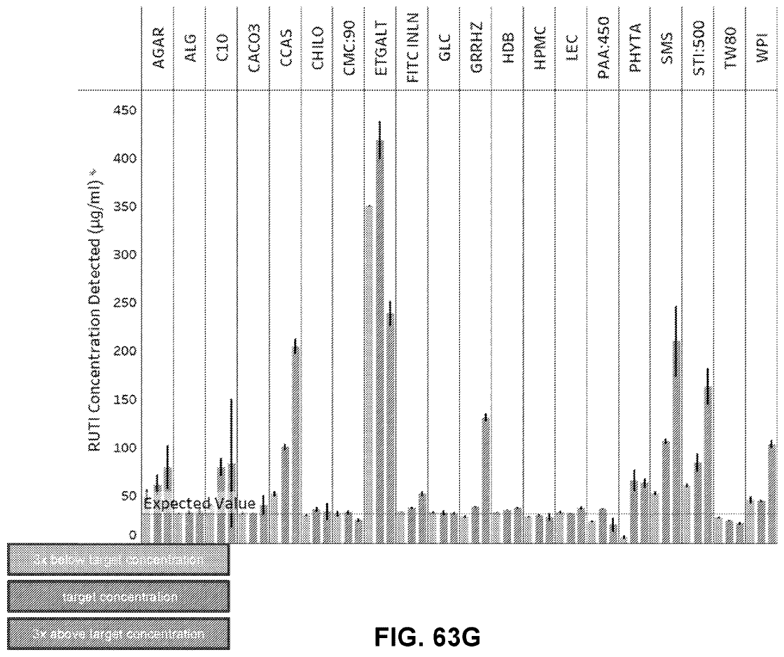

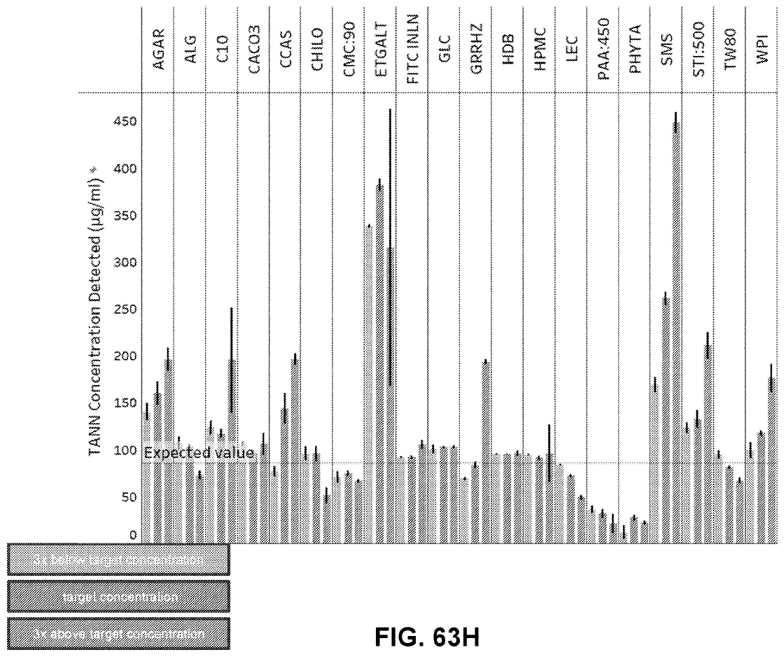

Standard colorimetric assays were performed to quantify cyanidin chloride, quercitin, rutin, and tannic acid concentrations by measuring sample absorbances at 501 nm, 380 nm, 359 nm, and 370 nm, respectively. As shown in FIG. 63A-63D, agarose, calcium caseinate, FITC inulin, lecithin, sucrose monostearate, starch, and whey protein isolate were found to interfere with the quantification of flavanoids.

Alternatively, a ferric antioxidant status detection kit (Thermo Scientific, Waltham, MA) was performed in accordance to the manufacturer's instructions. As shown in FIG. 63E-63H, agarose, sodium decanoate, calcium caseinate, dipotassium glycyrrhizin hydrate at high concentrations, phytic acid, sucrose monostearate, and starch were found to interfere with the quantification of flavanoids.

### KK. Example 29: Exemplary Method for Measuring Food Component Release

This example shows an exemplary automated dissolution method for measuring the release of food components (e.g., from microparticle preparations).

In this example, a Distek apparatus was used for automated dissolution testing in 500 mL of PBS pH 6.8, 37 °C with a USP Type II paddle apparatus, over 720 minutes. A filter protocol was used to prevent particles passing into sample collection values and filter clogging. Three decreasing sizes of mesh filters were placed in the direction of sample flow: (i) a “bubble” of moisture resistant mesh around the probe tip to provide a large surface area for filtering large particles; (ii) a screen filter fit inside of the probe filter cap atop the filter disc having a mesh size around the DV50 size of the particle preparation being tested (e.g., a 160 (~90 micron) or 250 (~62 micron) mesh); and (iii) a UHMW polyethylene 10 micron or 45 micron filter. Protein concentrations in collected samples were measured using a standard BCA assay according to the manufacturer's instructions.

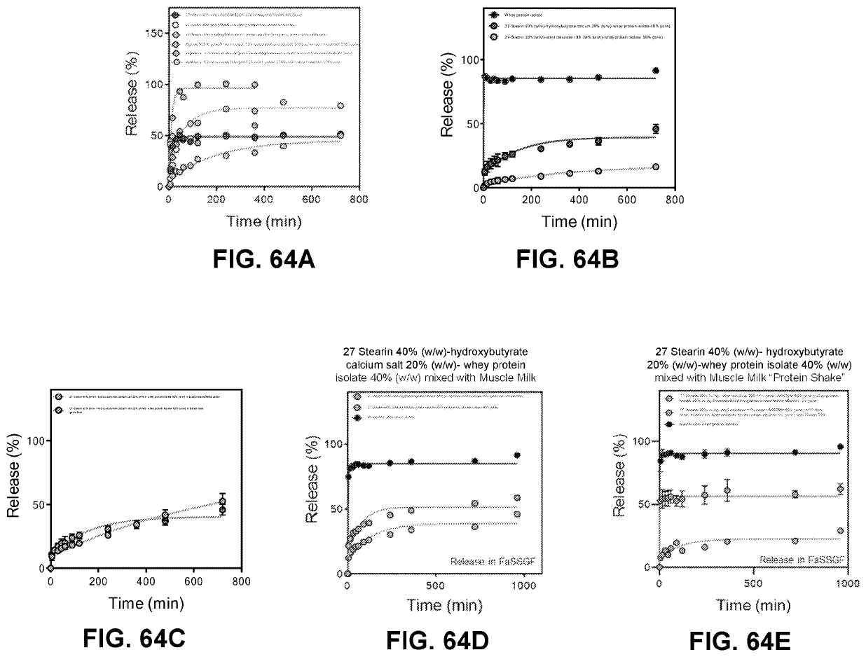

As shown in FIGS. 64A and 64B, dissolution testing using the three-filter protocol described above, allowed release curve measurements to be collected for various microparticle preparations including: (i) 40% (w/w) Stearin 27, 20% (w/w) PANODAN (monoglyceride and diglycerides of hydrogenated palm oil), and 40% (w/w) whey protein isolate; (ii) 40% (w/w) Stearin 27, 20% (w/w) propylene glycol monostearate, and 40% (w/w) whey protein isolate; (iii) 40% (w/w) Stearin 27, 20% (w/w) hydroxybutyrate calcium salt, and 40% (w/w) whey protein isolate; (iv) 32.8% (w/w) agarose, 1.3% (w/w) locust bean gum, 32.8% (w/w) gamma cyclodextrin, and 32.8% (w/w) calcium caseinate; (v) 32.8% (w/w) agarose, 1.3% (w/w) locust bean gum, 32.8% (w/w) gelucire 44/14, and 32.8% (w/w) calcium caseinate; (vi) 32.8% (w/w) agarose, 1.3% (w/w) locust bean gum, 32.8% (w/w) gamma cyclodextrin, and 32.8% (w/w) calcium caseinate; and (vii) 32.8% (w/w) agarose, 1.3% (w/w) locust bean gum, 32.8% (w/w) gamma cyclodextrin, and 30% (w/w) Stearin 27, 20% (w/w) ethyl cellulose, and 50% (w/w) whey protein isolate.

The dissolution method described above can also be used to measuring protein release for microparticle preparations distributed in other biorelevant buffers, e.g., fasted state simulated gastric fluid buffer (FaSSGF, Biorelevant, London, UK).

As shown in FIG. 64C-64E, the method described above was capable of measuring whey protein isolate release from 40% (w/w) Stearin 27, 20% (w/w) hydroxybutyrate calcium salt, and 40% (w/w) whey protein isolate preparations in both PBS and FaSSGF (FIG. 64C). The method described above was also capable of measuring whey protein isolate release from (i) 40% (w/w) Stearin 27, 20% (w/w) hydroxybutyrate calcium salt, and 40% (w/w) whey protein isolate (FIG. 64D) and (ii) 30% (w/w) Stearin 27, 3% (w/w) acetic acid esters of mono and digylcerides (ACETEM), 17% (w/w) ethyl cellulose 100 cP, 49% (w/w) whey protein isolate, and 1% FITC BSA (FIG. 64E) preparations mixed with Muscle Milk™ protein powder in a 50:50 ratio.

### LL. Example 30: Exemplary Matrix Compositions for Regulating Release of Food Components from Microparticle Preparations

This example shows exemplary matrix compositions incorporating one or more excipients for regulating the release of food components from microparticle preparations.

For testing exemplary matrix compositions, common base formulations incorporating 40% (w/w) 27 stearin and 40% (w/w) whey protein isolate were prepared. The remaining 20% (w/w) of the formulation included beeswax, carnauba wax, tristearin, stearic acid, ethyl cellulose, sitosterol, cholesterol, thiamine, or folic acid. Dissolution experiments were performed by distributing 150 mg of each formulation in 12 mL of PBS (pH 7.4) and allowing the formulation to freely rotate in a Benchmark Roto-Therm Mini set to 37 °C at 20 RPM for 24 hours. 150 μL samples were collected at t=0, 5, 15, 30, 60, 90, 120, 240, and 1440 minutes. Protein release for each sample was quantified using a standard BCA assay according to the manufacturer's instructions.

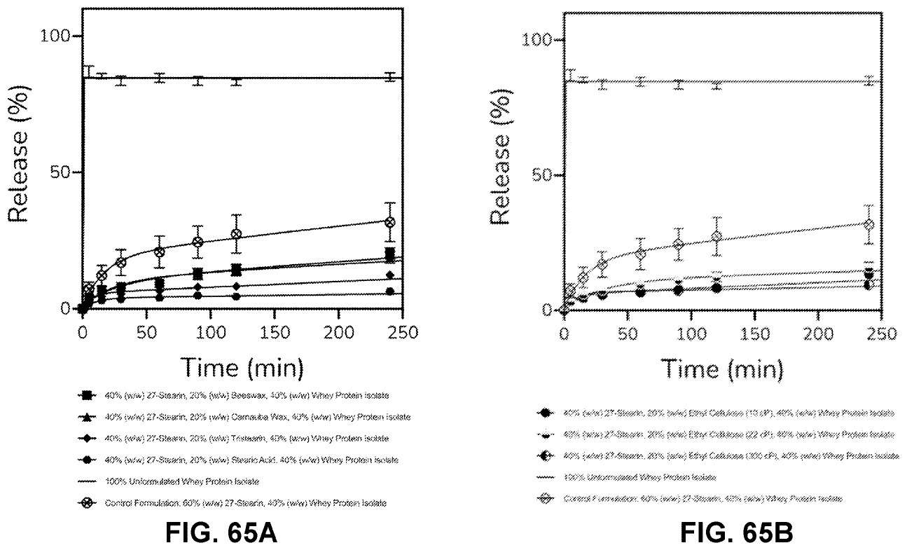

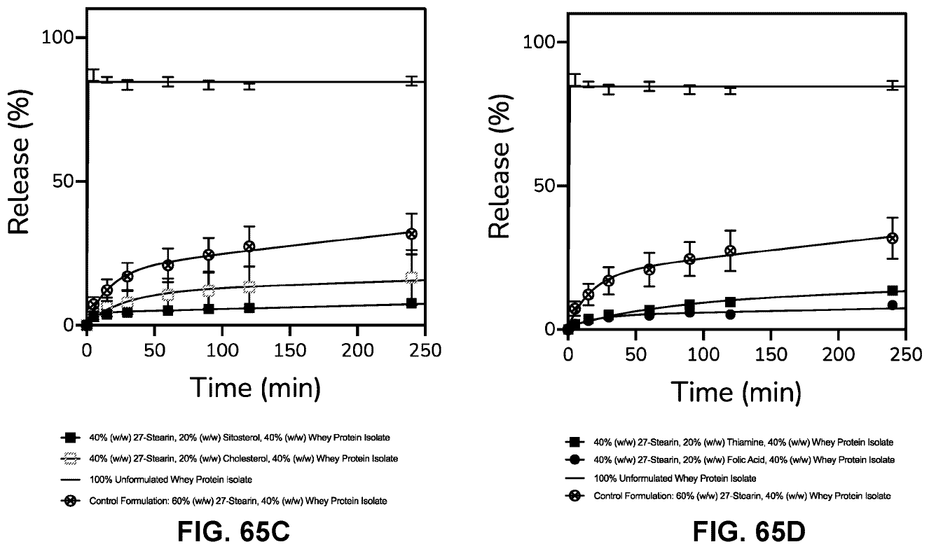

As shown in FIG. 65A-65D, various matrix compositions slowed the release of whey protein isolate into solution.

### MM. Example 31: Particle Sizes of Exemplary Microparticle Preparations Affect Release of Food Components

This example shows that the particle size of a microparticle preparation affects the release of food components into solution.

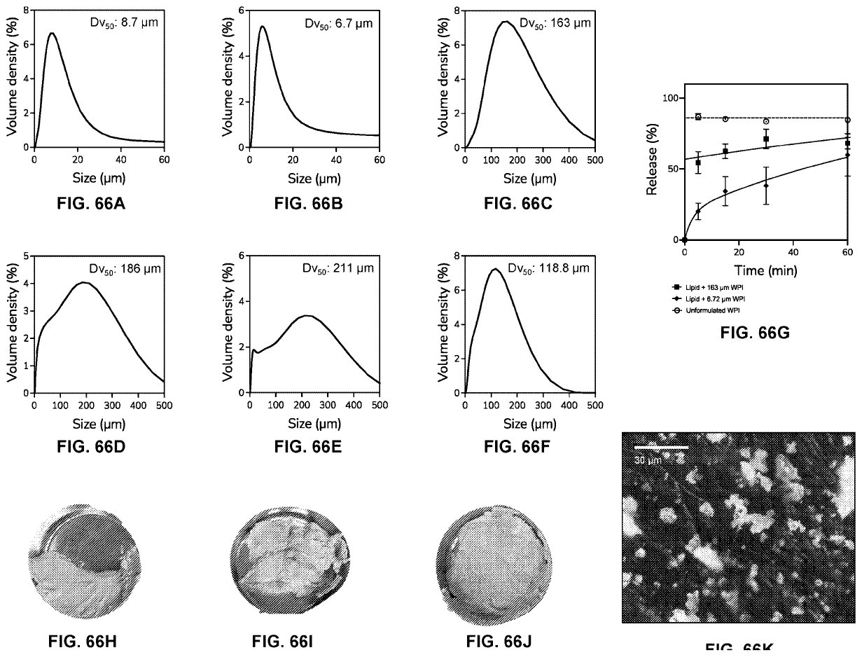

In an exemplary microparticle preparation, approximately 25 g of whey protein isolate was spray dried with 2% (w/w) sucrose monopalmitate (98% (w/w) whey protein isolate, 2% (w/w) sucrose monopalmitate). As shown in FIG. 66A, resulting particles had a Dv50 of 8.7 μm, which is significantly smaller than unformulated whey protein powder (Dv50 of 163 μm; FIG. 66C). In another exemplary preparation, approximately 25 g of whey protein isolate was spray dried with 15% (w/w) aspartic acid and mixed with 2% (w/w) silicon dioxide particles (10-20 nm) (83% (w/w) whey protein isolate, 15% (w/w) aspartic acid, 2% (w/w) silicon dioxide 10 nm particles). As shown in FIG. 66B, resulting particles had a Dv50 of 6.7 μm. Both exemplary preparations were significantly smaller than unformulated whey protein powder (Dv50 of 163 μm; FIG. 66C).

The exemplary microparticle preparations shown in FIG. 66A and FIG. 66B, and the unformulated whey protein powder shown in FIG. 66C, were further added (40% w/w) to a lipid formulation mixture including 38% (w/w) carnauba wax, 10% (w/w) ethyl cellulose 100 cP, 10% (w/w) stearic acid, and 2% (w/w) bulk phytosterols (practical grade, 60% sitosterol) and heated to 215 °C and stirred at 150 RPM for 5-10 minutes to ensure homogenous distribution. Preparations were then poured into a 75 mm aluminum pan and allowed to rest for 30 minutes or until the formulation reached room temperature. Once cooled, each bulk preparation was broken into approximately 1 in³ chunks and run through an IKA MF-Basic Hammer Mill at 5500 RPM using a 500 μm sieve. As shown in FIG. 66D, FIG. 66E, and FIG. 66F, lipid formulated microparticle preparations had Dv50s of 186 μm, 211 μm, and 118.8 μm, for the starting preparations shown in FIG. 66A, FIG. 66B, and FIG. 66C, respectively. Exemplary preparations had irregular particle shape as shown in FIG. 66K.

Lipid formulated preparations were also visually inspected. As shown in FIG. 66H, lipid formulation preparation incorporating monopalmitate (38% (w/w) carnauba wax, 10% (w/w) ethyl cellulose 100 cP, 10% (w/w) stearic acid, 2% (w/w) bulk phytosterols (practical grade, 60% sitosterol), 39.2% (w/w) whey protein isolate, and 0.8% (w/w) sucrose monopalmitate) produced a visually smoother, more homogenous, preparation as compared to preparation incorporating silicon dioxide (38% (w/w) carnauba wax, 10% (w/w) ethyl cellulose100 cP, 10% (w/w) stearic acid, 2% (w/w) bulk phytosterols (practical grade, 60% sitosterol), 33.2% (w/w) whey protein isolate, 6% (w/w) aspartic acid, and 0.8% silicon dioxide 10 nm particles; FIG. 66I) and unformulated whey protein isolate (38% (w/w) carnauba wax, 10% (w/w) ethyl cellulose 100 cP, 10% (w/w) stearic acid, 2% (w/w) bulk phytosterols (practical grade, 60% sitosterol), and 40% (w/w) whey protein isolate; FIG. 66J)

Lipid formulated preparations were subject to a dissolution experiment using the method previously described in Example 58. As shown in FIG. 66G, microparticle preparations having smaller protein particle sizes delayed whey protein release over a longer duration compared to larger whey protein isolate particle size.

### NN. Example 32: Solidification of Liquid Food Components

This example shows that low mass fractions of an excipient can solidify (i.e., gelate) liquid food components (e.g., fatty acids).

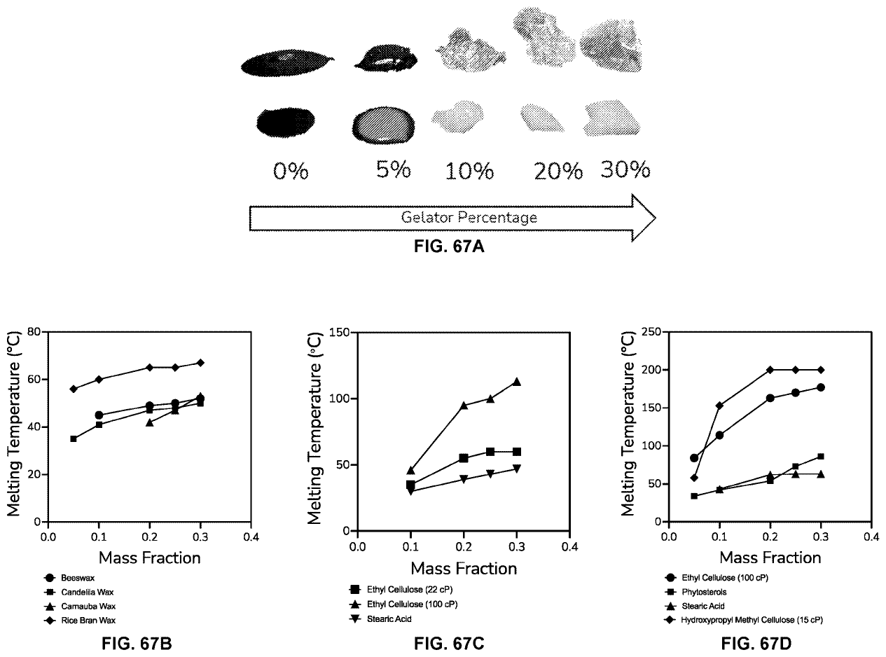

As shown in FIG. 67A (top row), 10 mL of oleic acid was heated to 135 °C-215 °C and stirred at 150 RPM to ensure complete melting/dispersion. 5% (w/w) ethyl cellulose was added to the melted oleic acid and taken off heat for a 15 minute rest period to assess gelation activity. Successful gelation was characterized as a material's ability to resist its own flow (e.g., material does not flow in a container when tilted). Melting/homogenization and 15 minute rest periods were repeated after addition of 5%, 10%, and 20% (w/w) of ethyl cellulose. Visual assessments of gelation were made during each rest period. An analogous experiment was performed substituting ethyl cellulose with carnauba wax (FIG. 67A, bottom row). These data indicate that liquid food components (e.g., fatty acids) can be solidified with as little as 5% (w/w) of an excipient.

As shown in FIG. 67B and FIG. 67C, an increase in mass fraction of an excipient can result in an increase in melting temperature. During rest periods of experiments analogous to those described in FIG. 67A, the temperature (as measured using an infrared thermometer) at which a homogenized mixture solidified was recorded. For all excipients tested (e.g., beeswax, candelilla wax, carnauba wax, rice bran wax, ethyl cellulose (22 cP), ethyl cellulose (100 cP), and stearic acid), an increased mass fraction resulted in an increase in melting temperature.

In another embodiment, 10 mL of R-3-hydroxybutyl-3-hydroxybutyrate was heated to 135 °C-215 °C and stirred at 150 RPM to ensure complete melting/dispersion. 5% (w/w) ethyl cellulose was added to the melted oleic acid and taken off heat for a 15 minute rest period to assess gelation activity. Successful gelation was characterized as a material's ability to resist its own flow (e.g., material does not flow in a container when tilted). Melting/homogenization and 15 minute rest periods were repeated after addition of 5%, 10%, and 20% (w/w) of ethyl cellulose. Analogous experiments were performed substituting ethyl cellulose with phytosterols, stearic acid, or hydroxypropyl methyl cellulose (15 cP). For all excipients tested, an increased mass fraction resulted in an increase in melting temperature (FIG. 67D).

### OO. Example 33: Exemplary Microparticle Preparation Excipients Allow Tunable Release Rates of Food Components

This example shows that a wide range of food component release rates are achievable depending on which excipient is selected for incorporating into a microparticle preparation.

Microparticle preparations incorporating 40% (w/w) dritex, 40% (w/w) whey protein isolate, and 20% (w/w) of cholesterol, ethyl cellulose, folic acid, polyoxyethylene (40) stearate, pluronic f-127, sitosterol, tween 40, or tween 80, were formulated by mixing 8 g of dritex, 4 g of the selected excipient, and 8 g of whey protein isolate. Mixtures were heated to 135 °C to 215 °C and stirred at 150-300 RPM for 5-10 minutes to ensure homogeneity. Preparations were then poured into a 75 mm aluminum pan and allowed to rest for 30 minutes or until the preparation reached room temperature. 150 mg samples of each preparation were assessed for protein release using a method as previously described in Example 57. As shown in FIG. 68A a wide range of protein release rates were achievable depending on the excipient used in a preparation.

In another embodiment, microparticle preparations incorporating 40% (w/w) dritex, 40% (w/w) alpha linoleic acid, and 20% (w/w) of beeswax, cholesterol, ethyl cellulose, folic acid, kolliphor k-188, propylene glycol monostearate, sitosterol, or stearic acid, were formulated by mixing 8 g of dritex, 4 g of the selected excipient, and 8 g of linoleic acid. Mixtures were heated to 135 °C to 215 °C and stirred at 150-300 RPM for 5-10 minutes to ensure homogeneity. Preparations were then poured into a 75 mm aluminum pan and allowed to rest for 30 minutes or until the preparation reached room temperature. 150 mg samples of each preparation were assessed for fatty acid release using a non-esterified fatty acid Wako (HR-2) assay (Fujifilm, Tokyo, JP) as previously described in Example 56. As shown in FIG. 68B a wide range of fatty acid release rates were achievable depending on the excipient used in a preparation.

In another embodiment, microparticle preparations incorporating 40% (w/w) dritex, 40% (w/w) quercetin, and 20% (w/w) of kolliphor k-188, folic acid, propylene glycol monostearate, cholesterol, lecithin, beeswax, or stearic acid, were formulated by mixing 4 g of dritex, 2 g of the selected excipient, and 4 g of quercetin. Mixtures were heated to 135 °C to 215 °C and stirred at 150-300 RPM for 5-10 minutes to ensure homogeneity. Preparations were then poured into a 75 mm aluminum pan and allowed to rest for 30 minutes or until the preparation reached room temperature. 150 mg samples of each preparation were assessed for flavonoid release using a ferric antioxidant status detection kit (Thermo Scientific, Waltham, MA) as previously described in Example 56. As shown in FIG. 68C a wide range of flavonoid release rates were achievable depending on the excipient used in a preparation.

### PP. Example 34: Excipients in Agarose Hydrogel Matrices Affect Rates of Food Component Release from an Exemplary Microparticle Preparation

This example shows that the presence of one or more excipients in agarose hydrogel matrices can affect the release of a food component from an exemplary microparticle preparation.

In an embodiment, agarose hydrogels were prepared by mixing 20-30 mg/mL of agarose with 20 mL of PBS (pH 7.4) and 100 mg/mL whey protein isolate. Excipients selected from chitosan (Sigma Aldrich Chemical, St. Louis, MO), Eudragit E PO (Vikram Thermo, Gujarat, India), or hydroxyapatite (diameter 5 μm obtained from Sigma Aldrich Chemical, St. Louis, MO), were added to the agarose/whey protein solution at specified concentrations (3-10 mg/mL in final solution). Mixtures were heated at 120 °C for 1 minute duration via and subsequently cooled to room temperature. Dissolution analysis assay of preparations was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

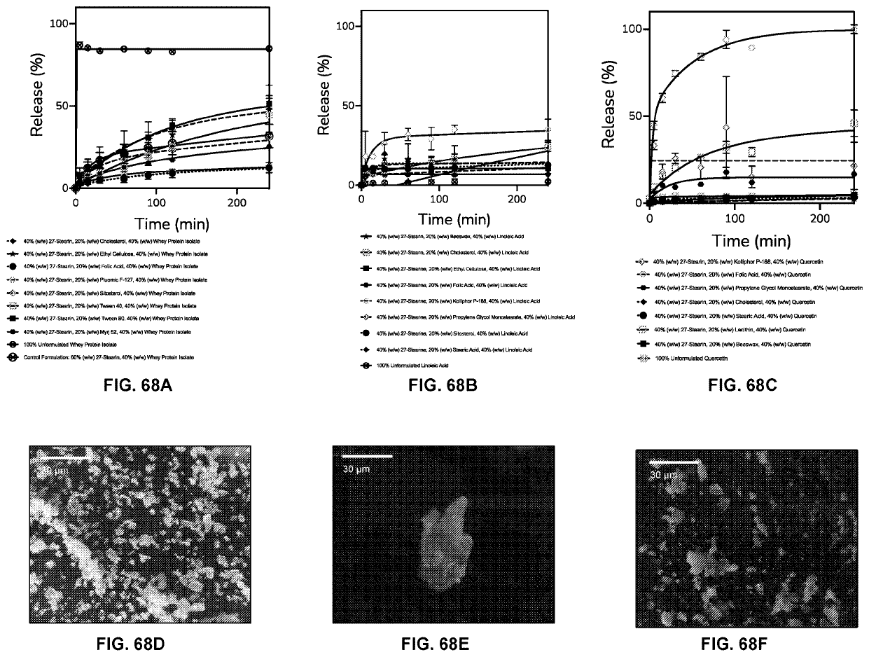

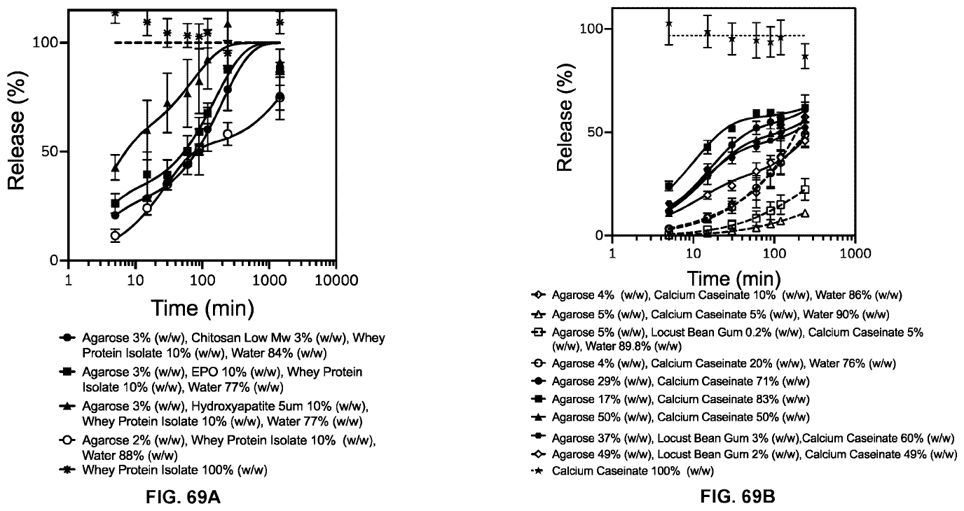

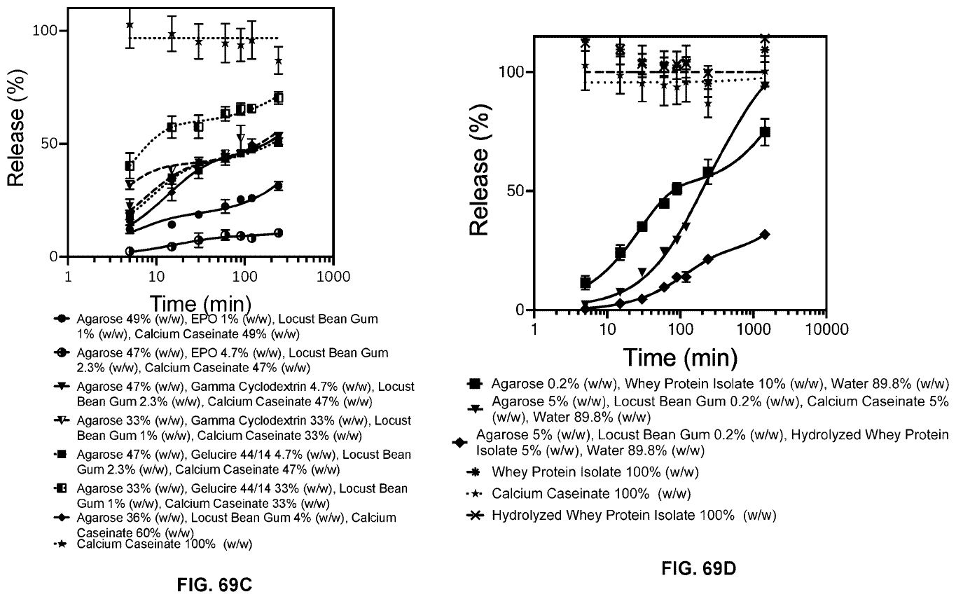

As shown in FIG. 69A, agarose hydrogel preparations are capable of releasing up to 100% of whey protein isolate after 1440 minutes in excipient-containing microparticle preparations. In the absence of excipient, nearly 70% of whey protein isolate is released after 1440 minutes.

In another embodiment, agarose hydrogels were prepared by mixing 10-100 mg/mL of agarose with 20 mL of PBS (pH 7.4) and 50-200 mg/mL calcium caseinate. Locust bean gum excipient (Spectrum Chemical, New Brunswick, NJ) was added to the agarose/caseinate to achieve a 2 mg/mL final solution. The mixture was heated at 120 °C for 1 minute and subsequently cooled to room temperature to form solid hydrogel preparations. A portion of the preparation was incubated in a drying oven at 60 °C overnight before milling via hammer mill (MF-10 Basic, IKA, Wilmington, NC) at 5500 rpm. Dissolution analysis assay of the preparation was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

As shown in FIG. 69B, the rate of release for dried/milled preparations was generally observed to be greater than that of equivalent formulations in hydrogel form. The slowest releasing particle preparation was 49% (w/w) agarose, 2% (w/w) locust bean gum, and 49% (w/w) calcium caseinate.

In another embodiment, agarose hydrogels were prepared by mixing 50 mg/mL of agarose with 20 mL of PBS (pH 7.4) and 50 mg/mL calcium caseinate. An excipient selected from locust bean gum (Spectrum Chemical, New Brunswick, NJ), Gelucire 44/14 (Gattefosse, Paramus, NJ), Eudragit E PO (Vikram Thermo, Gujarat, India), or gamma cyclodextrin (Spectrum Chemical, New Brunswick, NJ) was added to the agarose/calcium caseinate solution to achieve a specified final concentration (1-100 mg/mL). The mixture was heated at 120 °C for 1 minute and subsequently cooled to room temperature to form solid hydrogel preparations. A portion of the preparation was incubated in a drying oven at 60 °C overnight before milling via hammer mill (MF-10 Basic, IKA, Wilmington, NC) at 5500 rpm. Dissolution analysis assay of the preparation was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

As shown in FIG. 69C, the rate of casein release is tunable depending on which excipient is selected.

In another embodiment, agarose hydrogels were prepared by mixing 50 mg/mL of agarose with 20 mL of PBS (pH 7.4) and 50 mg/mL calcium caseinate, 50 mg/ml hydrolyzed whey protein isolate, or 100 mg/ml whey protein isolate. Locust bean gum (Spectrum Chemical, New Brunswick, NJ) was added to the agarose/calcium caseinate or agarose/whey protein solutions to achieve a final concentration of 2 mg/mL. The mixtures were heated at 120 °C for 1 minute and subsequently cooled to room temperature to form solid hydrogel preparations. A portion of the preparation was incubated in a drying oven at 60 °C overnight before milling via hammer mill (MF-10 Basic, IKA, Wilmington, NC) at 5500 rpm. Dissolution analysis assay of the preparation was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

As shown in FIG. 69D, agarose matrices incorporating hydrolyzed whey protein isolate had substantially lower rates of release and total release of food component payload over 24 hours as compared to calcium caseinate preparations or non-hydrolyzed whey protein preparations.

In another embodiment, agarose hydrogels were prepared by mixing 50 mg/mL of agarose with 20 mL of PBS (pH 7.4) and 50 mg/ml hydrolyzed whey protein isolate. Locust bean gum (Spectrum Chemical, New Brunswick, NJ) was added to the agarose/calcium caseinate or agarose/whey protein solutions to achieve a final concentration of 2 mg/mL. An excipient selected from chitosan (Sigma Aldrich, St. Louis, MO) or Eudragit E PO (Vikram Thermo, Gujurat, India) were mixed in the agarose/hydrolyzed whey protein isolate/locust bean gum solution to achieve a 25 mg/ml final solution. The mixtures were heated at 120 °C for 1 minute and subsequently cooled to room temperature to form solid hydrogel preparations. A portion of the preparation was incubated in a drying oven at 60 °C overnight before milling via hammer mill (MF-10 Basic, IKA, Wilmington, NC) at 5500 rpm. Dissolution analysis assay of the preparation was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

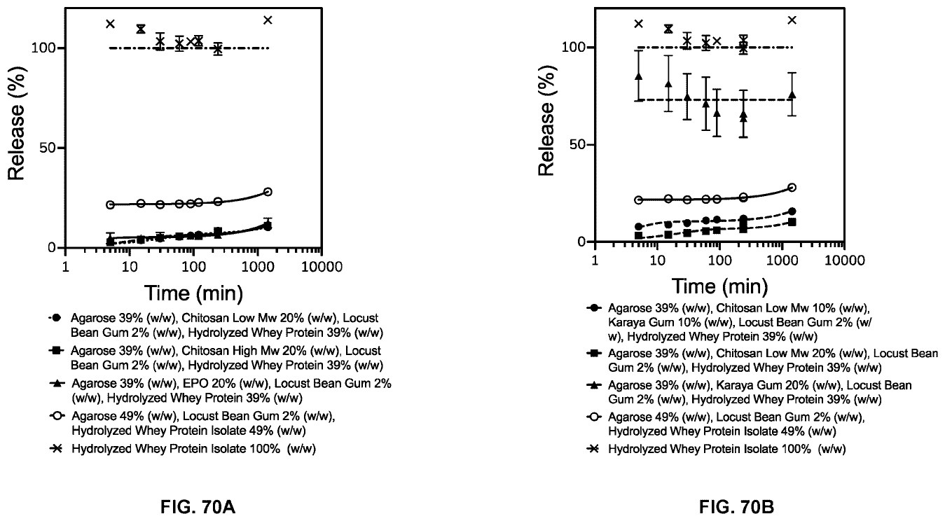

As shown in FIG. 70A, the rate of release of protein from agarose matrices was significantly reduced when Eudragit E PO or chitosan were incorporated into the preparations.

In another embodiment, agarose hydrogels were prepared by mixing 50 mg/mL of agarose with 20 mL of PBS (pH 7.4) and 50 mg/ml hydrolyzed whey protein isolate. Locust bean gum (Spectrum Chemical, New Brunswick, NJ) was added to the agarose/calcium caseinate or agarose/whey protein solutions to achieve a final concentration of 2 mg/mL. An excipient selected from chitosan (Sigma Aldrich, St. Louis, MO) and/or karaya gum (Sigma Aldrich, St. Louis, MO) were mixed in the agarose/hydrolyzed whey protein isolate/locust bean gum solution to achieve a 25 mg/ml final solution. The mixtures were heated at 120 °C for 1 minute and subsequently cooled to room temperature to form solid hydrogel preparations. A portion of the preparation was incubated in a drying oven at 60 °C overnight before milling via hammer mill (MF-10 Basic, IKA, Wilmington, NC) at 5500 rpm. Dissolution analysis assay of the preparation was performed using a benchtop Roto-Therm incubator (Benchmark Scientific, Sayreville, NJ) at 37 °C. Dissolution was performed using 200 mg replicates in triplicate using 15 mL Falcon tubes containing 12 mL of PBS (pH 7.4). Aliquots of 200 μL were sampled at times 0, 5, 15, 30, 60, 90, 120, 240, and 1440 minutes and transferred to a polypropylene 96-well microplate. Protein present in samples was quantified using a Pierce™ BCA assay (Thermo Scientific, Waltham, MA) according to the manufacturer's instructions.

As shown in FIG. 70B, the rate of release of protein from preparations incorporating chitosan and karaya gum as an excipient was between the rates of release of protein from preparations incorporating chitosan or karaya gum alone as an excipient.

### QQ. Example 35: High Food Component Loaded Exemplary Microparticle Preparations

This example shows that high food component loading (e.g., greater than 30% w/w) of exemplary microparticle preparations is achievable.

In this example, four microparticle preparations were prepared via wet granulation, extrusion, and spheronization and incorporate: (i) 55% (w/w) micellar casein, 29% (w/w) StarTab, 15% (w/w) d-lactose, and 1% (w/w) d-glucose; (ii) 35% (w/w) VitaSmooth, 15% (w/w) d-lactose and 50% (w/w) d-glucose; (iii) 12.5% (w/w) microcrystalline cellulose, 12.5% (w/w) d-lactose and 75% (w/w) micellar casein; or (iv) 5% (w/w) StarTab, 3% (w/w) lactose, 1% (w/w) magnesium stearate, 1% (w/w) microbial transglutaminase, and 90% (w/w) micellar casein.

As shown in FIG. 71A-71D, granulated preparations incorporating microcrystalline cellulose or StarTab generally resulted in well-formed particles (FIG. 71A and FIG. 71C). In contrast, preparations incorporating calcium carbonate (FIG. 71B) resulted in poorly formed spheres, particularly at high concentrations of food component payload loading (e.g., greater than 30% w/w). As shown in FIG. 71D, preparations incorporating 5% (w/w) StarTab, 3% (w/w) lactose, and 1% (w/w) magnesium stearate achieved high food component payload loading (e.g., greater than 90% w/w).

As shown in FIG. 71E, a preparation incorporating 90% (w/w) micellar casein, 5% (w/w) StarTab compressible starch, 3% (w/w) lactose, 1% (w/w) magnesium stearate, and 1% (w/w) microbial transglutaminase, had a significantly reduced release rate as compared to a preparation incorporating 90% (w/w) micellar casein, 9% (w/w) microcrystalline cellulose, and 1% (w/w) microbial transglutaminase.

### RR. Example 36: Incorporation of Exemplary Microparticle Preparations into Food Compositions

This example shows that the component excipient and matrices of exemplary microparticle preparations can affect incorporation into food compositions (e.g., food products).

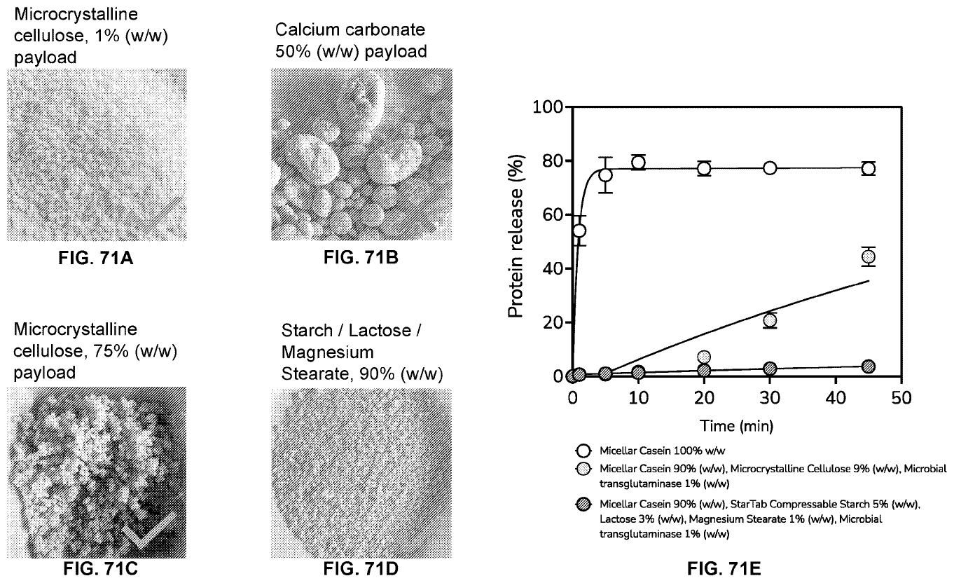

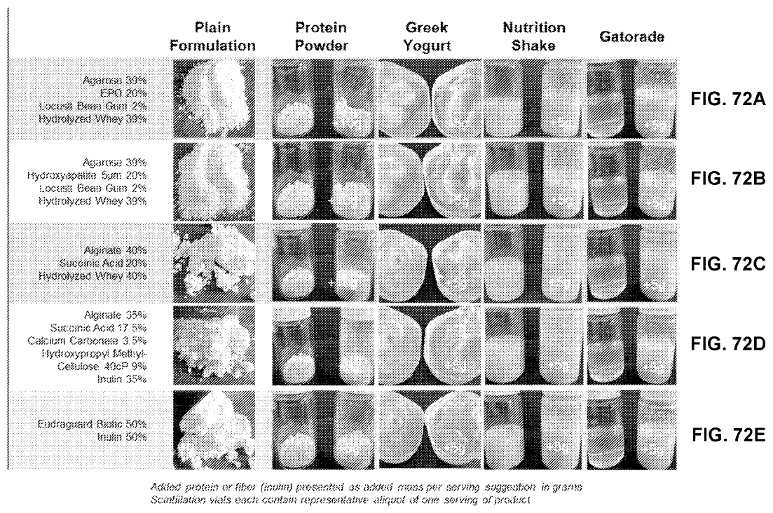

As shown in FIG. 72A, an exemplary milled protein particle preparation (first panel) containing 39% (w/w) agarose (VWR, Rador, PA), 20% (w/w) Eudragit E PO (Vikram Thermo, India), 2% (w/w) locust bean gum (Spectrum Chemical, New Brunswick, NJ), 39% (w/w) hydrolyzed whey protein isolate (AMCO Proteins, Burlington, NJ) was incorporated into vanilla protein powder (Muscle Milk™, PepsiCo, Purchase, NY; second panel), strawberry Greek yogurt (Chobani™, Norwich, NY; third panel), nutrition shake (Nutren™, Nestle, Bridgewater, NJ; fourth panel), or lemon-lime sports drink (Gatorade™, PepsiCo, Purchase, NY; fifth panel). Images show the food compositions (e.g., food products) in the absence (left) or absence (right) of microparticle preparation. Added protein to each food composition (e.g., food product) was an additional 10 grams, 5 grams, 5 grams, or 5 grams of protein per serving of protein powder, yogurt, nutrition shake or sports drink, respectively. Samples of 1 gram of vanilla protein powder, 10 grams of Greek yogurt, 10 mL of nutrition shake, or 10 mL of sports drink were transferred to a 20 mL scintillation vial or polypropylene weigh boat and mixed with adequate mass of formulated agarose protein particles to increase the protein content of a sample to 10 grams of protein per serving of vanilla protein powder, 5 grams per serving of Greek yogurt, 5 grams per serving of nutrition shake, or 5 grams per serving of sports drink. Scintillation vials were homogenized via vortexing on high for 60 seconds prior to imaging. As shown in FIG. 72A, addition of exemplary particle preparation to dry protein powder, Greek yogurt and nutrition shake resulted in minimal visual alterations. The exemplary particle preparation did not incorporate well into the sports drink food product as particles were observed to settle at the bottom of the beverage.

As shown in FIG. 72B, an exemplary milled particle preparation containing 39% (w/w) agarose (VWR, Rador, PA), 20% (w/w) hydroxyapatite 5 μm (Sigma Aldrich, St. Louis, MO), 2% (w/w) Locust bean gum (Spectrum Chemical, New Brunswick, NJ), 39% (w/w) hydrolyzed whey protein isolate (AMCO Proteins, Burlington, NJ) was incorporated into vanilla protein powder (Muscle Milk™, PepsiCo, Purchase, NY; second panel), strawberry Greek yogurt (Chobani™, Norwich, NY; third panel), nutrition shake (Nutren™, Nestle, Bridgewater, NJ; fourth panel), or lemon-lime sports drink (Gatorade™, PepsiCo, Purchase, NY; fifth panel). Images show the food compositions (e.g., food products) in the absence (left) or absence (right) of microparticle preparation. Added protein to each food composition (e.g., food product) was an additional 10 grams, 5 grams, 5 grams, or 5 grams of protein per serving of protein powder, yogurt, nutrition shake or sports drink, respectively. Samples of 1 gram of vanilla protein powder, 10 grams of Greek yogurt, 10 mL of nutrition shake, or 10 mL of sports drink were transferred to a 20 mL scintillation vial or polypropylene weigh boat and mixed with adequate mass of formulated agarose protein particles to increase the protein content of a sample to 10 grams of protein per serving of vanilla protein powder, 5 grams per serving of Greek yogurt, 5 grams per serving of nutrition shake, or 5 grams per serving of sports drink. Scintillation vials were homogenized via vortexing on high for 60 seconds prior to imaging. As shown in FIG. 72B, addition of exemplary particle preparation to dry protein powder, Greek yogurt and nutrition shake resulted in minimal visual alterations. The exemplary particle preparation did not incorporate well into the sports drink food product as particles were observed to settle at the bottom of the beverage.

As shown in FIG. 72C, an exemplary spray-dried, cross-linked, alginate microparticle (CLAM) preparation containing 40% (w/w) alginate (Sigma Aldrich, St. Louis, MO), 20% (w/w) succinic acid (Spectrum Chemical, New Brunswick, NJ), and 40% (w/w) hydrolyzed whey protein isolate (AMCO Proteins, Burlington, NJ), was incorporated into vanilla protein powder (Muscle Milk™, PepsiCo, Purchase, NY; second panel), strawberry Greek yogurt (Chobani™, Norwich, NY; third panel), nutrition shake (Nutren™, Nestle, Bridgewater, NJ; fourth panel), or lemon-lime sports drink (Gatorade™, PepsiCo, Purchase, NY; fifth panel). Images show the food compositions (e.g., food products) in the absence (left) or absence (right) of microparticle preparation. Added protein to each food composition (e.g., food product) was an additional 10 grams, 5 grams, 5 grams, or 5 grams of protein per serving of protein powder, yogurt, nutrition shake or sports drink, respectively. Samples of 1 gram of vanilla protein powder, 10 grams of Greek yogurt, 10 mL of nutrition shake, or 10 mL of sports drink were transferred to a 20 mL scintillation vial or polypropylene weigh boat and mixed with adequate mass of formulated agarose protein particles to increase the protein content of a sample to 10 grams of protein per serving of vanilla protein powder, 5 grams per serving of Greek yogurt, 5 grams per serving of nutrition shake, or 5 grams per serving of sports drink. Scintillation vials were homogenized via vortexing on high for 60 seconds prior to imaging. As shown in FIG. 72C, addition of exemplary particle preparation to dry protein powder, resulted in minimal visual alterations. Addition of exemplary particle preparation to Greek yogurt, nutrition shake, and sports drink significantly increased the viscosity. Large clumps were observed when added to Greek yogurt, and incorporation of air into the sports drink was observed (e.g., formation of an unstable foam).

As shown in FIG. 72D, an exemplary spray-dried, cross-linked, alginate microparticle (CLAM) preparation containing 35% (w/w) alginate (Sigma Aldrich, St. Louis, MO), 17% (w/w) succinic acid (Spectrum Chemical, New Brunswick, NJ), 3.5% (w/w) calcium carbonate (SPI Pharma, Wilmington, DE), 9% (w/w) hydroxypropyl methyl cellulose 40 cP (Spectrum Chemical, New Brunswick, NJ), and 35% (w/w) inulin (TCI Chemical, Tokyo, Japan), was incorporated into vanilla protein powder (Muscle Milk™, PepsiCo, Purchase, NY; second panel), strawberry Greek yogurt (Chobani™, Norwich, NY; third panel), nutrition shake (Nutren™, Nestle, Bridgewater, NJ; fourth panel), or lemon-lime sports drink (Gatorade™, PepsiCo, Purchase, NY; fifth panel). Images show the food compositions (e.g., food products) in the absence (left) or absence (right) of microparticle preparation. Added protein to each food composition (e.g., food product) was an additional 10 grams, 5 grams, 5 grams, or 5 grams of protein per serving of protein powder, yogurt, nutrition shake or sports drink, respectively. Samples of 1 gram of vanilla protein powder, 10 grams of Greek yogurt, 10 mL of nutrition shake, or 10 mL of sports drink were transferred to a 20 mL scintillation vial or polypropylene weigh boat and mixed with adequate mass of CLAMs. Scintillation vials were homogenized via vortexing on high for 60 seconds prior to imaging. As shown in FIG. 72D, addition of exemplary particle preparation to dry protein powder, resulted in minimal visual alterations. Addition of exemplary particle preparation to Greek yogurt, nutrition shake, and sports drink significantly increased the viscosity. Large clumps were observed when added to Greek yogurt, and incorporation of air into the sports drink was observed (e.g., formation of a slight foam).

As shown in FIG. 72E, an exemplary spray-dried inulin preparation containing 49.5% (w/w) inulin (TCI Chemical, Tokyo, Japan), 0.5% (w/w) FITC-inulin (Sigma Aldrich, St. Louis, MO), and 50% Eudraguard Biotic (Vikram Thermo, India) was incorporated into vanilla protein powder (Muscle Milk™, PepsiCo, Purchase, NY; second panel), strawberry Greek yogurt (Chobani™, Norwich, NY; third panel), nutrition shake (Nutren™, Nestle, Bridgewater, NJ; fourth panel), or lemon-lime sports drink (Gatorade™, PepsiCo, Purchase, NY; fifth panel). Images show the food compositions (e.g., food products) in the absence (left) or absence (right) of microparticle preparation. Samples of 1 gram of vanilla protein powder, 10 grams of Greek yogurt, 10 mL of nutrition shake, or 10 mL of sports drink were transferred to a 20 mL scintillation vial or polypropylene weigh boat and mixed with adequate mass of inulin preparation. Scintillation vials were homogenized via vortexing on high for 60 seconds prior to imaging. As shown in FIG. 72E, addition of exemplary particle preparation to dry protein powder, resulted in minimal visual alterations. Addition of exemplary particle preparation to Greek yogurt, nutrition shake, and sports drink significantly increased the viscosity. Large clumps were observed when added to Greek yogurt, and incorporation of air into the sports drink was observed (e.g., formation of an unstable foam).

### SS. Example 37: Exemplary Spray Dried Microparticle Preparations can Achieve Small Particle Sizes

This example shows that exemplary microparticle preparations manufactured using a spray dried process can result in a decreased particle size as compared to commercial food components.

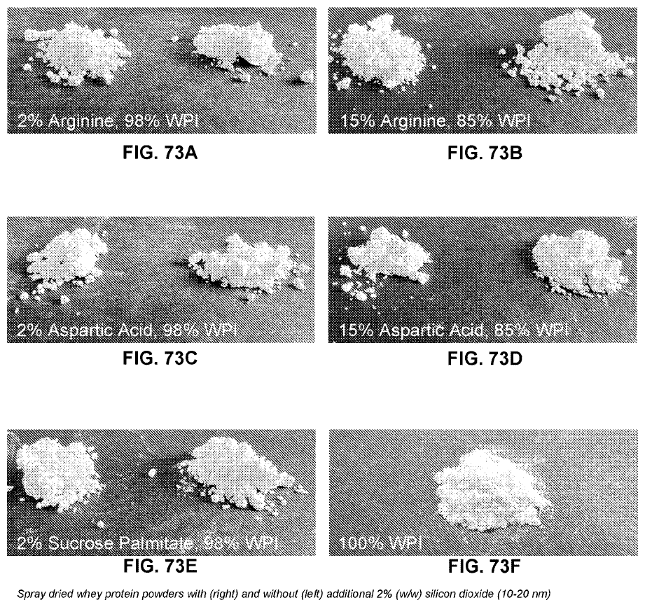

As delivered, whey protein isolate (AMCO Proteins, Burlington, NJ) particle size is approximately 300 μm (as shown in FIG. 73F), meaning that milled particle formulations ranging from 200-300 μm are ineffective at entrapping this protein. Solubilization and subsequent spray drying of whey protein can reduce particle size to that of individual whey proteins on a nanometer scale. In an embodiment, a 500 mL solution of 10% (w/v) whey protein isolate and 0.2% (w/v) L-arginine (Millipore Corp., Darmstadt, Germany) in Milli-Q water was prepared at room temperature over a stir plate. The solution was then spray dried using a Buchi B-290 mini spray dryer (Buchi, New Castle, DE) operating at an inlet temperature of 130 °C, an outlet temperature of 51 °C, pump 30%, needle valve at 45 mm and aspirator set to 100%. The resulting powder (FIG. 73A, left) was mixed with silicon dioxide 10-20 nm (Sigma Aldrich, St. Louis, MO) using an IKA Eurostar overhead stirrer (IKA, Wilmington, NC) at 800 rpm (FIG. 73A, right).

In another embodiment, a 500 mL solution of 10% (w/v) whey protein isolate and 1.5% (w/v) L-arginine (Millipore Corp., Darmstadt, Germany) in Milli-Q water was prepared at room temperature over a stir plate. The solution was then spray dried using a Buchi B-290 mini spray dryer (Buchi, New Castle, DE) operating at an inlet temperature of 130 °C, outlet temperature of 51 °C, pump 30%, needle valve at 45 mm and aspirator set to 100%. The resulting powder (FIG. 73B, left) was mixed with silicon dioxide 10-20 nm (Sigma Aldrich, St. Louis, MO) using an IKA Eurostar overhead stirrer (IKA, Wilmington, NC) at 800 rpm (FIG. 73B, right).

In another embodiment, a 500 mL solution of 10% (w/v) whey protein isolate and 0.2% (w/v) aspartic acid (Sigma Aldrich, St. Louis, MO) in Milli-Q water was prepared at room temperature over a stir plate. The solution was then spray dried using a Buchi B-290 mini spray dryer (Buchi, New Castle, DE) operating at an inlet temperature of 130 °C, outlet temperature of 51 °C, pump 30%, needle valve at 45 mm and aspirator set to 100%. The resulting powder (FIG. 73C, left) was mixed with silicon dioxide 10-20 nm (Sigma Aldrich, St. Louis, MO) using an IKA Eurostar overhead stirrer (IKA, Wilmington, NC) at 800 rpm (FIG. 73C, right).

In another embodiment, a 500 mL solution of 10% (w/v) whey protein isolate and 1.5% (w/v) aspartic acid (Sigma Aldrich, St. Louis, NO) in Milli-Q water was prepared at room temperature over a stir plate. The solution was then spray dried using a Buchi B-290 mini spray dryer (Buchi, New Castle, DE) operating at an inlet temperature of 130 °C, outlet temperature of 51 °C, pump 30%, needle valve at 45 mm and aspirator set to 100%. The resulting powder (FIG. 73D, left) was mixed with silicon dioxide 10-20 nm (Sigma Aldrich, St. Louis, MO) using an IKA Eurostar overhead stirrer (IKA, Wilmington, NC) at 800 rpm (FIG. 73D, right).

In another embodiment, a 500 mL solution of 10% (w/v) whey protein isolate and 0.2% (w/v) sucrose palmitate (Biosynth AG, Staad, Switzerland) in Milli-Q water was prepared at room temperature over a stir plate. The solution was then spray dried using a Buchi B-290 mini spray dryer (Buchi, New Castle, DE) operating at an inlet temperature of 130 °C, outlet temperature of 51 °C, pump 30%, needle valve at 45 mm and aspirator set to 100%. The resulting powder (FIG. 73E, left) was mixed with silicon dioxide 10-20 nm (Sigma Aldrich, St. Louis, MO) using an IKA Eurostar overhead stirrer (IKA, Wilmington, NC) at 800 rpm (FIG. 73E, right).

### TT. Example 38: Methods for Manufacturing Exemplary Microparticle Preparations can be Scaled Up

This example shows that methods for manufacturing exemplary microparticle preparations can be scaled up.

In an embodiment, hydrolyzed whey protein food component (e.g., payload) encapsulated within a matrix composition further comprising agarose was scaled up to 30 g. A stock mixture of 50:2 agarose:locust bean gum was prepared. 236.2 mL of PBS (pH 7.4) was added to a 500 ml beaker while stirring at 200 RPM on a hot plate. 11.81 g of AMCO hydrolyzed whey protein was added to the PBS at room temperature. 5.905 g of Spectrum hydroxypropyl methylcellulose (100 cP) was added to the mixture until completely dissolved. 12.28 g of the agarose: locust bean gum mixture was slowly added to the mixture at 300 RPM. Once the mixture solubilized, the hot plate was set to 190 °C and the temperature of the mixture was measured using an infrared thermometer. Once the temperature of the mixture reached 90 °C, the heat was held for 120 seconds and then removed from heat and incubated at room temperature for 30 minutes to cool. Once cooled and solidified, the resulting gel was cut into approximately 2 cm³ pieces, transferred to weigh boats, and placed in an oven to dry at 60 °C for 22 hours. Dried material was milled at room temperature at 5250 RPM using a 500 μm mesh sieve. Particles were collected and weighed.

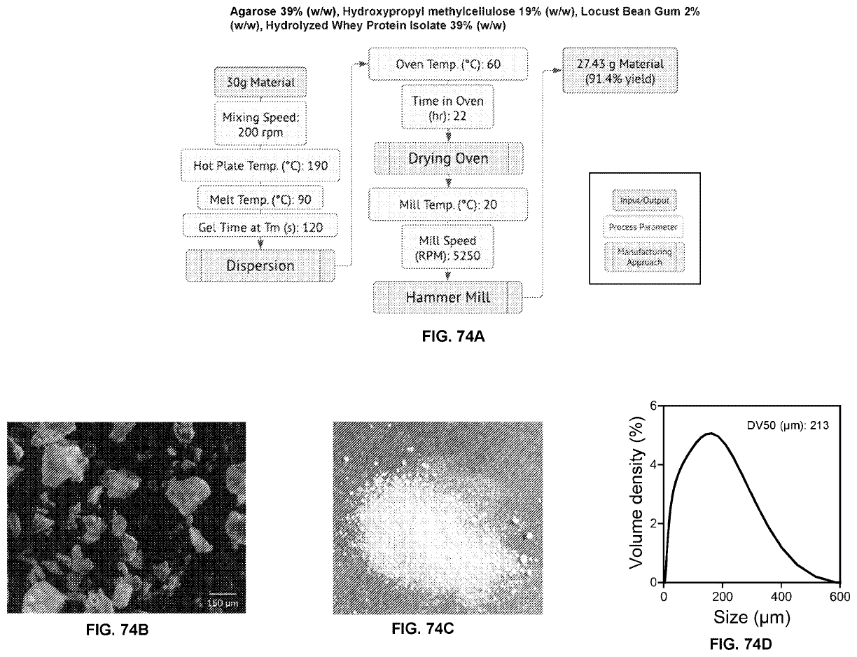

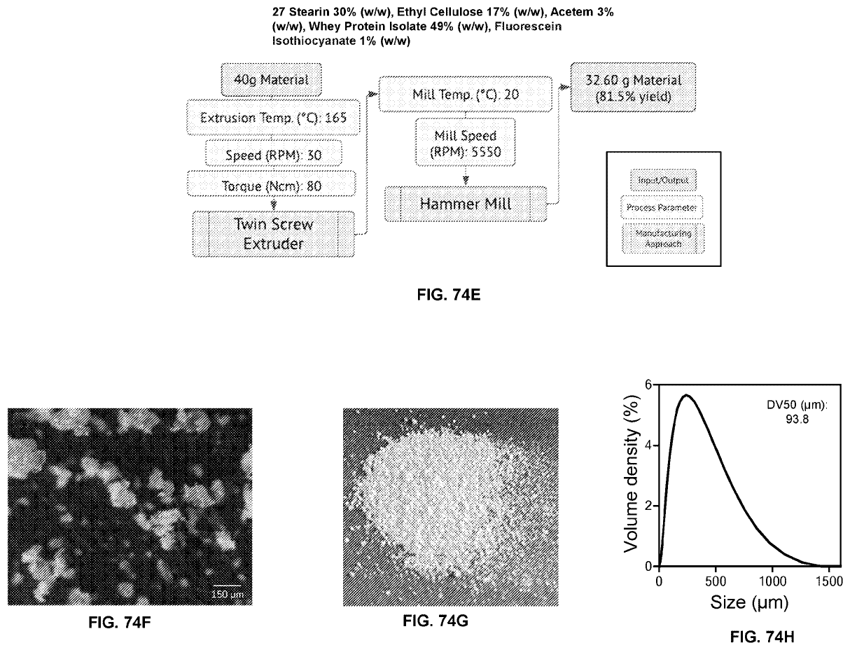

FIG. 74A shows a flow chart of the scaled-up manufacturing process. FIG. 74B, FIG. 74C, and FIG. 74D show a microscopic image, photographic image, and volume density distribution plot, respectively, of the resulting microparticle preparations.

In another embodiment, a mixture of 12 g of 27 Stearin (Bunge Loders Croklaan), 6.8 g of ethyl cellulose 100 cP (Sigma-Aldrich), 1.2 g of acetic acids of mono and di-glycerides (DANISCO), 19.6 g of bovine serum albumin (Sigma-Aldrich), and 0.4 g of FITC bovine serum albumin (Sigma-Aldrich) was mixed in a closed glass container by vigorously shaking for 20 minutes. A Haake MiniLab 3 Extruder (Thermo Scientific) was assembled with counter-rotating twin screws set to 165 °C and 30 RPM. The mixture was fed into the extruder using a pneumatic feeder in 500 mg portions. The formulation mixture was extruded at 90 Ncm torque. Once all material was extruded, the extrudate was broken up into ~5 cm long pieces for milling. Milling was conducted at room temperature at 5550 RPM using 500 μm mesh sieve. 32.60 g of final material was collected and particle size analysis was performed.

FIG. 74E shows a flow chart of the scaled-up melt-extrusion manufacturing process. FIG. 74F, FIG. 74G, and FIG. 74H show a microscopic image, photographic image, and volume density distribution plot, respectively, of the resulting microparticle preparations.

### UU. Example 39: Exemplary Multi-Coated Microparticle Preparations

Particles having single coating layers often fail due to cracks forming in the coating shell. To mitigate coating failure, this example shows microparticle preparations having two coating layers: one hydrophobic layer, and a hydrophilic layer.

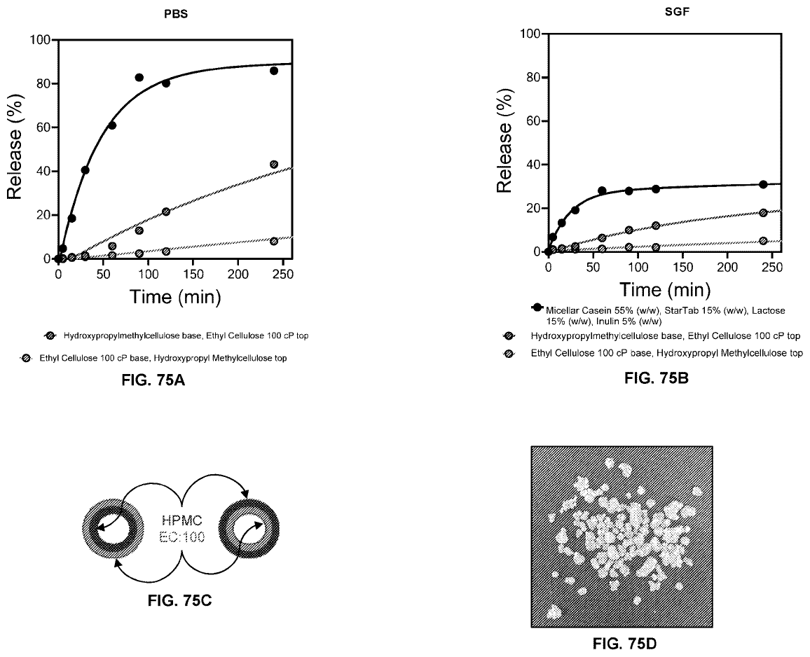

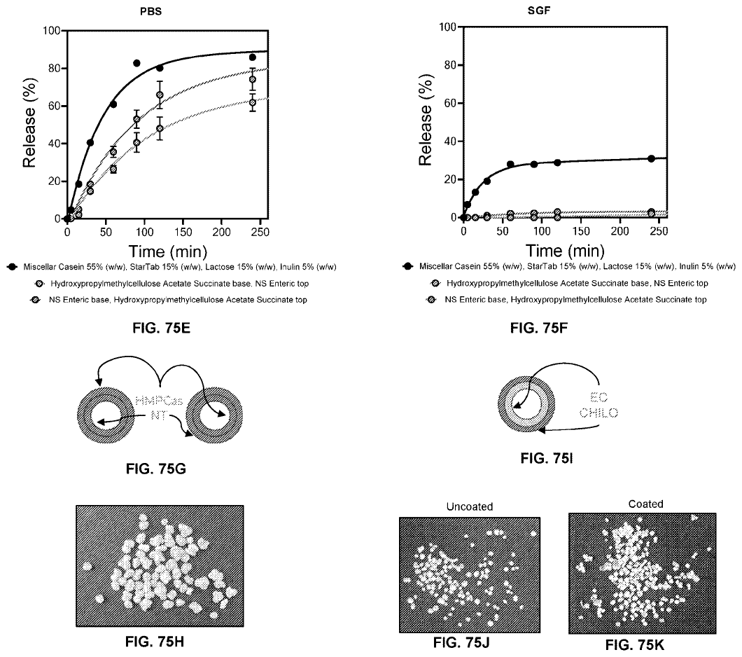

A 2% (w/w) solution of hydroxypropyl methylcellulose in 100 mL water was stirred at 400 RPM at 100 °C for 30 mins. A fluid bed coater was assembled in accordance with the manufacturer's instructions. A 1 mm diameter microparticle preparation incorporating 55% (w/w) micellar casein, 15% (w/w) StarTab, 15% (w/w) lactose, and 5% (w/w) inulin was obtained and the mass was recorded. The hydroxypropyl methylcellulose solution was placed on a hot plate set to 50 °C and 250 RPM and pumped through the tubing of the fluid bed coater. The fluid bed coater parameters were set as follows: spray on/off: 0.4/0.6, 12 RPM, pump rev: 5 seconds, inlet temp: 30 °C. The particles were consistently monitored to assure fluidization and that the nozzle did not clog. Spraying occurred until 5% of hydroxypropyl methylcellulose was coated onto particles. The single-coated particle mass was recorded. All tubing was cleaned with water followed by ethanol by pumping the two solutions through the tubing at 60 RPM. A 5% (w/w) ethyl cellulose 100 cP solution in 100 mL ethanol was stirred at 400 RPM at 100 °C for 30 minutes. The solution was then placed on a hot plate set to 80 °C and 250 RPM. The fluid bed coater parameters were as follows: spray on/off: 0.2/0.8, 15 RPM, pump rev: 5 seconds, inlet temp: 80 °C. The particles were consistently monitored to assure fluidization and that the nozzle did not clog. Coating occurred until 8% ethyl cellulose was coated onto particles. The dual-coated particle mass was recorded. The same dual-coating process was repeated but with the order of hydroxypropyl methylcellulose and ethyl cellulose coatings reversed. Particle dissolution assays of both dual-coated coated particles and uncoated particles were performed in triplicates in 12 mL PBS and simulated gastric fluid. 200 μL of sample was taken at 0, 5, 15, 30, 60, 120, 240, and 1440 mins. A standard BCA assay was then performed. As shown in FIG. 75A and FIG. 75B, a microparticle preparation having a hydrophobic base coat and a hydrophilic top coat was more effective at delaying release of food component (e.g., payload) in both neutral and acidic conditions (i.e., PBS; FIG. 75A, and simulated gastric fluid, FIG. 75B, respectively).

In another embodiment, 10% (w/w) hydroxypropyl methylcellulose acetate succinate was added to 100 ml of water and stirred at 400 RPM at 100 °C for 30 mins. A fluid bed coater was assembled in accordance with the manufacturer's instructions. A 1 mm diameter microparticle preparation incorporating 55% (w/w) micellar casein, 15% (w/w) StarTab, 15% (w/w) lactose, and 5% (w/w) inulin was obtained and the mass was recorded. The hydroxypropyl methylcellulose acetate succinate solution was placed on a hot plate set to 50 °C and 250 RPM and pumped through the fluid bed coater tubing. The fluid bed coater parameters were as follows: Spray on/off: 0.6/0.4, 18 RPM, pump rev: 5 seconds, inlet temp: 25 °C. The particles were consistently monitored to assure fluidization and that the nozzle did not clog. Coating occurred until 14% hydroxypropyl methylcellulose acetate succinate was added to the particles. The single-coated particle mass was recorded. All tubing was cleaned with water by pumping through the tubing at 60 RPM. 2% (w/w) of NS Enteric (Sodium Alginate) in 100 mL of water was stirred at 400 RPM at 100 °C until NS Enteric appeared solubilized. The NS Enteric solution was then placed on a hot plate set to 80 °C and 250 RPM. The fluid bed coater parameters were as follows: Spray on/off: 1.0/0.4, 11 RPM, pump rev: 5 seconds, inlet temp: 80 °C. The particles were consistently monitored to assure fluidization and that the nozzle did not clog. Spraying occurred until 6% of NS Enteric was coated onto the particles. The dual-coated particle mass was recorded. The same dual-coating process was repeated but with the order of hydroxypropyl methylcellulose acetate succinate and NS Enteric coatings reversed. Particle dissolution assays of both dual-coated coated particles and uncoated particles were performed in triplicates in 12 mL PBS and simulated gastric fluid. 200 μL of sample was taken at 0, 5, 15, 30, 60, 120, 240, and 1440 mins. A standard BCA assay was then performed. As shown in FIG. 75E and FIG. 75F, a microparticle preparation having a hydrophobic base coat and a hydrophilic top coat was more effective at delaying release of food component (e.g., payload) in both neutral and acidic conditions (i.e., PBS, FIG. 75E and simulated gastric fluid, FIG. 75F, respectively).

In another embodiment, 5% (w/w) ethyl cellulose 300 cP solution in water was prepared by mixing on a stir plate at 400 RPM and 100 °C for 30 mins. The fluid bed coater was assembled in accordance with the manufacturer's instructions. A 0.5 mm diameter microparticle preparation incorporating 50% (w/w) microcrystalline cellulose, 5% (w/w) hydroxypropyl cellulose grade SSL, 5% (w/w) DryFlo, 38% (w/w) inulin, and 2% (w/w) FITC-inulin was obtained and the mass was recorded. The ethyl cellulose 300 cP solution was placed on a scale and pumped through the fluid bed coater tubing at 60 RPM. The fluid bed coater parameters were as follows: Spray on/off: 0.4/0.6, 17 RPM, pump rev: 5 seconds, inlet temp: 80 °C. The particles were consistently monitored to assure fluidization and that the nozzle did not clog. Coating occurred until 9.5% of ethyl cellulose was coated onto the particles. The single-coated particle mass was recorded. All tubing was cleaned with ethanol followed by water by pumping the two solutions through the tubing at 60 RPM. A solution with 1% (w/w) low molecular weight chitosan in 1% Acetic Acid (v/v %) with 1% (w/w) glycerol and 0.25% (w/w) stearic acid was stirred at 400 RPM at 130 °C until the chitosan appeared solubilized. The solution was then placed on a scale and pumped through the fluid bed coater tubing. The fluid bed coater parameters were as follows: spray on/off: 0.4/0.6, 20 RPM, pump rev: 5 seconds, inlet temp: 50 °C. The particles were consistently monitored to assure fluidization and that the nozzle did not clog. Spraying occurred until 4% chitosan was coated onto the particles.

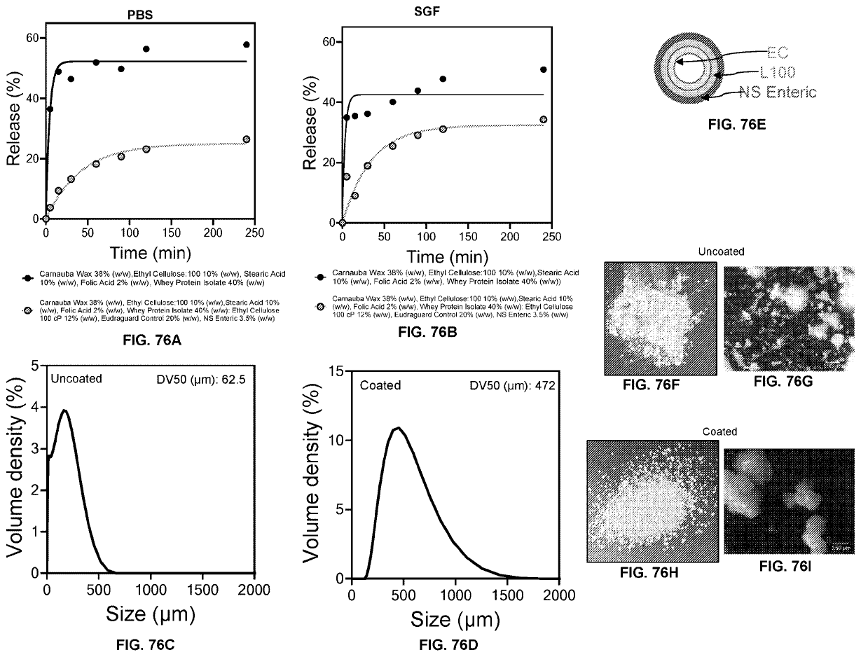

In another embodiment, a solution containing 5% (w/w) ethyl cellulose 300 cP in 100 mL ethanol was stirred at 400 RPM at 100 °C for 30 mins. The fluid bed coater was assembled according to the manufacturer's instructions. Particles incorporating 38% (w/w) carnauba wax, 10% (w/w) ethyl cellulose 100, 10% (w/w) stearic acid, 2% (w/w) folic acid, and 40% (w/w) whey protein isolate were obtained. The ethyl cellulose 300 cP solution was placed on a scale to track coating weight in grams as spraying occurred. The fluid bed parameters were as follows: spray on/off: 0.8/0.8, 50 RPM, pump rev: 6 seconds, inlet temp: 50 °C. Spraying occurred until 20% (w/w) of ethyl cellulose 300 cP was added to the particles. The particles were consistently monitored to assure fluidization and that the nozzle did not clog. All tubing was cleaned with ethanol followed by water by pumping the two solutions through the tubing at 60 RPM. 100 mL of Eudragit Control (Eudragit L100) was obtained. The Eudragit L100 solution was placed on a scale to track coating weight in grams as spraying occurred. The fluid bed coater parameters were as follows: spray on/off: 0.8/0.8, 50 RPM, pump rev: 6 seconds, inlet temp: 30 °C. Spraying occurred until 12% (w/w) of Eudragit L100 was added to the particles. All tubing was cleaned with water by pumping it through the tubing at 60 RPM. Next, a solution of 2% (w/w) NS Enteric in 100 mL of water was prepared on a 100 °C hot plate, stirring at 400 RPM for 30 mins. The NS Enteric solution was placed on a scale to track coating weight in grams as spraying occurred. The fluid bed coater parameters were as follows: spray on/off: 0.0/0.0, 15 RPM, pump rev: 5 seconds, inlet temp: 80 °C. Spraying occurred until 2.5% (w/w) of NS Enteric was added to the particles. The particles were consistently monitored to assure fluidization and that the nozzle did not clog. The Fluid bed coater was then cleaned in accordance with the manufacturer's instructions. Particle dissolution assays of dual-coated coated particles and uncoated particles were performed in triplicates in 12 mL PBS and simulated gastric fluid. 50 mg of particles were added to each sample tube and 300 μL of sample was taken at 0, 5, 15, 30, 60, 120, 240, and 1440 mins. Once a timepoint sample was collected, a 1 ml syringe was used to aspirate 200 μl of sample and passed through a 0.22 μm filter to reduce agglomerates. A standard BCA assay was then performed. As shown in FIG. 76A and FIG. 76B, an exemplary dual-coated microparticle preparation can delay the release of food component (e.g., payload) in both acidic and neutral conditions (i.e., PBS, FIG. 76A, and simulated gastric fluid, FIG. 76B, respectively).

Particle size analysis was performed on both uncoated (FIG. 76C) and coated particles (FIG. 76D), and shown to have DV50 values of 62.5 μm and 473 μm, respectively. FIGS. 76F-76I show microscopy images at 10× magnification.

### VV. Example 40: Methods for Manufacturing Exemplary High-Loaded Microparticle Preparations

This example shows an exemplary method for manufacturing a high-loaded microparticle preparation having a small particle size.

To encapsulate inulin in Eudraguard Biotic, 6% (w/v) polymer was dispersed in 500 mL of deionized water followed by dropwise addition of 3 mL of concentrated aqueous ammonium hydroxide solution. The pH was observed to quickly rise to 10, followed by a gradual decrease and increase in dispersion transparency upon polymer solubilization. Once pH reached 6, additional ammonium hydroxide solution was added. This process was repeated until pH was stabilized at ~9. Then, 6% (w/v) inulin was added to the solution and allowed to dissolve (~30 minutes). The dissolved inulin and polymer were fed to a Buchi B-290 Mini Spray Dryer with inlet temperature of 130 °C, outlet temperature of 61 °C, sweep gas at 35 cm³/min, aspirator at 100%, and flow rate at 30%. Dry powder yield (FIG. 77F and FIG. 77G) was 71%. An analogous procedure was carried out using sodium alginate, succinic acid, and calcium carbonate forming the initial polymer solution, with either whey protein (FIG. 77B and FIG. 77C), or inulin (FIG. 77D and FIG. 77E).

As shown in FIG. 77A, particle size analysis, using a laser diffraction particle sizer analyzer (Malvern Mastersizer 3000) of an enteric spray dry-encapsulated protein formulation (40% (w/w) sodium alginate, 20% (w/w) succinic acid, 40% (w/w) hydrolyzed whey protein)) indicated an exemplary microparticle exhibited a DV50 of ~8 μm.

Microscopy of exemplary spray dry-encapsulated protein particle preparations (40% (w/w) sodium alginate, 20% (w/w) succinic acid, 40% (w/w) hydrolyzed whey protein)) indicated that the particles had spherical morphology (FIG. 77B).

75 mg portions of exemplary spray dried particles were added to 15 ml conical centrifuge tubes holding 12 mL of either simulated intestinal fluid (pH 7.5) or simulated gastric fluid (pH 1) at 37 °C and rotating at 20 rpm. 200 μL of samples were collected at 5, 15, 30, 60, 90, 120, 240, and 1440 minutes. Collected samples were assayed for protein release using a Pierce™ 660 nm assay in accordance with the manufacturer's instructions (FIG. 77C).

Microscopy of exemplary spray dry-encapsulated inulin particle preparations (35% (w/w) sodium alginate, 17.5% (w/w) succinic acid, 3.5% (w/w) calcium carbonate, 8.5% (w/w) hydroxypropyl methylcellulose 40 cP, 36% (w/w) inulin) indicates spherical morphology (FIG. 77D). 75 mg portions of exemplary spray dried particles were added to 15 mL conical centrifuge tubes holding 12 mL of either simulated intestinal fluid (pH 7.5) or simulated gastric fluid (pH 1) at 37 °C and rotating at 20 rpm. 200 μL samples were collected at 5, 15, 30, 60, 90, 120, 240, and 1440 minutes. Collected samples were assayed for inulin release by quantifying the fluorescence of doped (2% relative to total inulin content) FITC inulin (FIG. 77E).

Microscopy of exemplary spray dry-encapsulated inulin particle preparations (49.5% (w/w) Eudraguard Biotic, 50.5% (w/w) inulin) indicates spherical morphology (FIG. 77F). 75 mg portions of spray dried particles were added to 15 ml conical centrifuge tubes holding 12 mL of either simulated intestinal fluid (pH 7.5) or simulated gastric fluid (pH 1) at 37 °C and rotating at 20 rpm. 200 μL samples were collected at 5, 15, 30, 60, 90, 120, 240, and 1440 minutes. Collected samples were assayed for inulin release by quantifying the fluorescence of doped (2% relative to total inulin content) FITC inulin (FIG. 77G).

This process of spray dry encapsulation was repeated with higher loading of hydrolyzed whey protein isolate. To prepare this exemplary microparticle preparation, 22 g of sodium alginate was dissolved in 900 mL of water overnight at 40 °C, followed by the dissolution of 66 g of hydrolyzed whey protein isolate and 12 g of succinic acid. The pH of the solution was adjusted to at least 7.2, at least 7.4, at least 7.6, at least 7.8, at least 8.0, at least 8.2, or at least 8.4 using ammonium hydroxide. The solution was then spray-dried using a Buchi B-290 benchtop spray drier with inlet temperature at least 120 °C, at least 125 °C, at least 130 °C, at least 135 °C, at least 140 °C, or at least 145 °C; flow rate at 20%, and sweep gas at 414 L/h. Microscopy of exemplary spray dry-encapsulated whey protein isolate particle preparations indicates spherical morphology (FIG. 77H).

### WW. Example 41: Exemplary Microparticle Preparations Increase Bioavailability of Food Components

This example shows that an exemplary microparticle preparation can increase bioavailability of a food component (e.g., payload) by increasing intestinal permeability.

Approximately 40,000 Caco-2 cells were seeded in the upper chamber of a 12-well 0.4 μm polycarbonate transwell assay system (Nunc Cat #141078). After 21 days in culture, cells were switched into pre-warmed Hank's balanced salt solution (HBSS) and equilibrated for 30 minutes at 37 °C. Cellular TEER vales were measured for each well before and after addition of dosing solutions using a Millicell ERS-2 Voltohmmeter (Millipore Sigma Cat #MERS00002). TEER for each well was calculated as ohms per cm², using the formula (R_{Sample}−R_{blank})*A where A is the culture area in cm².

TEER measurements and permeability samples were collected simultaneously.

400 μL of HBSS (negative control) or a dosing solution was added to the upper (apical) compartment of the transwell system, and 800 μL of HBSS was added to the lower (basal) compartment. At each sampling time point, 200 μL was transferred from the basal compartment to a 96-well assay plate, and replaced with fresh HBSS. At the end of the experiment, any remaining volume from the apical compartment was also collected for permeability measurements. Samples were collected at t=0, 1, 2, 3, 4, and 8 hours. Depending on the compound being investigated for permeability, samples were either read on a fluorescence plate reader directly or analyzed using an appropriate assay kit. Effective permeability (P_{eff}) was calculated using the following formula (dQ/dT)*(V/A*C0) where dQ/dT is the apparent permeability, V is the volume in the lower compartment, A is the culture area of the plate, and C0 is the initial concentration in the upper compartment. Percent permeability was calculated as the (C_{lower}/C_{dosed})*100. Data shown as cumulative percent permeability over the course of 4 hours.

Dosing solutions were selected from 100 μM Lucifer yellow, 10 mM caffeine, 1 mM cyanidin chloride, or 1 mM FITC-inulin. Exemplary preparations containing cyanidin chloride or FITC inulin food components (e.g., payloads) had either a low (cyanidin chloride-0.5 mM, FITC inulin-1 mM) or high (cyanidin chloride-1 mM, FITC inulin-2 mM) particle loading. Cyanidin chloride was formulated in a liquid preconcentrate comprising 22% Kolliphor RH40, 4% sodium decanoate, 2% cholesterol, 73% cyanidin chloride. FITC inulin was formulated in a liquid preconcentrate comprising: 61% Kappa-carrageenan, 24% Locust bean gum, 2% sodium decanoate, and 12% FITC inulin.

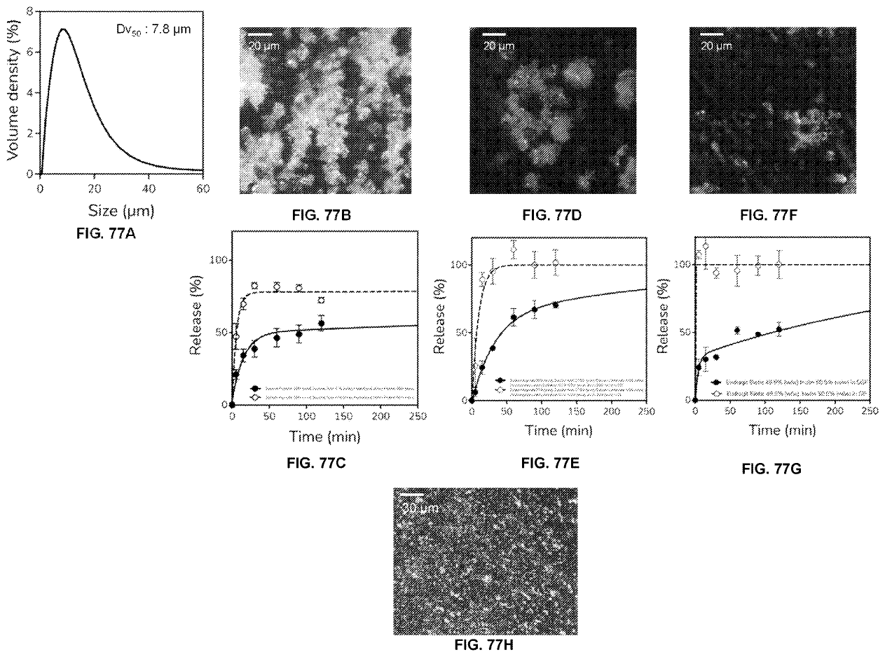

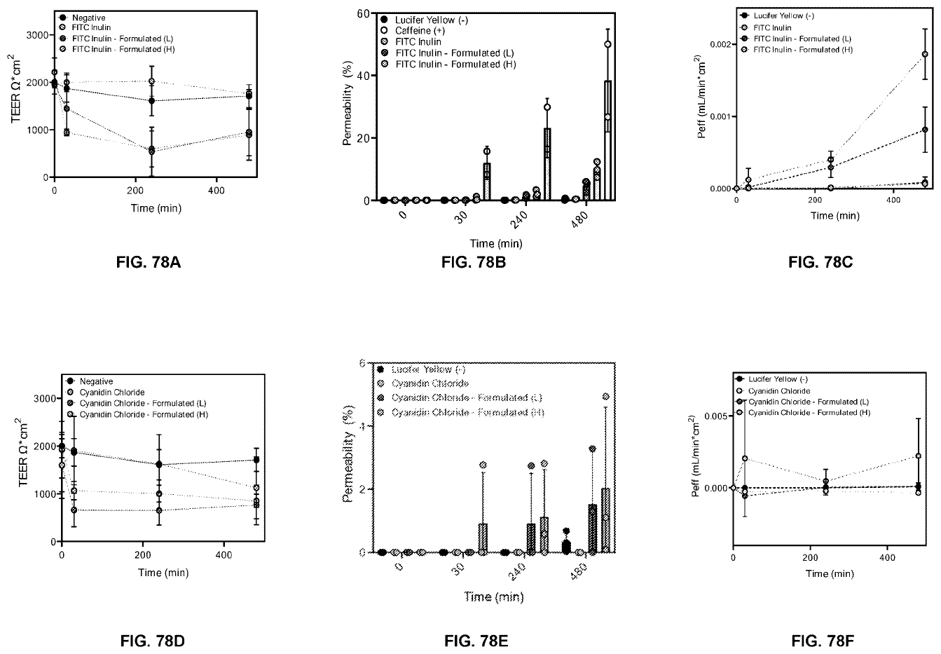

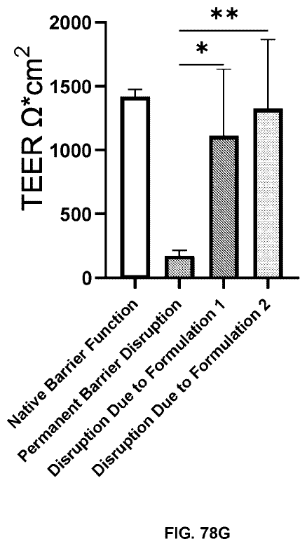

FIG. 78A, shows TEER measurements following dosing with formulated versus unformulated FITC inulin. Exemplary low and high dose formulations of FITC inulin appeared to cause a decrease in resistance (i.e., permeability) as compared to unformulated FITC inulin and negative control.

FIG. 78B and FIG. 78C, show percent permeability and P_{eff}, respectively, of lucifer yellow, caffeine, unformulated FITC inulin, and low and high doses of formulated FITC inulin. Exemplary low and high dose formulations of FITC inulin appeared to have greater permeability across the Caco-2 monolayer as compared to unformulated FITC inulin and Lucifer yellow, but less than the permeability of caffeine.

FIG. 78D, shows TEER measurements following dosing with formulated versus unformulated cyanidin chloride. Exemplary low and high dose formulations of cyanidin chloride appeared to cause a decrease in resistance (i.e., permeability) as compared to unformulated cyanidin chloride and negative control.

FIG. 78E and FIG. 78F, show percent permeability and P_{eff}, respectively, of lucifer yellow, unformulated cyanidin chloride, and low and high doses of formulated cyanidin chloride. Exemplary low and high dose formulations of cyanidin chloride appeared to have greater permeability across the Caco-2 monolayer as compared to unformulated cyanidin chloride and Lucifer yellow.

At the end of each assay, the TEER measurements were taken for cell culture monolayers dosed with the exemplary low or high dose FITC inulin formulations, or the exemplary low or high dose cyanidin chloride formulations. As shown in FIG. 78G, minimal barrier disruption and/or cell death was observed after dosing of exemplary formulations. TEER measurements were statistically different from Caco-2 monolaters having permanent barrier disruption. Data is shown as mean±/−standard deviation. *p<0.05, **p<0.01.

### XX. Example 42: Exemplary Dual-Coated Microparticle Preparations can Release Food Components in a Sequential Manner

This example shows that exemplary dual-coated microparticle preparation can release food components (e.g., payload) in a manner specific to coating order-specific or sequence.

In an exemplary embodiment, base microparticles incorporated 47% (w/w) micellar casein, 25% (w/w) startab starch, 15% (w/w) lactose, and 4% (w/w) inulin. For each coating solution, solids were weighed and dissolved in the appropriate solvent with stirring at >300 RPM until no solids remained. Exemplary coating solutions were as follows: 15% (w/v) hydroxypropyl methylcellulose acetate succinate (HPMCas) dissolved in water, 2% (w/v) NS enteric (NT-Colorcon) dissolved in water, 5% (w/v) ethyl cellulose (EC-100 cP) dissolved in ethanol, and 5% (w/v) hydroxypropyl methylcellulose (HPMC) dissolved in cold water. 100 mL of each exemplary coating solution was used for fluid-bed coating.

All fluid-bed coating was conducted on a Freund-Vector benchtop mini fluid-bed coater which was assembled and operated in accordance with the manufacturer's instructions. Exemplary coating solutions were run through the peristaltic pump and spray rates were calculated as grams per minute prior to attachment to the spray nozzle. Spray rates in grams/minute varied based on the polymer. The spray rates used were as follows: HPMCas—0.6 grams/minute, NT—0.4 grams/minute, EC—0.4 grams/minute, and HPMC 0.54 grams/minute. Each exemplary coating layer was sprayed until the base particle had a minimum percentage weight gain of 3%, and each top coat was sprayed until particles had a minimum percentage weight gain of 2%.

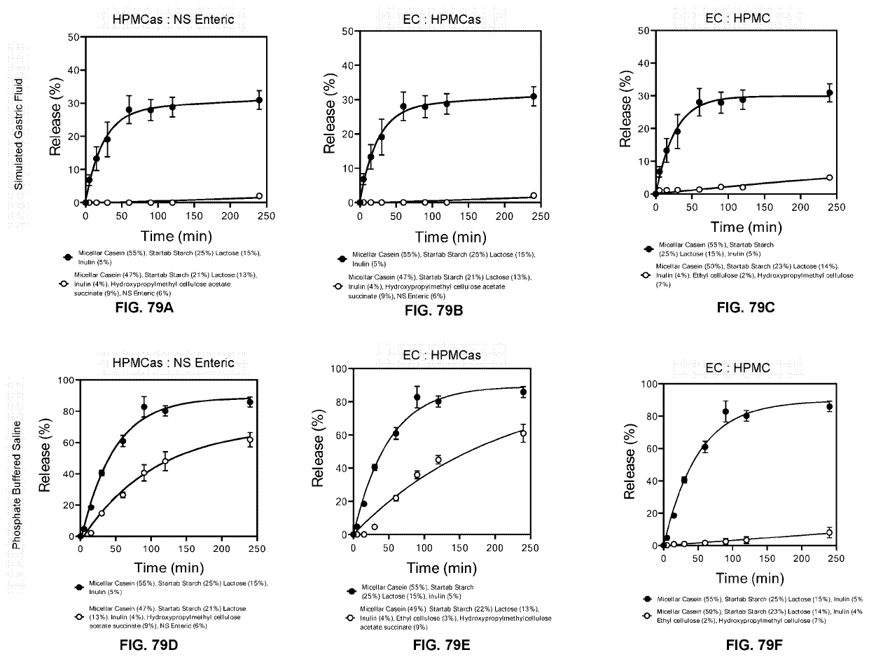

100 mg of both coated and uncoated pelletized inulin particles were used for each dissolution assay. The same base formulation was used to assess the dual coating strategy and pH responsiveness. Particles were added to 12 mL of pre-warmed (37 °C) simulated gastric fluid (FIGS. 79A-79C) or phosphate buffered saline (FIGS. 79D-79F) and rotated in a tube rotisserie. 200 μL of sample were collected at t=0, 5, 15, 30, 60, 90, 120, 240, and 1440 minutes after particles were added. Protein release was quantified using a bicinchoninic (BCA) colorimetric assay. Data was fit to a 2-phase association curve. Data is presented as mean±/−CV %.

As shown in FIGS. 79A-79F, protein release from a base particle and exemplary coated formulation particles were measured up to 4 hours in simulated gastric fluid. In FIG. 79A and FIG. 79D coated particles contained a base layer of 9% hydroxypropylmethyl cellulose acetate succinate and an outer coat of 6% sodium alginate or “NS Enteric” (Colorcon). In FIG. 79B and FIG. 79E, coated particles contained a base coat of 3% ethyl cellulose and top coat of 9% hydroxypropylmethyl cellulose acetate succinate. In FIG. 79C and FIG. 79F, coated particles contained a base coat of 2% ethyl cellulose and a top coat of 7% hydroxypropylmethyl cellulose. Data shown with y-axis indicating the percentage of protein release, x-axis is time under dissolution conditions in minutes. All graphs presented as the mean of n=3 replicates +/−CV %.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

What is claimed is:

1. A formulated tastant composition comprising:
a carrier component comprising at least one excipient; and
a payload component comprising at least one taste modulator,
wherein the at least one taste modulator is Clostridium perfringens, verapamil, EGTA, EDTA, sodium caprate, salcaprozate sodium, collagenase, dispase, elastase, heparitinase, chondroitinase, hyaluronidase, lysozyme, or a combination thereof, and
wherein the payload component is released in an animal over an extended period following ingestion of the composition by the animal as compared to ingestion of the payload component alone.

2. The composition of claim 1, wherein the preparation comprises about 35% to about 90% (w/v) payload component.

3. The composition of claim 1 or 2, wherein the at least one excipient comprises a polysaccharide, a fatty acid, a polyphenol, a ketone, a sugar, a reducing agent, a terpene, a gum, a surfactant, a polymer, a mineral, a complex carbohydrate, or a combination thereof.

4. The composition of any one of claims 1-3, wherein the at least one excipient comprises agarose, alginate, sodium decanoate, low molecular weight chitosan, sodium carboxymethyl cellulose MW:90000, ethyl gallate, 3-hydroxybutyrate, glucose, gluconolactone, dipotassium glycyrrhizin hydrate, hydroxypropyl methylcellulose, locust bean gum, lecithin, poly(acrylic acid) MW 450000, phytic acid, Span 60, tannic acid, Tween 80, calcium carbonate, calcium caseinate, sucrose monostearate, pre-gelatinized maize starch, or a combination thereof.

5. The composition of any one of claims 1-4, further comprising one or more coatings.

6. The composition of any one of claims 1-4, further comprising two or more coatings.

7. The composition of any one of claims 1-6, comprising:
(i) a first coat encapsulating the payload component; and
(ii) a second coat encapsulating the payload component and the first hydrophobic coat.

8. The composition of claim 7, wherein:
the first coat comprises ethyl cellulose cP or hydroxypropyl methycellulose acetate succinate, and
the second hydrophilic coat comprises hydroypropyl methylcellulose, sodium alginate, or hypromellose.

9. The composition of any one of claims 1-8, further comprising a matrix component.

10. The composition of claim 9, wherein the payload component is dispersed throughout the matrix component.

11. The composition of claim 9 or 10, wherein the matrix component comprises a hydrophobic component, a hydrophilic component, an amphiphilic component, or a combination thereof.

12. The composition of any one of claims 9-11, wherein the matrix component comprises a biocompatible material.

13. The composition of any one of claims 9-12, wherein the matrix comprises a sugar, a polysaccharide, a carbohydrate, an oil, a fat, a wax, a protein, or a combination thereof.

14. The composition of any one of claims 1-13, wherein the payload component comprises at least one carbohydrate.

15. The composition of claim 14, wherein the at least one carbohydrate comprises glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, sodium carboxymethylcellulose, or a combination thereof.

16. The composition of any one of claims 1-15, wherein the payload component comprises at least one protein.

17. The composition of claim 16, wherein the at least one protein comprises a protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, legumin, or a combination thereof.

18. The composition of any one of claims 1-17, wherein the carrier component comprises at least one fat.

19. The composition of claim 18, wherein the at least one fat comprises paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, betulinic acid, or a combination thereof.

20. The composition of any one of claims 1-19, wherein the carrier component comprises at least one polyunsaturated fatty acid.

21. The composition of claim 20, wherein the at least one polyunsaturated fatty acid comprises a medium-chain triglyceride, docosahexaenoic acid, eicosapentaenoic acid, arachidonic acid, linoleic acid, linolenic acid, oleic acid, parinaric acid, rumenic acid, or a combination thereof.

22. The composition of any one of claims 1-21, wherein the payload component comprises at least one ketone.

23. The composition of claim 22, wherein the at least one ketone comprises acetoacetate, R-β-hydroxybutyl R-β-hydroxybutyrate, β-hydroxybutyrate, R-3-hydroxybutyl R-3-hydroxybutyrate monoester, 1,3-butanediol, or a combination thereof.

24. The composition of any one of claims 1-23, wherein the at least one excipient comprises an anti-caking component, a surfactant component, a plasticizing component, an acid scavenger, a moisture scavenger, a water scavenger, an oxygen scavenger, a taste modifier, a texture modifier, a desiccant, a polymer, a preservative, a colorant, a flavoring, an antioxidant, a humectant, a solvent, or a combination thereof.

25. The composition of claim 24, wherein the composition comprises, on a weight basis, about 0.5% to about 10% of the at least one excipient.

26. The composition of any one of claims 1-25, further comprising an extended release component.

27. The composition of claim 26, wherein the extended release component comprises a mucoadhesive component.

28. The composition of claim 27, wherein the mucoadhesive component comprises at least one catechol.

29. The composition of claim 28, wherein the at least one catechol comprises L-dopamine, poly(L-dopamine), hydroxytyrosol, catechol, caffeic acid, vanillin, veratraldehyde, eugenol, tannic acid, syringaldehyde, protocatechuic aldehyde, or a combination thereof.

30. The composition of claim 28 or 29, wherein the at least one catechol interacts with a mucosal interface upon ingestion of the composition by the animal.

31. The composition of claim 27, wherein the mucoadhesive component comprises a charged polymer.

32. The composition of claim 31, wherein the charged polymer comprises an anionic mucoadhesive polymer component.

33. The composition of claim 32, wherein the anionic mucoadhesive polymer component comprises poly(acrylic acid), poly(methacrylic acid), poly(glycerol citrate), or a combination thereof.

34. The composition of claim 31, wherein the charged polymer comprises a cationic mucoadhesive polymer component.

35. The composition of claim 34, wherein the cationic mucoadhesive polymer component comprises poly(ethyleneimine), trimethylchitosan, poly(L-arginine), or a combination thereof.

36. The composition of any one of claims 26-35, wherein the extended release component comprises a mucopenetrative component.

37. The composition of claim 36, wherein the mucopenetrative component comprises poly(ethylene glycol), poly(propylene glycol), poly(vinyl alcohol), poly(ethylene oxide-co-propylene oxide), or a combination thereof.

38. The composition of any one of claims 1-37, wherein the at least one taste modulator confers at least one nutritional benefit when the composition is ingested by the animal.

39. The composition of any one of claims 1-38, wherein the taste modulator enhances a taste experienced by the animal.

40. The composition of any one of claims 1-39, wherein the taste modulator reduces an amount of salt, sugar, fat, or a combination thereof, in a food product or beverage product in which the composition is embedded or incorporated.

41. The composition of any one of claims 1-40, wherein the taste modulator reduces an amount of food and/or beverage ingested by an animal following ingestion of the composition.

42. The composition of any one of claims 38-41, wherein the at least one nutritional benefit comprises enhancing passage of the payload component through a selective barrier in the animal.

43. The composition of claim 42, wherein the selective barrier comprises an enzymatic component, a physical component, a molecular component, or a combination thereof.

44. The composition of claim 42 or 43, wherein the selective barrier comprises ATPases, zonula occludens, chondroitin, heparan sulfates, glycosaminoglycans, proteoglycans, or a combination thereof.

45. The composition of any one of claims 1-44, wherein the at least one taste modulator promotes binding of the payload component to one or more taste receptors.

46. The composition of any one of claims 1-45, wherein the at least one taste modulator:
(i) extends a retention time of the payload component in an animal following ingestion of the composition;
(ii) modulates a release rate of the payload component in the animal following ingestion of the composition;
(iii) modulates an adsorption rate of the payload component in the animal following ingestion of the composition;
(iv) modulates an absorption rate of the payload component in the animal following ingestion of the composition;
(v) modulates interaction of the payload component with one or more of a gastrointestinal compartment, tissue, cell, and receptor, or
(vi) a combination thereof.

47. The composition of any one of claims 1-46, wherein the composition comprises, on a dry weight basis, at least 90% payload component.

48. A food or beverage product, wherein a composition of any one of claims 1-47 is embedded and/or incorporated therein.

49. A method of providing a payload component to an animal comprising:
administering a composition of any one of claims 1-47 to the animal.

50. The method of claim 49, wherein the composition is administered via ingestion.

51. The method of claim 49 or 50, wherein the composition is administered as a single bolus dose.

52. The method of any one of claims 49-51, wherein the animal is a human.

53. A method of preparing a composition of any one of claims 1-47, comprising spray drying, extruding, milling, lyophilizing, fluidized bed spray coating, or a combination thereof.
